(19) United States
(12) Patent Application Publication
(10) Pub. No.: US 2026/0071023 A1
(43) Pub. Date: Mar. 12, 2026

(54) POLYESTER THERMOSETS FROM ESTER-CONTAINING EPOXY AND AMINE COMPONENTS

(71) Applicants: Derek Patton, Hattiesburg, MS (US); Jeffrey Aguinaga, Hattiesburg, MS (US)

(72) Inventors: Derek Patton, Hattiesburg, MS (US); Jeffrey Aguinaga, Hattiesburg, MS (US)

(73) Assignee: The University of Southern Mississippi, Hattiesburg, MS (US)

(21) Appl. No.: 19/291,016

(22) Filed: Aug. 5, 2025

Related U.S. Application Data
(60) Provisional application No. 63/679,288, filed on Aug. 5, 2024.

(51) Int. Cl. C08G 59/24; C08G 59/50; C08L 63/00

(52) U.S. Cl. CPC C08G 59/245; C08G 59/504; C08L 63/00

(57) ABSTRACT

The present invention relates to difunctional aryl ether epoxy monomers that contain aliphatic or aromatic ester linkages and regularly-embedded short flexible spacers, and to thermosets produced via polymerization of the epoxy monomers with either ester-containing aryl diamine or non-ester-containing diamine monomers. Where ester-containing aryl diamine monomers are used, the distribution of aromatic ester linkages and short flexible spacers into each network strand augments fracture toughness and impact resistance of the resultant polyester thermosets with limited loss in strength and modulus relative to conventional aromatic diepoxide-aryl diamine thermosets.

### CROSS-REFERENCE TO RELATED APPLICATIONS

This application claims the benefit of U.S. provisional application No. 63/679,288, filed on Aug. 5, 2024, the disclosure of which is hereby incorporated by reference in its entirety as if fully set forth herein.

### STATEMENT OF GOVERNMENT SUPPORT

This invention was made with government support under contract #W912HZ21C0029; BAA 20-0110 awarded by the US Army Corps of Engineers—Engineer Research and Development Center. The Government has certain rights in the invention.

### BACKGROUND

Epoxy thermosets are extensively used in coating, electrical (e.g., power transmission equipment and motors), electronic (e.g., printed circuit boards, component encapsulation), fibrous composites, and structural and non-structural adhesive applications. High thermal/electrical/corrosion resistance, good mechanical behavior, ease of polymerization, and low cure shrinkage/lack of condensation byproducts are common attributes, though properties can vary widely as a function of several factors. Epoxy monomers polymerize via the epoxide (oxirane) group either cationically or anionically through chain growth mechanisms, or via a step-growth mechanism with active-hydrogen compounds (amines, thiols, etc.) as comonomers. In step-growth polymerization, material properties are controllable through systematic structural variation of the epoxide monomer, the active hydrogen component or both. Diglycidyl ether of bisphenol A (DGEBA) in monomeric/oligomeric form is the most common epoxide component in terms of volume usage and constitutes an estimated 75-90% of epoxy systems currently in use.

DGEBA is derived from bisphenol A (bis(4-hydroxyphenylene)-2,2-propane, BPA) via condensation of two equivalents of phenol with acetone—both produced in the cumene process. Although epichlorohydrin—known as the typical epoxidation agent for BPA—is produceable via reaction of biobased glycerol and hydrochloric acid, the typical production route is based on propylene allylic chlorination and hypochlorination. Six million tons of BPA were produced globally in 2017, and 30% of it was converted to DGEBA, with the remainder predominately used in polycarbonate production. The petrochemical derivation and its classification as an endocrine disruptor are potential concerns. The abundance of biologically produced or bioderivable phenolic compounds offers many options for substitution of bisphenol A (and by extension DGEBA). Phenolic compounds that contain one or more carboxylic acid functionalities are of interest since their reaction with alcohols enables the formation of ester-linked bisphenols. Examples of ester-linked bisphenols for polymeric use are found in US2019/0023644, where the bisphenol compounds are employed as precursors to polyarylates and polycarbonates. Several researchers have derived epoxy monomers from ester-linked bisphenols. In 1979, Kakiuchi et al. synthesized ester-linked bisphenols derived from para-hydroxybenzoic acid (pHBA) and several aliphatic dihalides, and then epoxidized the bisphenols via an ECH/base process and studied the structure-property relationships of the diepoxide monomers and polymers derived from those monomers. (Kakiuchi, H. a. T., S. New Epoxy Resins from Alkylene-bis-(p-hydroxy benzoate). ACS Organic Coatings and Plastics Division 1979, 40, ACS pre-prints). In another example, Fourcade et al. used pHBA and 1,6-hexanediol to synthesize a difunctional ester-containing epoxy monomer. (Fourcade, D.; Ritter, B. S.; Walter, P.; Schanfeld, R.; Miilhaupt, R. Renewable resource-based epoxy resins derived from multifunctional poly(4-hydroxybenzoates). Green Chemistry 2013, 15 (4), 910-918).

Additionally, in WO2014162219 A2, p-coumaric acid and aliphatic diols were used to form ester-containing diepoxide monomers for use in photo-responsive hydrophilic coatings (cis-trans isomerizable upon exposure to UV or visible light) and polymerizable with a wide range of UV curing agents and/or active hydrogen compounds. Several other researchers have preinstalled ester functionality into epoxy monomers (many focusing on the aspects of bisphenol A replacement and/or bioderivability), and some have evaluated hydrolysis of the ester groups of the epoxy-amine networks to gauge chemical recyclability of the epoxy thermosets.

Among routes to epoxy/amine-derived polyester thermosets, preinstallation of ester functionality into amine monomers is also possible (in addition to preinstallation into the epoxide monomer). There are several ways to form aromatic ester-containing diamine compounds (e.g. transesterification of amino-benzoates with alcohols/diols, esterification of amine-containing aromatic carboxylic acids, and esterification of nitrobenzoic acids or transesterification of nitrobenzoates with alcohols/diols and subsequent reduction of the nitro functionality to amine). For example, in WO2000029368 the transesterification of aminobenzoates is described as a process to prepare para-substituted alkanediol diaminobenzoates, including several aromatic diamine structures used to form the polyester thermosets of the present invention. US20030212291 describes preparation of many meta-substituted equivalent structures for use in polyurethane-polyurea elastomers, including several aromatic diamine structures used to form the polyester thermosets of the present invention.

Aromatic ester-containing diamines have been used to form several types of ester-containing polymeric materials. For example, polyimides with low dielectric constants, as reported in CN118440321. Polyesteramides and polyurethanes are additional classes of ester-containing polymers derived aromatic ester-containing diamines. Ester-containing diamine compounds have been used in epoxy-derived thermoset polymers. For example, Cui et al (Cui, H.-w.; Li, D.-s.; Fan, Q. Adhesion of a novel flexible epoxy molding compound and its molecular dynamics simulation. International Journal of Adhesion and Adhesives 2012, 35, 50-54.) used an aromatic ester-containing diamine to augment molecular flexibility in a thermoset novolac-type epoxy molding compound for electronic applications. EP2842735 A1 also lists the use of aromatic ester-containing diamines as components in underfill formulations for electronic assemblies. Another example of an epoxy-derived polymer from an ester-containing diamine is found in JP2014055251 A, where the epoxy compound is a mesogenic terphenyl epoxy. An additional example of epoxy polymer derived from an ester-containing diamine is found in Harada, M.; Okamoto, N.; Ochi, M. Influence of the introduction of flexible alkyl chains on the thermal behavior and mechanical properties of mesogenic epoxy thermosets. Journal of Applied Polymer Science 2016, 133 (47), where the mesogenic epoxy monomer had imine functionality.

In Japanese Patent Application JPH11323162A, thermosets for use as thermally conductive/electrically-insulative materials for electric and electronic application derivable from several mesogenic epoxy monomers (including several that contained aromatic ester functionality) and several diamines are described. One aromatic ester-containing diamine (4,4′-diaminophenylbenzoate) was described as a hardener/comonomer. The ester groups of both the diepoxide and diamine are directly connected at either end to phenylene units. Unlike JPH11323162A, the present invention employs both ester-bridged difunctional epoxides and ester-bridged difunctional amines with short aliphatic spacers internal to the rigid phenylene units to produce thermoset polyesters. This results in a repeating network structure with uniform distribution of flexible and rigid segments in every strand—a structural design that constitutes a strategy to increase molecular mobility and, by extension, energy dissipation under quasi-static or dynamic loading, resulting in enhanced fracture toughness, impact resistance, and thermal shock resistance. This distribution of structural features enables a unique balance of toughness and rigidity, and improves degradability—none of which are suggested, taught, or enabled by JPH11323162A.

Relatively low fracture toughness, impact resistance, and thermal shock resistance are understood as general limitations of typical epoxy thermosets known to those familiar with the art (Neville, H. L. a. K. Handbook of Epoxy Resins; McGraw-Hill Book Co., 1982). The aromatic ester linkage has a relatively low rotational barrier about the carbonyl/singly bound oxygen linkage, though it is rigid compared to an aliphatic linkage due to direct attachment to a phenyl/phenylene unit. In addition, esterification in general allows the modular introduction of relatively short flexible spacer units. The uniform distribution of both structural features into every network strand could limit internal stress development throughout the polymerization/cure process. Lower internal stress contributes to the material response to mechanical loading and could permit controlled formation of epoxy-thermoset derived parts of increased volume and increased complexity due to maintenance of geometry.

The use of aromatic ester linkages (as opposed to aliphatic) and the limitation to relatively short spacer units could mitigate the decrease in strength properties relative to industrially-relevant DGEBA-derived thermosets—particularly those cured with aromatic amine compounds. While the compact, rigid aromatic structure of DGEBA can contribute to good mechanical properties and thermal/chemical resistance in the resultant thermosets (in particular when an aromatic amine is the comonomer), limited molecular mobility results in poor resistance to fracture under static or dynamic loading or thermal shock. Although many strategies known to increase the toughness of epoxies rely on phase-separated domains of disparate materials (for example: elastomers, ductile thermoplastics, hyperbranched polymers), processing drawbacks related to their high viscosity and the complexity of the phase-separation process place limitations on these materials. Intrinsic toughness (specific to the epoxy thermoset itself and unrelated to a phase separated component) is possible through modulation of monomer stoichiometry, functionality and/or chemical composition. If intrinsic toughness is improved, it is still possible to further augment toughness using the above-mentioned approaches or addition of fibrous or particulate inorganic fillers.

Stoichiometry and functionality (in addition to polymerization conditions) regulate the fraction of elastically-active network strands and crosslink density. Crosslink density can limit molecular mobility through confinement of motions available to the chemical structure. Levita et al. found an inversely proportional relationship of fracture toughness and crosslink density in evaluation of several DGEBA oligomer-4,4′-diaminodiphenylsulfone (4,4′-DDS) systems. (Levita, G.; De Petris, S.; Marchetti, A.; Lazzeri, A. Crosslink density and fracture toughness of epoxy resins. Journal of Materials Science 1991, 26 (9), 2348-2352). Although the use of conventional long chain aliphatic flexibilizers (for example: epoxidized polyether glycols or long chain diglycidyl esters) can decrease crosslink density and add molecular flexibility and thereby provide an increase in toughness, modulus and strength are typically severely affected. An example of a subtle molecular modification strategy in an epoxy thermoset through addition of flexible linkages is described in Grillet et al. (Grillet, A. C.; Galy, J.; Gérard, J.-F.; Pascault, J.-P. Mechanical and viscoelastic properties of epoxy networks cured with aromatic diamines. Polymer 1991, 32 (10), 1885-1891.) which integrated additional phenoxy linkages into 4,4-diaminodiphenylmethane (4,4′-DDM) and 4,4′-DDS. The additional ether linkages augmented the rotational ability of the network strands with only a minor decrease in crosslink density. The fracture toughness among the modified and reference networks varied by nearly a factor of three—with modest crosslink density differences unable to completely account for the substantial fracture toughness variations—an indication of the contribution of structural flexibility of the aromatic-ether modified amines to the fracture toughness.

Preinstallation of ester functionality into the epoxy monomer and/or amine monomer and subsequent polymerization with amines is one of multiple epoxy-based routes to polyester thermosets. An alternate route to epoxy-derived polyester thermosets is through reaction of an epoxy monomer that lacks ester functionality with an anhydride or carboxylic acid. In epoxy/anhydride or epoxy/acid systems, the placement of flexible spacers is less controllable as the ester linkages are formed on polymerization. Epoxy-anhydride reactions are complex, as anhydride functionality cannot directly react with epoxide. Anhydrides can react with hydroxyl groups present to form carboxylic acid functionality and ester linkages. Epoxide/hydroxyl reaction (etherification) can also occur, and formed carboxylic acid can promote this reaction—though basic accelerators that promote the esterification reaction are also commonly used.

In both epoxy/anhydride and epoxy/amine derived polyesters, there is the ability to depolymerize via ester hydrolysis or alcoholysis—of potential utility from and end-of-use processing standpoint. Clarke et al demonstrated degradation via high-pressure methanolysis of epoxy-anhydride glass fiber composites. (Clarke, R. W.; Rognerud, E. G.; Puente-Urbina, A.; Barnes, D.; Murdy, P.; McGraw, M. L.; Newkirk, J. M.; Beach, R.; Wrubel, J. A.; Hamernik, L. J.; et al. Manufacture and testing of biomass-derivable thermosets for wind blade recycling. Science 2024, 385 (6711), 854-860.) In epoxy-amine derived polyester thermosets, the uniform and widespread distribution of ester linkages improves the ability to depolymerize via hydrolysis or alcoholysis—as those processes occur at the ester linkages.

In addition to epoxy/anhydride and epoxy/acid-derived polyesters, there are two principal types of conventional network polyesters; alkyds and unsaturated polyesters (UPEs). As for epoxy/anhydride and epoxy/acid systems, ester functionality is formed by condensation polymerization rather than preinstallation in monomeric components. There are two principal types of conventional network polyesters: alkyds and unsaturated polyesters (UPEs). Alkyds are typically used for coating applications and are derived from polybasic acids or acid anhydrides (examples are: phthalic anhydride, isophthalic acid, maleic anhydride, and fumaric acid), polyols (examples are: pentaerythritol, glycerol, trimethylolpropane, trimethylolethane, ethylene glycol, and neopentyl glycol), and monobasic saturated and unsaturated fatty acids. Crosslinks are possible where the functionality of the polyol exceeds two, and via the alkene content of the unsaturated fatty acids in the presence of oxygen. UPEs are produced via condensation of diacids and diols with alkene containing acids or anhydrides. As in alkyds, the alkenes act as crosslink sites in UPEs. Unlike alkyds though, radically polymerizable monomers like styrene are used to link the linear polyester chains together and 25%-45% by weight of radically polymerizable crosslinker is typical. UPEs are typically used in glass fiber reinforced composites (processed as bulk molding or sheet molding compounds) where there is overlap in application scope with epoxy systems.

### SUMMARY OF THE INVENTION

The present invention relates to ester-containing disubstituted aryl glycidyl ether monomers (aromatic diepoxide monomers) and polyester thermosets derived from those monomers and ester-containing and non-ester containing diamine monomers. The diepoxide monomers are derived from ester-containing bisphenols producible via phenolic carboxylic acids such as para-hydroxybenzoic acid (pHBA), meta-hydroxybenzoic acid (mHBA), ortho-hydroxybenzoic acid, para-hydroxyphenylacetic acid (pHPAA), and para-hydroxyphenylpropanoic acid (pHPPA) and either aliphatic diols such as 1,2-ethanediol or 1,3-propanediol or phenolic alcohols such as para-hydroxyphenethyl alcohol (tyrosol or TY) or meta-hydroxyphenethyl alcohol or cyclic aliphatic diols.

Structural variation in phenolic acid and alcohol components enables the synthesis of para- and meta-substituted ester-containing bisphenols. The phenolic content of the bisphenols is epoxidized (for example, via reaction with epichlorohydrin and sodium hydroxide or via reaction with allyl bromide and subsequently meta-chloroperoxybenzoic acid) and results in formation of diepoxide monomers. Thermosets are formed via reaction of the diepoxide monomers with diamine monomers (for example, isophorone diamine or an ester-containing diamine). Variation in the diepoxide monomer bridge length (i.e. the structural span in-between aryl units), steric and electronic factors, and the number of ester groups in the monomer(s) enables variation of thermomechanical and ambient-temperature mechanical properties and the depolymerizablity of the thermosets. In contrast to phase-separated toughening strategies, the present invention achieves enhanced toughness and impact resistance through molecular-level design. By distributing aromatic ester linkages and flexible aliphatic spacers uniformly throughout the network via both diepoxide and diamine monomer structures, the current invention avoids the high viscosity, mixing difficulties, and phase compatibility challenges typically associated with multiphase systems.

Examples of ester-containing diamine monomers that the present invention relates to are derived from methyl para- or meta- or ortho-nitrobenzoate and para- or meta-nitrophenethyl alcohol or cyclic or acyclic aliphatic diols. In the case that polyester thermosets of the present invention are formed from the ester-containing diamines and ester-containing diepoxides, the presence of ester functionality and aliphatic spacer units in both monomer types prompts the distribution both types of structural features into every network strand. Activation energies for formation of the polyester thermosets are intermediate to those of non-ester containing aromatic epoxy/amine reference networks derived from DGEBA and industrially-relevant aromatic diamines 4,4′DDM or 4,4′-DDS—an indication that the requisite energy input for polymerization is within an acceptable range. Modulation in thermomechanical and mechanical properties among this type of polyester thermoset is accomplished via modification of bridge length, aromatic substitution pattern, and the number of ester groups of both diepoxide and diamine monomers. For example, an increase in the bridge length or meta-substitution depresses glass transition temperature. Tensile and flexural strengths and moduli increase with meta-substitution and ester content and decreased as bridge length increased. Although all polyester thermosets exhibit lower glass transition temperatures than reference DGEBA-4,4′-DDM or 4,4′-DDS thermosets and marginally lower thermal stability, tensile and flexural strengths and moduli are comparable and flexural toughness, plane-strain fracture toughness, impact resistance, and certain adhesive properties are higher for the epoxy/amine-derived polyester thermosets vs. DGEBA-4,4′DDM or 4,4′-DDS. This comparable strength and moduli are unexpected, as increased molecular mobility is typically associated with reductions in those properties. The retention of strength and modulus despite the introduction of ester linkages and flexible spacers indicates a unique balance of flexibility and rigidity enabled by the strategy of the present invention. Additionally, lower mechanical property loss is observed upon addition of inorganic particulate filler relative to conventional aromatic diepoxide/diamine-derived thermosets. In contrast to conventional epoxy/amine-derived thermosets, depolymerization via ambient-pressure glycolysis or high-pressure methanolysis of the ester linkages of the polyester thermosets of present invention is possible. Although this process is not circular (the recoverable compound differs from the initial monomers), the polyester thermosets are degradable generally on the same order of magnitude in time scale as thermoplastic aromatic polyester poly(ethylene terephthalate) (PET).

The present invention may be described by the following sentences.

1. In a first aspect, the present invention relates to a polyester thermoset produced from an ester-bridged diepoxide monomer and a diamine, comprising a crosslinked network, wherein the ester-bridged diepoxide monomer is selected from the group consisting of monomers of the Formulae (I)-(VI):

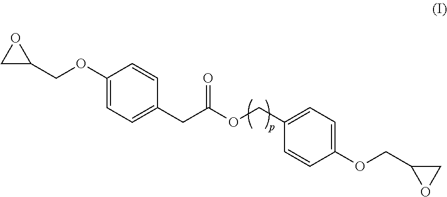

wherein m is an integer between 1 and 10, or between 1 and 3; and p is an integer between 1 and 10, or between 1 and 5, or between 1 and 3;

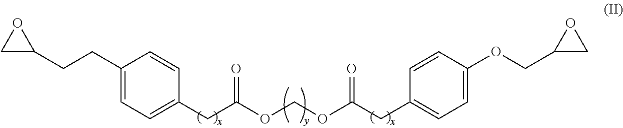

wherein x an integer between 1 and 10, or between 1 and 3; and y is an integer between 1 and 10, or between 1 and 5;

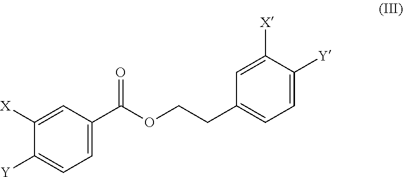

wherein X, Y, X′, and Y′ are each independently selected from

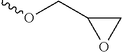

and H, and the pairs X and Y and X′ and Y′ are not the same, and optionally, the monomer of Formula (III) is selected from 2-(4-glycidyloxyphenethyl) 4-glycidyloxybenzoate (para-para), and 2-(3-glycidyloxyphenethyl) 3-glycidyloxybenzoate (meta-meta), and

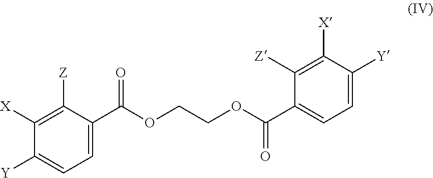

wherein X, X′ are both

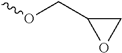

and the pairs Y, Y′, or Z, Z′ are H;
Y, Y′ are both

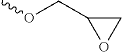

and the pairs X, X′ and Z, Z′ are H; or
Z, Z′ are both

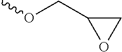

and the pairs X, X′ and are H, and optionally, the monomer of Formula (IV) is selected from ethyl-1,2-bis-4-glycidyloxybenzoate (para-para),ethyl-1,2-bis-3-glycidyloxybenzoate (meta-meta), and ethyl-1,2-bis-2-glycidyloxybenzoate (ortho-ortho); and

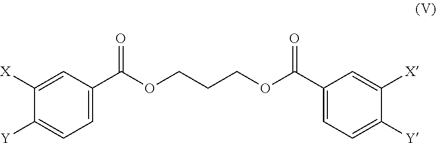

wherein X, Y, X′, and Y′ are each independently selected from

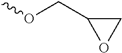

and H, and the pairs X and Y and X′ and Y′ are not the same, and optionally, the monomer of Formula (V) is selected from propyl-1,3-bis-4-glycidyloxybenzoate (para-para), propyl-1,3-bis-3-glycidyloxybenzoate (meta-meta); and

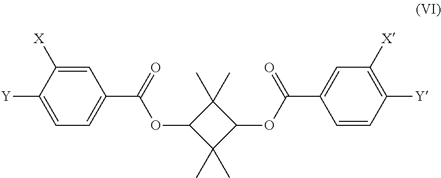

wherein X, Y, X′, and Y′ are each independently selected from

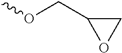

and H, and the pairs X and Y, and X′ and Y′ are not the same.
   2. The polyester thermoset of sentence 1, wherein the diamine monomer is selected from the group consisting of isophorone diamine, diaminocyclohexane, 4,4′methylenebis(cyclohexan-1-amine), diethyl-toluene-diamine, p-phenylenediamine, m-phenylenediamine, 4,4′-diaminodiphenylmethane, 4,4′-diaminodiphenylsulfone, 3,3′-diaminodiphenylsulfone, and a diamine according to Formulae (VII)-(VI):

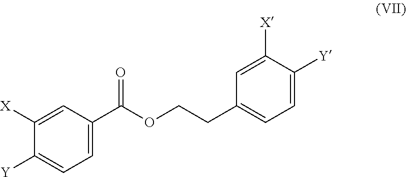

wherein X, Y, X′, and Y′ are each independently selected from NH₂ and H, wherein the pairs X and Y, and X′ and Y′ are not the same, and

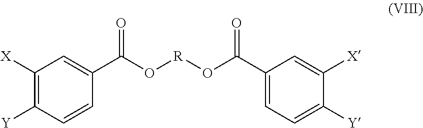

wherein R is selected from a hydrocarbylene group comprising 2 or 3 carbon atoms, and a cycloalkane ring having 4 carbon atoms and is optionally substituted with two or more methyl groups.
   3. The polyester thermoset of any one of sentences 1-2, wherein the crosslinked network is formed by curing at a temperature range of from about 60° C. to 200° C.
   4. The polyester thermoset of any one of sentences 1-3, wherein Formulae (I) is a compound selected from:
a) 4-glycidyloxyphenethyl 2-(4-glycidyloxyphenyl)acetate

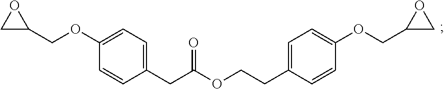 [SMILES: O=C(Cc1ccc(OCC2CO2)cc1)OCCc1ccc(OCC2CO2)cc1]

and
b) 4-glycidyloxyphenethyl 3-(4-glycidyloxyphenyl)propanoate

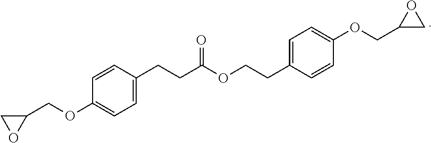 [SMILES: O=C(CCc1ccc(OCC2CO2)cc1)OCCc1ccc(OCC2CO2)cc1]

5. The polyester thermoset according to any one of sentences 1-3, wherein Formula (II) is a compound selected from:
a) 2-[(4-glycidyloxyphenyl)acetyloxy]ethyl 4-glycidyloxyphenylacetate

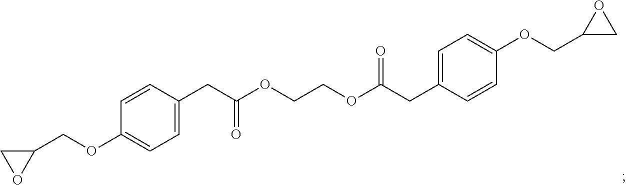 [SMILES: O=C(Cc1ccc(OCC2CO2)cc1)OCCOC(=O)Cc1ccc(OCC2CO2)cc1]

b) 2-[3-(4-glycidyloxyphenyl)propanoyloxy]ethyl 3-(4-glycidyloxyphenyl)propanoate

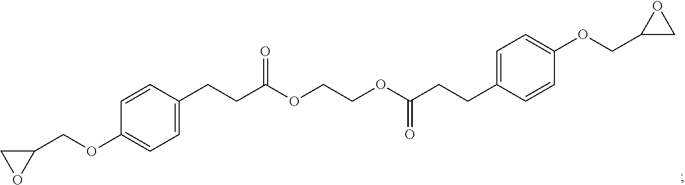 [SMILES: O=C(CCc1ccc(OCC2CO2)cc1)OCCOC(=O)CCc1ccc(OCC2CO2)cc1]

c) 3-[4-glycidyloxyphenyl)acetyloxy]propyl 4-glycidyloxyphenylacetate

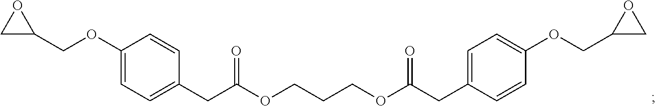 [SMILES: O=C(Cc1ccc(OCC2CO2)cc1)OCCCOC(=O)Cc1ccc(OCC2CO2)cc1]

and
d) 3-[3-(4-glycidyloxyphenyl)propanoyloxy]propyl 3-(4-glycidyloxyphenyl)propanoate

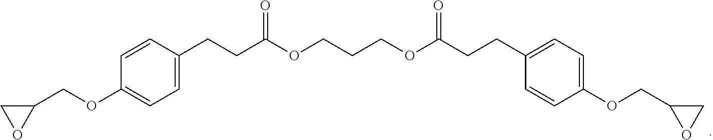 [SMILES: O=C(CCc1ccc(OCC2CO2)cc1)OCCCOC(=O)CCc1ccc(OCC2CO2)cc1]

6. The polyester thermoset according to any one of sentences 1-3, wherein Formula (III) is a compound selected from:
a) 2-(4-glycidyloxyphenethyl) 4-glycidyloxybenzoate

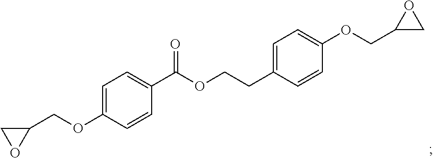 [SMILES: O=C(OCCc1ccc(OCC2CO2)cc1)c1ccc(OCC2CO2)cc1]

and
b) 2-(3-glycidyloxybenzoyl)oxyethyl 3-glycidyloxybenzoate

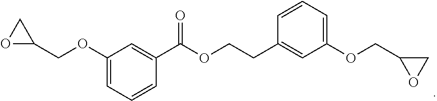 [SMILES: O=C(OCCc1cccc(OCC2CO2)c1)c1cccc(OCC2CO2)c1]

7. The polyester thermoset according to any one of sentences 1-3, wherein Formula (IV) is a compound selected from:
a) ethyl-1,2-bis-4-glycidyloxybenzoate

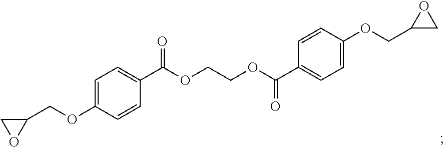 [SMILES: O=C(OCCOC(=O)c1ccc(OCC2CO2)cc1)c1ccc(OCC2CO2)cc1]

b) ethyl-1,2-bis-3-glycidyloxybenzoate

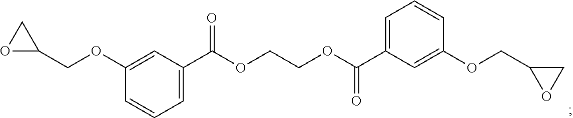 [SMILES: O=C(OCCOC(=O)c1cccc(OCC2CO2)c1)c1cccc(OCC2CO2)c1]

and
c) ethyl-1,2-bis-2-glycidyloxybenzoate

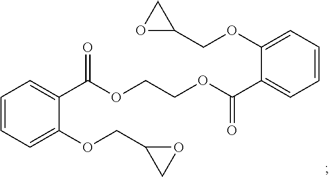 [SMILES: O=C(OCCOC(=O)c1ccccc1OCC1CO1)c1ccccc1OCC1CO1]

7. The polyester thermoset according to any one of sentences 1-3, wherein Formula (V) is a compound selected from:
a) propyl-1,3-bis-4-glycidyloxybenzoate

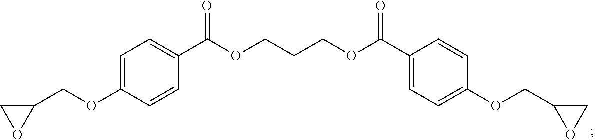 [SMILES: O=C(OCCCOC(=O)c1ccc(OCC2CO2)cc1)c1ccc(OCC2CO2)cc1]

and
b) propyl-1,3-bis-3-glycidyloxybenzoate

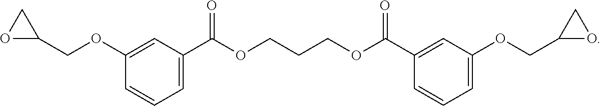 [SMILES: O=C(OCCCOC(=O)c1cccc(OCC2CO2)c1)c1cccc(OCC2CO2)c1]

8. The polyester thermoset according to any one of sentences 1-3, wherein Formula (VI) is a compound selected from:
a) 2,2,4,4-tetramethylcyclobutane-1,3-diyl-bis-4-glycidyloxybenzoate

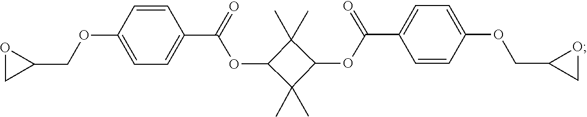 [SMILES: CC1(C)C(OC(=O)c2ccc(OCC3CO3)cc2)C(C)(C)C1OC(=O)c1ccc(OCC2CO2)cc1]

and
b) 2,2,4,4-tetramethylcyclobutane-1,3-diyl-bis-3-glycidyloxybenzoate

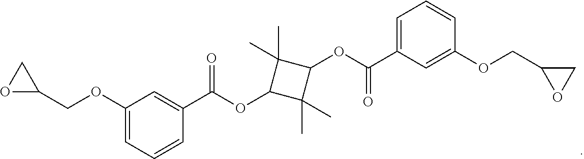 [SMILES: CC1(C)C(OC(=O)c2cccc(OCC3CO3)c2)C(C)(C)C1OC(=O)c1cccc(OCC2CO2)c1]

9. The polyester thermoset according to sentence 2, wherein the diamine of Formula (VII) is a compound selected from:
a) 4-aminophenethyl 4-aminobenzoate

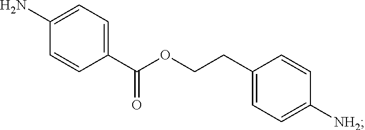 [SMILES: Nc1ccc(CCOC(=O)c2ccc(N)cc2)cc1]

and
b) 3-aminophenethyl 3-aminobenzoate

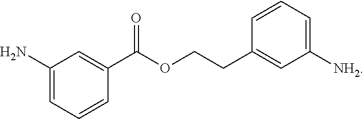 [SMILES: Nc1cccc(CCOC(=O)c2cccc(N)c2)c1]

10. The polyester thermoset according to sentence 2, wherein the diamine of Formula (VIII) is a compound selected from:
a) ethyl-1,2-bis-4-aminobenzoate

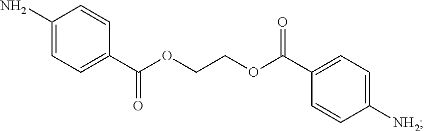 [SMILES: Nc1ccc(C(=O)OCCOC(=O)c2ccc(N)cc2)cc1]

b) ethyl-1,2-bis-3-aminobenzoate

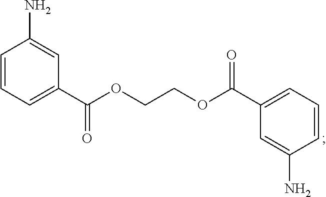 [SMILES: Nc1cccc(C(=O)OCCOC(=O)c2cccc(N)c2)c1]

c) propyl-1,3-bis-4-aminobenzoate

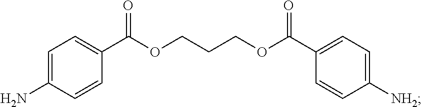 [SMILES: Nc1ccc(C(=O)OCCCOC(=O)c2ccc(N)cc2)cc1]

d) propyl-1,3-bis-3-aminobenzoate

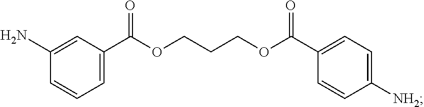 [SMILES: Nc1ccc(C(=O)OCCCOC(=O)c2cccc(N)c2)cc1]

e) 2,2,4,4-tetramethylcyclobutane-1,3-diylbis(4-aminobenzoate)

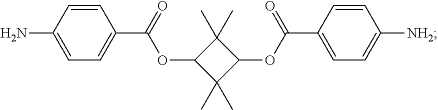 [SMILES: CC1(C)C(OC(=O)c2ccc(N)cc2)C(C)(C)C1OC(=O)c1ccc(N)cc1]

and
f) 2,2,4,4-tetramethylcyclobutane-1,3-diyl bis(3-aminobenzoate)

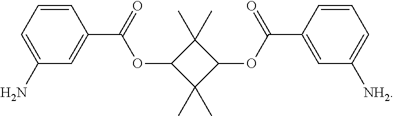 [SMILES: CC1(C)C(OC(=O)c2cccc(N)c2)C(C)(C)C1OC(=O)c1cccc(N)c1]

11. The polyester thermoset of any one of sentences 1-9, wherein a moiety of the polyester thermoset is prepared by reacting the diepoxide monomer and the diamine such that a molar ratio of an epoxide group of the diepoxide and an amine hydrogen of the diamine is from about 1:0.5 to 1:2, or about 1:1.
12. In a second aspect, the present invention relates to a method for producing a polyester thermoset comprising steps of:
reacting one or more diepoxide monomers with one or more diamine monomers to form a mixture, wherein the one or more diepoxide monomers is according to Formulae (I)-(VI):

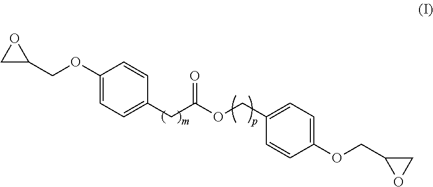

wherein m is an integer between 1 and 10, or between 1 and 3; and p is an integer between 1 and 10, or between 1 and 5, or between 1 and 3;

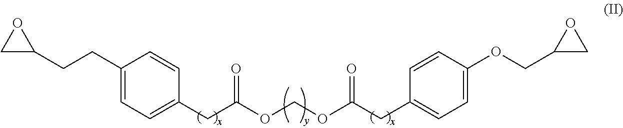

wherein x is an integer between 1 and 10, or between 1 and 3; y is an integer between 1 and 10, or between 1 and 3;

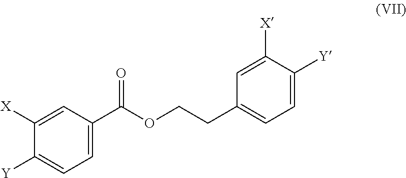

wherein X, Y, X′, and Y′ are each independently selected from

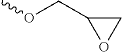

and H, and the pairs X and Y and X′ and Y′ are not the same, and optionally, the monomer of Formula (III) is selected from 2-(4-glycidyloxyphenethyl) 4-glycidyloxybenzoate (para-para), 2-(3-glycidyloxyphenethyl) 3-glycidyloxybenzoate (meta-meta),

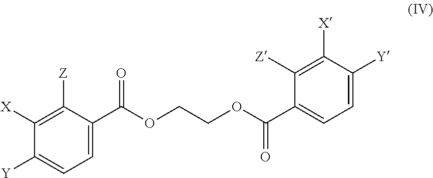

wherein X, X′ are both

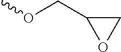

and the pairs Y, Y′, or Z, Z′ are H or Y, Y′ are both

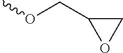

and the pairs X, X′ and Z, Z′ are H, or Z, Z′ are both

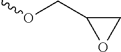

and the pairs X, X′ and are H, and optionally, the monomer of Formula (IV) is selected from ethyl-1,2-bis-4-glycidyloxybenzoate (para-para),ethyl-1,2-bis-3-glycidyloxybenzoate (meta-meta), and ethyl-1,2-bis-2-glycidyloxybenzoate (ortho-ortho);

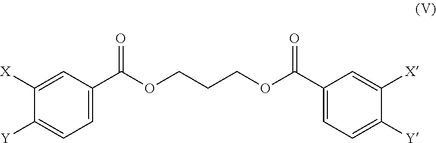

wherein X, Y, X′, and Y′ are each independently selected from

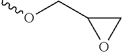

and H, and the pairs X and Y and X′ and Y′ are not the same, and optionally, the monomer of Formula (V) is selected from propyl-1,3-bis-4-glycidyloxybenzoate (para-para), propyl-1,3-bis-3-glycidyloxybenzoate (meta-meta), and

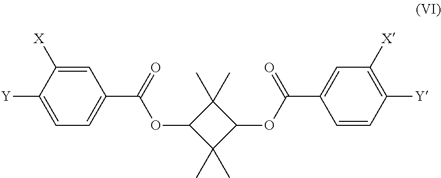

wherein X, Y, X′, and Y′ are each independently selected from

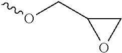

and H, and the pairs X and Y, and X′ and Y′ are not the same; and the one or more diamine monomers is according to Formulae (VII)-(VIII):

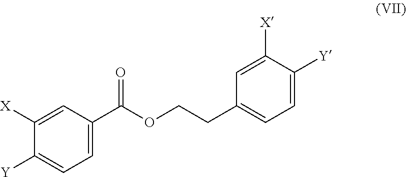

wherein X, Y, X′, and Y′ are each independently selected from NH₂ and H, and wherein the pairs X and Y, and X′ and Y′ are not the same, and

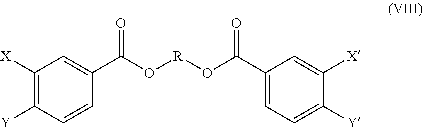

heating the mixture from about 100° C.-150° C. to form a solution; and gradually heating the solution further to a temperature of about 200° C. to form the polyester thermoset comprising a crosslinked network.
   13. In a third aspect, the present invention relates to a diepoxide monomer according to Formulae (I)-(VI):

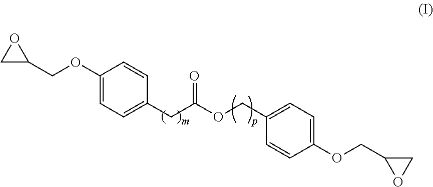

wherein m is an integer between 1 and 10, or between 1 and 3; and p is an integer between 1 and 10, or between 1 and 3;

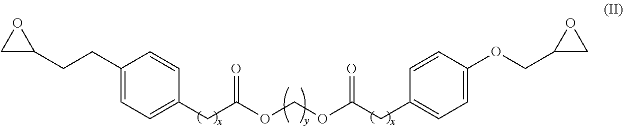

wherein x is an integer between 1 and 10, or between 1 and 3; y is an integer between 1 and 10, or between 1 and 3; and

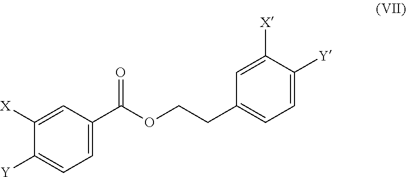

wherein X, Y, X′, and Y′ are each independently selected from

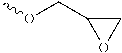

and H, and the pairs X and Y and X′ and Y′ are not the same, and optionally, the monomer of Formula (III) is selected from 2-(4-glycidyloxyphenethyl) 4-glycidyloxybenzoate (para-para), 2-(3-glycidyloxyphenethyl) 3-glycidyloxybenzoate (meta-meta), and

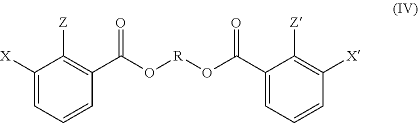

wherein R is a hydrocarbylene group comprising 2 carbon atoms and X, Z, X′, and Z′ are each independently selected from

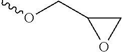

and H, and the pairs X and Z, and X′ and Z′ are not the same and or R is a hydrocarbylene group comprising 3 carbon atoms, and X and X′ are

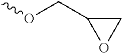

and Z and Z′ are H; and

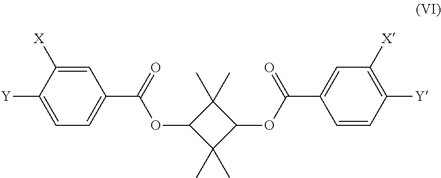

wherein X, Y, X′, and Y′ are each independently selected from

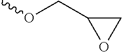

and H, and the pairs X and Y, and X′ and Y′ are not the same.
   14. The monomer according to sentence 13, wherein the compound of the Formula (I) is selected from:
a) 2-[(4-glycidyloxyphenyl)acetxyoxy]ethyl 4-glycidyloxyphenylacetate

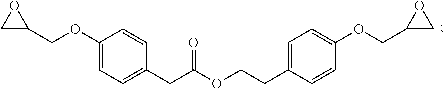 [SMILES: O=C(Cc1ccc(OCC2CO2)cc1)OCCc1ccc(OCC2CO2)cc1]

and
b) 4-glycidyloxyphenethyl 3-(4-glycidyloxyphenyl)propanoate

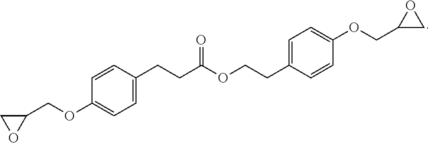 [SMILES: O=C(CCc1ccc(OCC2CO2)cc1)OCCc1ccc(OCC2CO2)cc1]

15. The monomer according to sentence 13, wherein the compound of the Formula (II) is selected from:
a) 2-[(4-glycidyloxypheryl)acetyloxy]ethyl 4-glycidyloxyphenyiacetate

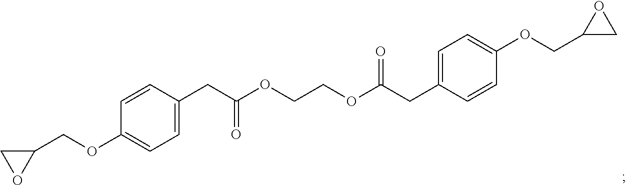 [SMILES: O=C(Cc1ccc(OCC2CO2)cc1)OCCOC(=O)Cc1ccc(OCC2CO2)cc1]

b) 2-[3-(4-glycidyloxyphenyl)propanoyloxy]ethyl 3-(4-glycidyloxyphenyl)propanoate

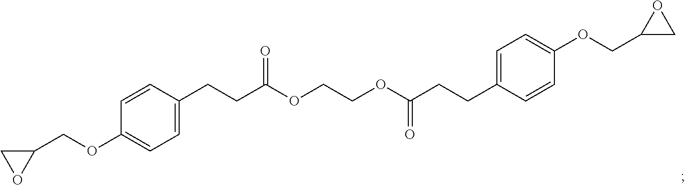 [SMILES: O=C(CCc1ccc(OCC2CO2)cc1)OCCOC(=O)CCc1ccc(OCC2CO2)cc1]

c) 3-[(4-glycidyloxyphenyl)acetyloxy]propyl 4-glycidyloxyphenylacetate

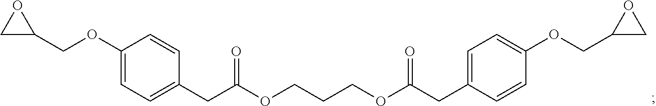 [SMILES: O=C(Cc1ccc(OCC2CO2)cc1)OCCCOC(=O)Cc1ccc(OCC2CO2)cc1]

and
d) 3-[3-(4-glycidyloxyphenyl)propanoyloxy]propyl 3-(4-glycidyloxyphenyl)propanoate

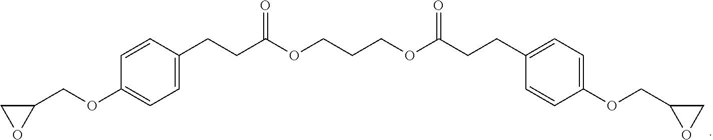 [SMILES: O=C(CCc1ccc(OCC2CO2)cc1)OCCCOC(=O)CCc1ccc(OCC2CO2)cc1]

16. The monomer according to sentence 13, wherein the compound of the Formula (III) is selected from:
a) 2-(4-glycidyloxyphenethyl) 4-glycidyloxybenzoate

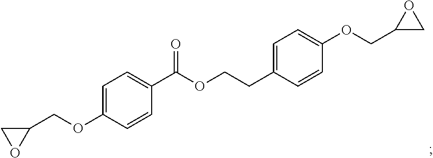 [SMILES: O=C(OCCc1ccc(OCC2CO2)cc1)c1ccc(OCC2CO2)cc1]

and
b) 2-(3-glycidyloxybenzoyl)oxyethyl 3-glycidyloxybenzoate

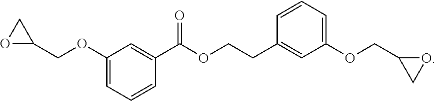 [SMILES: O=C(OCCc1cccc(OCC2CO2)c1)c1cccc(OCC2CO2)c1]

17. The monomer according to sentence 13, wherein the compound of the Formula (IV) is selected from:
a) ethyl-1,2-bis-3-glycidyloxybenzoate

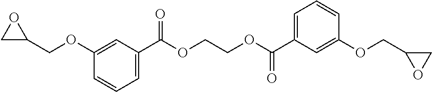 [SMILES: O=C(OCCOC(=O)c1cccc(OCC2CO2)c1)c1cccc(OCC2CO2)c1]

b) ethyl-1,2-bis-2-glycidyloxybenzoate

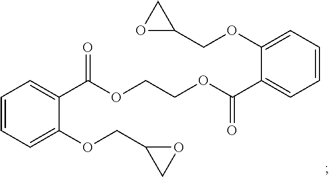 [SMILES: O=C(OCCOC(=O)c1ccccc1OCC1CO1)c1ccccc1OCC1CO1]

and
c) propyl-1,3-bis-3-glycidyloxybenzoate

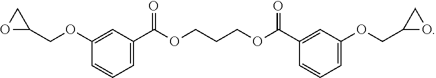 [SMILES: O=C(OCCCOC(=O)c1cccc(OCC2CO2)c1)c1cccc(OCC2CO2)c1]

18. The monomer according to sentence 13, wherein the compound of the Formula (V) is selected from:
a) 2,2,4,4-tetramethylcyclobutane-1,3-diyl-bis-4-glycidyloxybenzoate

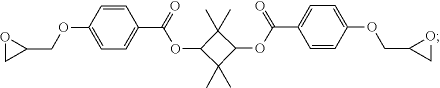 [SMILES: CC1(C)C(OC(=O)c2ccc(OCC3CO3)cc2)C(C)(C)C1OC(=O)c1ccc(OCC2CO2)cc1]

and
b) 2,2,4,4-tetramethylcyclobutane-1,3-diyl-bis-3-glycidyloxybenzoate

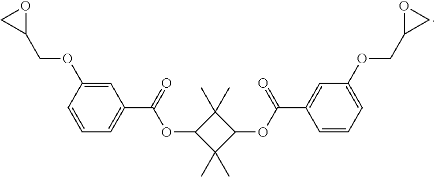 [SMILES: CC1(C)C(OC(=O)c2cccc(OCC3CO3)c2)C(C)(C)C1OC(=O)c1cccc(OCC2CO2)c1]

19. In a fifth aspect, the present invention relates to a polymer comprising one or more moieties prepared by reacting one or more diepoxide monomers according to any one of sentences 13-18 with one or more diamines.
20. The polymer of sentence 19, wherein the one or more moieties have a structure according to Formula (IX):

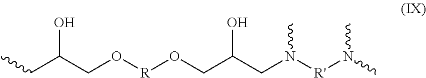

wherein R in Formula (IX) is derived from the diepoxides of Formulae (I)-(VI) of sentence 14 and R′ in Formula (IX) is derived from a diamine, and optionally the diamine may be selected from the group selected from isophorone diamine, diaminocyclohexane, 4,4′methylenebis(cyclohexan-1-amine), 1,3-bis(aminomethyl)cyclohexane, diethyl-toluene-diamine, 4,4′-diaminodiphenylmethane, 4,4′-diaminodiphenylsulfone, 3,3′-diaminodiphenylsulfone, and the diamines according to Formulae (VII) and (VIII) of sentence 12.
   21. The polymer of sentence 19, wherein the polymer comprises one or more moieties according to Formulae (X)-(XXXIII):

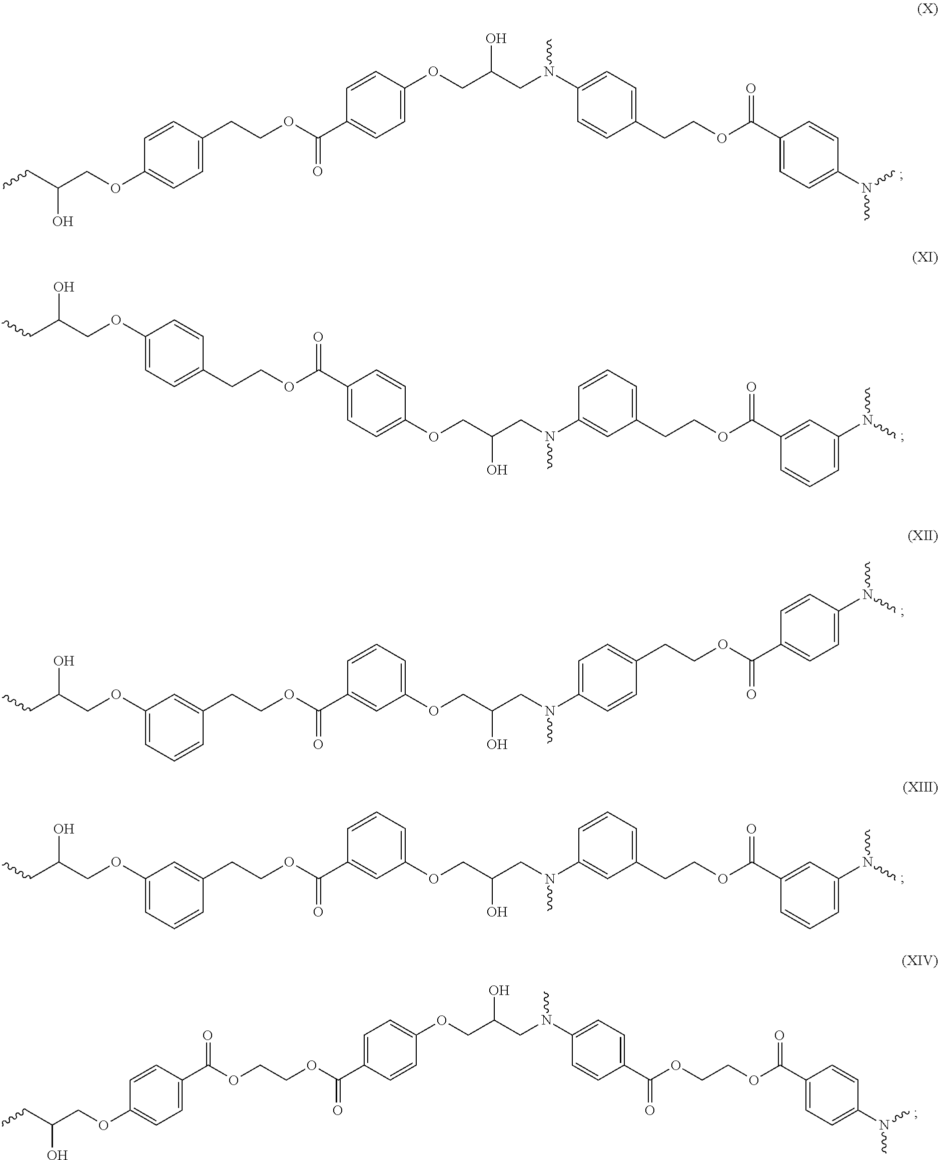

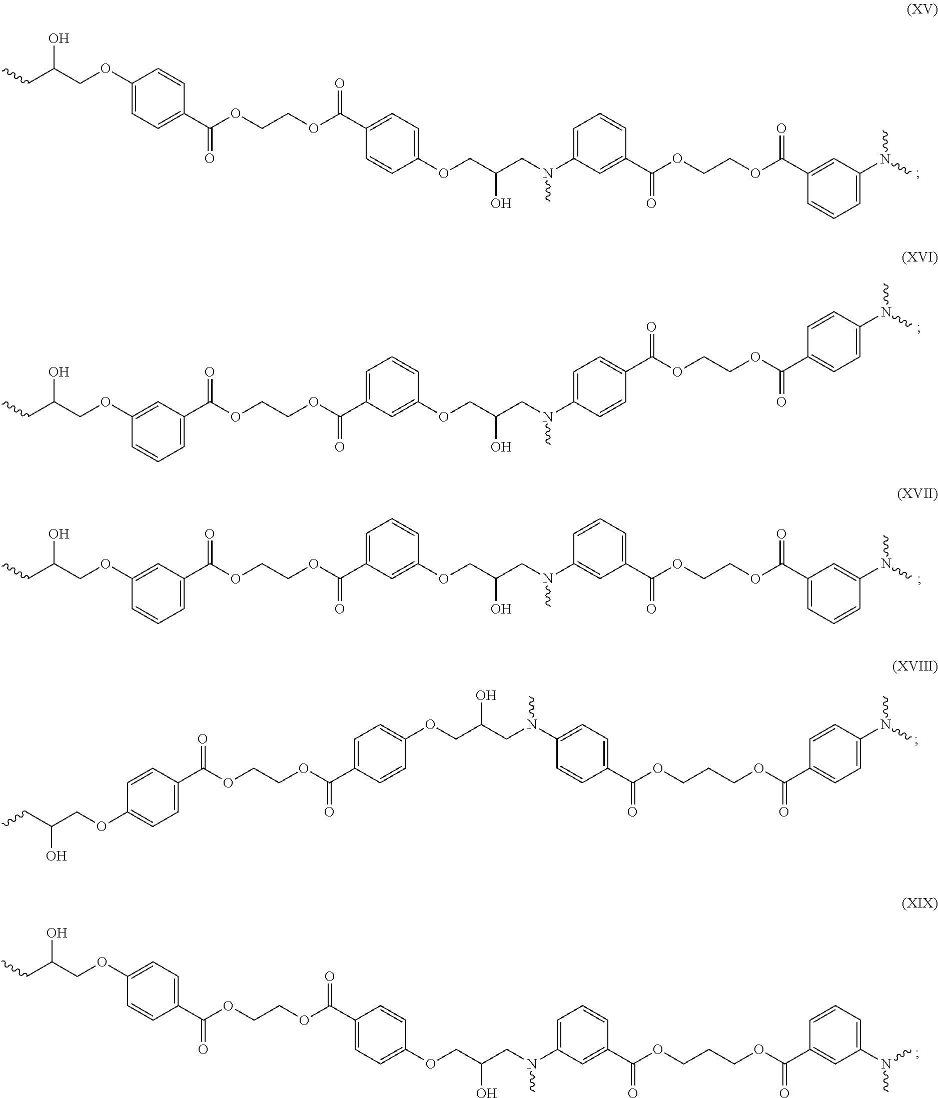

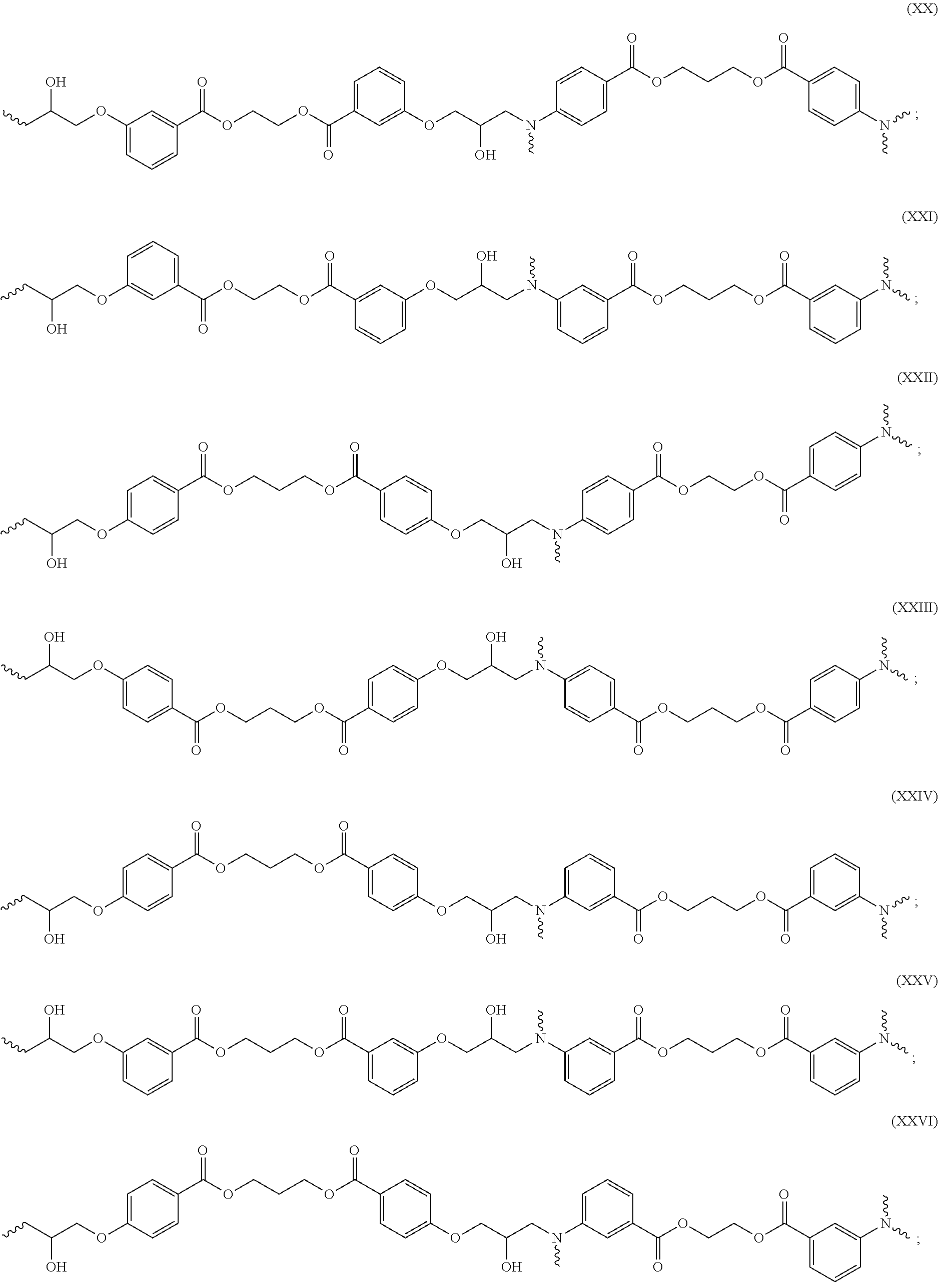

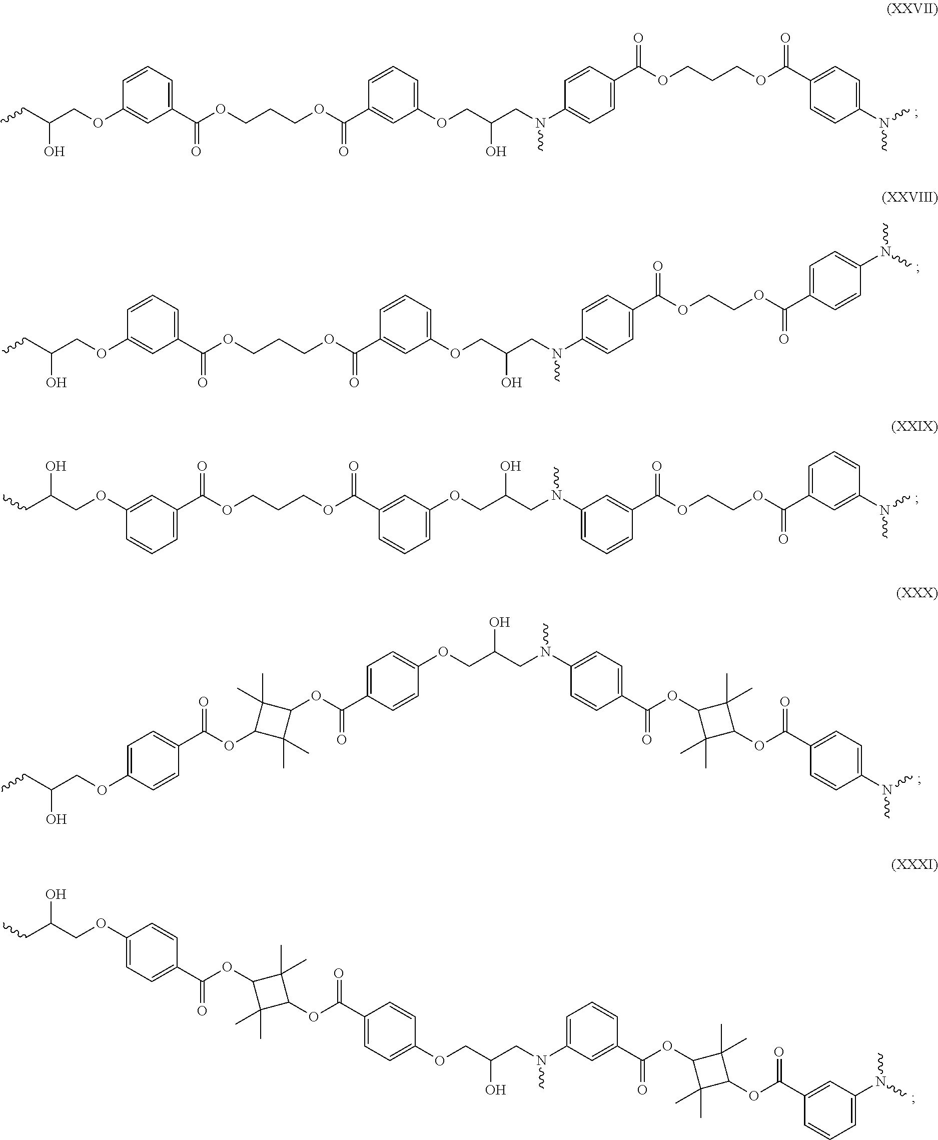

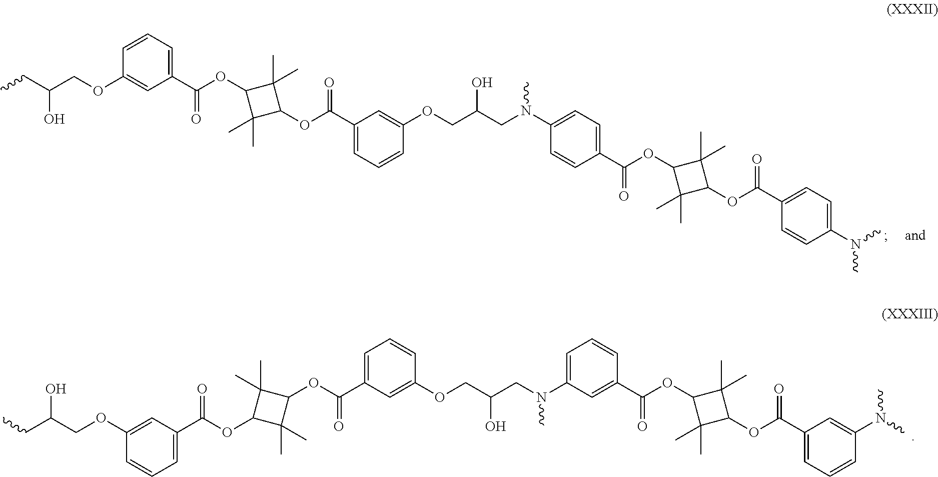

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows monoester-bridged bisphenols prepared via esterification of tyrosol with a series of phenolic acids.

FIG. 1B shows synthetic reaction schemes for forming diester bisphenols.

FIG. 2 shows a variety of bisphenol synthetic pathways according to the present invention.

FIG. 3 shows a proton nuclear magnetic resonance (¹H NMR) spectrum of pHPAA-ED bisphenol as confirmation of structure and purity.

FIG. 4 shows synthetic pathways to diepoxides of the present invention using the monoester/diester bisphenols.

FIG. 5A shows a ¹H NMR spectrum of pHPAA-ED diepoxide monomer.

FIG. 5B shows a carbon nuclear magnetic resonance (¹³C NMR) spectrum of pHPAA-ED diepoxide monomer.

FIG. 6 shows a chart comparing the melting points of diepoxide monomers of the present invention relative to that of DGEBA as determined by differential scanning calorimetry (DSC).

FIG. 7 shows a chart identifying certain diepoxide monomers and corresponding structure.

FIG. 8 shows a generic polymeric network structure obtained from epoxy-amine reaction of an ester-containing diepoxide monomer with the commercially available isophorone diamine (IPDA) (top) and network “repeat unit” (bottom).

FIG. 9 shows an overlaid spectra of the reaction of the pHPAA-ethylene glycol diepoxide and IPDA using a standard 7-hour cure protocol as determined by near-infrared spectroscopy (NIR) spectrometry.

FIG. 10A shows thermogravimetric analysis plots of pHBA-derived and DGEBA networks, at 20° C./min ramp rate under nitrogen (for comparison of thermal stability).

FIG. 10B shows thermogravimetric analysis plots of pHPAA-derived networks, at 20° C./min ramp rate under nitrogen.

FIG. 10C shows thermogravimetric analysis plots of pHPPA-derived networks, at 20° C./min ramp rate under nitrogen.

FIGS. 11A-11C show the storage moduli and mechanical glass transitions of networks formed from diepoxide monomers and IPDA.

FIG. 11A shows the storage moduli and mechanical glass transitions of pHBA-derived and DGEBA networks.

FIG. 11B shows the storage moduli and mechanical glass transitions of pHPAA-derived networks.

FIG. 11C shows the storage moduli and mechanical glass transitions of pHPPA-derived networks.

FIGS. 12A-12C—show tensile stress-strain plots of networks formed from diepoxide monomers and IPDA (type V specimens and test conditions as per ASTM D638).

FIG. 12A shows stress-strain plots of pHBA-derived and DGEBA networks.

FIG. 12B shows stress-strain plots of pHPAA-derived networks.

FIG. 12B shows stress-strain plots of pHPPA-derived networks.

FIG. 13A shows stress strain plots of pHBA-derived and DGEBA networks in compression at 1.3 mm/min crosshead speed (cylinder dimensions 7 mm diameter×14 mm length and test conditions as per). Inset pictures show compression cylinders before and after testing.

FIG. 13B stress strain plots of pHPAA-derived networks in compression at 1.3 mm/min crosshead speed (cylinder dimensions 7 mm diameter×14 mm length). Inset pictures show compression cylinders before and after testing.

FIG. 13C shows stress strain plots of pHPPA-derived networks in compression as per ASTM D695 at 1.3 mm/min crosshead speed (cylinder dimensions 7 mm diameter×14 mm length). Inset pictures show compression cylinders before and after testing.

FIG. 14A shows single lap shear strengths of polymer networks of the present invention compared to DGEBA on 1.6 mm thick AR-type tabbed aluminum panels with overlap area=25.4×12.7 mm at 1.3 mm/min crosshead speed (test conditions as per ASTM D1002).

FIG. 14B shows pull-off adhesion strengths (test conditions as per ASTM D4541) of networks from diepoxide monomers of the present invention compared to DGEBA.

FIG. 15A shows the relative propensity toward hydrolytic degradation of the polymer networks of the present invention via thermoset weight loss in 20% sodium hydroxide in water at 70 C over a 28-day test period.

FIG. 15B shows the integration of ester linkages into epoxy-amine thermosets that enable hydrolysis and the corresponding ¹H NMR spectrum of the product of degradation—a tetra-functional carboxylate salt comprising an IPDA core.

FIG. 16 shows synthetic schemes for aryl dinitro compounds and subsequent reduction to ester-containing aromatic diamines.

FIG. 17A shows ¹H NMR spectrum for 4-nitrophenethyl-4-nitrobenzoate.

FIG. 17B shows the structure of 4-nitrophenethyl-4-nitrobenzoate with labeling corresponding to the ¹H NMR spectrum.

FIG. 18 shows ¹H NMR spectrum for 4-aminophenethyl-4-aminobenzoate.

FIG. 19 shows ¹H NMR spectrum for ethyl-1,2-bis-4-nitrobenzoate.

FIG. 20 shows ¹H NMR spectrum for ethyl-1,2-bis-4-aminobenzoate.

FIG. 21 shows ¹H NMR spectrum for ethyl-1,2-bis-3-nitrobenzoate.

FIG. 22 shows 1H NMR spectrum for ethyl-1,2-bis-3-aminobenzoate.

FIG. 23 shows in image a) a representative polymeric network structure obtained from epoxy-amine reaction of an ester-containing diepoxide monomer with an ester-containing diamine monomer. Image b) of FIG. 23 shows a representative polymer repeat unit obtained from epoxy-amine reaction of an ester-containing diepoxide monomer with an ester-containing diamine monomer.

FIGS. 24A-24C show plots of thermal stability of networks formed from ester-containing diepoxides/diamines and comparison to networks derived from commercially available non-ester containing diepoxide and diamine components.

FIG. 24A shows a plot for DGEBA-44DDM and DGEBF (diglycidyl ether of bisphenol F)-ethyl-1,2-bis-4-aminobenzoate (E-12B-4-AB).

FIG. 24B shows a plot for DGEBF-44DDM, DGEBF-4-aminophenethyl-4-aminobenzoate (4-APE-4-AB), and DGEBF-E-1,2-B-4-AB.

FIG. 24C shows a plot for pHBA-TY-4-APE-4-AB and pHBA-ED-E-1,2-B-4-AB.

FIG. 25 shows a table of the thermal stability (with 1% weight loss temperatures identified) networks formed from aromatic ester-containing diepoxides/diamines and comparison to networks derived from commercially-available non-ester containing aromatic diepoxide and diamine components.

FIGS. 26A-26C show plots from dynamic thermomechanical analysis of networks formed from ester-containing diepoxides/diamines and comparison to networks derived from commercially available non-ester containing diepoxide and diamine components.

FIG. 26A shows a plot for DGEBA-4,4DDM and DGEBA-4,4-DDS.

FIG. 26B shows a plot for DGEBF-4,4DDM, DGEBF-4-APE-4-AB, and DGEBF-E-1,2-B-4-AB.

FIG. 26C shows a plot for pHBA-TY-4-APE-4-AB and pHBA-ED-E-1,2-B-4-AB.

FIG. 27 shows a table of dynamic thermomechanical properties of networks formed from ester-containing diepoxides/diamines and comparison to networks derived from commercially available non-ester containing diepoxide and diamine components.

FIG. 28 shows a chart of tensile properties of networks formed from ester-containing diepoxides/diamines and comparison to networks derived from commercially available non-ester containing diepoxide and diamine components. The line connecting the bar graph corresponds to the secondary y-axis.

FIG. 29 shows a table of the tensile properties of networks formed from ester-containing diepoxides/diamines and comparison to networks derived from commercially available non-ester containing diepoxide and diamine components.

FIG. 30 shows a table of flexural properties (data obtained via test conditions as per ASTM D790) of networks formed from ester-containing diepoxides/diamines and comparison to networks derived from commercially available non-ester containing diepoxide and diamine components.

FIG. 31A shows a network formation reaction for diester diepoxides and isophorone diamine (IPDA). This scheme is applicable to monoester diepoxide systems.

FIG. 31B shows overlaid differential scanning calorimetry curves for network formation and post network formation using described cure profile for DGEBA-IPDA.

FIG. 31C shows overlaid DSC curves for network formation and post network formation using described cure profile for pHPAA-TY diepoxide-IPDA for comparison of polymerization/cure enthalpy to residual enthalpy in order to evaluate extent of cure.

FIG. 31D shows overlaid DSC curves for network formation and post network formation using described cure profile for pHPAA-ED diepoxide-IPDA.

FIG. 32 shows ¹H NMR spectrum of pHBA-tyrosol bisphenol.

FIG. 33 shows ¹³C NMR spectrum of pHBA-tyrosol bisphenol.

FIG. 34 shows ¹H NMR spectrum of pHPAA-tyrosol bisphenol.

FIG. 35 shows ¹³C NMR spectrum of pHPAA-tyrosol bisphenol.

FIG. 36 shows ¹H NMR spectrum of pHPPA-tyrosol bisphenol.

FIG. 37 shows ¹³C NMR spectrum of pHPPA-tyrosol bisphenol.

FIG. 38 shows ¹H NMR spectrum of pHBA-ethylene glycol bisphenol.

FIG. 39 shows ¹³C NMR spectrum of pHBA-ethylene glycol bisphenol.

FIG. 40 shows ¹H NMR spectrum of pHPAA-ethylene glycol bisphenol.

FIG. 41 shows ¹³C NMR spectrum of pHPAA-ethylene glycol bisphenol.

FIG. 42 shows ¹H NMR spectrum of pHPPA-ethylene glycol bisphenol.

FIG. 43 shows ¹³C NMR spectrum of pHPPA-ethylene glycol bisphenol.

FIG. 44 shows ¹H NMR spectrum of pHBA-1,3-propanediol bisphenol.

FIG. 45 shows ¹³C NMR spectrum of pHBA-1,3-propanediol bisphenol.

FIG. 46 shows ¹H NMR spectrum of pHPAA-1,3-propanediol bisphenol.

FIG. 47 shows ¹³C NMR spectrum of pHPAA-1,3-propanediol bisphenol.

FIG. 48 shows ¹H NMR spectrum of pHPPA-1,3-propanediol bisphenol.

FIG. 49 shows ¹³C NMR spectrum of pHPPA-1,3-propanediol bisphenol.

FIG. 50 shows ¹H NMR spectrum of pHBA-tyrosol diepoxide (purified).

FIG. 51 shows ¹³C NMR spectrum of pHBA-tyrosol diepoxide (purified).

FIG. 52 shows ¹H NMR spectrum of pHPAA-tyrosol diepoxide (purified).

FIG. 53A shows ¹³C NMR spectrum of pHPAA-tyrosol diepoxide (purified).

FIG. 53B shows an inset from the ¹³C NMR spectrum of FIG. 53A.

FIG. 53C shows the chemical structure of pHPAA-tyrosol diepoxide.

FIG. 54 shows the ¹H NMR spectrum of pHPPA-tyrosol diepoxide (purified).

FIG. 55 shows ¹³C NMR spectrum of pHPPA-tyrosol diepoxide (purified).

FIG. 56 shows ¹H NMR spectrum of pHBA-ethylene glycol diepoxide (purified).

FIG. 57 shows ¹³C NMR spectrum of pHBA-ethylene glycol diepoxide (purified).

FIG. 58 shows ¹H NMR spectrum of pHPAA-ethylene glycol diepoxide (purified).

FIG. 59 shows ¹³C NMR spectrum of pHPAA-ethylene glycol diepoxide (purified).

FIG. 60 shows ¹H NMR spectrum of pHPPA-ethylene glycol diepoxide (purified).

FIG. 61 shows ¹³C NMR spectrum of pHPPA-ethylene glycol diepoxide (purified).

FIG. 62 shows ¹H NMR spectrum of pHBA-1,3-propanediol diepoxide (purified).

FIG. 63 shows ¹³C NMR spectrum of pHBA-1,3-propanediol diepoxide (purified).

FIG. 64 shows ¹H NMR spectrum of pHPAA-1,3-propanediol diepoxide (purified).

FIG. 65 shows ¹³C NMR spectrum of pHPAA-1,3-propanediol diepoxide (purified).

FIG. 66 shows ¹H NMR spectrum of pHPPA-1,3-propanediol diepoxide (purified).

FIG. 67 shows ¹³C NMR spectrum of pHPPA-1,3-propanediol diepoxide (purified).

FIG. 68 shows ¹H NMR spectrum of acetone-phenol diepoxide (DGEBA) (purified) synthesized via the same process as the ester-containing diepoxide monomers as a reference.

FIG. 69 shows ¹³C NMR spectrum of acetone-phenol diepoxide (DGEBA) (purified).

FIG. 70 shows ¹H NMR spectrum of pHBA-tyrosol diepoxide (pre-purification).

FIG. 71 shows ¹H NMR spectrum of pHPAA-tyrosol diepoxide (pre-purification).

FIG. 72 shows ¹H NMR spectrum of pHPPA-tyrosol diepoxide (pre-purification).

FIG. 73 shows ¹H NMR spectrum of pHBA-ethylene glycol diepoxide (pre-purification).

FIG. 74 shows ¹H NMR spectrum of pHPAA-ethylene glycol diepoxide (pre-purification, normal base level).

FIG. 75 shows ¹H NMR spectrum of pHPAA-ethylene glycol diepoxide (pre-purification, lower base level).

FIG. 76. shows ¹H NMR spectrum of pHPAA-ethylene glycol bisphenol/ECH (epichlorohydrin) product in the presence of tetrabutylammonium bromide (TBAB) prior to base addition. The main peak isolated in flash chromatography was mono-epoxide/mono-halohydrin.

FIG. 77 shows ¹H NMR spectrum of pHPPA-ethylene glycol diepoxide (pre-purification).

FIG. 78 shows ¹H NMR spectrum of pHBA-1,3-propanediol diepoxide (pre-purification).

FIG. 79 shows ¹H NMR spectrum of pHPAA-1,3-propanediol diepoxide (pre-purification).

FIG. 80 shows ¹H NMR spectrum of pHPPA-1,3-propanediol diepoxide (pre-purification).

FIG. 81 shows a mid infrared (IR) spectrum of formed network derived from pHPAA-ethylene glycol diepoxide-IPDA.

FIG. 82 shows overlaid near IR spectra of pHPAA-ethylene glycol diepoxide-IPDA obtained periodically throughout cure.

FIG. 83 shows a dynamic mechanical analysis (DMA) plot of storage modulus and tan δ curves for DGEBA-IPDA network.

FIG. 84 shows a DMA plot of storage modulus and tan δ curves for pHBA-tyrosol diepoxide-IPDA network.

FIG. 85 shows a DMA plot of storage modulus and tan δ curves for pHPAA-tyrosol diepoxide-IPDA network.

FIG. 86 shows a DMA plot of storage modulus and tan δ curves for pIPPA-tyrosol diepoxide-IPDA network.

FIG. 87 shows a DMA plot of storage modulus and tan δ curves for pHBA-ethylene glycol diepoxide-IPDA network.

FIG. 88 shows DMA plot of storage modulus and tan δ curves for pHPAA-ethylene glycol diepoxide-IPDA network.

FIG. 89 shows a DMA plot of storage modulus and tan δ curves for pHPPA-ethylene glycol diepoxide-IPDA network.

FIG. 90 shows a DMA plot of storage modulus and tan δ curves for pHPAA-1,3-propanediol diepoxide-IPDA network.

FIG. 91 shows a DMA plot of storage modulus and tan δ curves for pIPPA-13-propanediol diepoxide-IPDA network.

FIG. 92 shows a thermogravimetric analysis (TGA) plot (% weight vs. temperature) for DGEBA-IPDA network.

FIG. 93 shows a TGA plot (% weight vs. temperature) for pHBA-tyrosol diepoxide-IPDA network.

FIG. 94 shows a TGA plot (% weight vs. temperature) for pHPAA-tyrosol diepoxide-IPDA network.

FIG. 95 shows a TGA plot (% weight vs. temperature) for pHPPA-tyrosol diepoxide-IPDA network.

FIG. 96 shows a TGA plot (% weight vs. temperature) for pHBA-ethylene glycol diepoxide-IPDA network.

FIG. 97 shows a TGA plot (% weight vs. temperature) for pHPAA-ethylene glycol diepoxide-IPDA network.

FIG. 98 shows a TGA plot (% weight vs. temperature) for pHPPA-ethylene glycol diepoxide-IPDA network.

FIG. 99 shows a TGA plot (% weight vs. temperature) for pHPAA-1,3-propanediol diepoxide-IPDA network.

FIG. 100 shows a TGA plot (% weight vs. temperature) for pHPPA-1,3-propanediol diepoxide-IPDA network.

FIG. 101 shows water uptake curves. Rectangular specimens were immersed in deionized water at ambient temperature and periodically blotted dry and weighed. In a 60-day evaluation, the rate of water uptake for representative aromatic epoxy/amine-derived thermoset polyester material E4-P4 (derived from both ester-containing diepoxide and ester-containing diamine monomers, see FIG. 123 for thermoset repeat unit structures) was lower than that of aromatic thermoset epoxy-amine material derived from the standard liquid epoxy resin and industrially-relevant hardener 4,4′-diaminodiphenylsulfone.

FIG. 102 shows pre- and post-weathering glass transition temperature data for polyester thermosets derived from ester-containing diepoxide and ester-containing diamine monomers and DGEBA-type reference networks. See FIG. 123 for thermoset repeat unit structures. Formed network parts were subjected to 100 hours of exposure in a Q-Sun model Xe-3 Xenon test chamber (UV radiation, humidity, elevated temperature exposure) following ASTM G155-21 condition 1 (3× tensile bars and 2×DMA bars for each network type, inclusive of reference aromatic epoxy/amine). The bars in black correspond to the primary y-axis and the white bars outlined in black correspond to the secondary y-axis.

FIG. 103 shows pre- and post-weathered tensile strength data for polyester and reference networks. The bars in black correspond to the primary y-axis and the white bars outlined in black correspond to the secondary y-axis.

FIG. 104 shows rheological data demonstrating the potential to B-stage representative polyester system E4-P4 for composite application. Rheometry data for B-staged representative polyester system E4-P4 is shown. Prior to this rheometry experiment, E4 diepoxide and P4 diamine were B-staged at 120° C. for 2.5 hours. The glassy material was then stored overnight in a freezer and added to the rheometer. On the rheometer, a clear viscosity well was observed when the temperature approached 160° C.—a confirmation that the material still flowed, i.e. had not crosslinked. Modulus crossover (taken as the gel point or point of formation of an intractable crosslinked network) occurred about 22 minutes from the that point.

FIG. 105 shows a chart of the E4-P4 Brookfield viscosity (cone and plate viscometer) over time at a B stage temperature of 120° C. Clear viscosity increased as linear oligomer/polymer was formed.

FIG. 106 shows a table of the thermal conductivity data collected by C-Therm Trident for several ester-containing epoxy/ester-containing amine-derived polyester networks and reference epoxy/amine networks.

FIG. 107 shows a bar graph of bulk density data for ester-containing epoxy/ester-containing amine-derived polyester networks and reference epoxy/amine networks.

FIG. 108 shows theoretical network structure of an exemplary epoxy-anhydride system.

FIG. 109 shows a DSC curve of Epon 828 and hexahydrophthalic anhydride (HHPA) cure peak in the absence of catalyst to demonstrate impractically high cure temperature.

FIG. 110 shows a DSC curve of Epon 828 and HHPA cure peak in the presence of a typical epoxy-anhydride catalyst (1-methyl imidazole).

FIG. 111 shows a dynamic mechanical analysis plot that includes an epoxy/anhydride polyester network Epon 828-HHPA and DGEBA-type amine cured networks.

FIG. 112A shows a plot of tensile properties data that includes Epon 828-HHPA and DGEBA-type aromatic amine cured networks.

FIG. 112B shows the structure of epoxy/anhydride polyester network Epon 828-HHPA and DGEBA-type aromatic amine cured networks.

FIG. 113A shows a bar graph of flexural properties data (obtained via test conditions described in ASTM D790) that includes Epon 828-HHPA polyester network, DGEBA-type amine cured networks, and ester-containing epoxy/ester-containing amine derived polyester networks.

FIG. 113B shows a bar graph of flexural toughness (from integration of flexural stress-strain curves) data that includes Epon 828-HHPA polyester network, DGEBA-type amine cured networks, and ester-containing epoxy/ester-containing amine derived polyester networks.

FIG. 114 shows a bar graph of plane-strain fracture toughness data (critical stress intensity factors (K_{IC}) obtained via test conditions described in ASTM D5045) that includes Epon 828-HHPA polyester network, DGEBA-type amine cured networks, and ester-containing epoxy/ester-containing amine derived polyester networks.

FIG. 115 shows SEM micrographs of aromatic epoxy/amine-derived polyester composite cross section (left) and reference aromatic epoxy/amine composite (right, resin is standard liquid epoxy resin and 4,4′-diaminodipheyl sulfone as a curative) that show the distribution of silica filler (appears white) along the depth of molded parts. Both composites contain 50% by mass of unsized 325 mesh fused silica. Parts are 7 mm deep, and only the top and bottom 1 mm along the depth profile are shown for comparison of settling tendency. A comparable gradient in silica particle size is apparent for the systems.

FIG. 116A shows a plot of thermogravimetric data for polyester and reference networks in the absence of silica (solid lines) and composite materials (dashed lines).

FIG. 116B shows chemical structures of the polyester and reference networks employed in FIG. 116A.

FIG. 117A shows a plot of dynamic mechanical analysis data for polyester and reference networks in the absence of silica (solid lines) and composite materials (dashed lines).

FIG. 117B shows the chemical structures of the polyester and reference networks employed in FIG. 117A FIG. 118A shows a plot of tensile stress-strain data for polyester and reference networks in the absence of silica (solid lines) and composite materials (dashed lines).

FIG. 118B shows the chemical structures of the polyester and reference networks employed in FIG. 118A FIG. 119A shows flexural data for polyester and reference networks in the absence of silica (solid lines) and composite materials (dashed lines).

FIG. 119B shows the chemical structures of the polyester and reference networks employed in FIG. 119A.

FIG. 120 shows a bar graph of plane-strain fracture toughness data for polyester and reference networks in the absence of silica (solid bars) and composite materials (textured bars).

FIG. 121A shows a plot of coefficient of thermal expansion (CTE) data for E4-P4 neat system obtained via thermogravimetric analysis (TMA).

FIG. 121B shows a plot of CTE data for E4-P4 silica system obtained via thermogravimetric analysis (TMA).

FIG. 122 shows synthetic schemes for ester-containing precursor compounds in images a)-c) and representative diepoxide and diamine monomers synthetic schemes in images d)-e).

FIG. 123 shows an overview of polyester networks derived from ester-containing diepoxide and ester-containing diamine components.

FIG. 124A shows initial polymerization enthalpy for representative polyester system E4-P4.

FIG. 124B shows residual polymerization enthalpy for representative polyester system E4-P4 after the system was subjected to the described cure protocol.

FIG. 124C shows overlaid near infrared (NIR) spectra for representative polyester system E4-P4 over the course of the described cure protocol.

FIG. 124D shows functional group concentrations throughout the cure protocol for representative polyester system E4-P4.

FIG. 125A shows TGA curves (under nitrogen at 10° C./min ramp rate) for polyester and reference networks.

FIG. 125B shows storage modulus and tan δ curves (from DMA, tension clamp, 1 Hz oscillation, 0.1% strain) for polyester and reference networks.

FIG. 125C shows representative thermogravimetric tensile stress/strain (c) traces for polyester and reference networks.

FIG. 126A shows plane strain fracture toughness of several polyester networks and DGEBA-type networks.

FIG. 126B shows SEM images of the fracture surfaces of a DGEBA-type network specimen (top) and polyester network specimen (bottom) at 50×.

FIG. 127A shows representative load vs deflection curves in Dynatup impact resistance test.

FIG. 127B shows averaged puncture energy for test panels of conventional aromatic epoxy/amine-derived thermosets Epon 828-4,4-DDS, DGEBA-4,4-DDS, and DGEBA-3,3′-DDS vs those of epoxy/amine-derived polyester thermosets E4-P4, E4-E4, and E4-E3.

FIG. 128 shows the performance of polyester and reference networks in single lap shear and T-peel on aluminum substrates.

FIG. 129A shows a reaction scheme for depolymerization of a polyester network derived from a diester-bridge diepoxide and diester-bridge diamine. The product includes labels corresponding to the NMR spectra of FIG. 129C.

FIG. 129B shows a mass vs. time plot for polyester networks, non-ester containing networks, and PET throughout period of submersion in ethylene glycol in the precense of 1 wt % zinc acetate (transesterification catalyst) at 190° C. under ambient pressure.

FIG. 129C shows ¹H NMR spectrum for the depolymerization product shown in FIG. 129A.

FIG. 130 shows ¹H NMR spectrum of 4-hydroxyphenethyl-4-hydroxybenzoate.

FIG. 131 shows ¹³C NMR spectrum of 4-hydroxyphenethyl-4-hydroxybenzoate.

FIG. 132 shows ¹H NMR spectrum of ethyl-1,2-bis-4-hydroxybenzoate.

FIG. 133 shows ¹³C NMR spectrum of ethyl-1,2-bis-4-hydroxybenzoate.

FIG. 134 shows ¹H NMR spectrum of propyl-1,3-bis-4-hydroxybenzoate.

FIG. 135 shows ¹³C NMR spectrum of propyl-1,3-bis-4-hydroxybenzoate.

FIG. 136 shows ¹H NMR spectrum of ethyl-1,2-bis-3-hydroxybenzoate.

FIG. 137 shows ¹³C NMR spectrum of ethyl-1,2-bis-3-hydroxybenzoate.

FIG. 138 shows ¹H NMR spectrum of 4-nitrophenethyl-4-nitrobenzoate.

FIG. 139 shows ¹³C NMR spectrum of 4-nitrophenethyl-4-nitrobenzoate.

FIG. 140 shows ¹H NMR spectrum of ethyl-1,2-bis-4-nitrobenzoate.

FIG. 141 shows ¹³C NMR spectrum ethyl-1,2-bis-4-nitrobenzoate.

FIG. 142 shows ¹H NMR spectrum of propyl-1,3-bis-4-nitrobenzoate.

FIG. 143 shows ¹³C NMR spectrum of propyl-1,3-bis-4-nitrobenzoate.

FIG. 144 shows 1H NMR spectrum ethyl-1,2-bis-3-nitrobenzoate.

FIG. 145 shows ¹³C NMR spectrum ethyl-1,2-bis-3-nitrobenzoate.

FIG. 146 shows ¹H NMR spectrum of 4-glycidyloxyphenethyl-4-glycidyloxybenzoate.

FIG. 147 shows ¹³C NMR spectrum of 4-glycidyloxyphenethyl-4-glycidyloxybenzoate.

FIG. 148 shows ¹H NMR spectrum of ethyl-1,2-bis-4-glycidyloxybenzoate.

FIG. 149 shows ¹³C NMR spectrum of ethyl-1,2-bis-4-glycidyloxybenzoate.

FIG. 150 shows ¹H NMR spectrum of propyl-1,3-bis-4-glycidyloxybenzoate.

FIG. 151 shows ¹³C NMR spectrum of propyl-1,3-bis-4-glycidyloxybenzoate.

FIG. 152 shows ¹H NMR spectrum of ethyl-1,2-bis-3-glycidyloxybenzoate.

FIG. 153 shows ¹³C NMR spectrum of ethyl-1,2-bis-3-glycidyloxybenzoate.

FIG. 154 shows 1H NMR spectrum of 4-aminophenethyl-4-aminobenzoate.

FIG. 155 shows ¹³C NMR spectrum of 4-aminophenethyl-4-aminobenzoate.

FIG. 156 shows ¹H NMR spectrum ethyl-1,2-bis-4-aminobenzoate.

FIG. 157 shows ¹³C NMR spectrum ethyl-1,2-bis-4-aminobenzoate.

FIG. 158 shows 1H NMR spectrum propyl-1,3-bis-4-aminobenzoate.

FIG. 159 shows ¹³C NMR spectrum propyl-1,3-bis-4-aminobenzoate.

FIG. 160 shows ¹H NMR spectrum ethyl-1,2-bis-3-aminobenzoate.

FIG. 161 shows ¹³C NMR spectrum ethyl-1,2-bis-3-aminobenzoate.

FIG. 162 shows ¹H NMR spectrum ethyl-4-aminobenzoate (for amidation study).

FIG. 163 shows ¹H NMR spectrum ethyl-4-glycidyloxybenzoate (for amidation study).

FIG. 164 shows a reaction scheme of potential reactions of ethyl-4-aminobenzoate and ethyl-4-glycidyloxyobenzoate.

FIG. 165 shows ¹H NMR spectrum of ethyl-4-glycidyloxybenzoate/ethyl-4-aminobenzoate adduct.

FIG. 166A shows DSC traces for polymerization of a representative epoxy-amine derived polyester for comparison of polymerization enthalpy (ΔH) and peak temperature (Tp).

FIG. 166B shows DSC traces for polymerization of DGEBA-4,4′-DDS for comparison of polymerization enthalpy (ΔH) and peak temperature (Tp).

### DETAILED DESCRIPTION

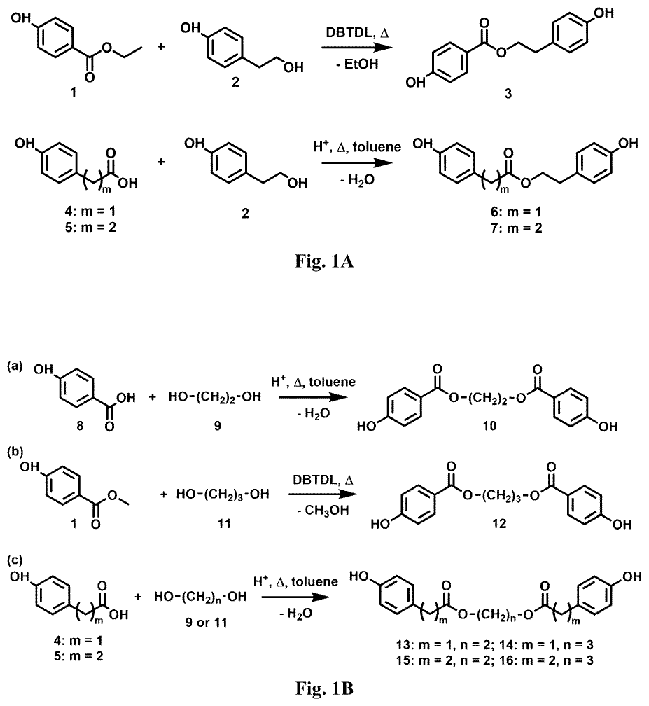

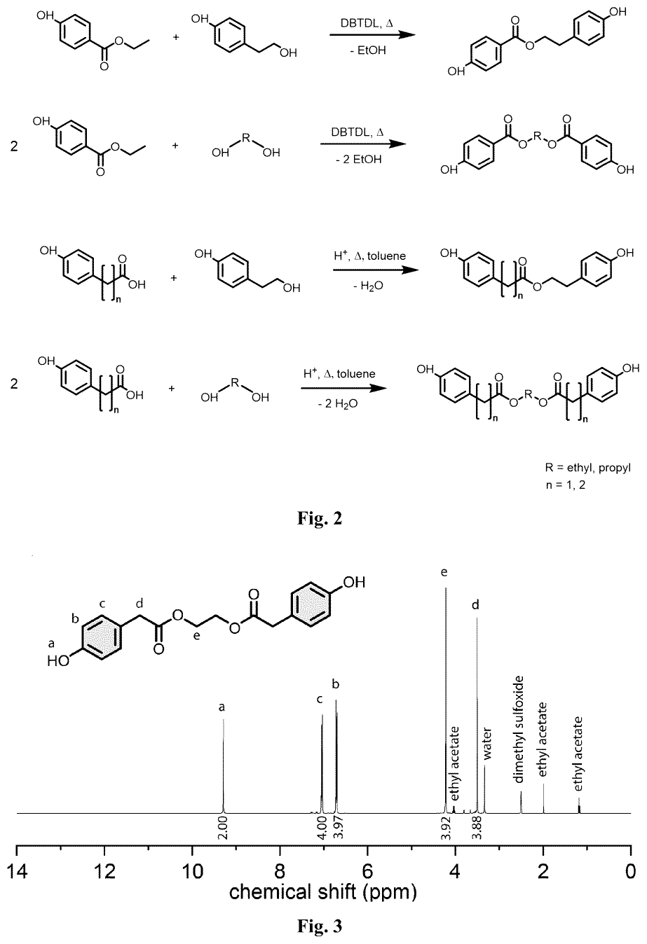

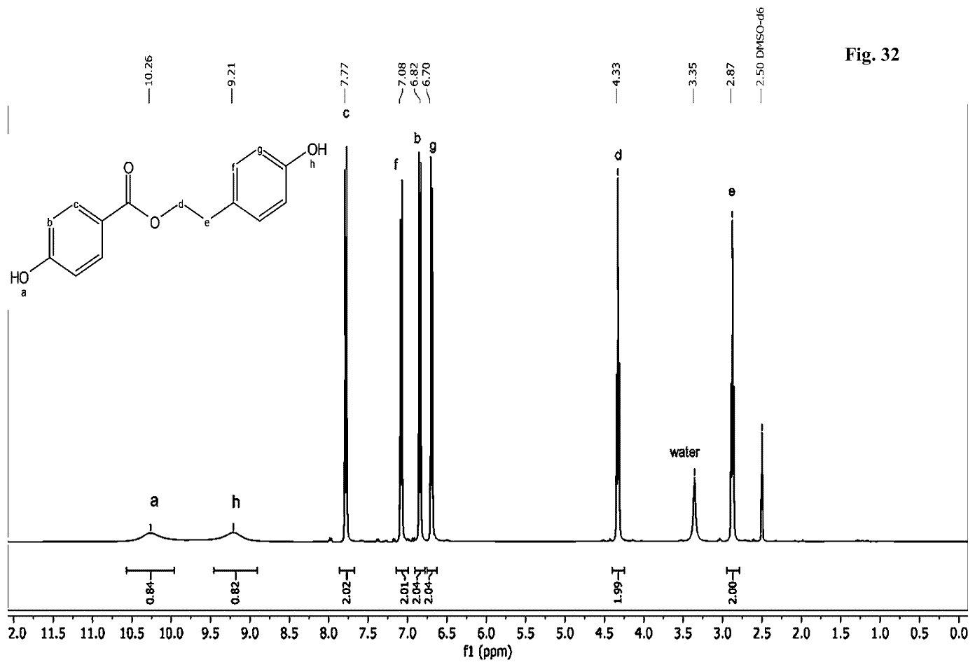

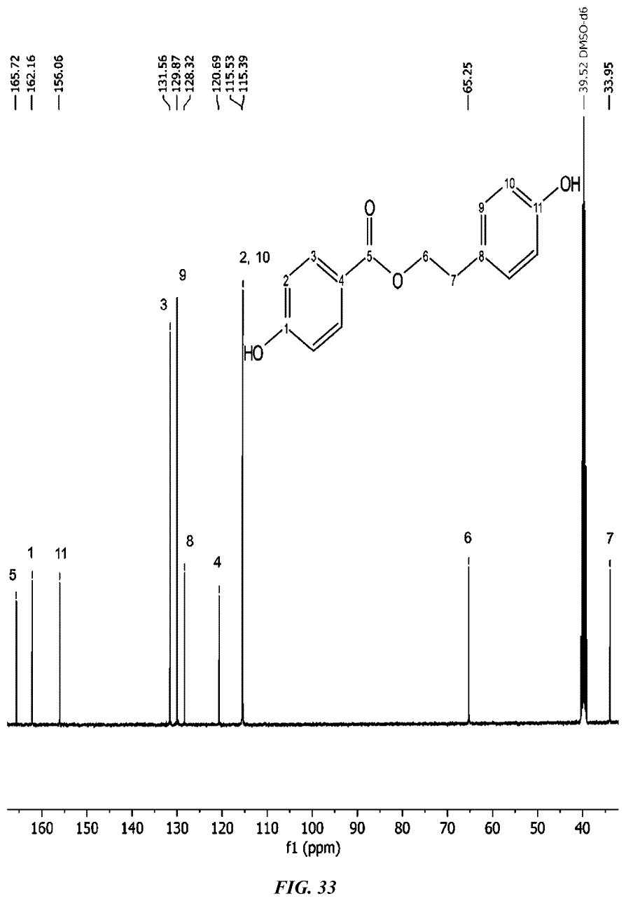

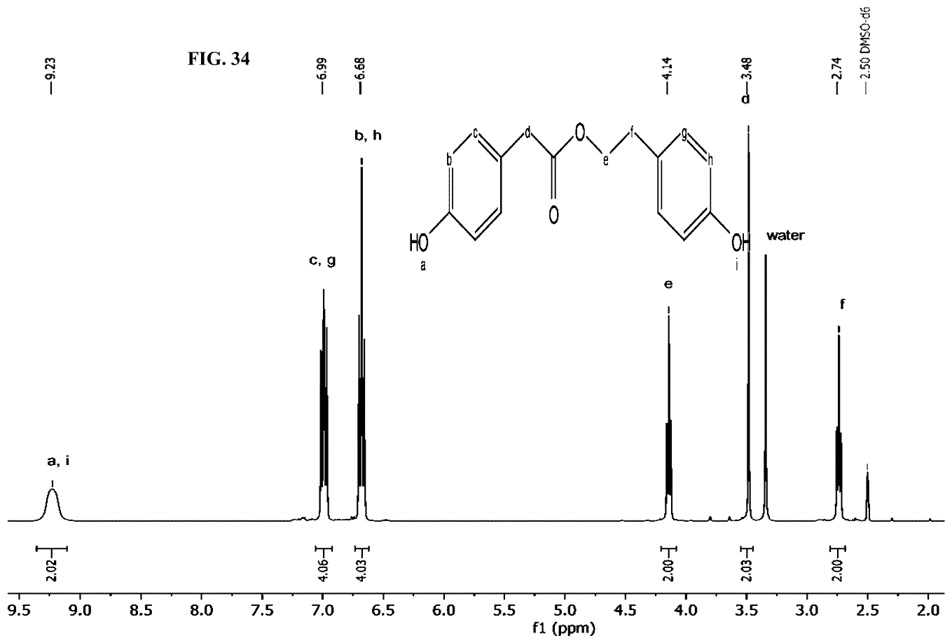

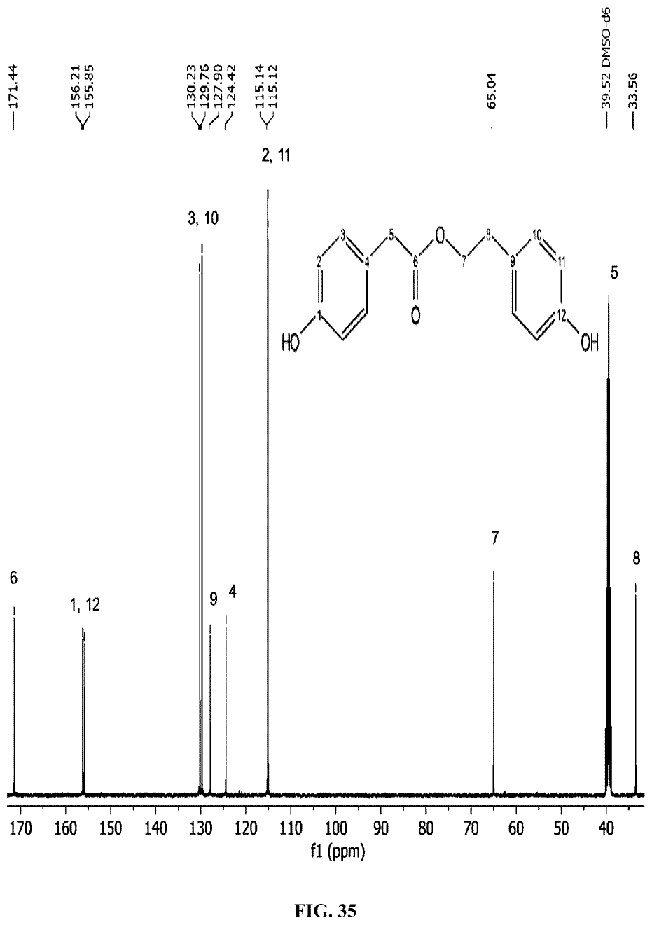

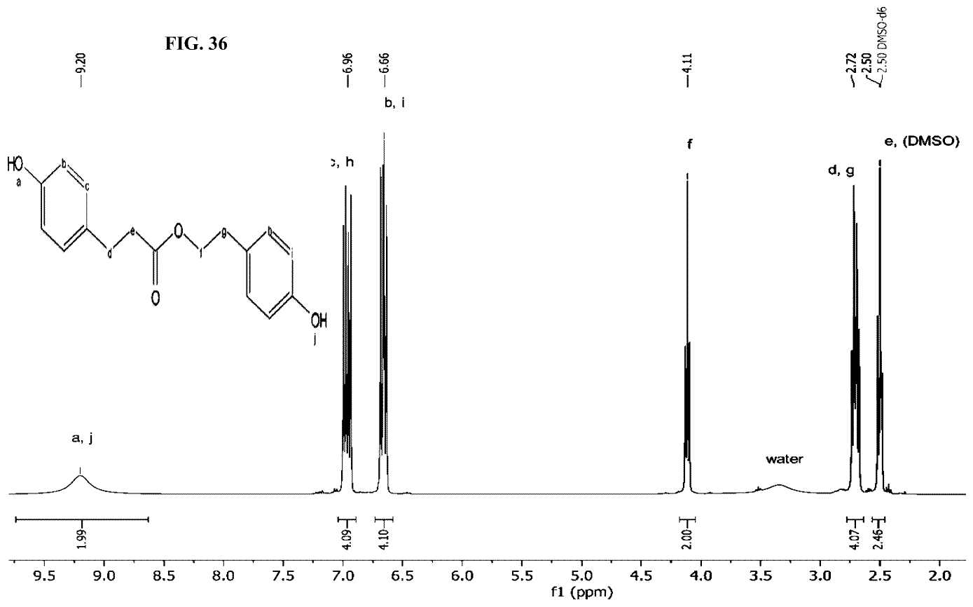

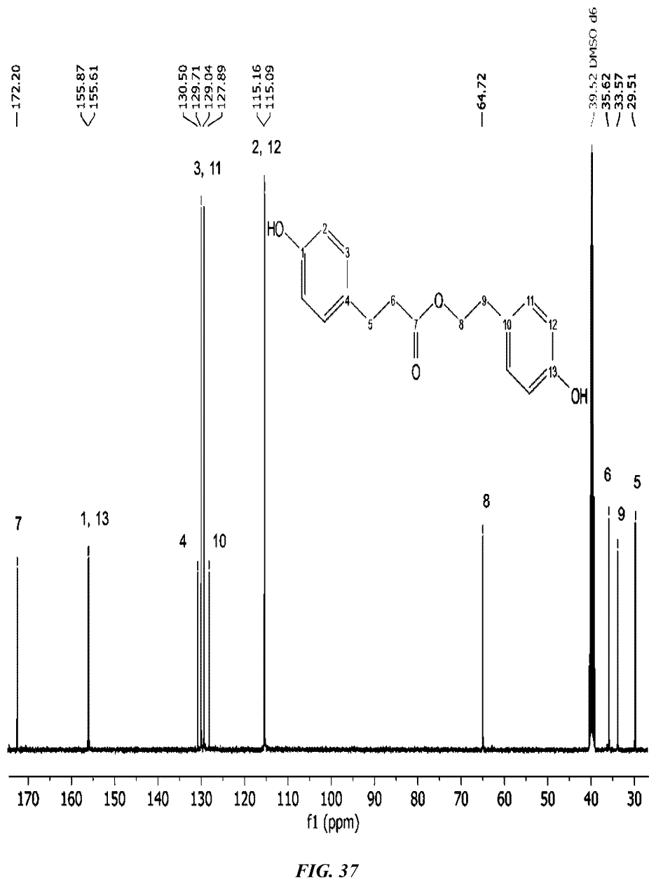

Monoester-bridged bisphenols were prepared via esterification of tyrosol with a series of phenolic acids, as shown in FIG. 1A. Fischer esterification of para-hydroxybenzoic acid and tyrosol in toluene using phosphoric acid as a catalyst was initially attempted, however, this approach failed to provide appreciable yields of the target compound 4-hydroxyphenethyl 4-hydroxybenzoate (3). Rather, (3) was afforded in a 78% yield through the transesterification of ethyl p-hydroxybenzoate and tyrosol in bulk using dibutyltin dilaurate as the catalyst. The chemical structure of (3) was confirmed by ¹H NMR, with the peak at 4.33 ppm characteristic of protons of the methylene adjacent to the ester (FIG. 32). The aliphatic monoester-bridged bisphenols, including 4-hydroxyphenethyl 2-(4-hydroxyphenyl)acetate (pHPAA, 6) and 4-hydroxyphenethyl 3-(4-hydroxyphenyl)propanoate (pHPPA) were synthesized via Fischer esterification of tyrosol with the respective phenolic acids (4 and 5), following the general protocol described by Cohen et al. (i.e. reaction in toluene with 7 mol % phosphoric acid based on the alcohol component and the collection of byproduct water). (Cohen, J.; Shultz, R. B.; Mullaghy, A.; Gwin, C.; Kohn, J. Bioresorbable tyrosol-derived poly(ester-arylate)s with tunable properties. Journal of Polymer Science 2021, 59 (10), 860-869), The ¹H and ¹³C NMR spectra for these bisphenols are shown in FIGS. 32-37.

Although the Fischer esterifications of para-hydroxyphenylacetic acid (pHPAA) or para-hydroxyphenylpropanoic acid (pHPPA) and tyrosol following the general process described by Cohen et al were not problematic, attempted Fischer esterification of para-hydroxybenzoic acid and tyrosol using the same process (toluene, 7 mol % phosphoric acid on alcohol component) failed to yield any appreciable level of product. Transesterification of ethyl para-hydroxybenzoate and tyrosol in bulk using dibutyltin dilaurate catalyst was instead used to produce the bisphenol.

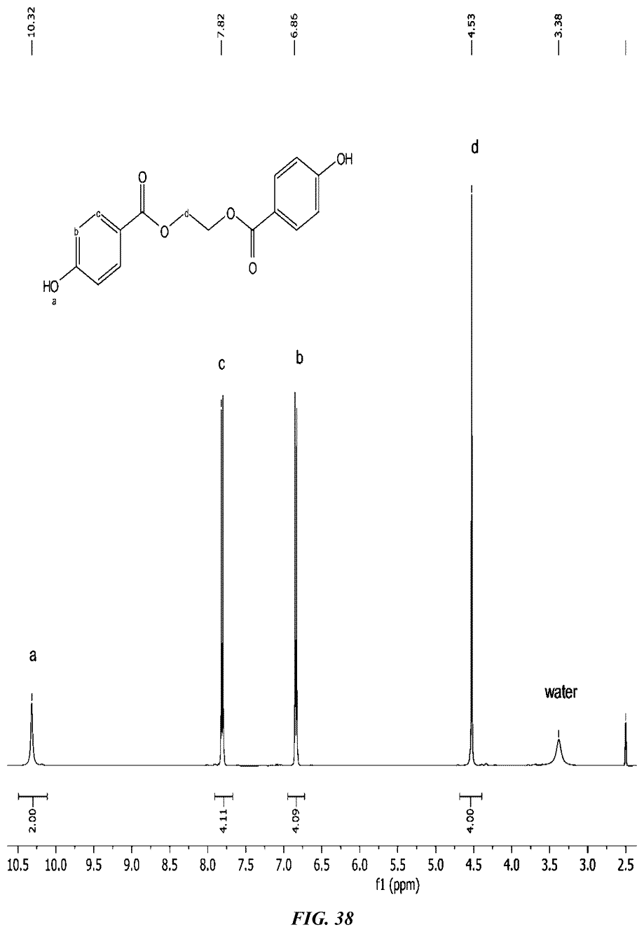

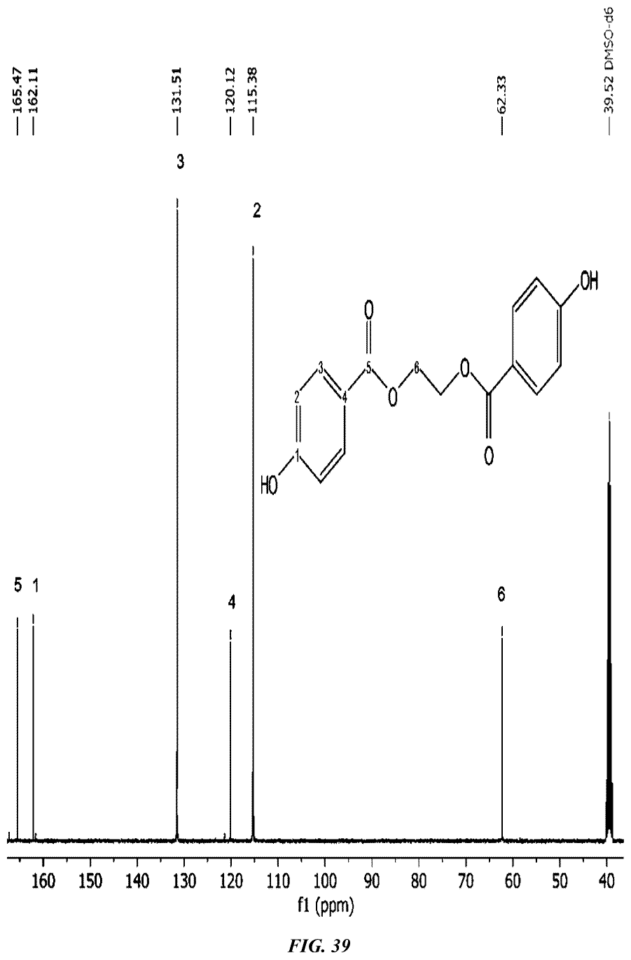

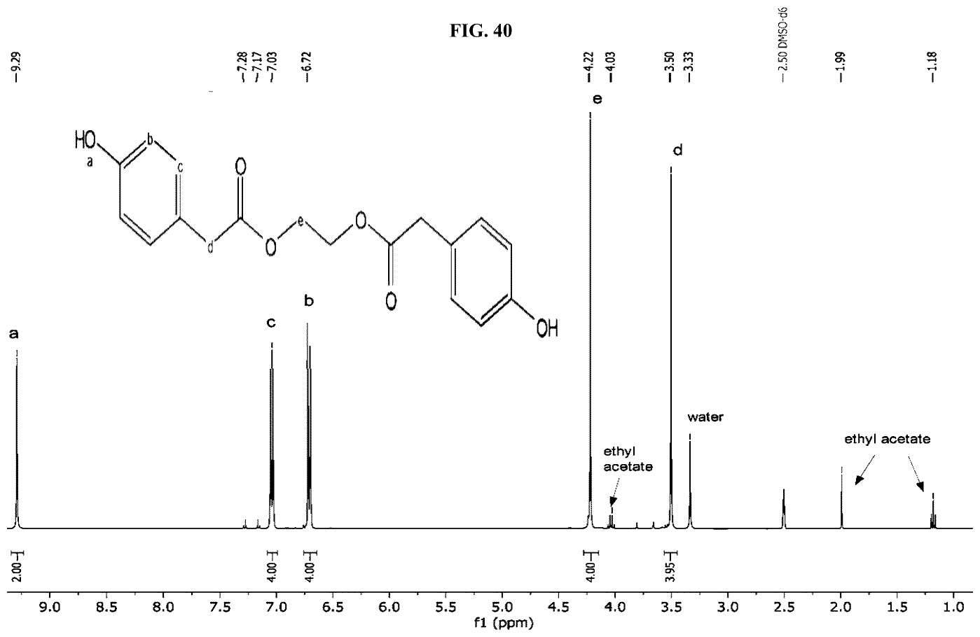

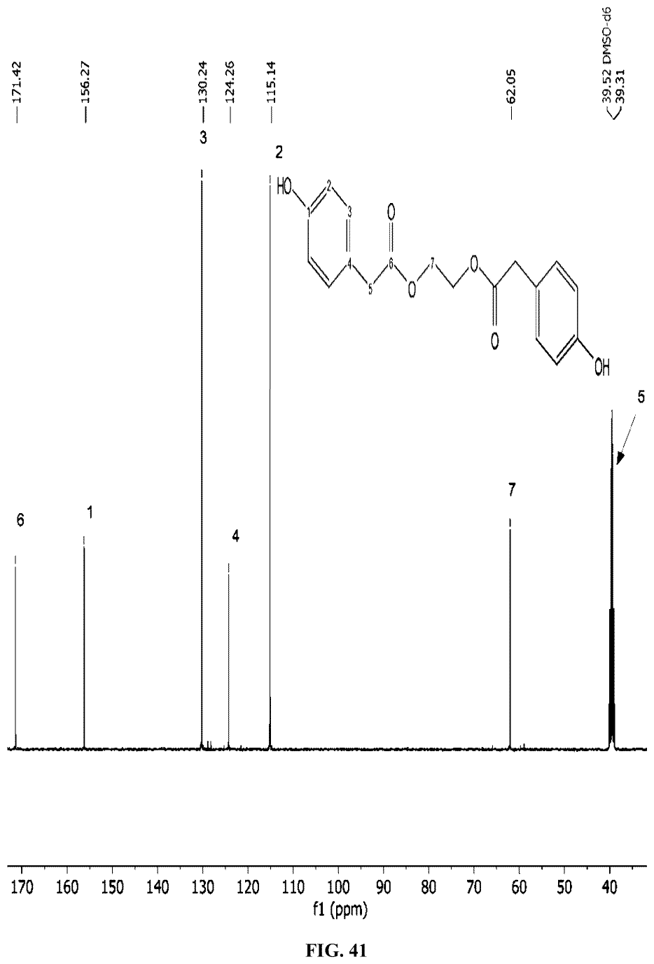

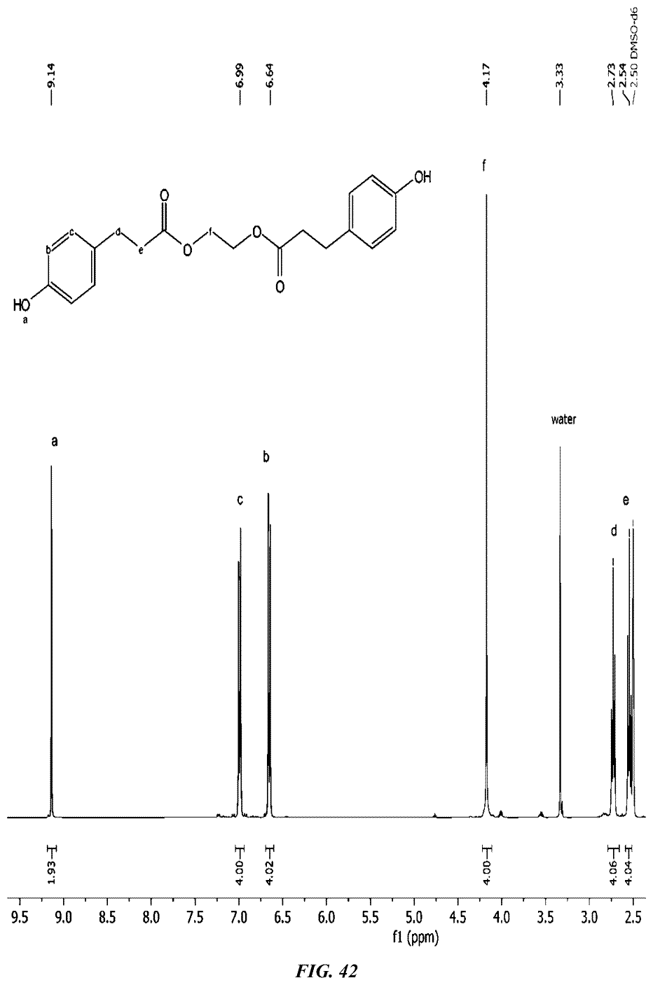

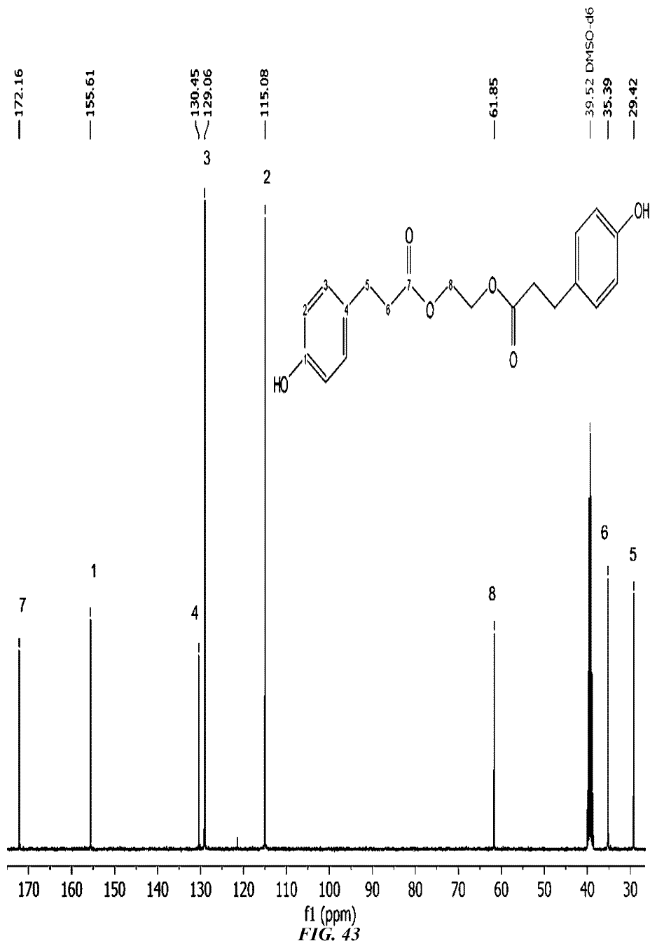

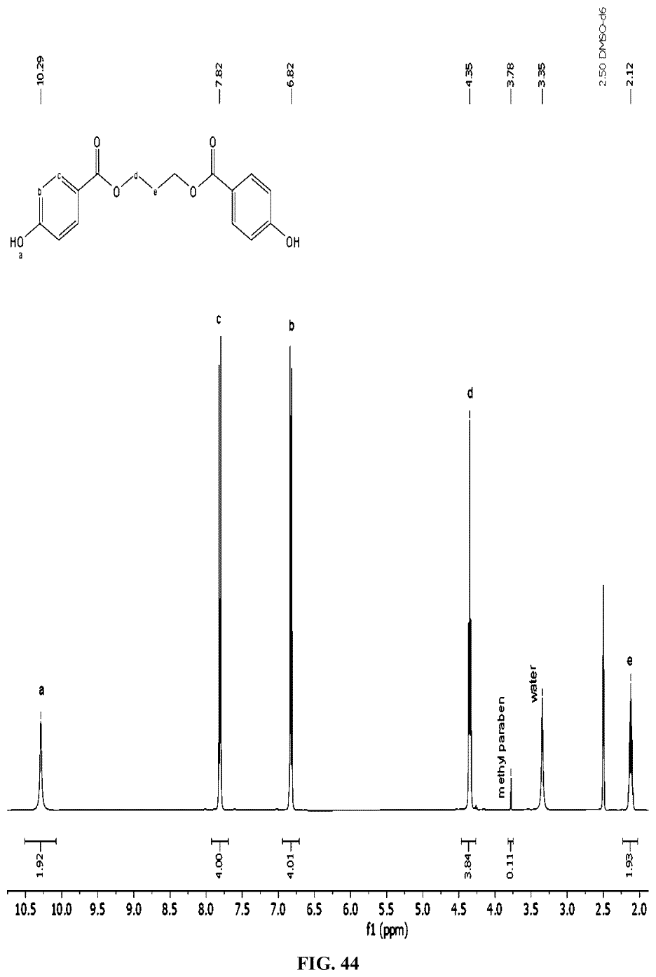

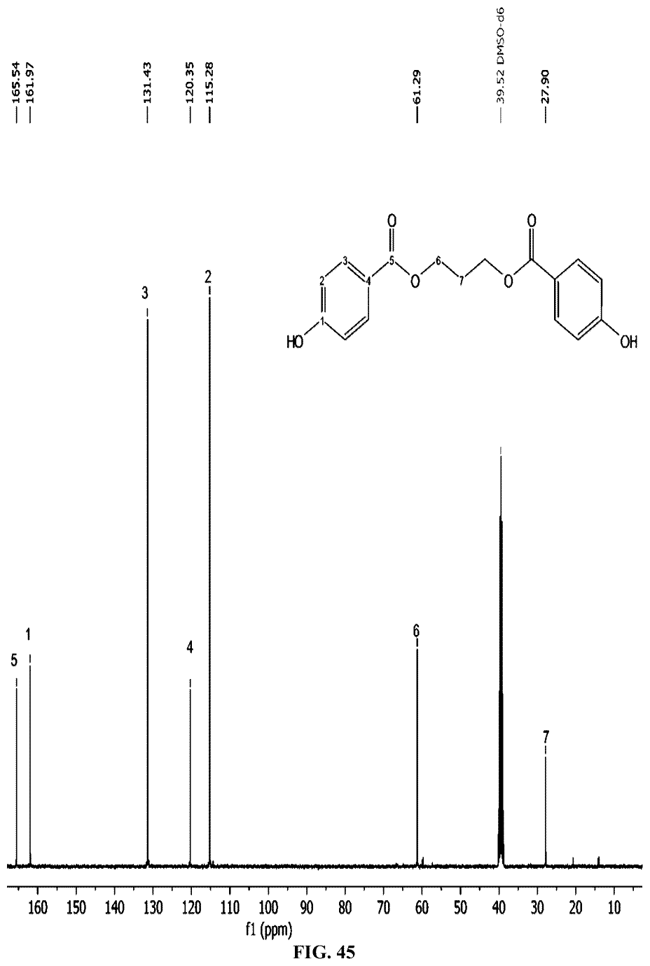

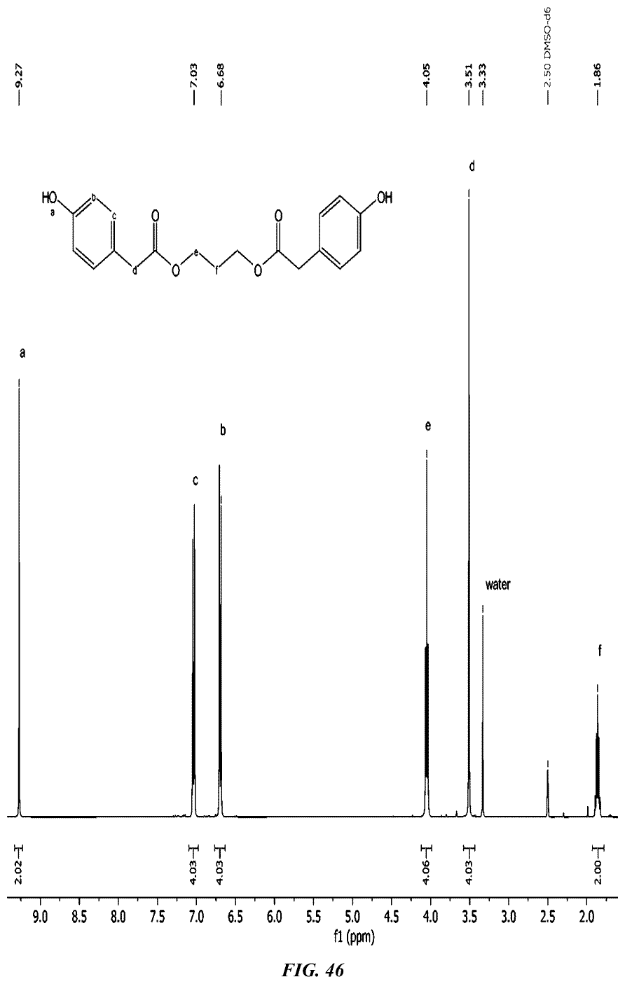

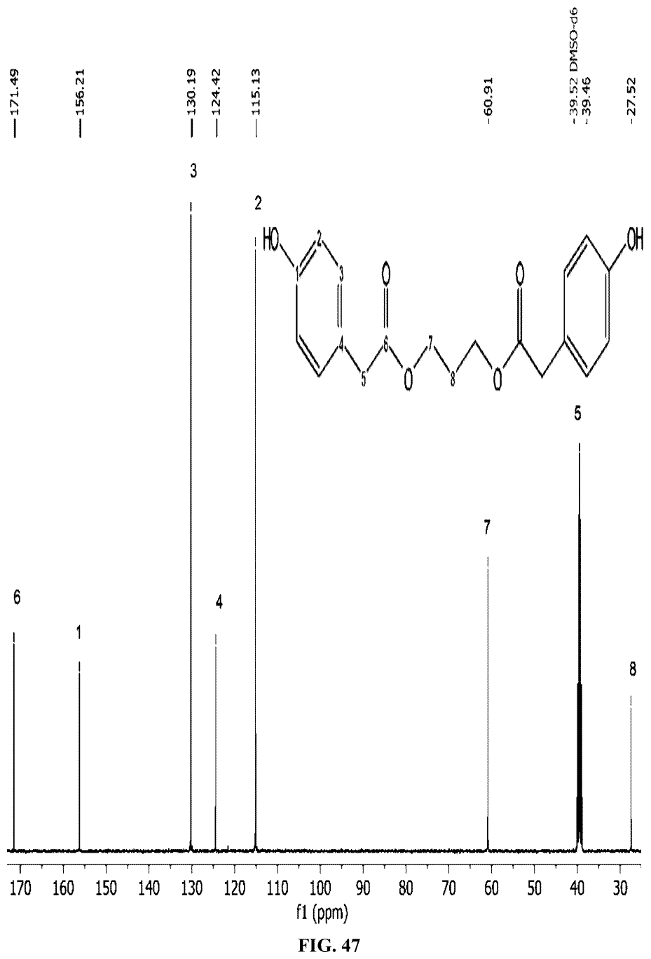

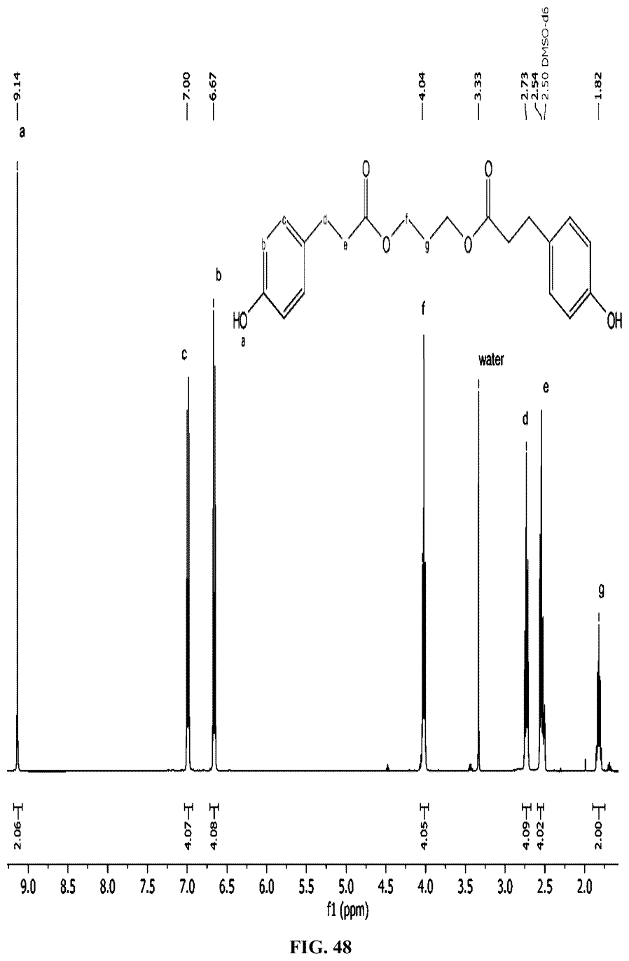

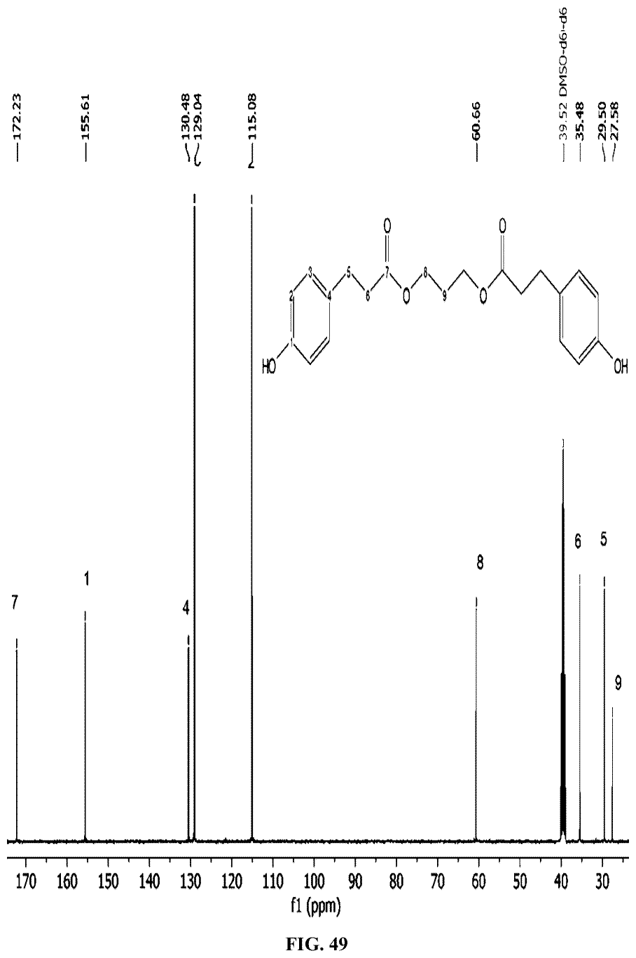

The synthetic routes for making the diester-bridged bisphenols are shown in FIG. 1A. Aromatic ester (pHBA-derived) bisphenols were prepared by either transesterification or by Fischer esterification, depending on the length of the diol spacer. When ethylene glycol (9) was used as a spacer, Fischer esterification (17.5 mol % sulfuric acid relative to the diol in toluene) with compound 8 provided the bisphenol 10 in high yield and purity (FIG. 1B). In contrast, when synthesis of bisphenol 12 was attempted via the same process, some self-reaction of compound 8 was observed (as indicated by additional aromatic peaks at 7.92, 7.02 ppm, and an ester-adjacent methylene peak at 4.19 ppm in the ¹H NMR spectrum). When a transesterification process was used for the synthesis of bisphenol 12 (as indicated in FIG. 1B), no substantial level of self-reaction of compound 8 was observed. Aliphatic ester bisphenols (13-16) were prepared by Fischer esterification of either ethylene glycol or 1,3-propanediol with phenolic acids 4 and 5, in toluene with 10 mol % phosphoric acid based on the diol component. In these reactions, an excess of phenolic acid was used to minimize mono-esterified products, and the progression of the reaction was monitored by the amount of byproduct water collected. In general, the ¹H NMR peak ca. 4.04-4.22 ppm attributed to the ester-adjacent methylene protons confirmed the formation of the ester. Mono-esterified products were negligible under these conditions, and excess phenolic acids were removable by sodium bicarbonate washes. The ¹H and ¹³C NMR spectra for these bisphenols are provided in FIGS. 38-49.

The lower reactivity of pHBA (as compared to pHPAA/pHPPA) toward Fischer esterification extended to the synthesis of diester-bridged bisphenols—derived from two equivalents of para-hydroxy substituted phenolic carboxylic acid component and 1 equivalent of aliphatic diol (ethylene glycol or 1,3-propanediol). Fischer esterification of para-hydroxybenzoic acid and ethylene glycol using the same process as used for pHPAA/pHPPA-ethylene glycol bisphenols (toluene, 10 mol % phosphoric acid on diol component) failed to yield any appreciable level of product. Fischer esterification using 17.5 mol % sulfuric acid on diol component in toluene (following a process described in US Patent 2016-0177028a1) was used successfully to produce the pHBA-ethylene glycol and pHBA-1,3-propanediol bisphenols. The transesterification process used for the pHBA-tyrosol bisphenol was also used successfully to produce the pHBA-ethylene glycol and pHBA-1,3-propanediol bisphenols. FIG. 3 shows ¹H NMR spectrum of pHPAA-ED bisphenol.

The pHPAA/pHPPA-1,3-propanediol bisphenols were produced using the same process as the pHPAA/pHPPA-ethylene glycol bisphenols (toluene, 10 mol % phosphoric acid on diol component). An excess of phenolic acid component was used in all cases to limit mono-esterified product, and reaction completion was determined via the level of byproduct water collected and the clarity of the refluxate. In practice, the mono-esterified product was not observed at any substantial level under the reaction conditions described, and sodium bicarbonate washes enabled removal of the excess phenolic acid component.

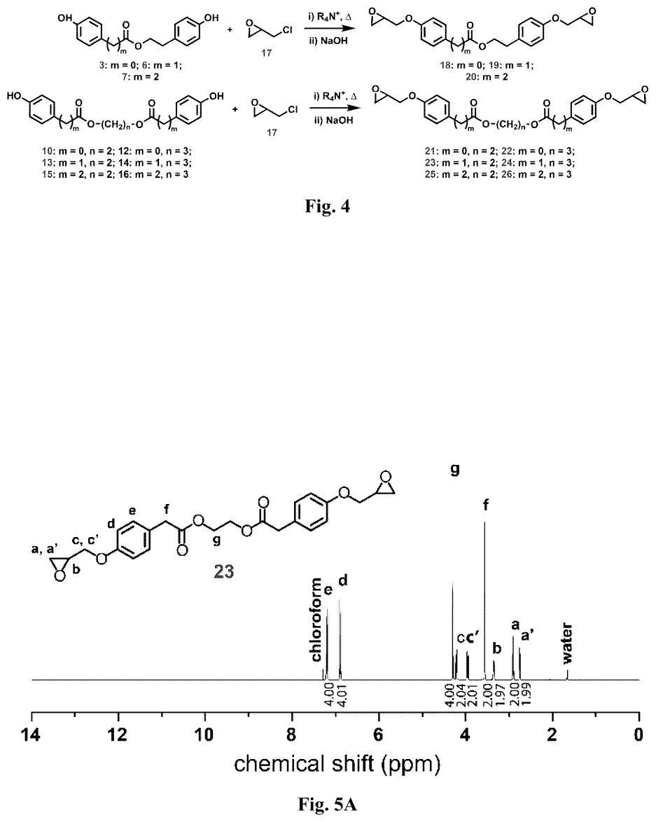

An epichlorohydrin (ECH)/base route adapted from work by Fang et al. (Fang, Z.; Weisenberger, M. C.; Meier, M. S. Utilization of Lignin-Derived Small Molecules: Epoxy Polymers from Lignin Oxidation Products. ACS Applied Bio Materials 2020, 3 (2), 881-890) was used for epoxidation for all bisphenols to obtain ester-bridged diepoxides, as shown in FIGS. 4 and 5A-5B and FIG. 122, image d. First, bisphenols were dissolved in and reacted with epichlorohydrin (17) at elevated temperature. Second, the temperature was lowered to near ambient and aqueous sodium hydroxide was added gradually. Tetra-butylammonium bromide (TBAB) was used as both a phenol-epoxide reaction catalyst in the first stage and as a phase transfer catalyst in the biphasic second stage. In this process, a 10:1 molar ratio of ECH (17) to phenol (20:1 ECH to bisphenol) was used to limit oligomerization via reaction of phenolic groups with epoxide groups formed in the reaction, and 10 mol % tetra-butylammonium bromide (TBAB) on bisphenol was used. At 1 hour reaction time at 100° C. using this level of TBAB, no residual phenolic content was observed via ¹H NMR. In contrast, a substantial level of phenolic content remained when the experiment was repeated in the absence of TBAB. Although the idealized bisphenol-ECH coupling stage produces a bis-chlorohydrin intermediate, in practice the products at the end of the bisphenol/ECH reaction in the presence of TBAB were dichlorohydrin, mono-chlorohydrin/mono-epoxide, and diepoxide. The function of a quaternary ammonium salt such as TBAB in ECH ring-opening, coupling to phenol, and chlorohydrin ring closure to form glycidyl aryl ether linkages is described mechanistically in U.S. Pat. No. 2,943,096A.

TBAB (at 10 additional mol %) was also used for the second stage of the epoxidation reaction (base-assisted ring closure); this occurs in a biphasic (ECH/water) environment, and TBAB functions there as a phase transfer catalyst. NaOH was added as a 5M aqueous solution, and the reaction was allowed to proceed for about 30 minutes at about 27° C. The crude product was immediately solubilized in ethyl acetate and washed with DI water. Despite the proximity of the weighted average density of the ethyl acetate/epichlorohydrin phase to 1.0 g/mL, separation from the aqueous phase was not problematic. The salt generated from epoxide ring-closure assisted the initial separation, and brine was added for each additional water wash.

Typically, a 2:1 molar ratio of NaOH to phenol (4:1 NaOH to bisphenol) was used. The base-assisted ring closure was performed at a 4:1 molar ratio of NaOH to bisphenol. At this molar ratio, ester retention—as determined by ¹H NMR of the crude diepoxides—ranged from 84% to 100%. See Table 1. Diepoxide 23 exhibited the lowest level of ester retention among the diepoxides, and an isolated experiment was performed to evaluate the impact of base level reduction on ester retention. Reduction of the NaOH to bisphenol molar ratio to 2.2:1 mitigated ester hydrolysis in diepoxide 23, with 97% ester retention at the lower concentration, as indicated by the ¹H NMR integral ratios of the crude product (¹H NMR in S43 and S44). At the higher NaOH level, the ¹H NMR spectrum of crude pHPAA-ethylene glycol diepoxide indicated 84% of theoretical ester functionality, whereas at the lower NaOH level the crude product spectrum indicated 97%. Additionally, the crude yield increased from 74 to 86%. No increase in chlorohydrin content was observed, an indication that epoxide ring formation was not hindered by the reduced base concentration. Maiorana et al. noted formation of glycidyl ester on epoxidation of diol-linked ferulic acid bisphenols (signal at about 4.4 ppm). (Maiorana, A.; Reano, A. F.; Centore, R.; Grimaldi, M.; Balaguer, P.; Allais, F.; Gross, R. A. Structure property relationships of biobased n-alkyl bisferulate epoxy resins. Green Chemistry 2016, 18 (18), 4961-4973) Interestingly, they found the highest rate of glycidyl ester formation (about 10% of possible formation) was found for epoxidation of the ethylene glycol linked bisphenol. The highest level of glycidyl ester (as a percentage of possible formation) determined by the present invention was about 4.5%—in the epoxidation of the pHPAA-ethylene glycol bisphenol with the standard described level of base. When using the lower described base level, the level of glycidyl ester dropped to 1.5%.

In all cases, water and ECH/EtOAc were removed from the monomers at elevated temperature under vacuum, and flash chromatography was used to obtain purified monomers for characterization and network synthesis (although crude reaction product was of relatively high purity and catalyst was removable via silica plug).

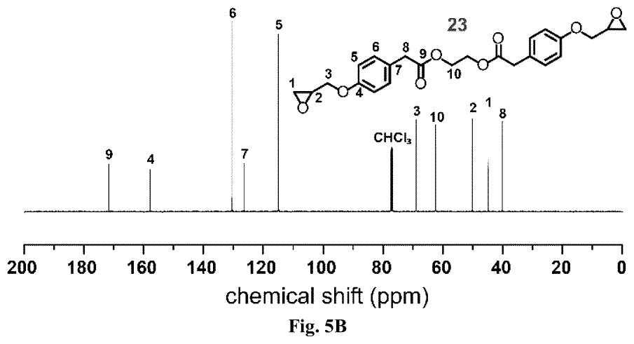

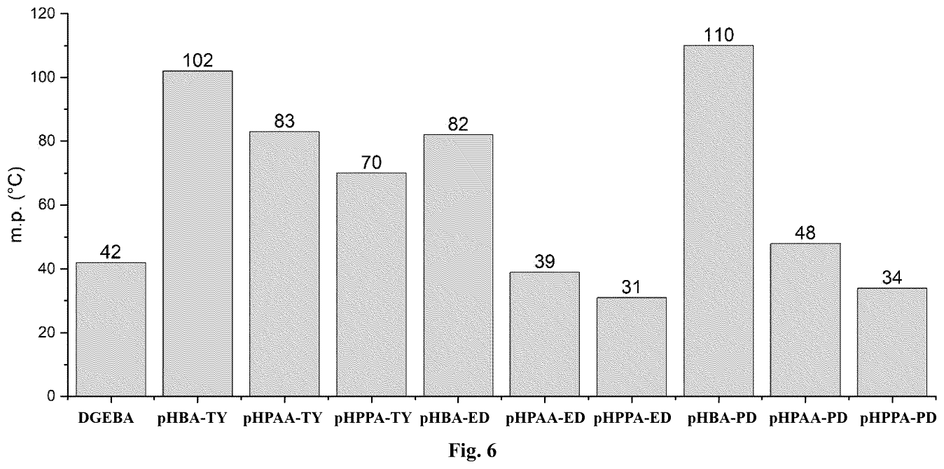

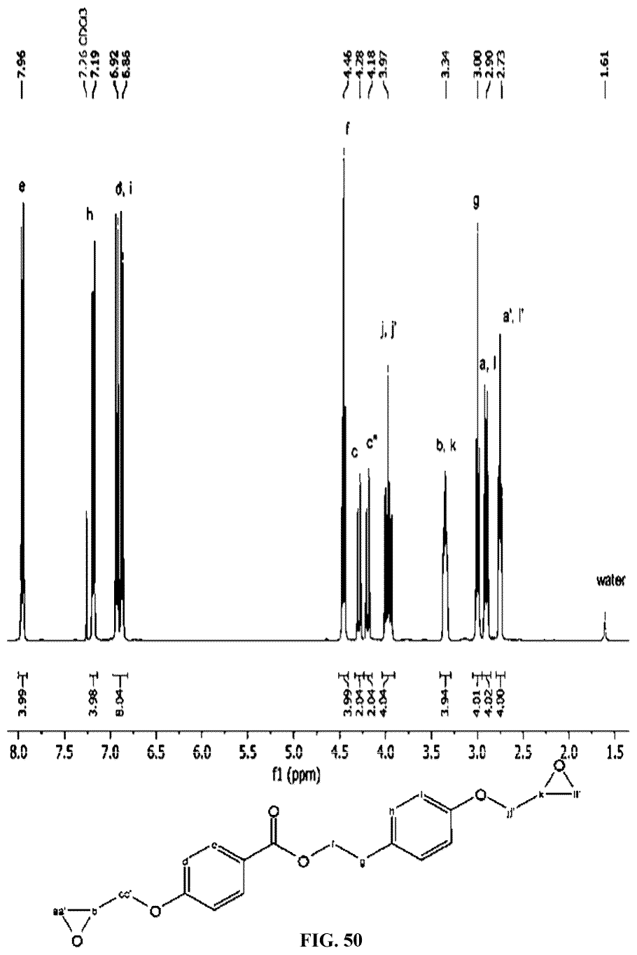

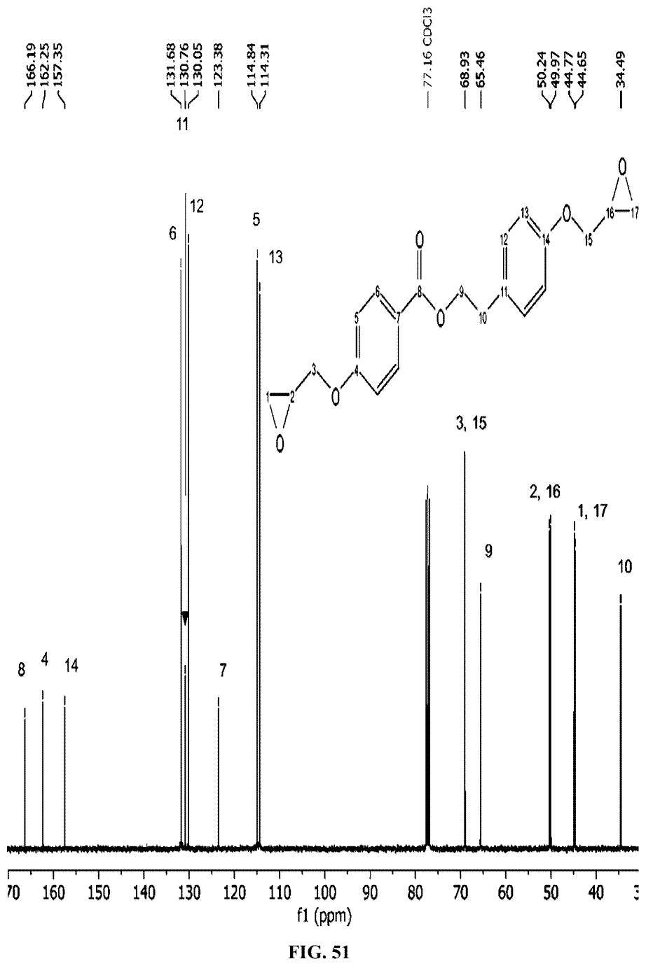

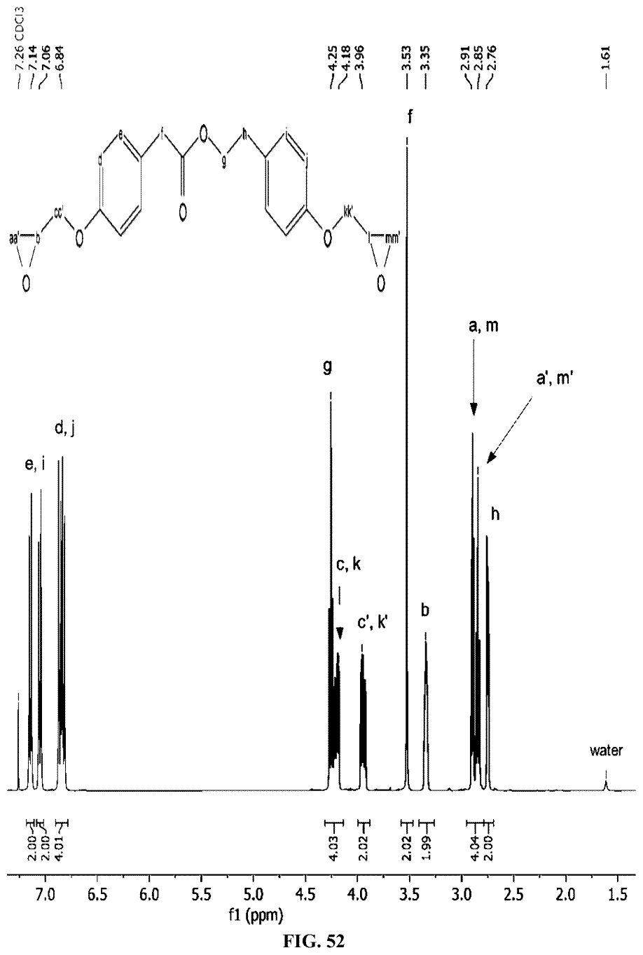

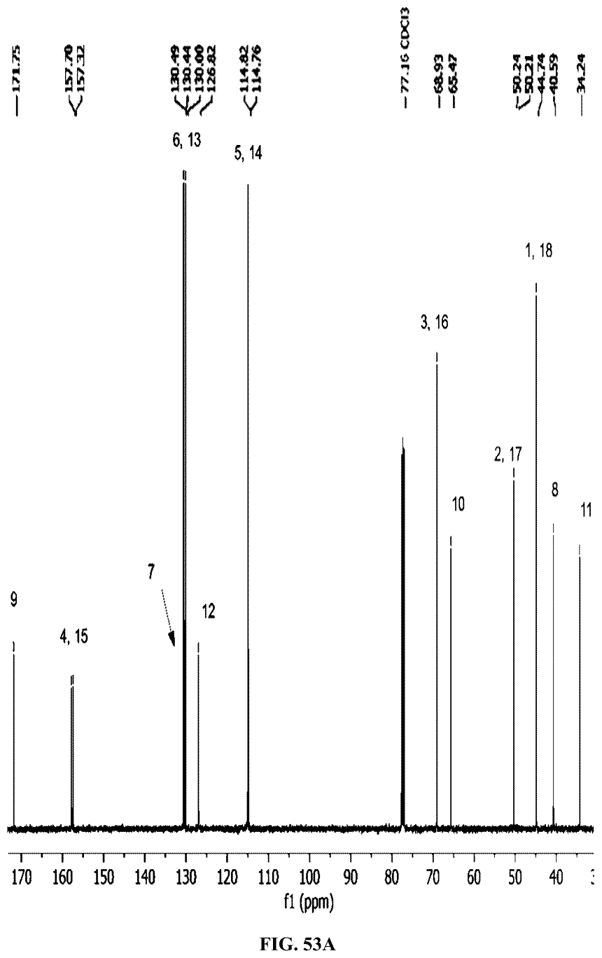

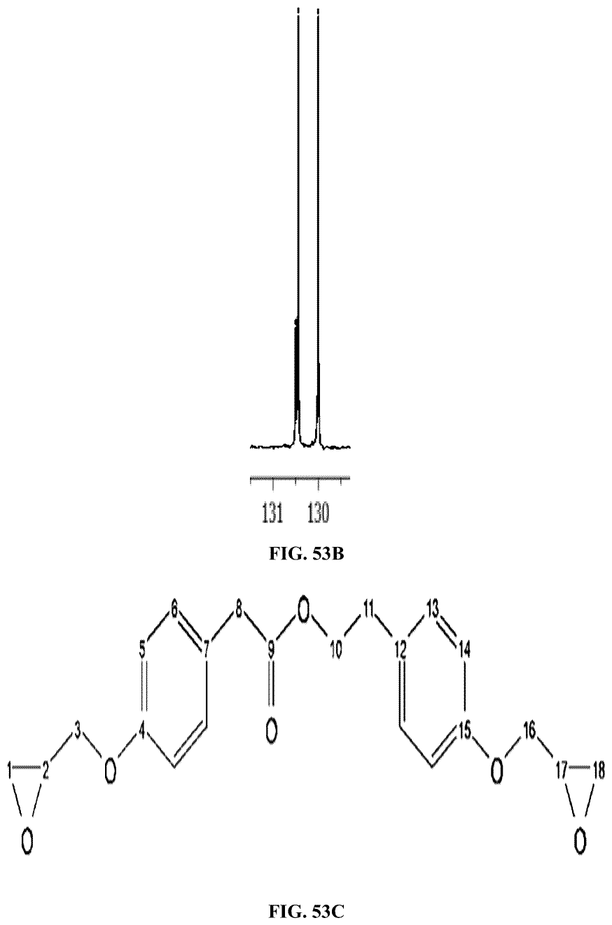

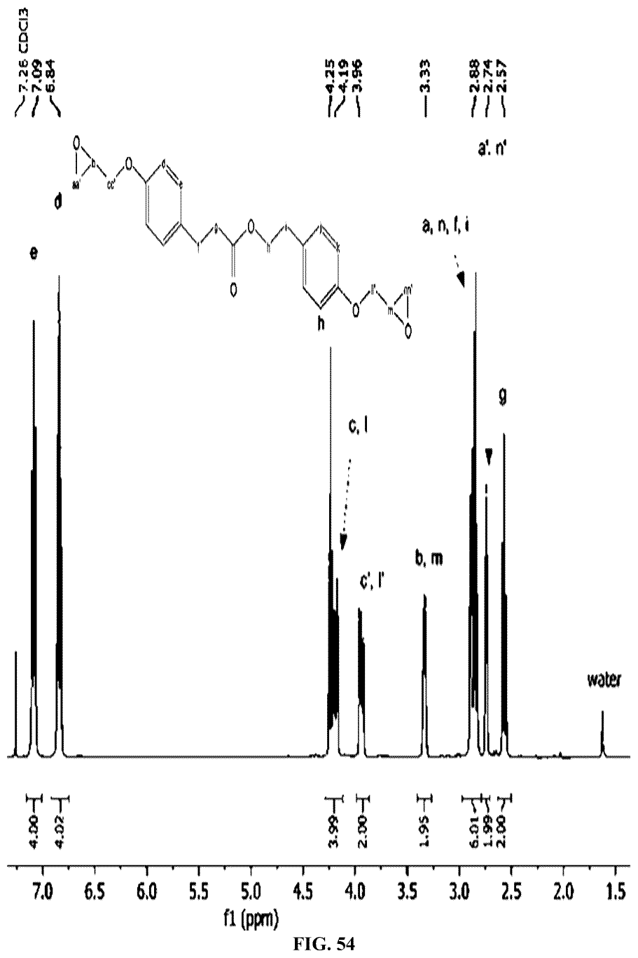

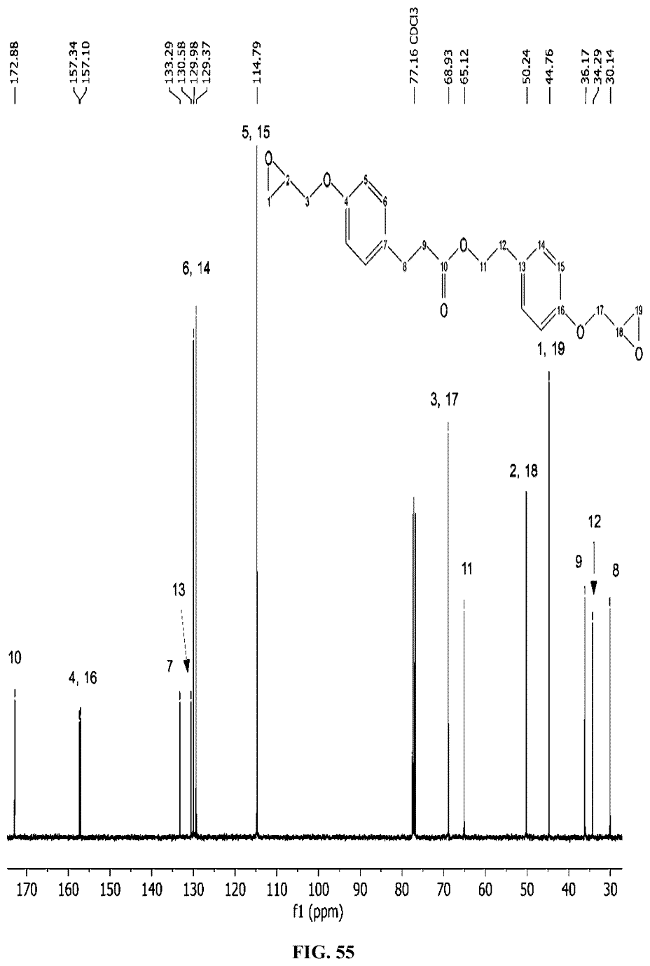

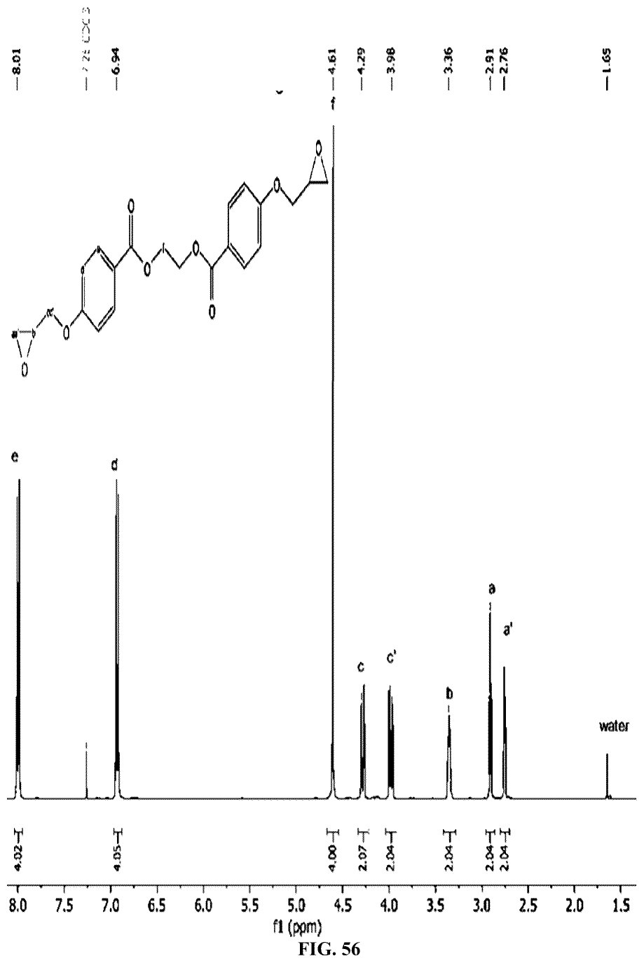

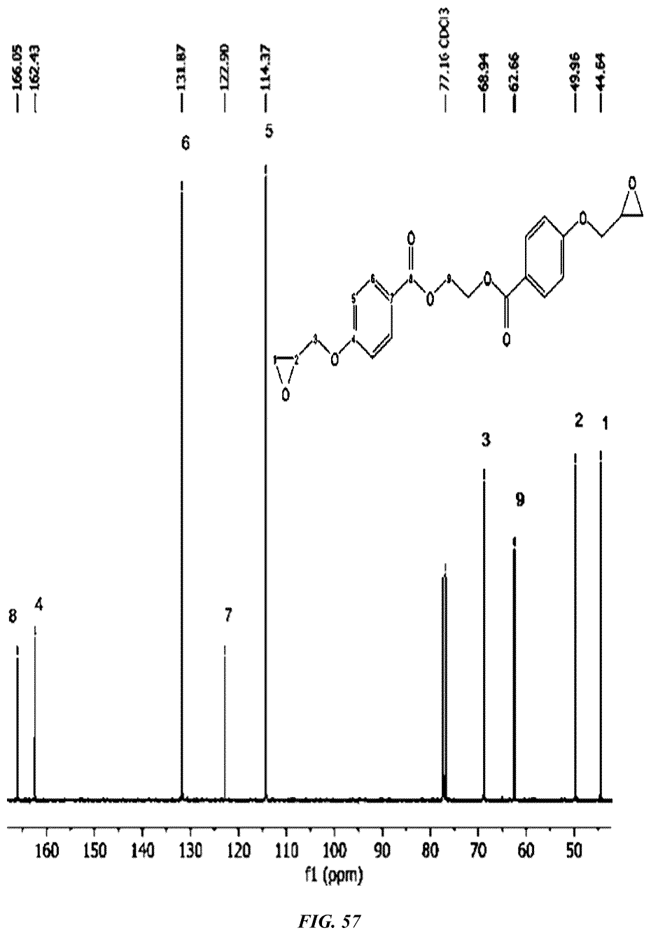

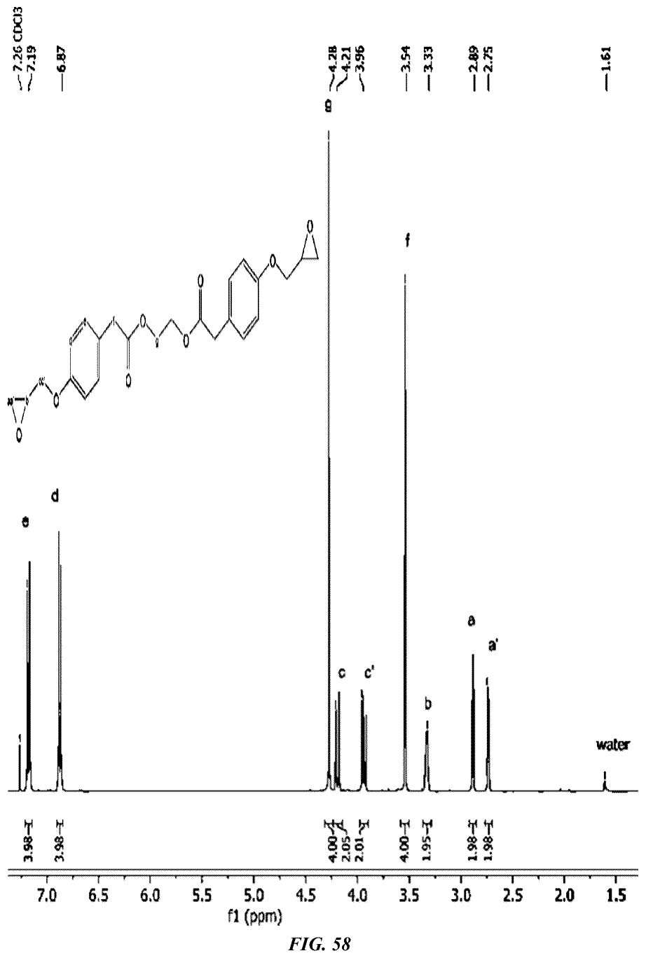

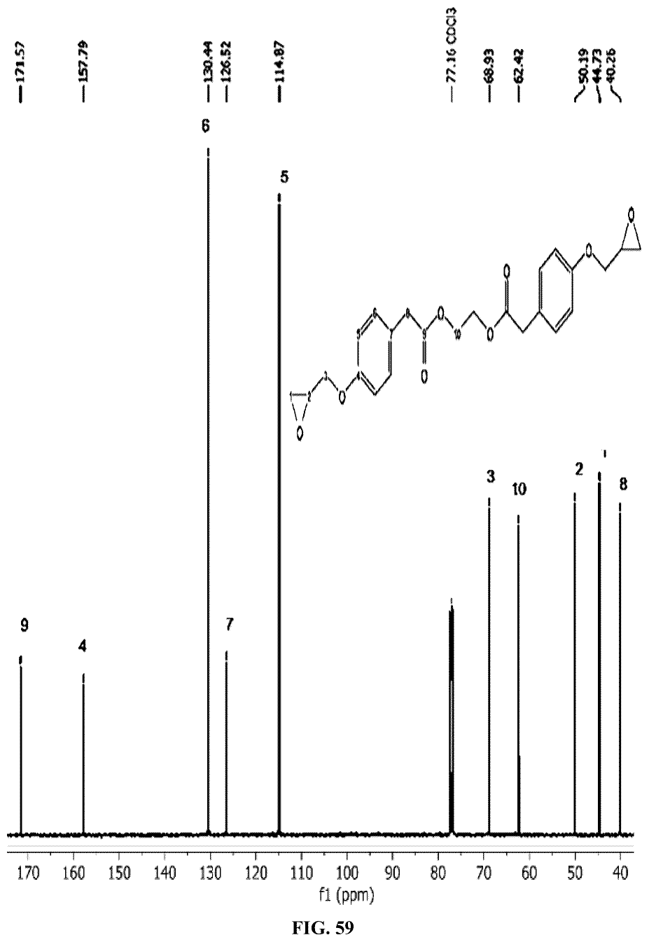

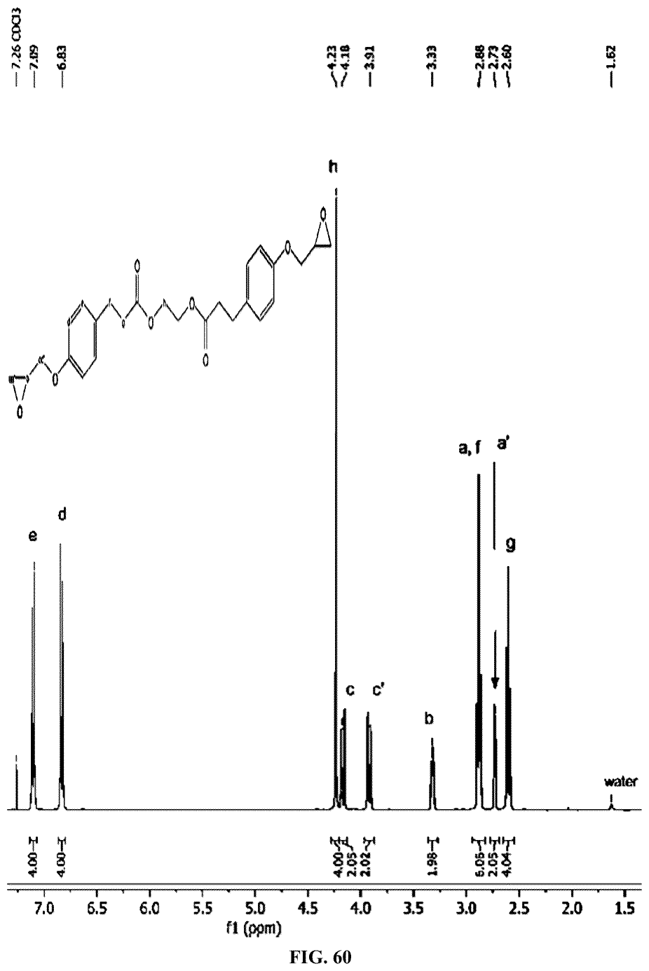

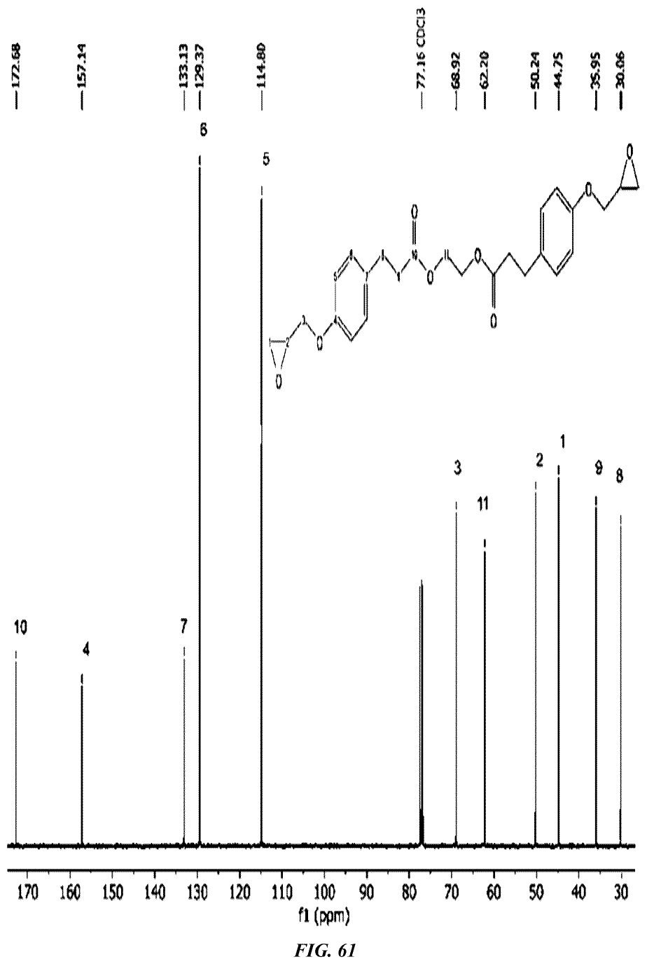

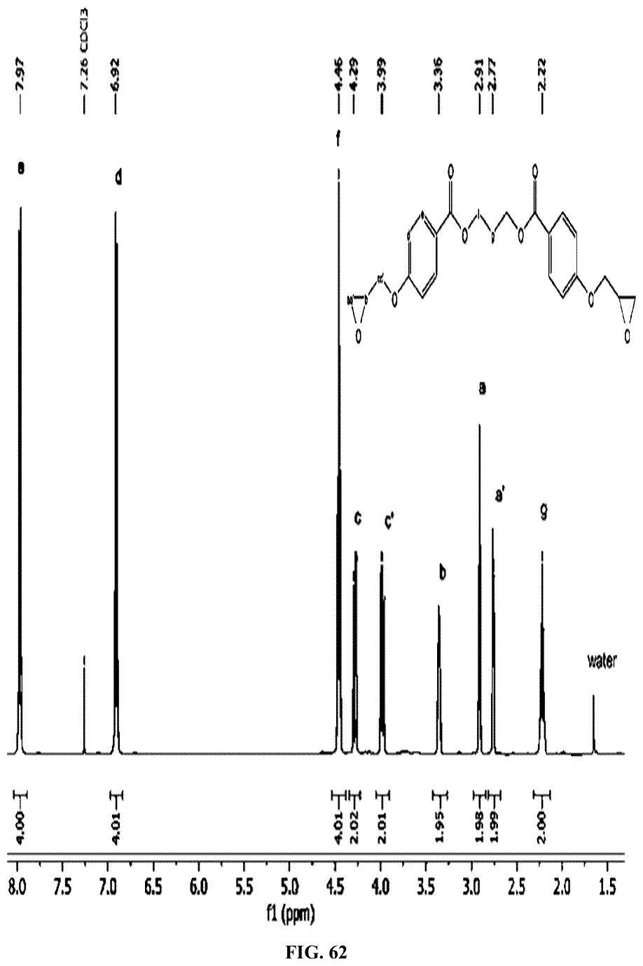

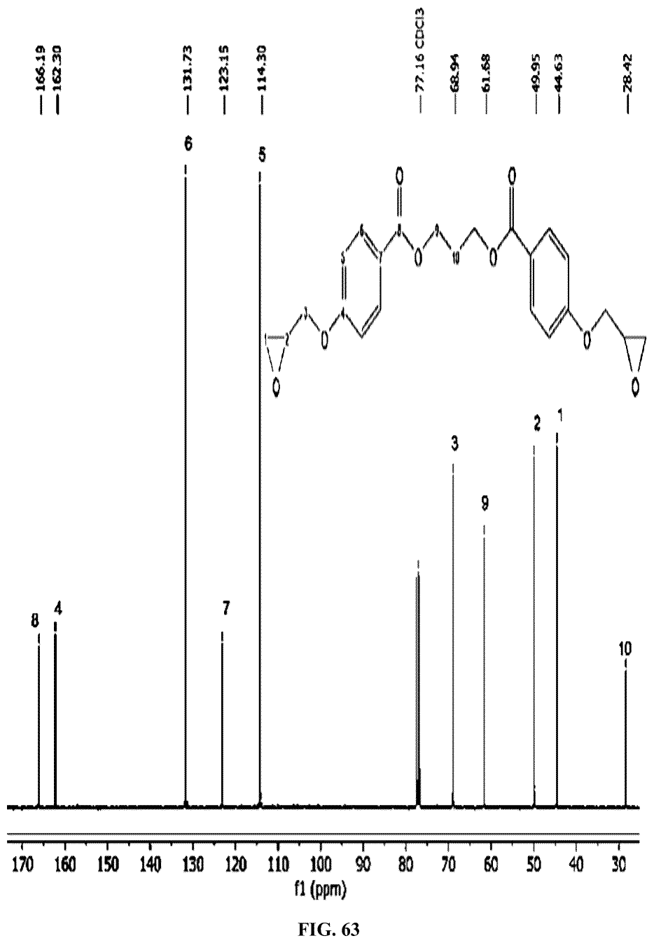

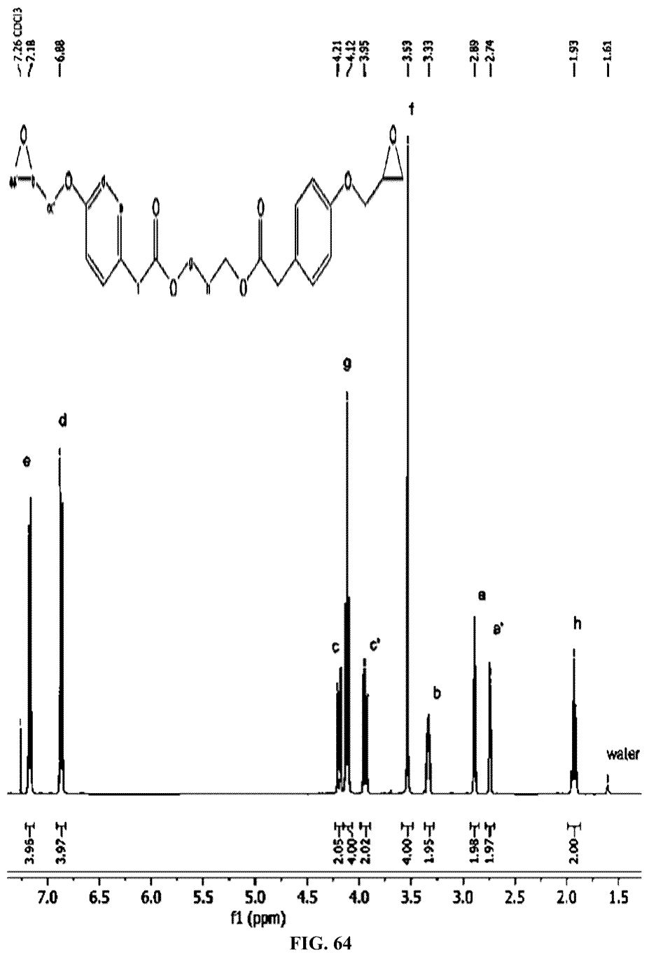

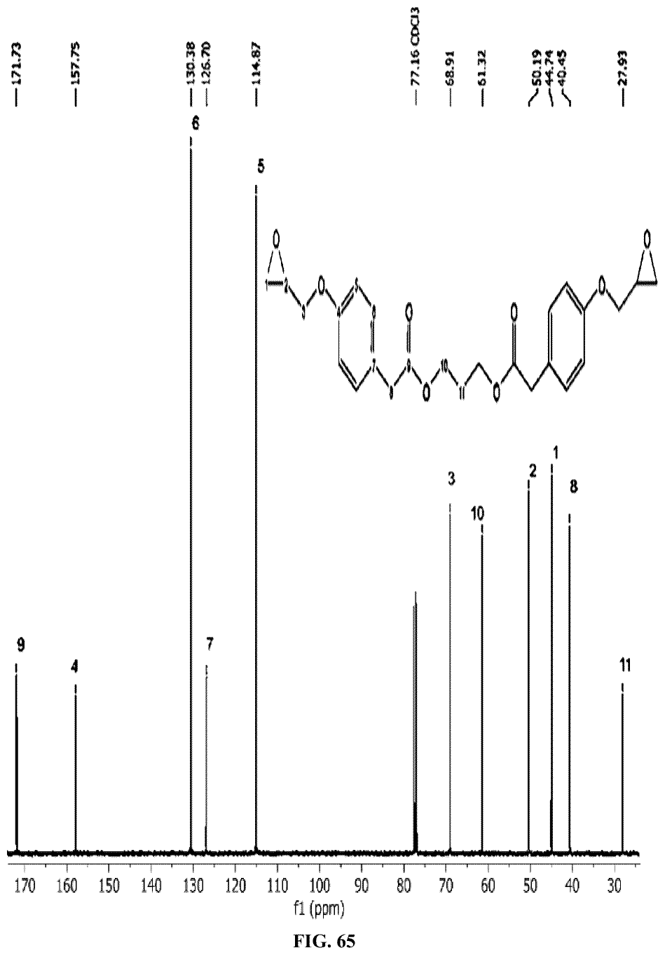

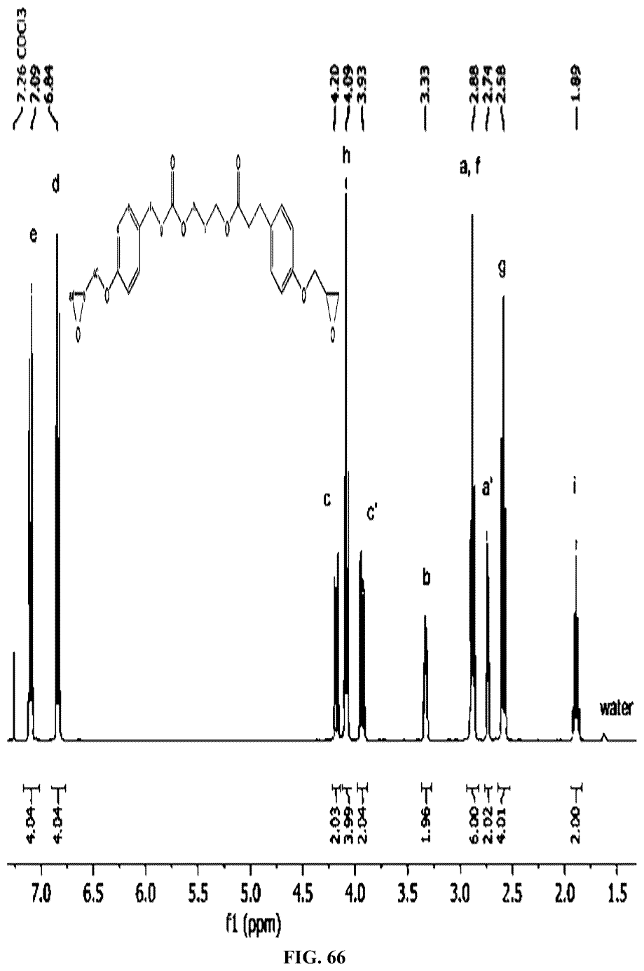

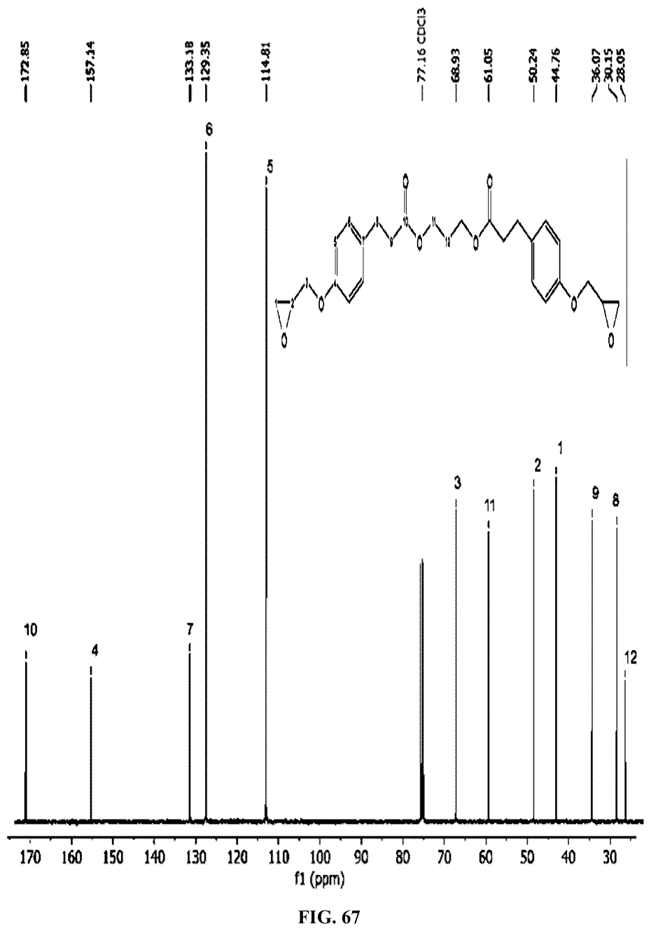

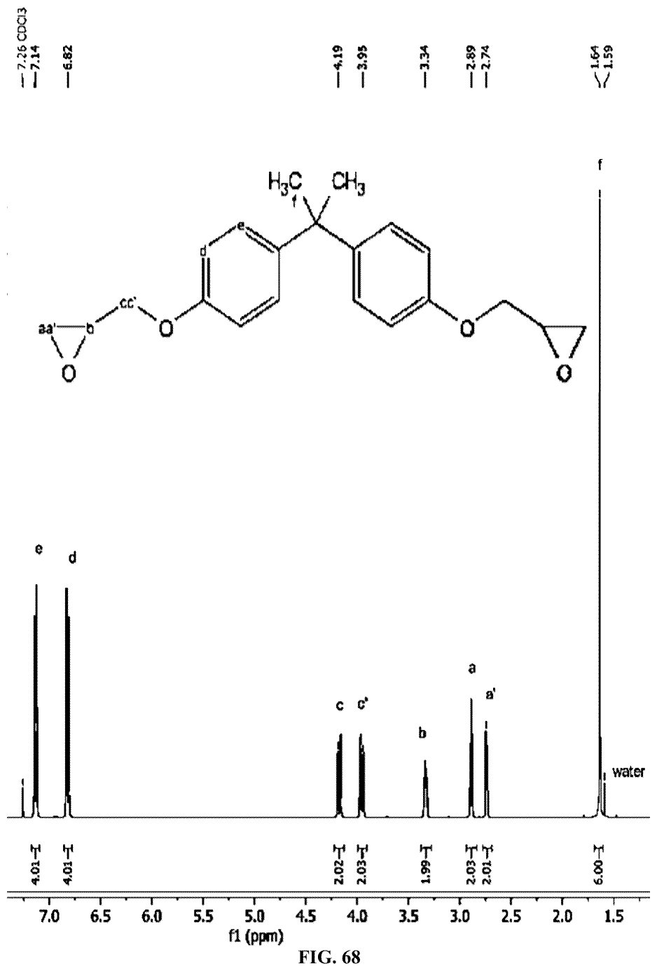

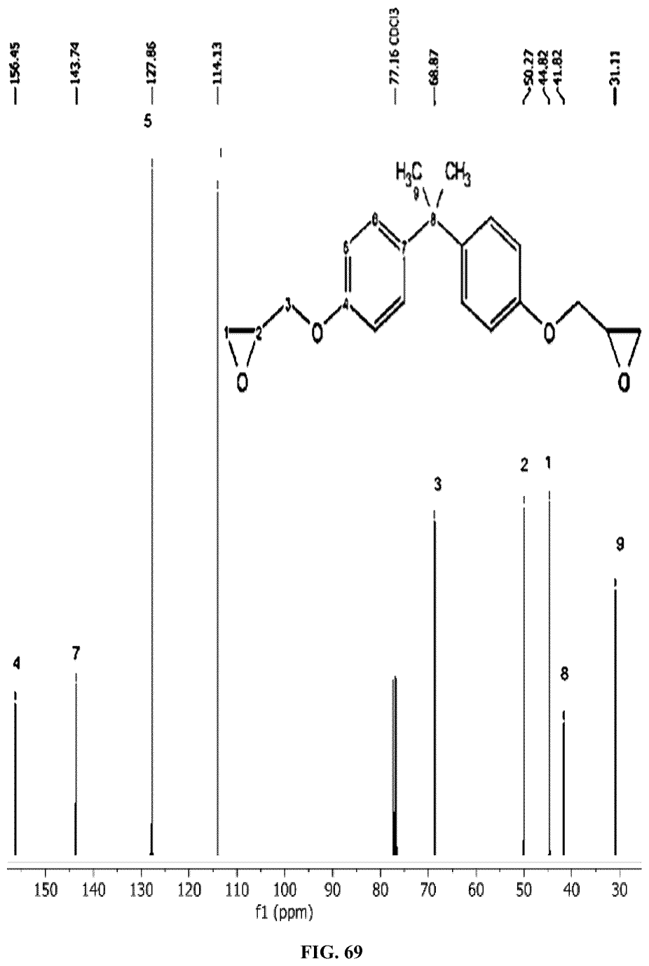

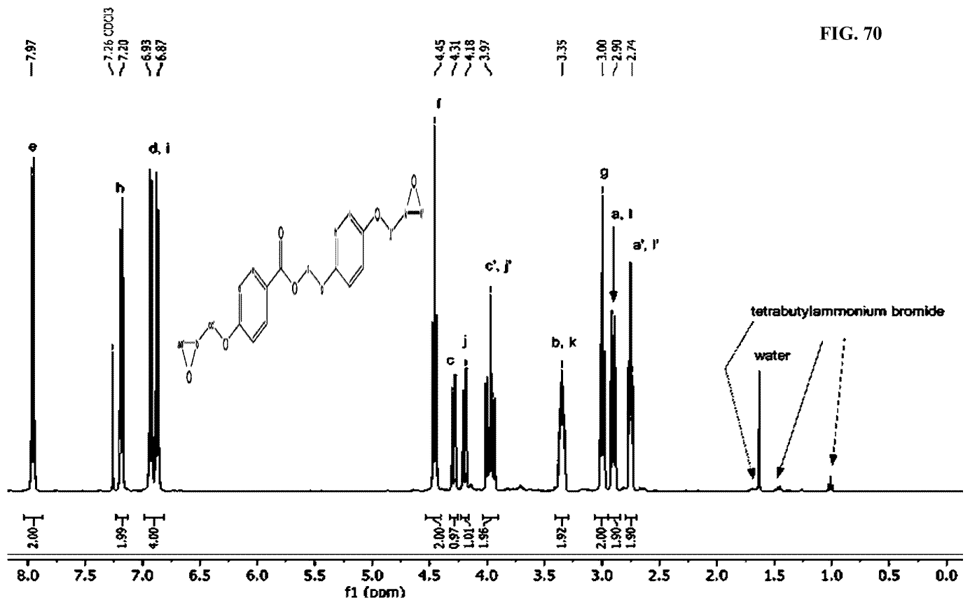

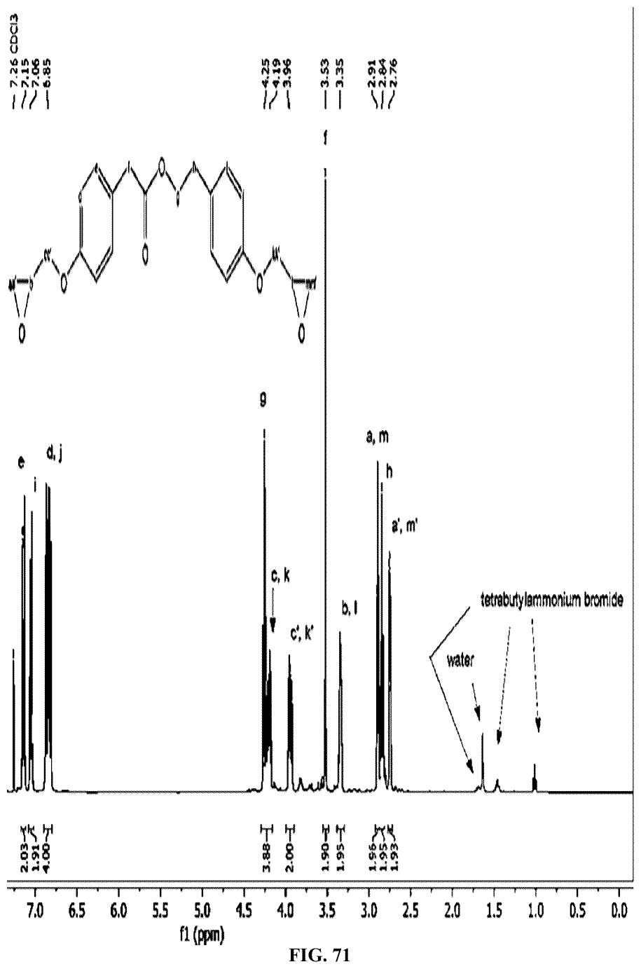

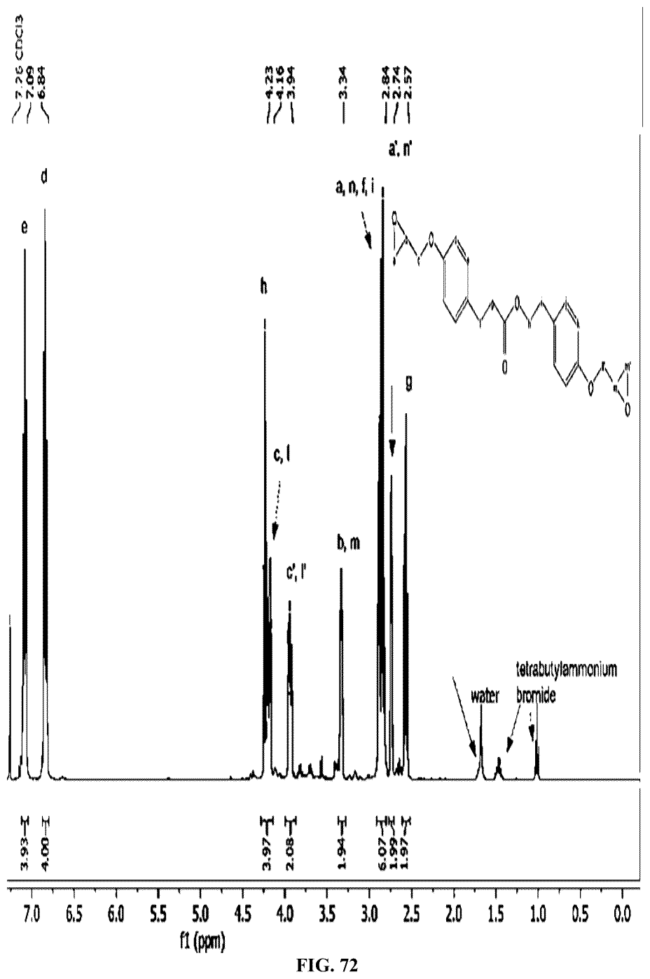

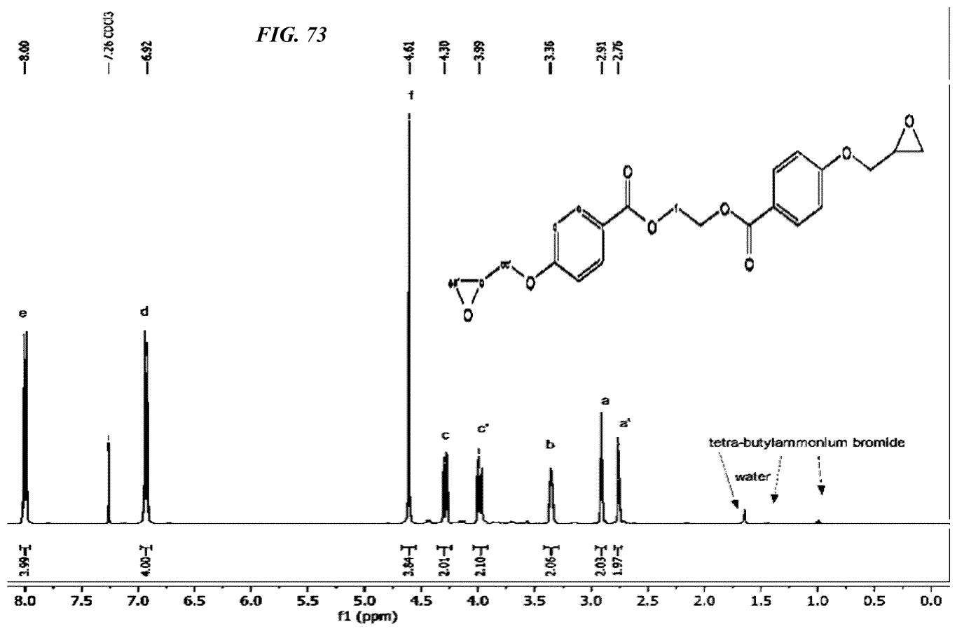

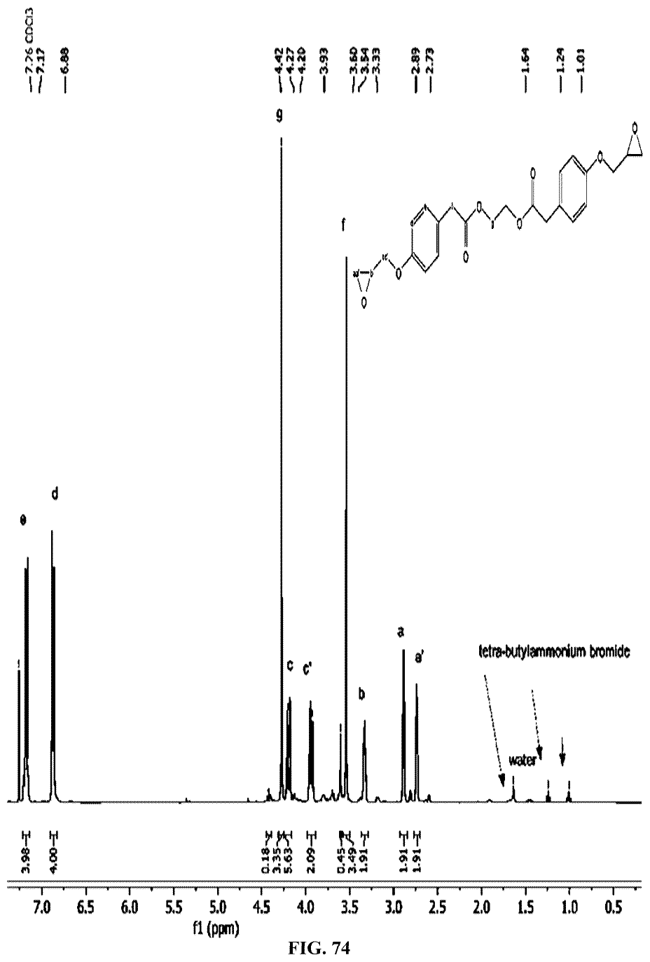

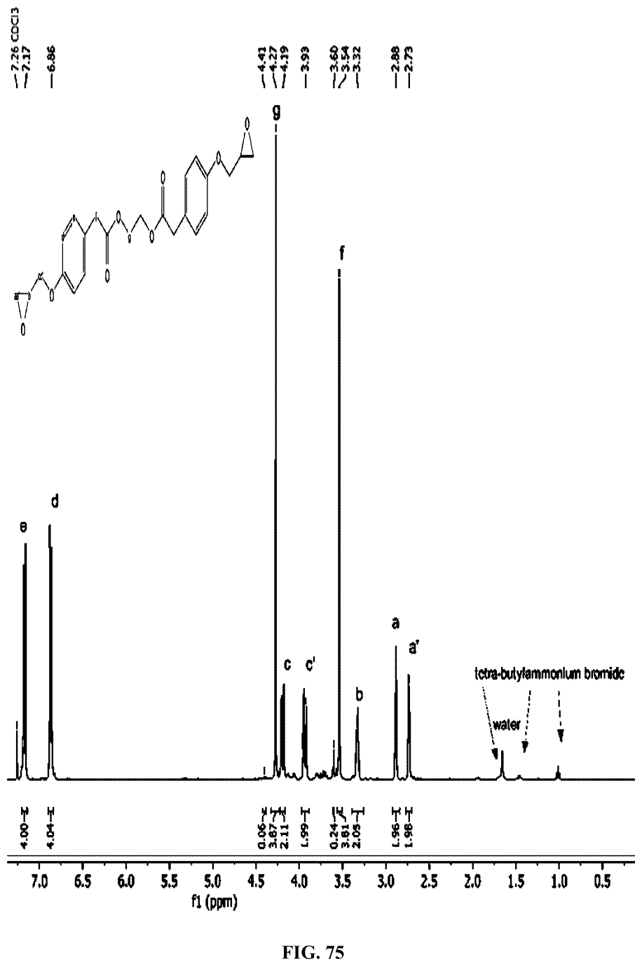

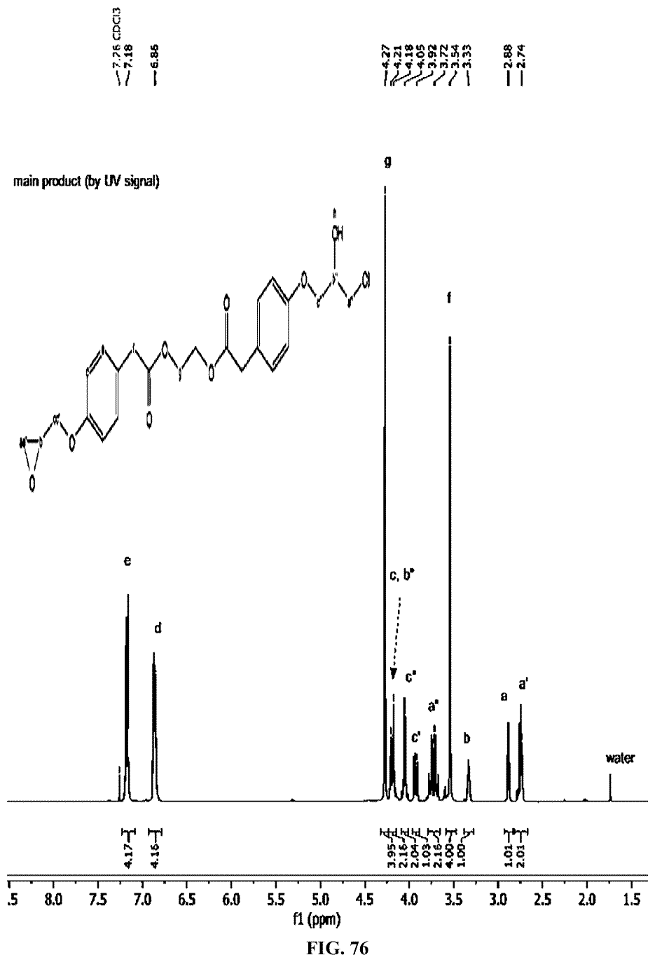

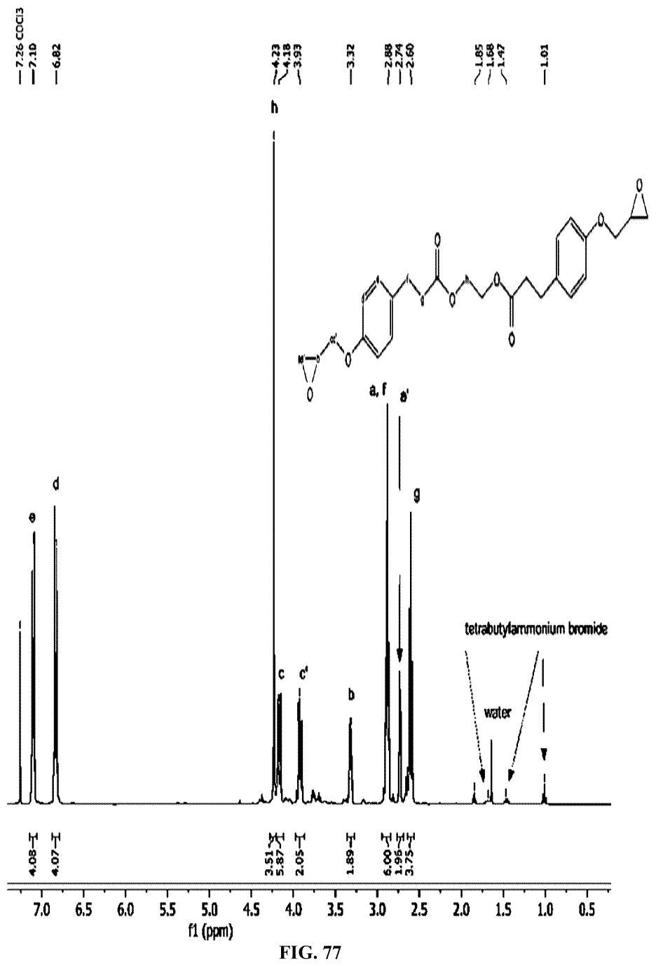

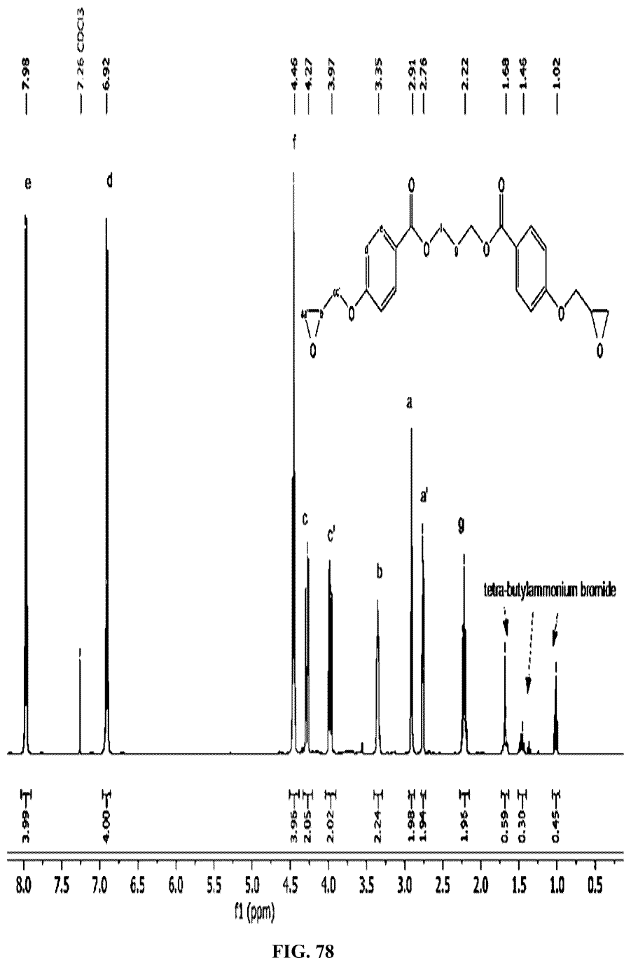

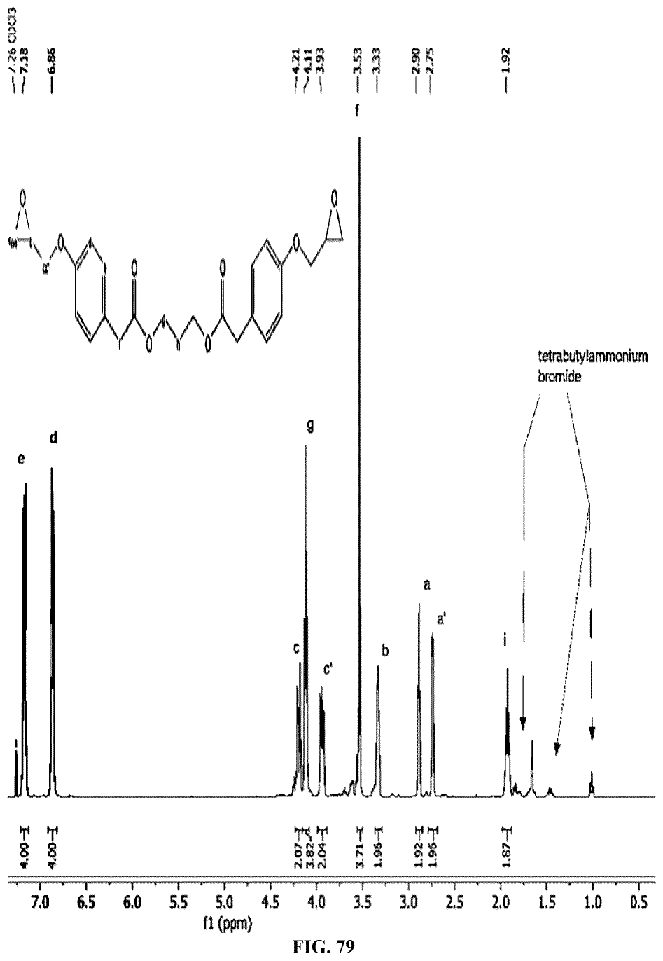

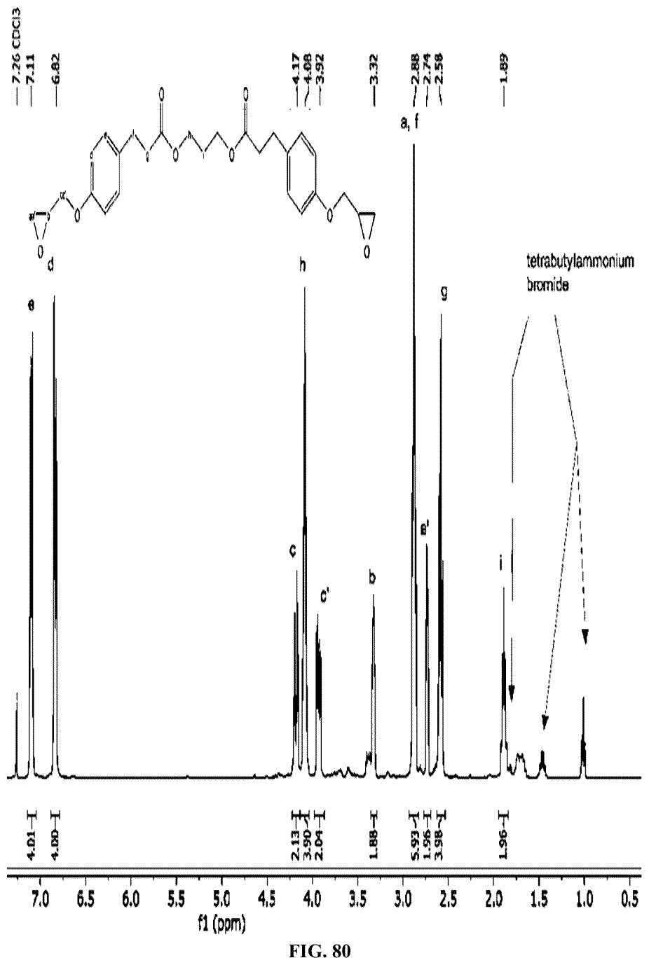

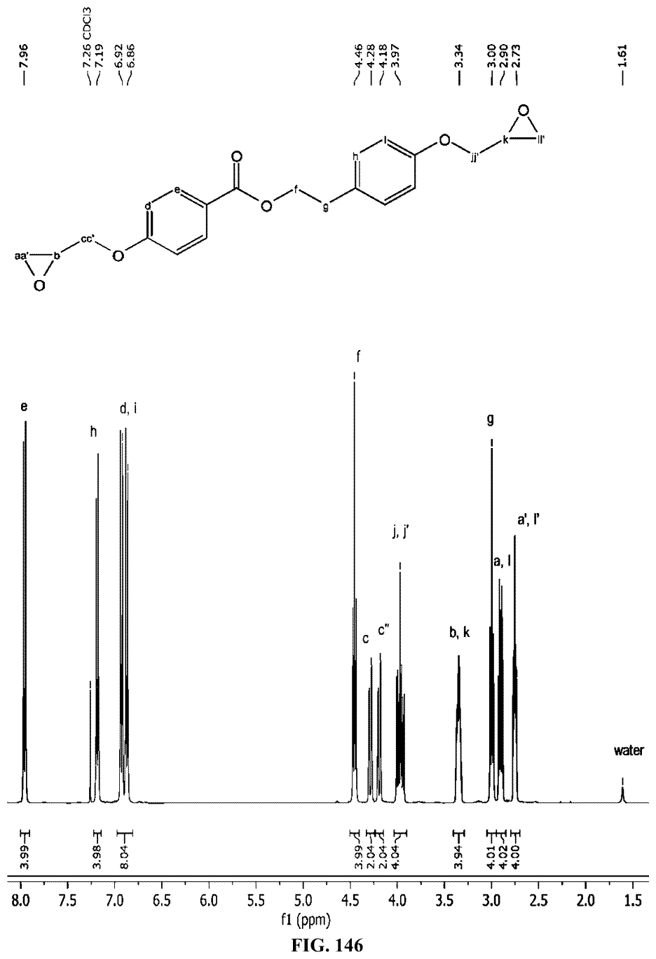

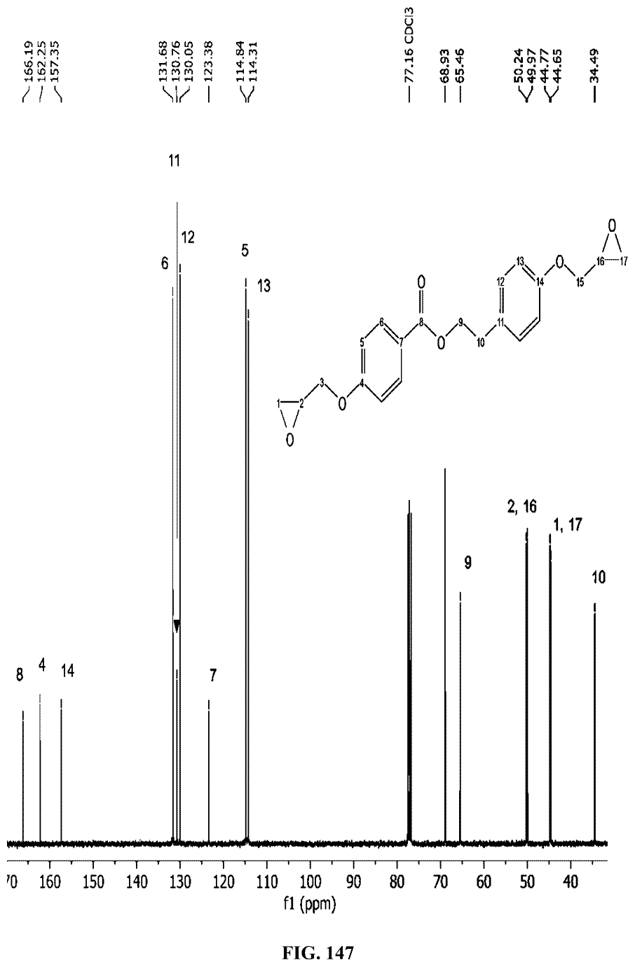

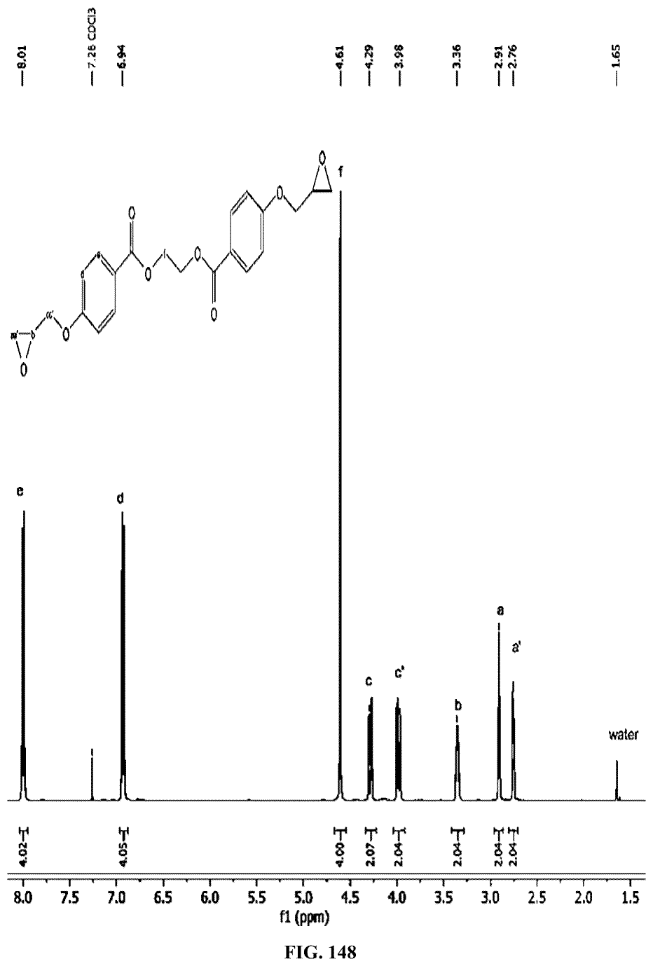

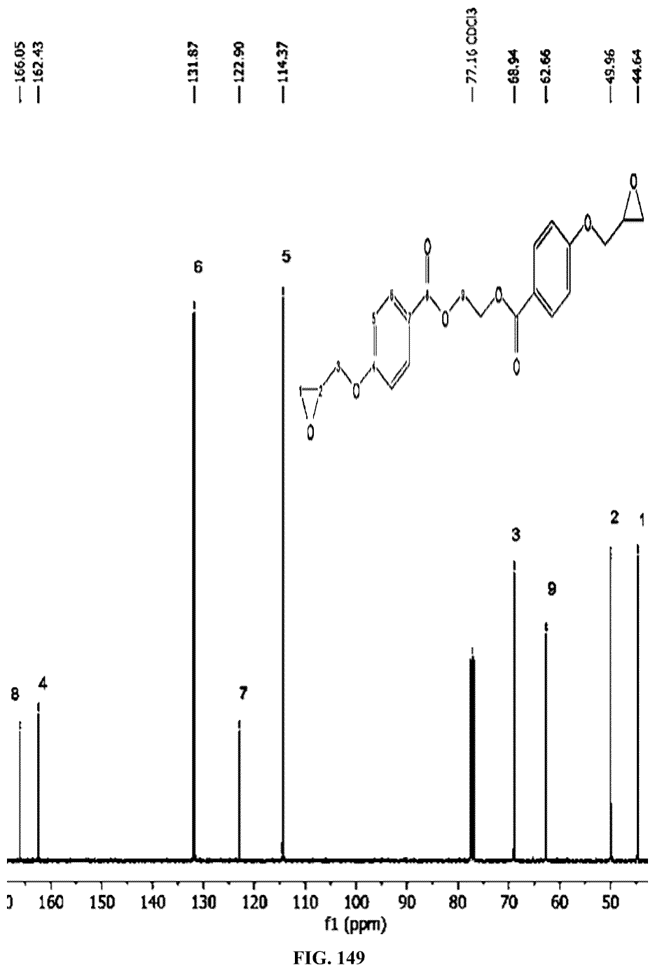

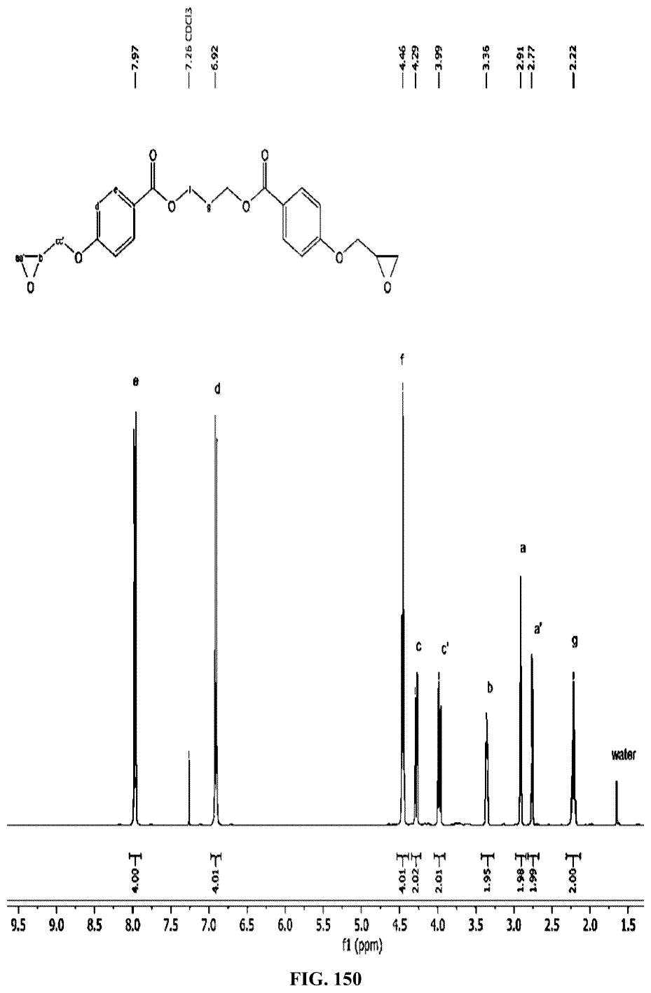

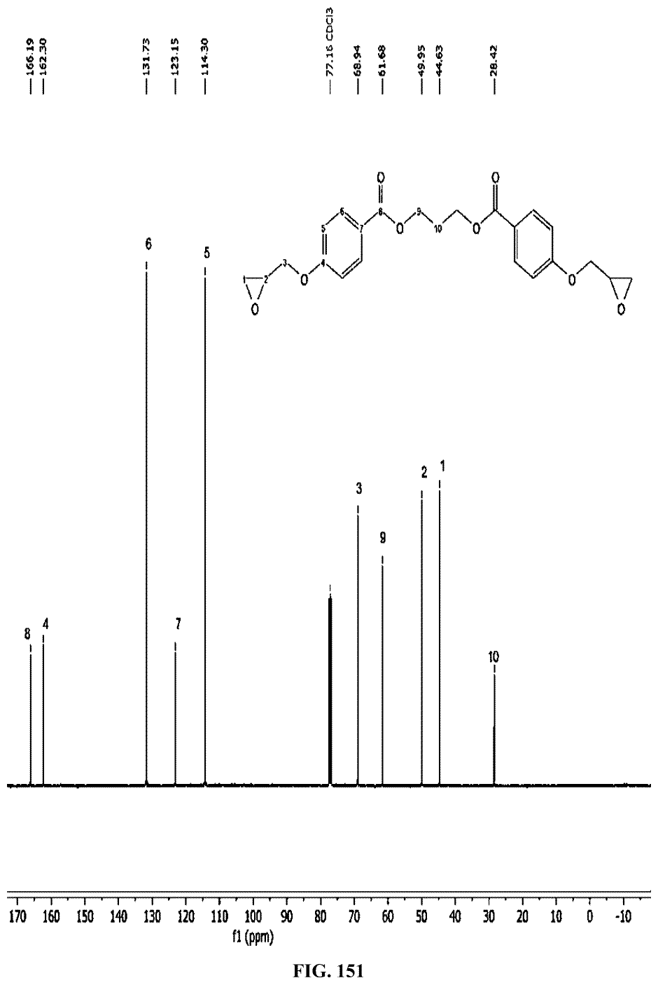

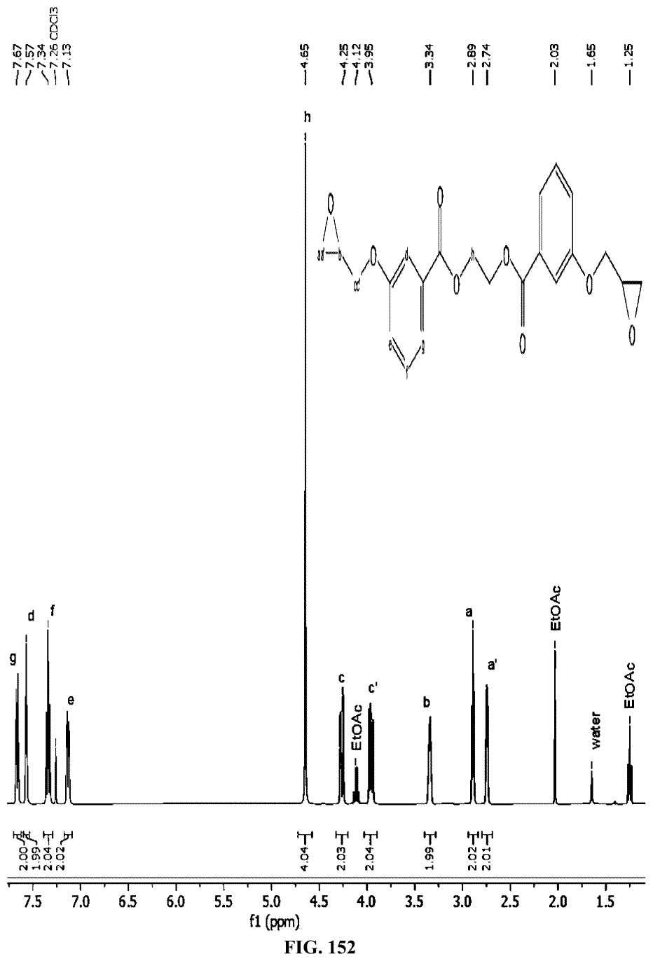

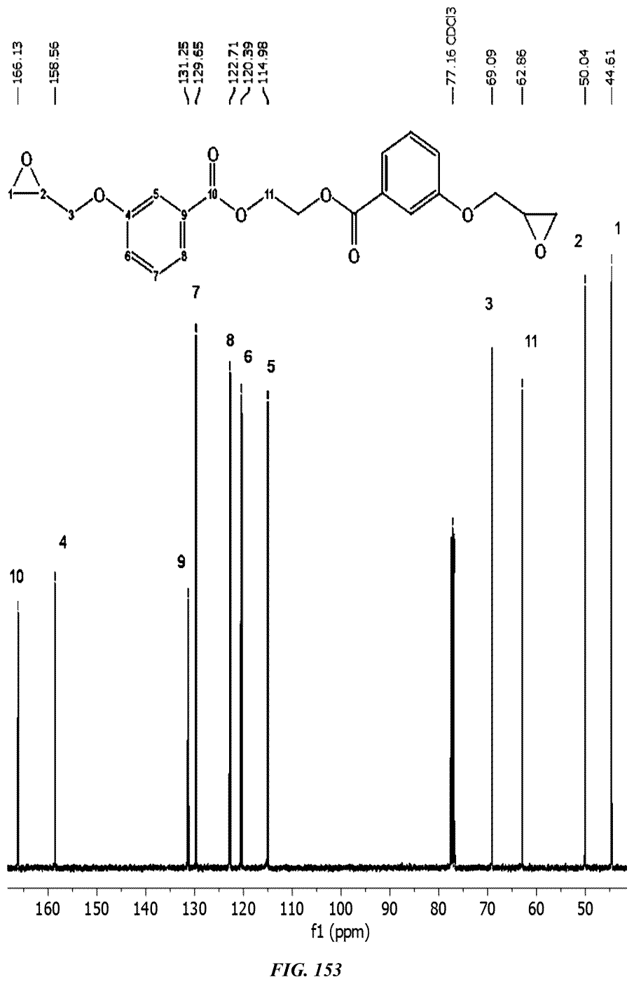

FIGS. 4 and 5A-5B show the ¹H and ¹³C NMR spectra, respectively, for diepoxide 23. The NMR spectra for all other diepoxides are shown in FIGS. 50-69 and 146-153. Yields ranged from 75%-82%. The key features of the ¹H spectrum are the peaks associated with the ester-adjacent methylene protons at 4.27 ppm and those associated with the epoxide ring protons at 3.33 ppm (methine), and 2.89 ppm and 2.73 ppm (methylene). Peaks at 4.19 ppm and 3.74 ppm are indicative of chlorohydrin content (i.e. lack of ring closure), An additional ¹H NMR spectrum taken at intermediate reaction stage shows signals at those locations is in FIG. 76. Purified monomer melting point (m.p.) was determined via differential scanning calorimetry (DSC), and the data is summarized in Table 1 and FIG. 6.

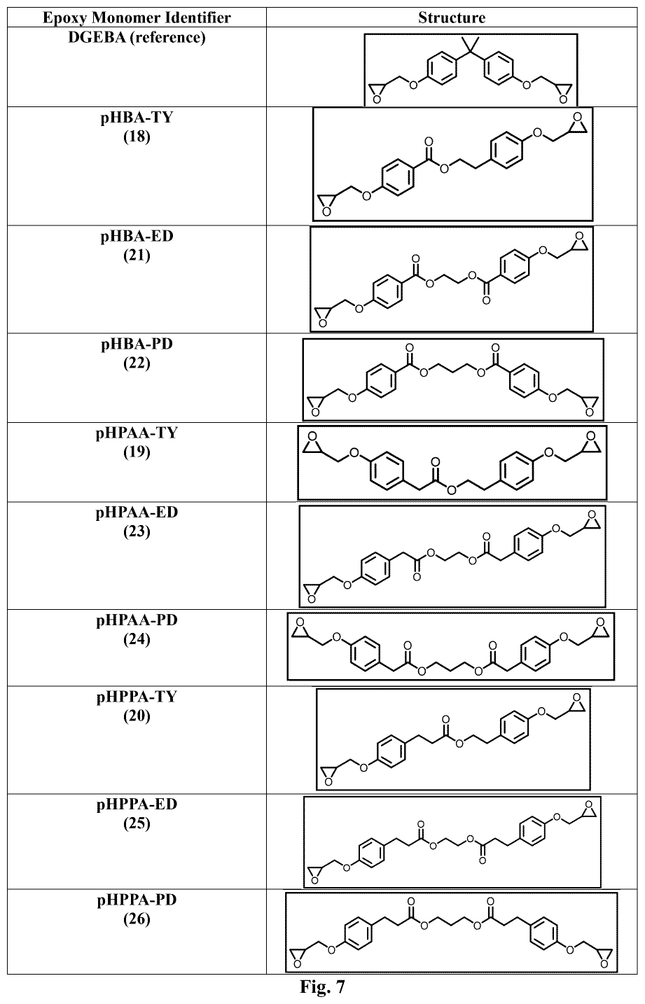

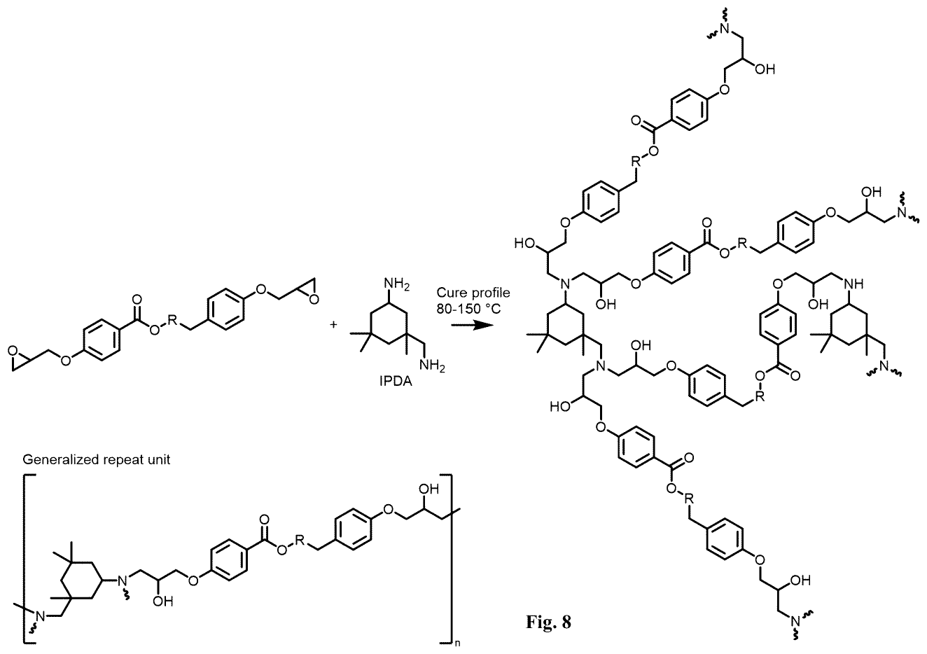

TABLE 1
Table 1 includes a monomer legend and select corresponding properties.
Fig. 7 shows the corresponding structures.

| | Ester | | Monomer | Monomer |
|---|---|---|---|---|
| | Hydrolysis | | Brookfield | EEW |
| | Observed in | Monomer | viscosity | (g/mol) |
| Diepoxide | Synthesis | m.p. | at 80° C. | measured |
| Identifier | (%) | (° C.) | (cP) | (theoretical) |
| DGEBA | N/A | 42 | 61 | 174 (170) |
| (reference) | | | | |
| pHBA-TY(18) | 0 | 102 | 118 | 184 (185) |
| pHPAA-TY(19) | 3 | 83 | 48 | 194 (192) |
| pHPPA-TY(20) | 1 | 70 | 44 | 198 (199) |
| pHBA-ED(21) | 4 | 82 | 240 | 205 (207) |
| pHBA-PD(22) | 1 | 110 | not evaluated | 217 (214) |
| pHPAA-ED(23) | 16 | 39 | 72 | 226 (221) |
| pHPAA-PD(24) | 4 | 48 | 61 | 235 (228) |
| pHPPA-ED(25) | 12 | 31 | 60 | 237 (235) |
| pHPPA-PD(26) | 2 | 34 | 55 | 243 (242) |

For both the asymmetric monoester and the symmetric diester series of monomers, the melting points were found to decrease as the aliphatic span from phenyl ring to ester group increased. A longer aliphatic span dilutes epoxide, ester, and phenyl groups with aliphatic content, which causes a decrease in the prevalence of dipole-dipole interactions and Π-Π stacking. Melting point is typically directly proportional to both molecular weight and the level and type of intermolecular interactions, and it appears that the impact of the decrease in intermolecular interactions is the more important factor. However, as the length of central aliphatic spacer in the diester series (the span in-between ester linkages) of the bridge increased from ethyl to propyl, an increase in melting point was observed. The melting points for butyl central spacer monomers were higher than for the ethyl and propyl equivalents in all cases (pHBA, pHPAA, and pHPPA derived diepoxide monomers).

The melting point of the epoxy monomers is an important property for processibility. In industrial practice, purposeful oligomerization of DGEBA is a common strategy to decrease structural regularity and thereby decrease the melting point. Despite the processibility issue, discrete monomer structures were studied for the purpose of structure-property relationship determination without interference from variation in oligomeric content. The absence of appreciable oligomeric content in the purified monomers was confirmed via comparison of epoxide equivalent weights (EEWs) determined by titration with theoretical values. The data for diepoxide melting points (m.p.) and EEW are summarized in Table 1. As most of the diepoxides are previously unreported, comparative data from literature is generally unavailable. However, the melting points for monomers 21 and 22 align well with those reported by Kakiuchi et al. For both the asymmetric monoester and symmetric diester series of monomers, m.p. decreases as the aliphatic span between the phenyl ring and ester group increases. For instance, the m.p. for monomers 18, 19, and 20 drops from 102° C. to 83° C. and 70° C., respectively, as the length of the methylene spacer derived from the phenolic acid increases. This trend is potentially attributable to the dilution of dipole-dipole interactions and π-π stacking by the increasing aliphatic content and reduction of the overall strength of intermolecular forces. Although m.p. generally correlates with molecular weight and the strength of intermolecular interactions, the reduction in intermolecular forces appears to dominate in this case. However, as the length of the central aliphatic spacer in the diester series (i.e., the distance between ester linkages) was increased from ethyl to propyl (e.g., monomer 21 to 22, monomer 23 to 24, and monomer 25 to 26), a corresponding increase in m.p. was observed.

Viscosity is an important parameter for processability, particularly for interfacial applications where wettability is important. Brookfield viscosity, as provided in Table 1, suggests a correlation to ester concentration and is significantly influenced by the type of ester (aliphatic vs aromatic) in the monomer structure. For example, the aromatic ester monomer 21 with the highest ester concentration exhibited a viscosity approximately four times higher than that of DGEBA (240 cP vs 61 cP). Aliphatic diester monomers 23, 24, 25, and 26 in contrast exhibited viscosities of 55 cP-72 cP, comparable to DGEBA, while the aliphatic monoester monomers displayed noticeably lower viscosity of 44 cP-48 cP.

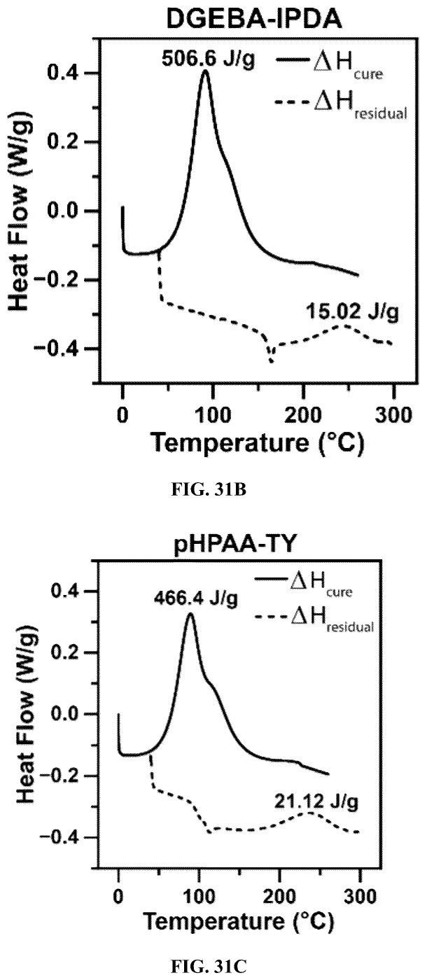

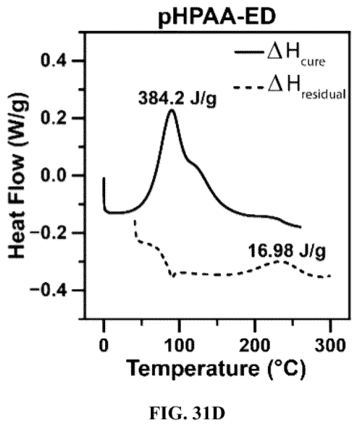

The epoxy-amine thermosets were synthesized from diepoxide monomers with diamine. For example, pHBA, pHPAA, and pHPPA derived diepoxide monomers were reacted with isophorone diamine (IPDA) to form polymeric networks. A generalized reaction scheme and polymer network structure is shown in FIGS. 8 and 31A. A 1:1 stoichiometry of an epoxide ring to amine hydrogen was used in all cases. For comparison, a reference networks were formed using commercial diglycidyl ether of bisphenol A (DGEBA). The reference networks containing DGEBA were synthesized using the same process as used for the ester-containing diepoxide monomers.

The systems were analyzed by DSC to determine cure behavior, and the thermograms for DGEBA and monomers 19, and 23 are shown in FIGS. 31B-31D. Peak onsets for the reactions of IPDA with DGEBA and monomers 19, and 23 were 63° C., 60° C. and 59° C., respectively, and the corresponding peak maxima were 91° C., 89° C. and 90° C., respectively. A right shoulder centered at about 120° C. was observed in all cases inclusive of the DGEBA reference. This multimodality is typically attributed to the reaction of the epoxide group with amines that exhibit different reactivities. For example, IPDA contains two amine groups in different chemical environments. The amine group attached to the secondary carbon (i.e. directly attached to the cyclohexyl group) exhibited lower reactivity due to steric hindrance and a higher activation energy. Differential reactivities also arise as primary amines are converted to secondary amines upon reaction with oxirane groups.

In both reactions, hydroxyl functionality was formed upon epoxide ring-opening; the formed hydroxyls can form hydrogen bonds with unreacted epoxide groups and thereby accelerate the epoxy-amine ring-opening reaction.

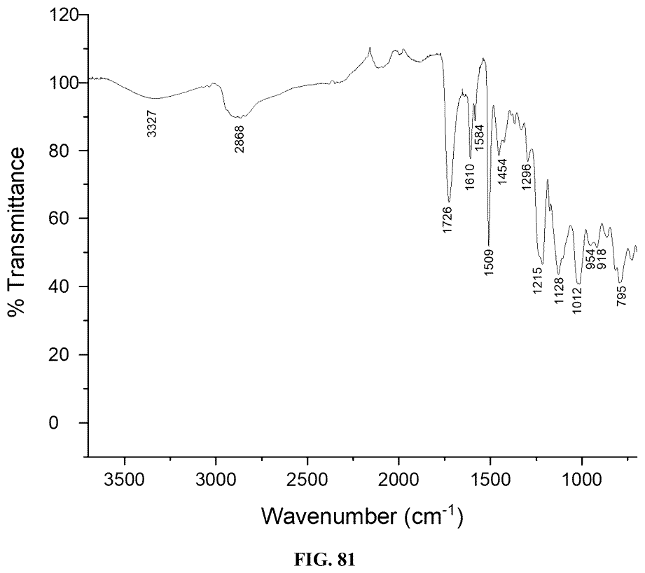

While the epoxy-amine reaction is expected to dominate due to its higher reactivity, the ester groups could undergo amidation—impacting the final network structure and properties. To assess the extent of amidation in the current systems, Fourier Transform Infrared Spectroscopy (FTIR) was used. FIG. 81 shows the mid-infrared spectrum of a representative network prepared from monomer 28 and IPDA. The characteristic ester carbonyl absorption at 1726 cm⁻¹ is evident; however, absorptions corresponding to secondary or tertiary amides (amide I band at 1680-1630 cm⁻¹) were not detected, indicating that minimal amidation occurs for the systems under the cure protocols used. Peaks nearby at 1610 and 1584 cm⁻¹ were observable and attributed to phenyl C═C stretch vibrations.

Based on the DSC data and monomer melting points, a single cure protocol was established to form the polymer networks. The established cure protocol was carried out at 80° C. for 3 h, ramp 80° C.-150° C. over 3 h, then 150° C. for 1 h, and yielded networks that exhibited extents of cure ranging from 95.5% to 97.0%. The processing and initial cure temperature of 80° C. was primarily determined by monomer melting point, despite the lower onset temperature for cure. The monomers had melting points of roughly 80° C. or lower except for the aromatic ester monomers 18 and 22. Fortunately, it was possible to heat and then supercool monomer 18 to allow for the addition of IPDA at 80° C. This process was not feasible for monomer 22, and thus the network derived from this monomer and IPDA was not analyzed. A post cure process of 160° C. for 2 hours was also evaluated, though isothermal TGA at 160° C. following a 1 hour drying period indicated minor weight loss over 2 hours (0.02% to 0.17% for the ester-containing networks vs. 0.00% for the DGEBA reference network).

Regulation of the network connectivity was possible by leveraging differences in reactivity of primary amine-epoxide, secondary amine-epoxide, hydroxyl-epoxide, etc. To evaluate the impact of a lower initial cure temperature on network architecture, a network (pHPAA-ethylene glycol diepoxide-IPDA) was formed using an alternate lower initial temperature cure profile (40° C.-150° C. for 6 hours, 150° C. for 1 hour). This network exhibited a lower heterogeneity (full width at half height (FWHH) of tan δ peak 8.7° C. vs 10.0° C.) as compared to the same network formed using the standard cure profile described.

The use of 40° C. at the initial temperature was not possible for several of the networks though, and this is why 80° C. was used as the initial temperature in the standard cure protocol. All monomers except for the pHBA-tyrosol and pHBA-1,3-propanediol monomers exhibited a melting point of roughly 80° C. or less. Despite the ˜100° C. melting point of the pHBA-tyrosol monomer, heating to about 100° C. followed by cooling to about 80° C. was possible prior to the addition of IPDA. The melting point of the pHBA-1,3-propanediol monomer (110° C.) was problematically high for controlled network formation.

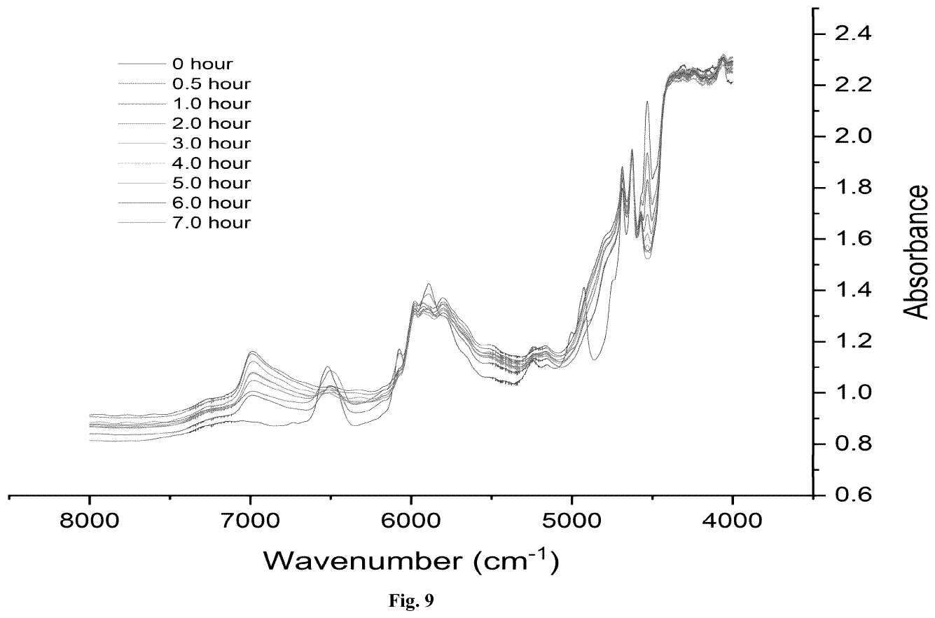

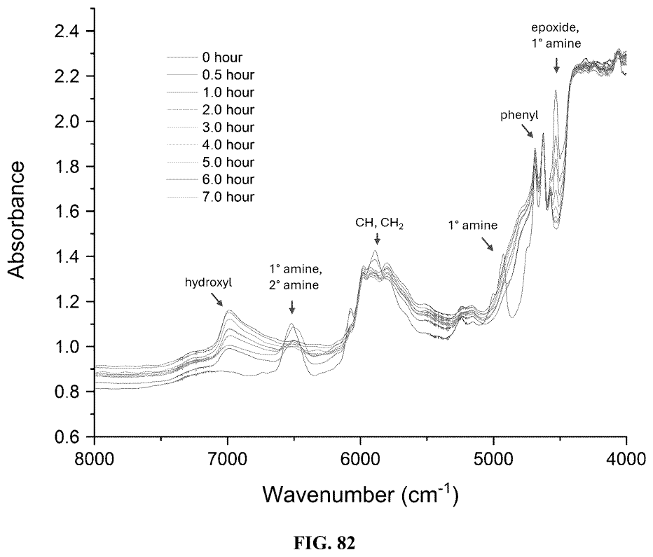

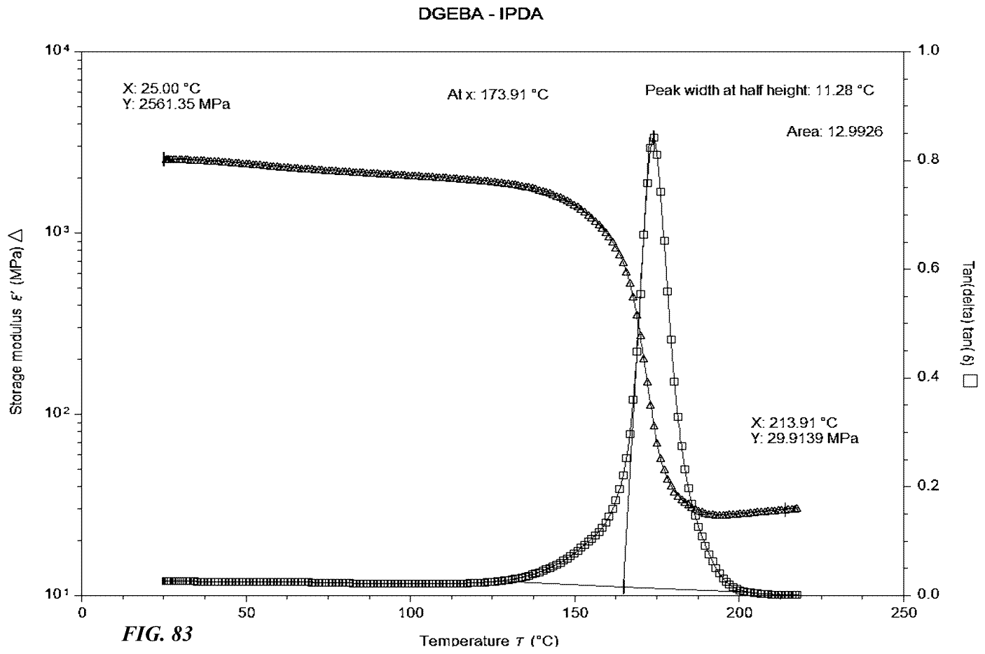

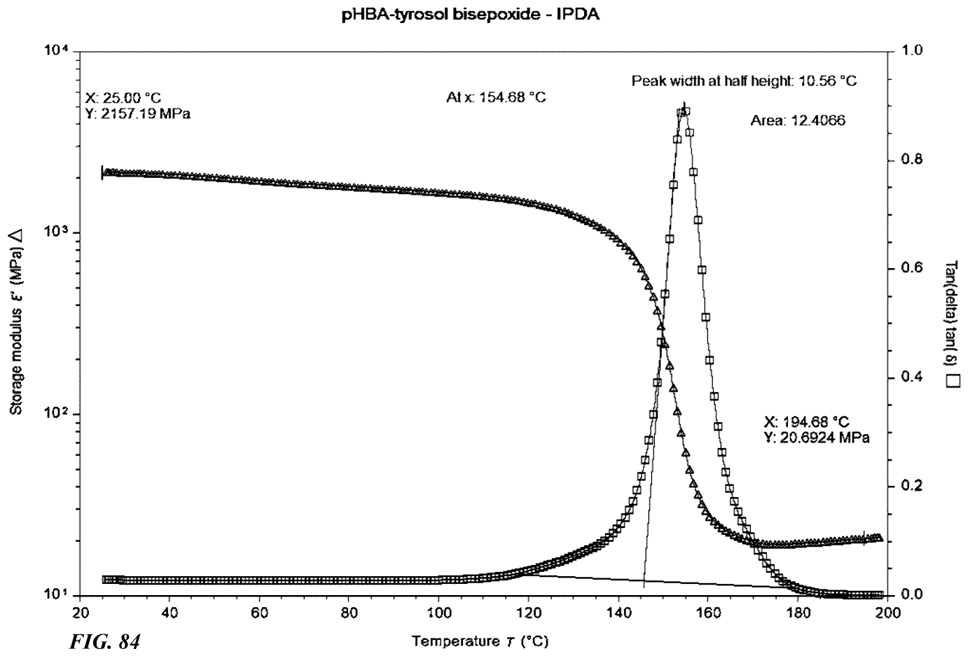

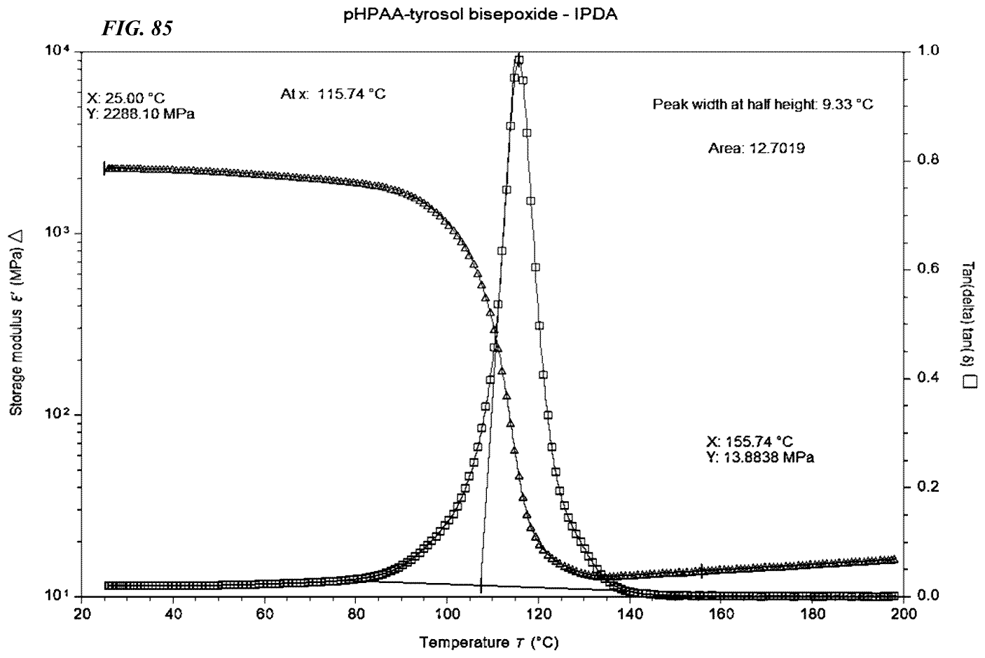

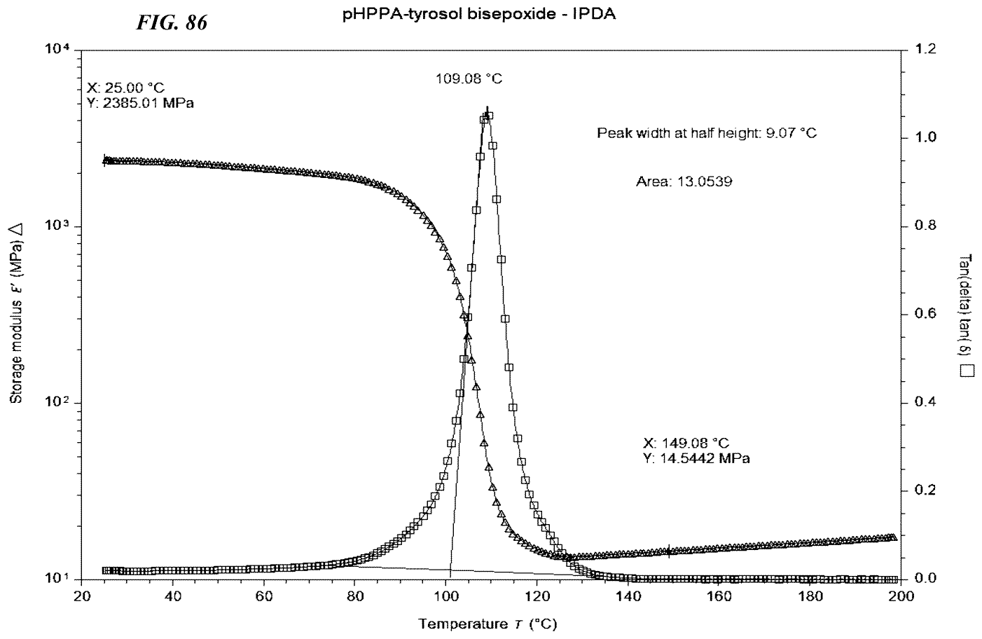

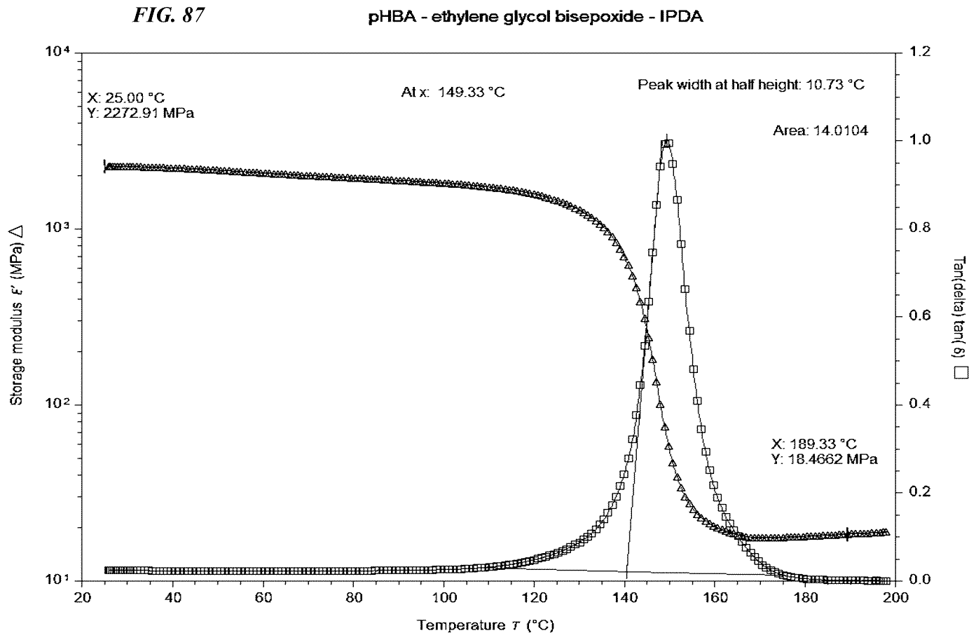

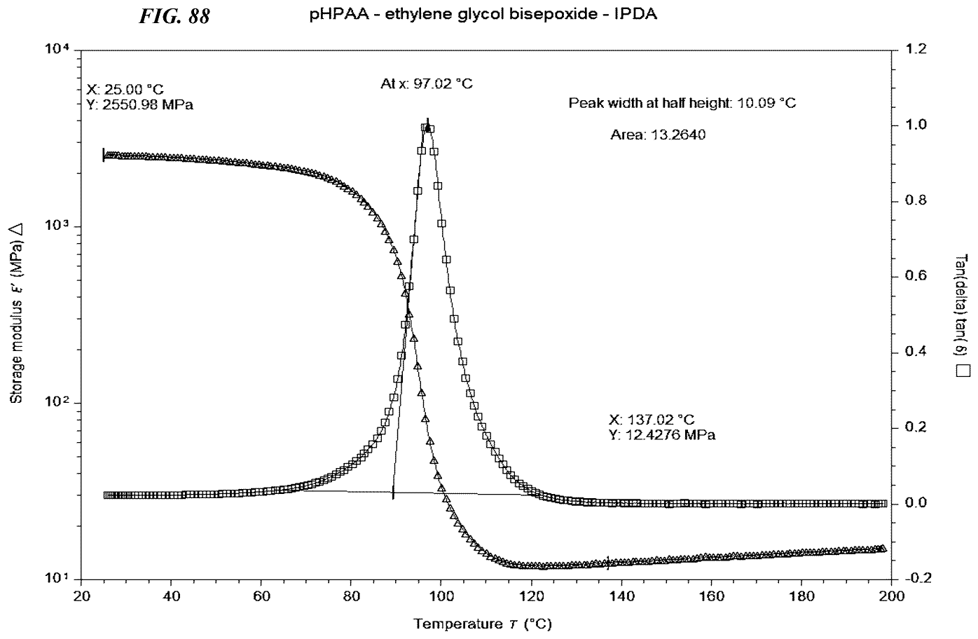

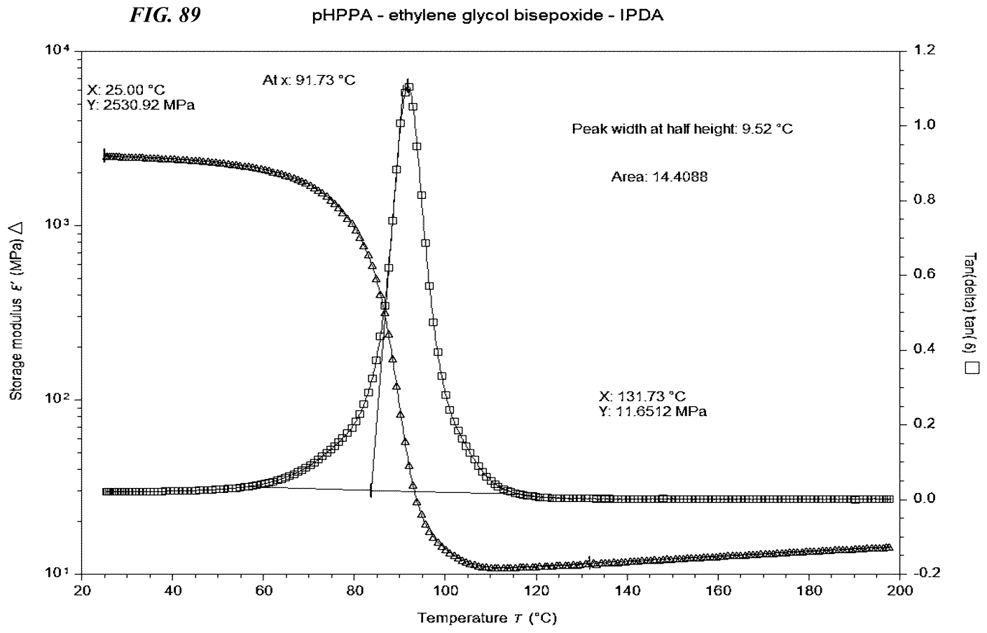

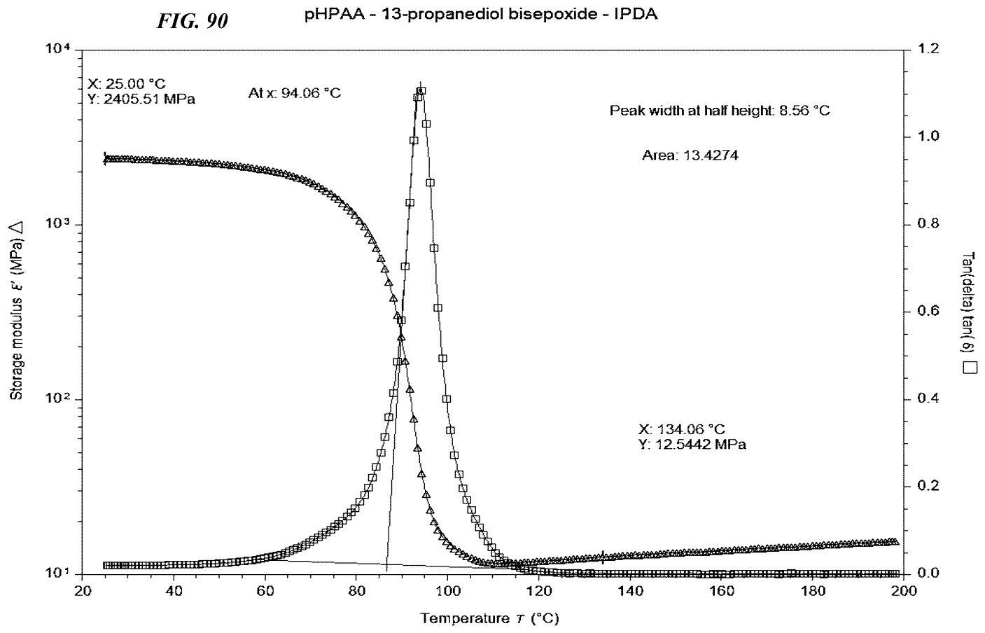

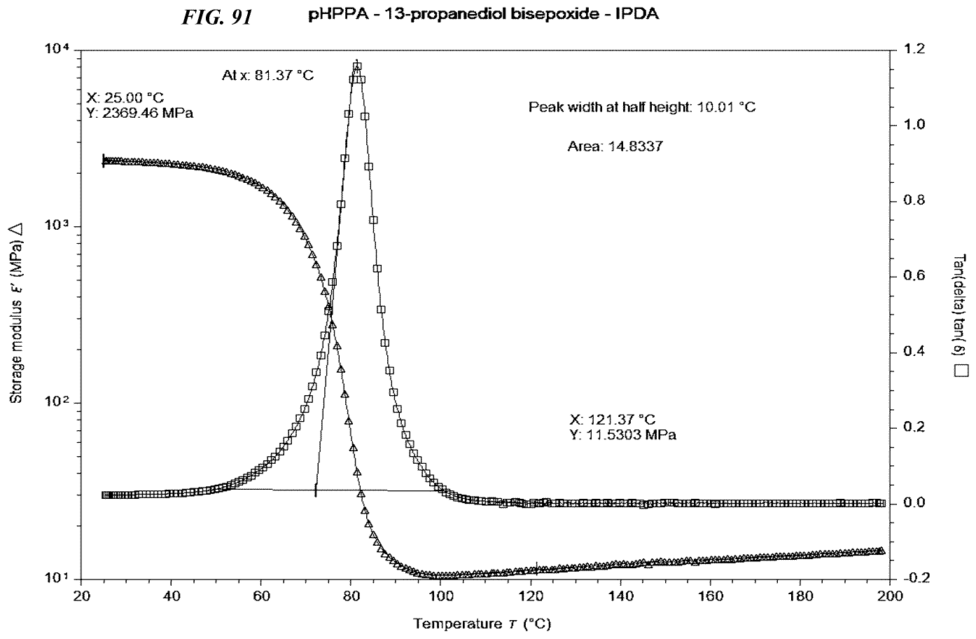

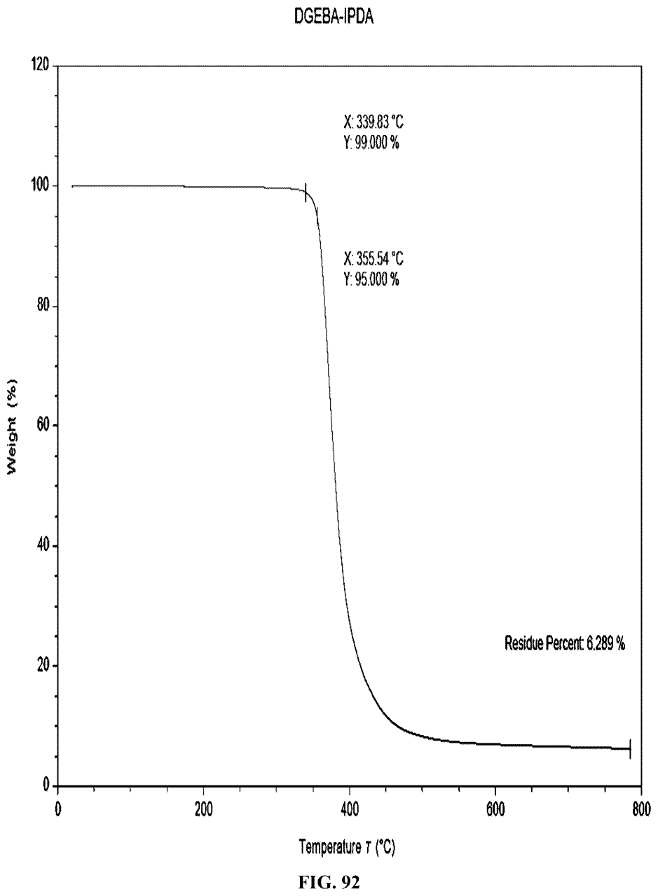

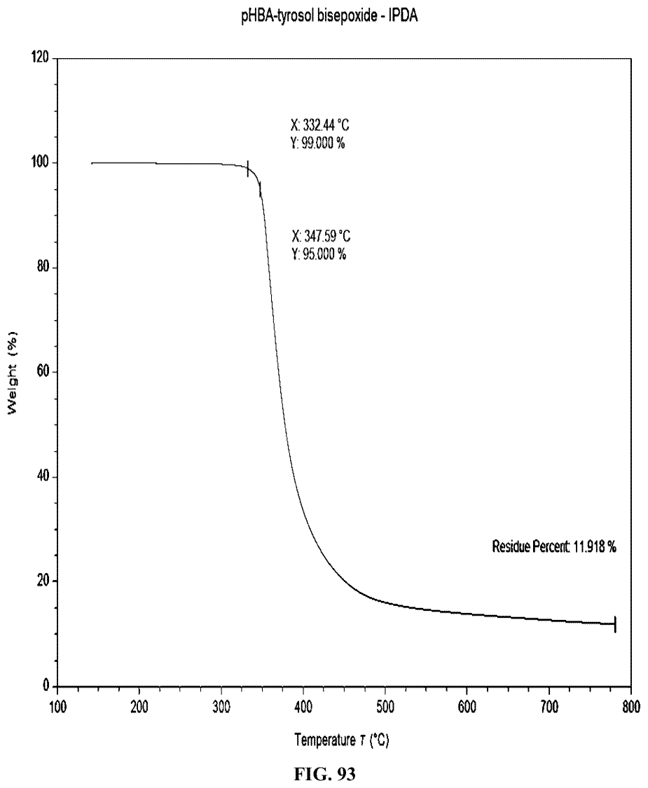

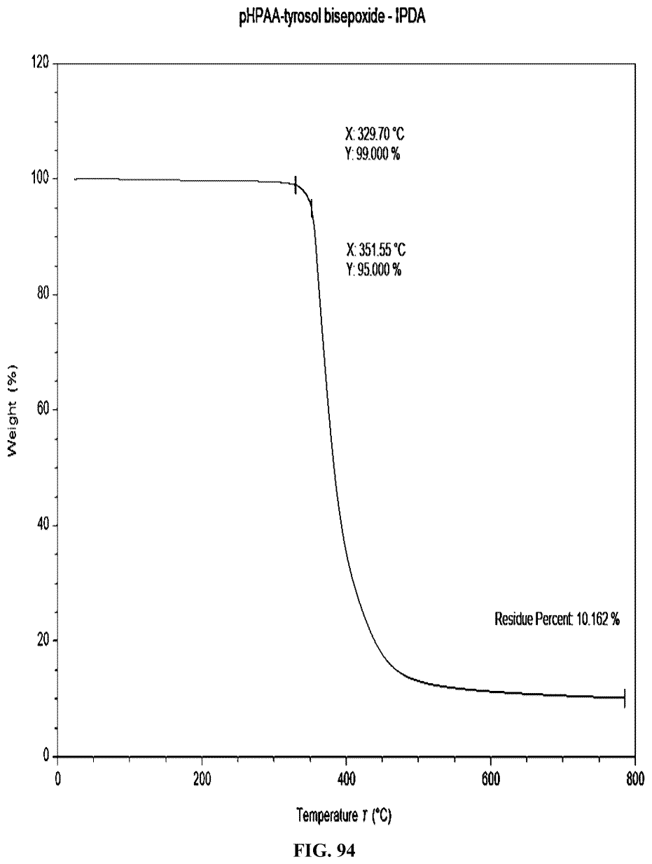

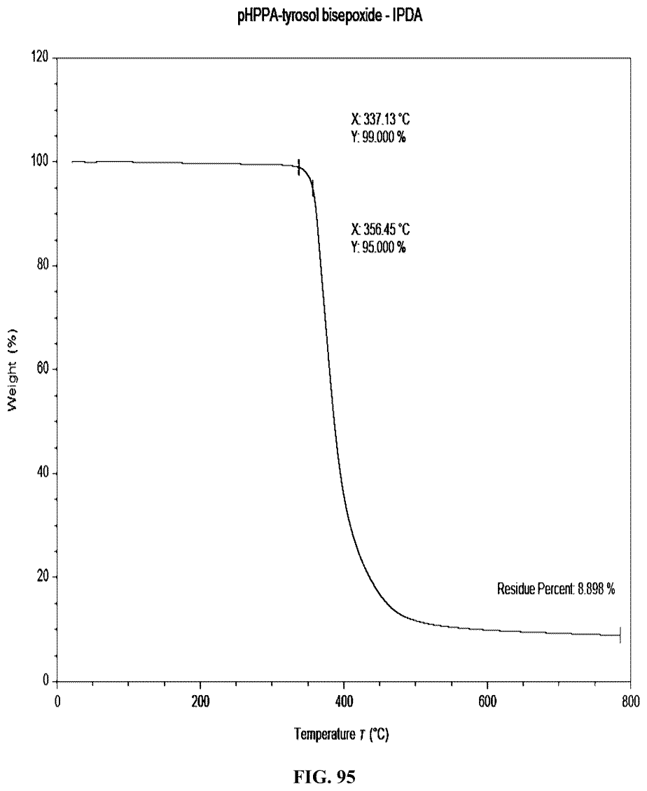

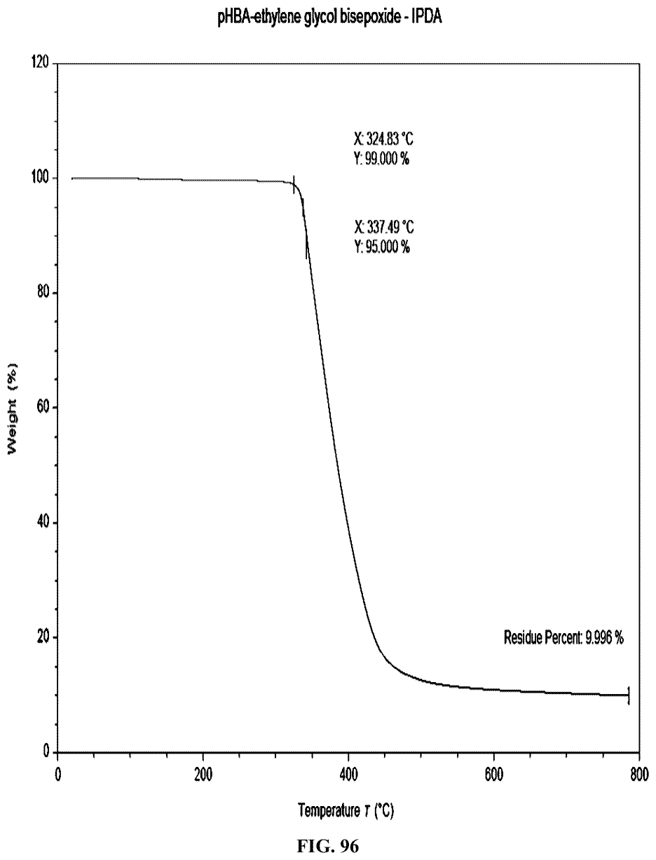

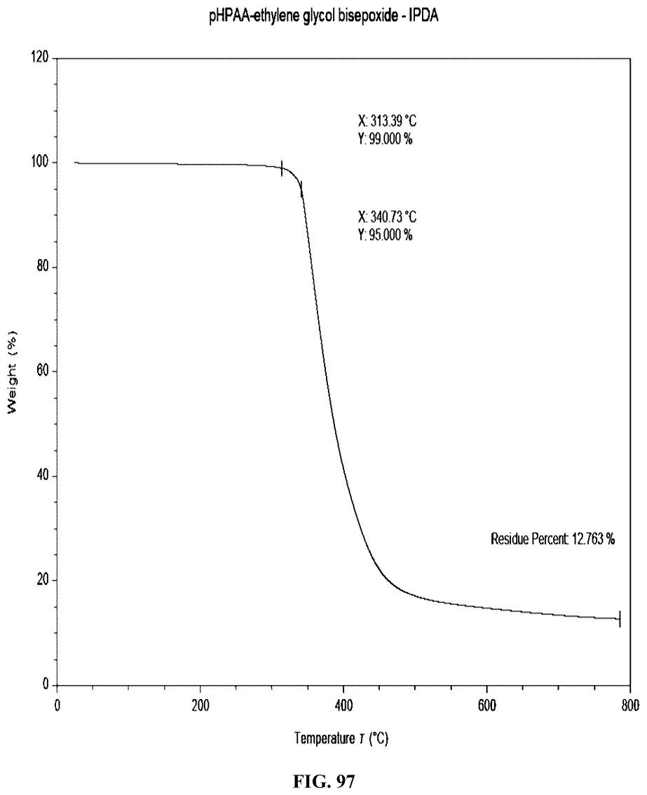

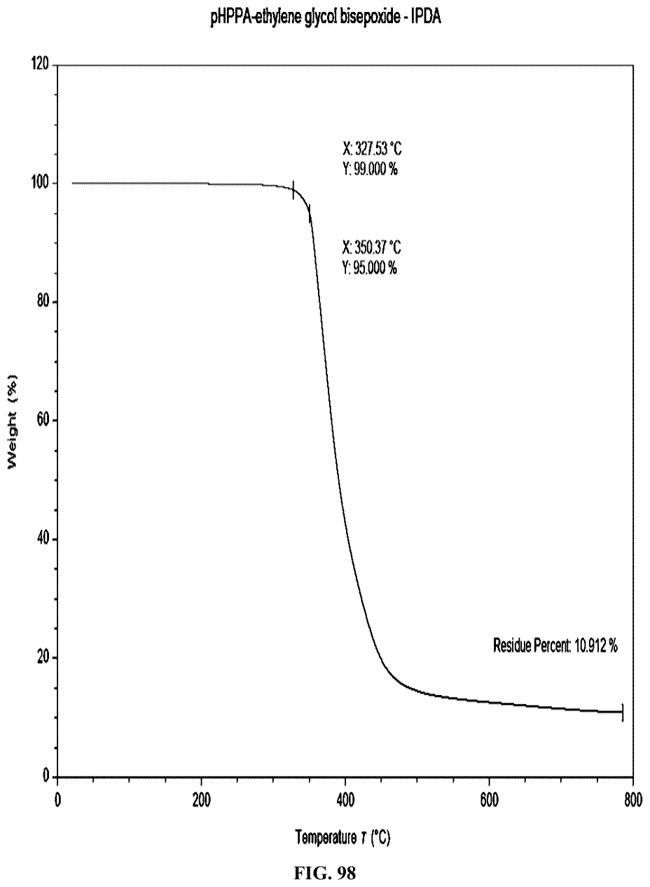

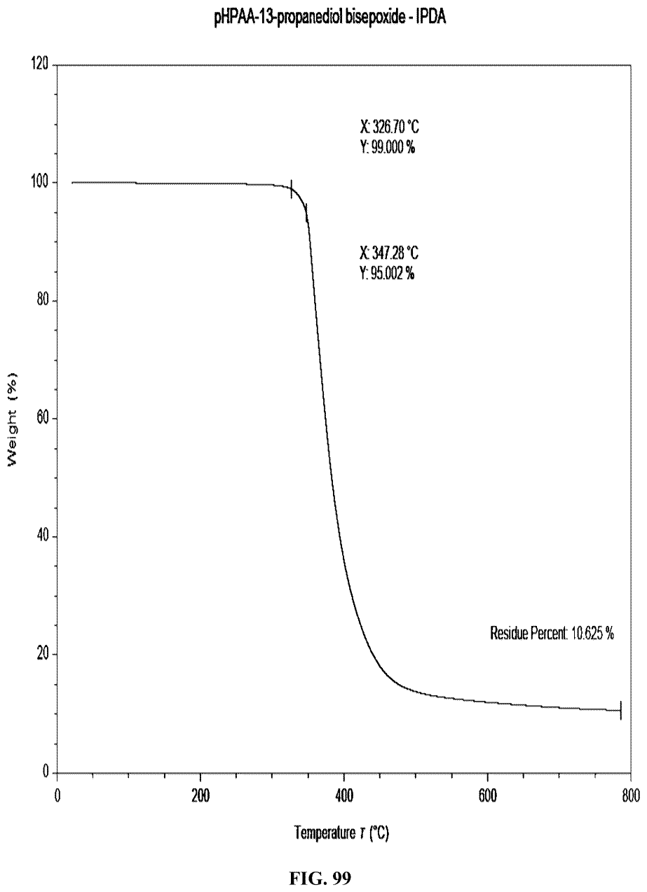

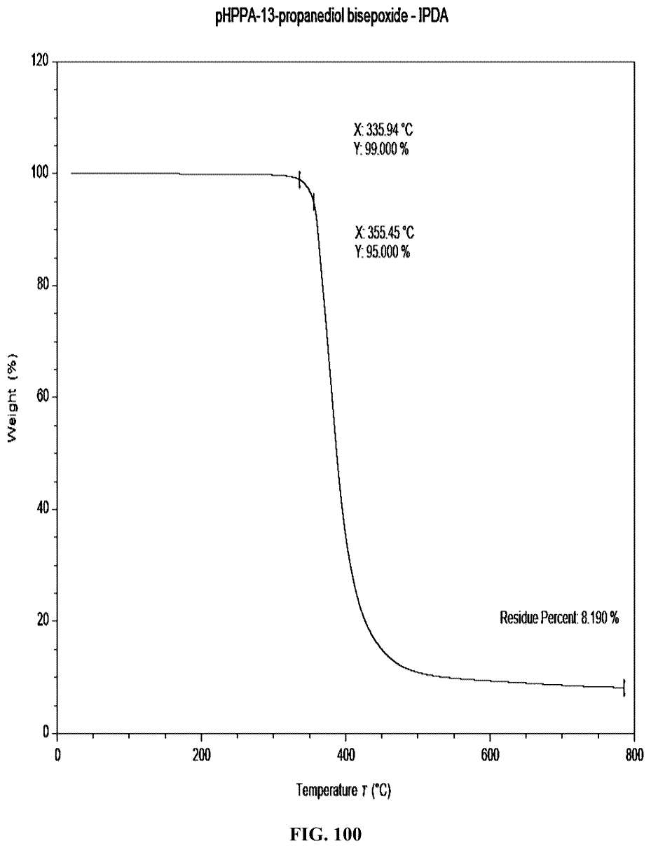

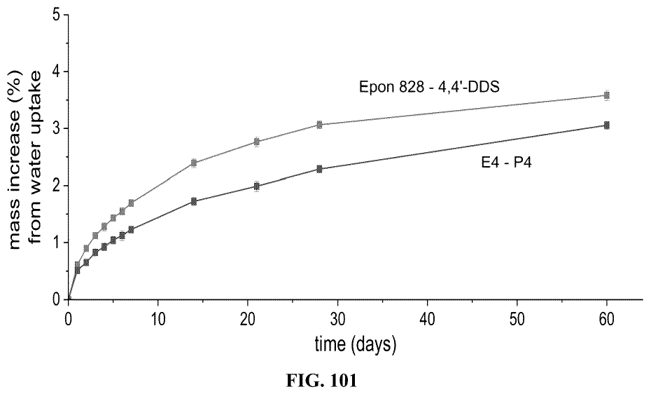

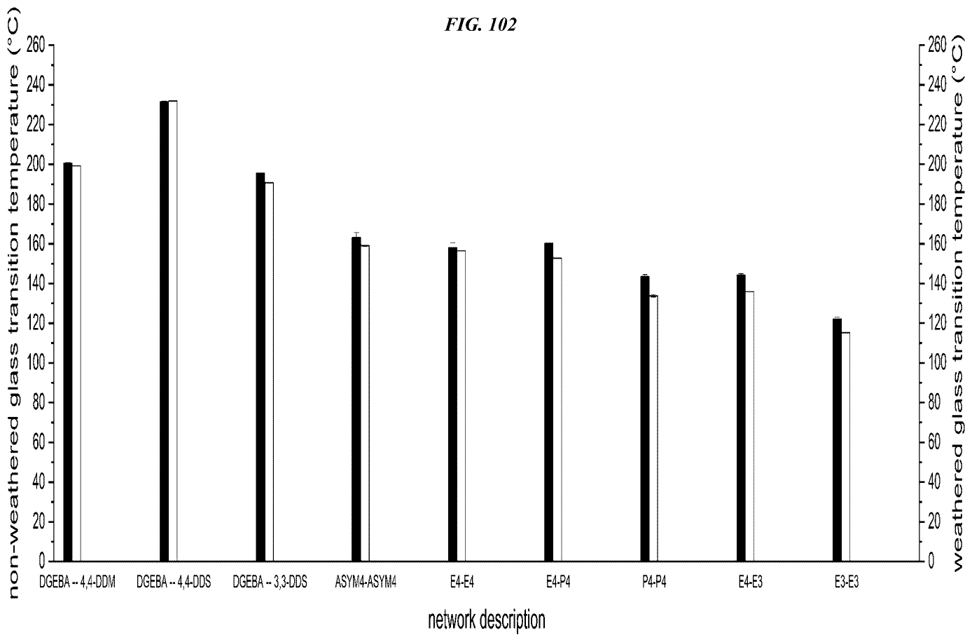

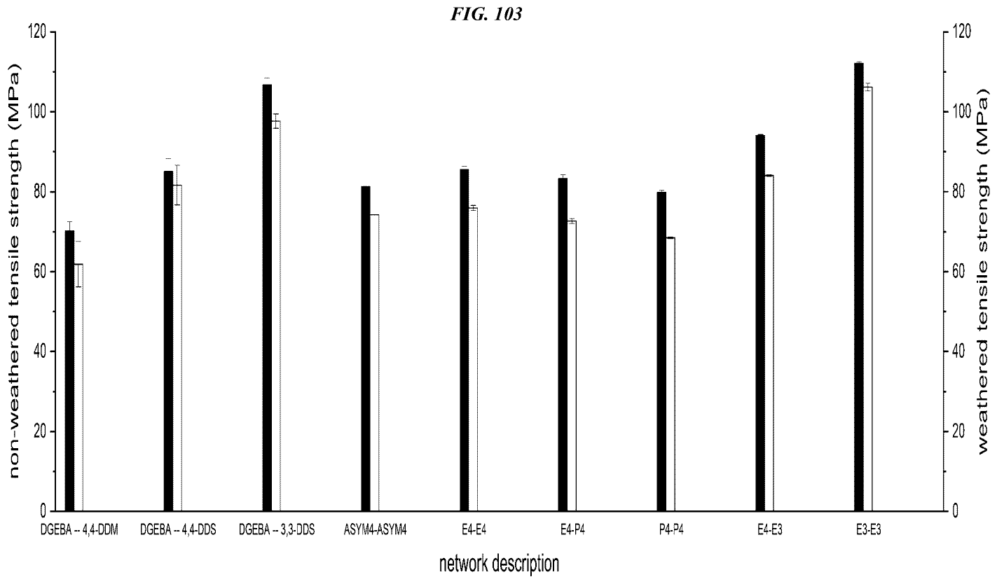

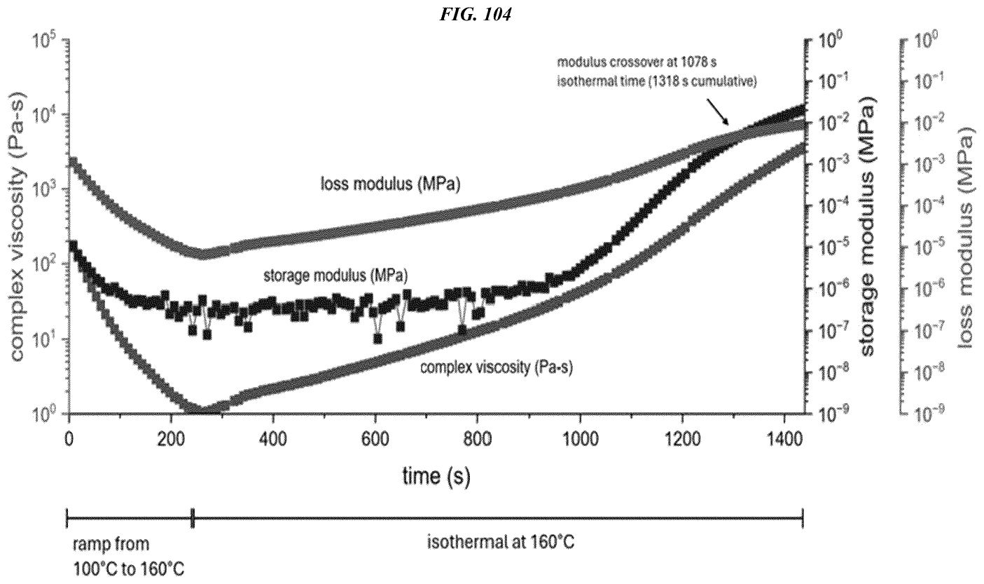

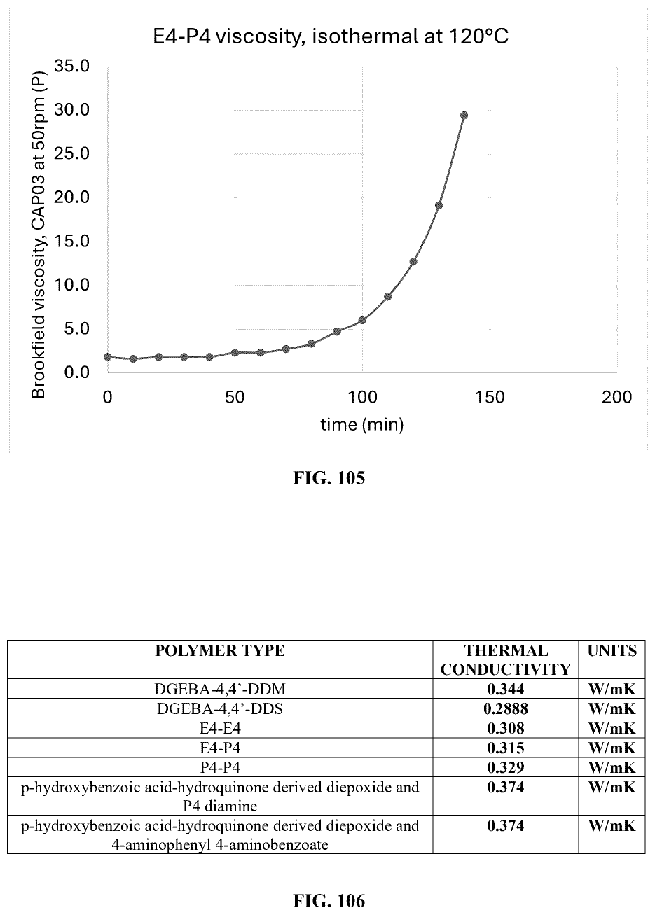

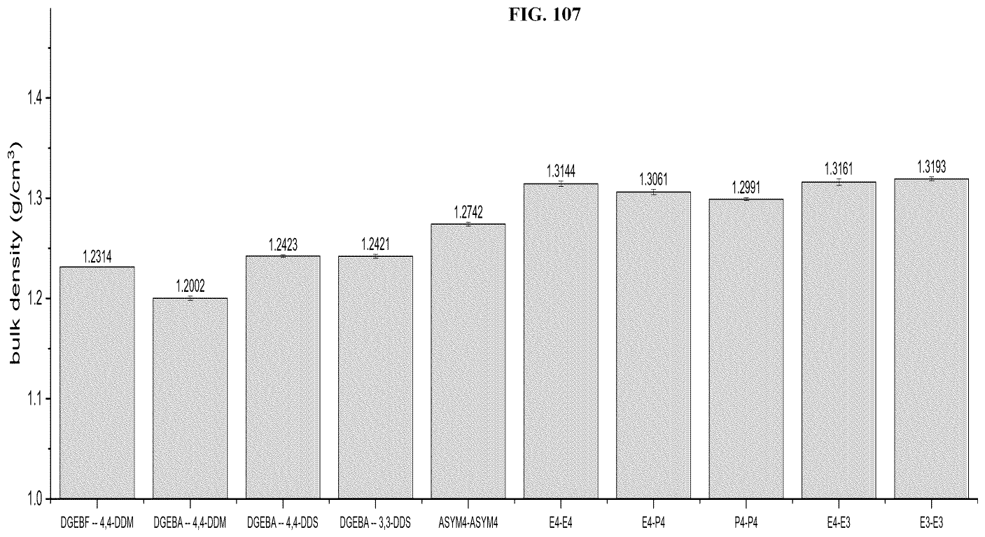

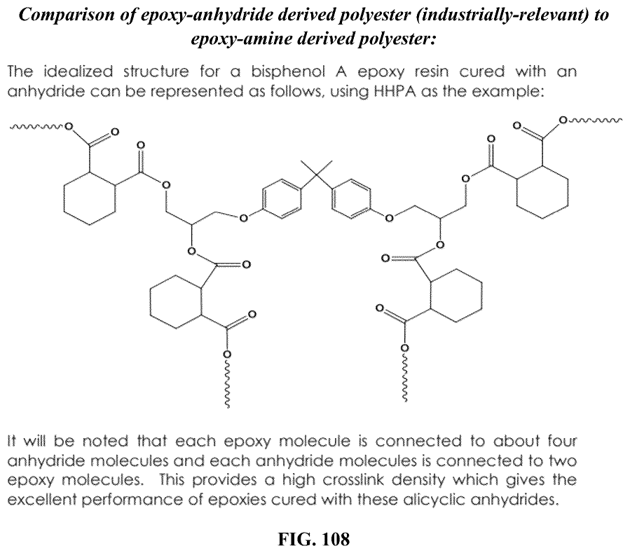

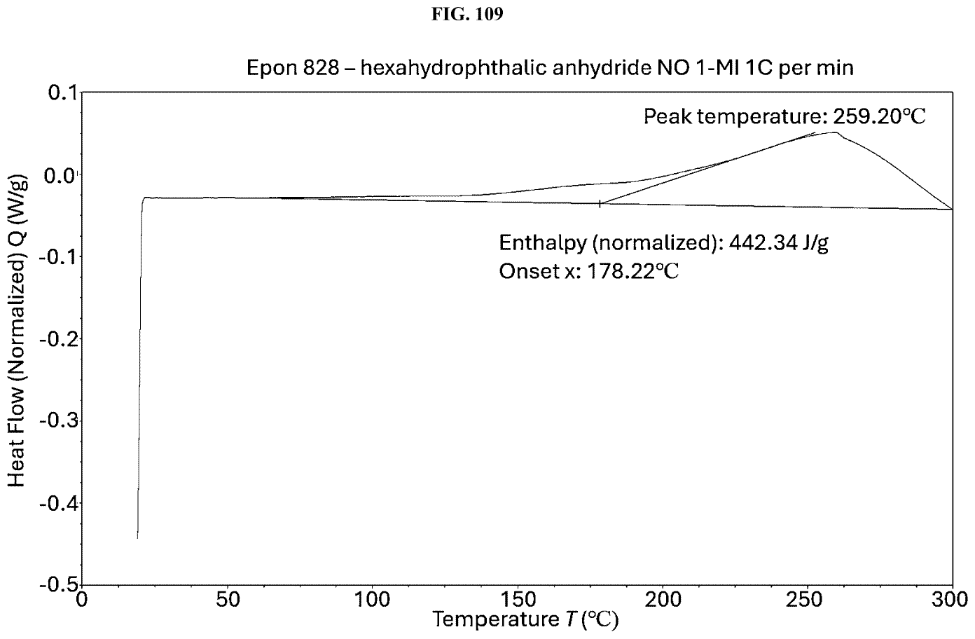

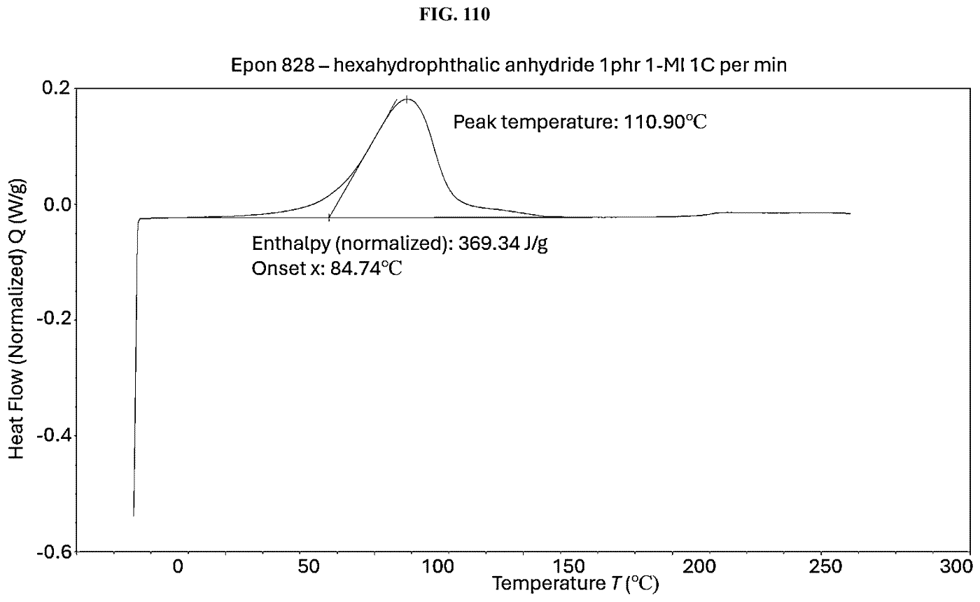

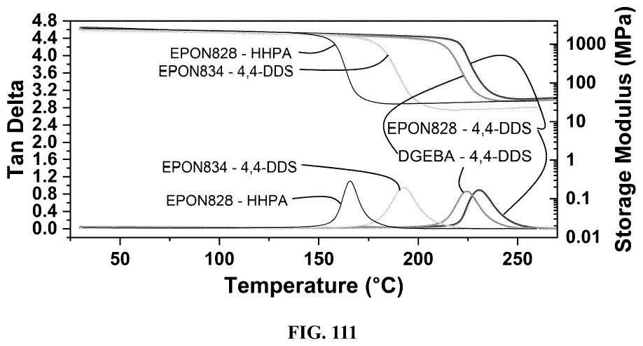

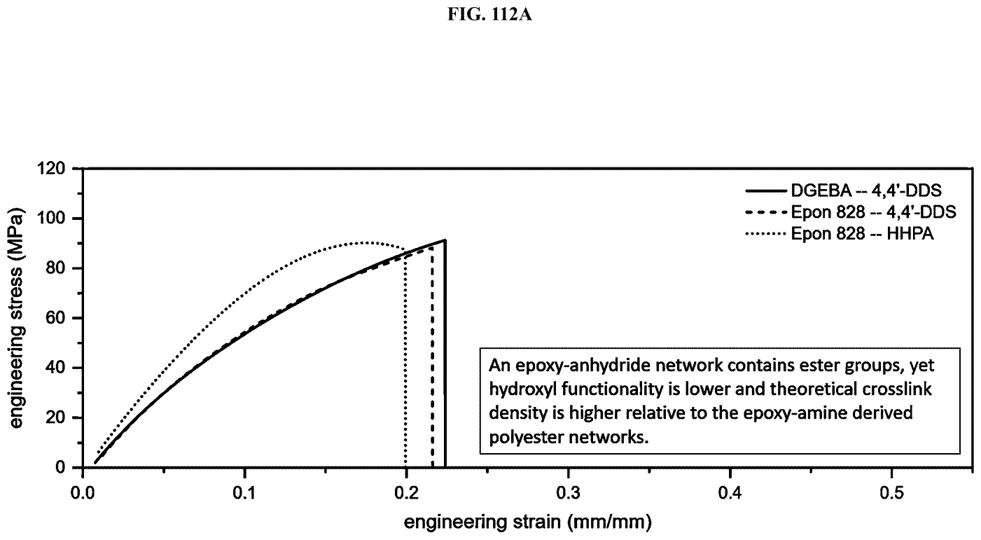

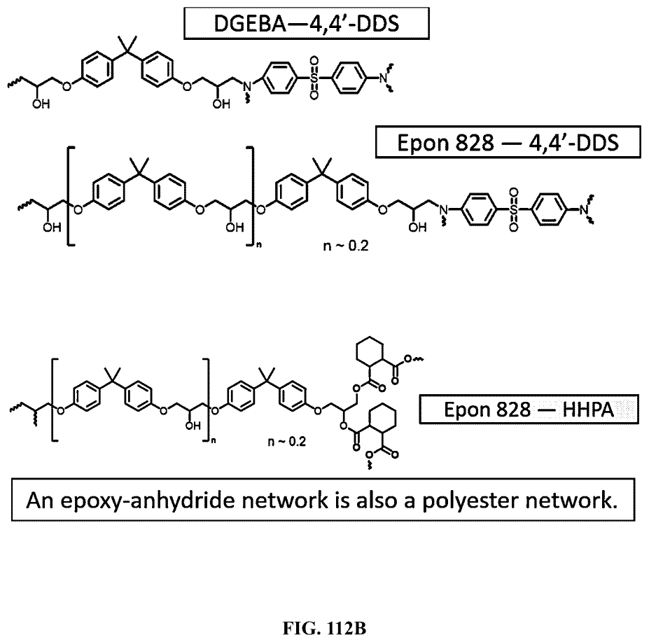

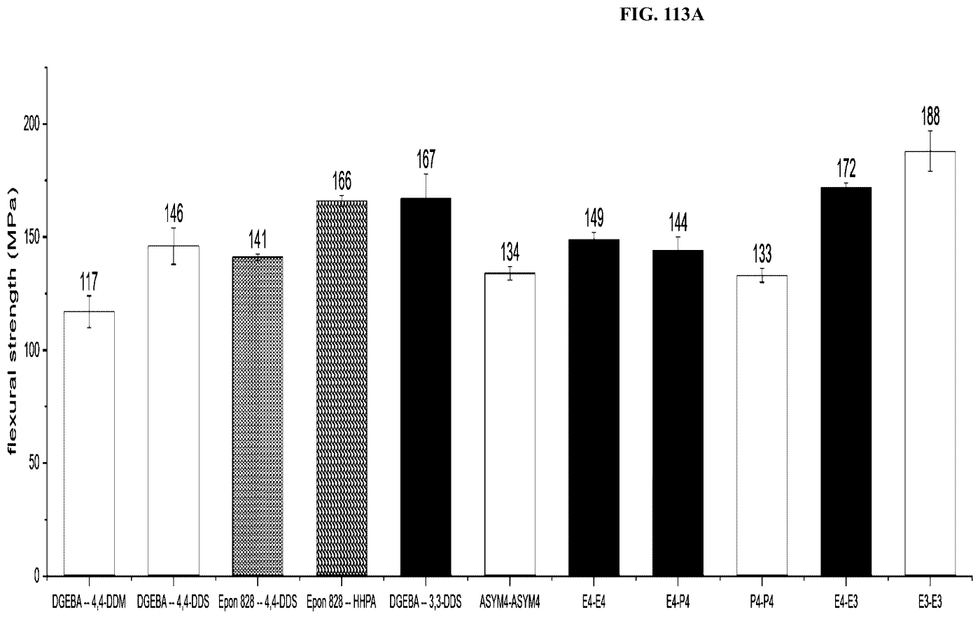

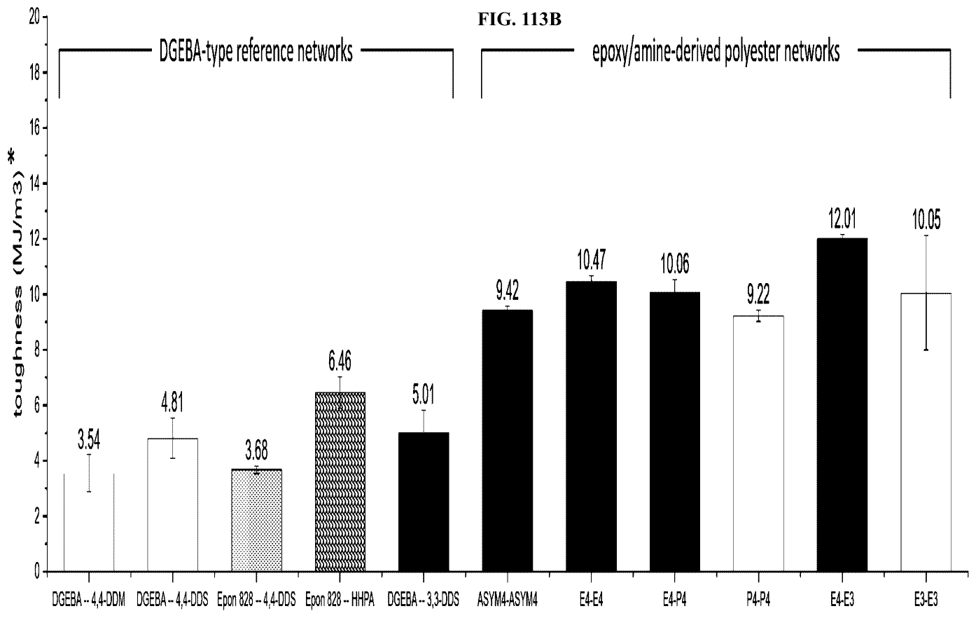

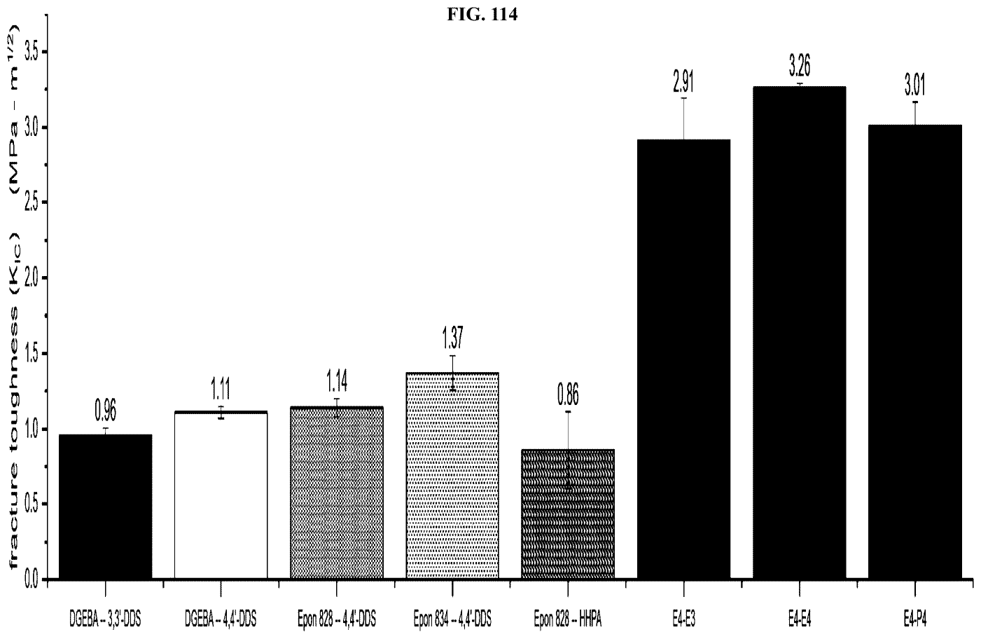

The reaction of the pHPAA-ethylene glycol diepoxide (23) and IPDA used the previously described standard 7-hour cure protocol and was monitored via near-infrared (NIR) spectrometry, and overlaid spectra are found in FIGS. 9 and 82. A peak near 4530 cm⁻¹, corresponding to the epoxide functionality, and peaks at about 4900 cm⁻¹ and 6500 cm¹, associated with primary amine and primary/secondary amine functionality, respectively, were observed to decrease continually with cure. This loss of absorption in those ranges indicates conversion to tertiary amine functionality. Concurrently, a peak at 7000 cm⁻¹, associated with hydroxyl functionality, was found to increase continually.

The bulk densities of the ester-containing networks were in the range of 1.184-1.234 g/mL, and density data for each network type may be found in Table 2. Density was observed to decrease in all cases as the aliphatic span from phenyl ring to ester group increased; this parallels the observed trend in monomer melting point. Networks derived from di-ester diepoxides exhibited higher densities than those derived from monoester diepoxides with equivalent phenyl to ester aliphatic spans. Among the di-ester series networks, density was found to decrease as the central aliphatic span (ester to ester span) increased.

Both the phenyl to ester and ester to ester spans contribute to the phenyl-to-phenyl span (i.e. overall bridge length). No clear relationship between network bridge length (and by extension crosslink density) and network thermal stability was observed. As bridge length increases, crosslink density and aromatic to aliphatic ratio reduce. The strengths of the primary bonds are the most important determinant of the heat resistance of a polymer structure, and aromatic ring systems possess the highest bond strength due to resonance stabilization. Although ester groups are potentially the weakest link in the networks, the 1% weight loss (d₁) temperatures for the ester-containing networks were in the range 313-337° C.—marginally lower than that of a non-ester containing DGEBA-IPDA reference network (d₁=340° C.).

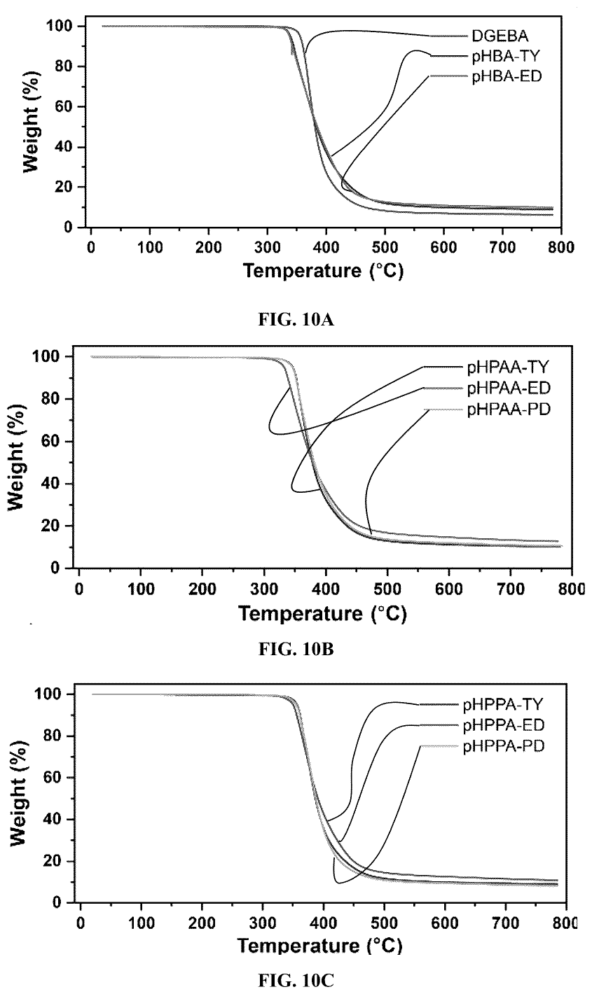

The thermal stabilities of the thermosets were evaluated using thermogravimetric analysis (TGA). The thermal degradation profiles (FIG. 10A-10C) indicated that the ester-bridged derivatives exhibited thermal stabilities comparable to those of the DGEBA-IPDA reference network. The T_{d5%} values are summarized in Table 2. For networks derived from mono-ester bridged monomers, T_{5%} values were lowest for those derived from para-hydroxybenzoic acid (monomer 18 at 348° C.), followed by para-hydroxyphenylacetic acid (monomer 19 at 352° C.), followed by para-hydroxyphenylpropanoic acid (monomer 20 at 357° C.). The same trend was observed for networks derived from diester-bridged derivatives, although no clear trend was evident with respect to the diol spacer.

Thermomechanical and network architectural information is also summarized in Table 2. Mechanical glass transition temperatures of the networks were strongly correlated with rubbery plateau moduli obtained via Dynamic Mechanical Analysis (DMA) (r=0.903). Rubbery plateau moduli were disproportionately high for the pHBA networks vs other ester-containing networks based on theoretical crosslink densities alone. Although the theoretical crosslink density of the pHPAA-tyrosol network was higher than that of the pHBA-ethylene glycol network, the glass transition temperature of the pHBA-ethylene glycol network was substantially higher at 151° C. vs 114° C. The higher structural rigidity from aromatic ester functionality compared to aliphatic was likely a potential additional contributor to the higher observed rubbery plateau moduli. The rubbery plateau modulus for the structurally rigid DGEBA-IPDA network (lowest overall bridge length and highest glass transition (174° C.) of any network evaluated) was disproportionally higher with respect to theoretical crosslink density. Although crosslink density is the principal determinant of rubbery plateau modulus, flexibility is a condition for the operation of rubber elasticity, and the hinderance toward oscillatory motion imposed by the high relative structural rigidity of the DGEBA network and aromatic ester networks could account for the disproportionality high rubbery plateau moduli observed.

TABLE 2
Table 2 shows the network thermal stability and thermomechanical properties.
Corresponding to FIGS. 10A-10C & 11A-11C. Amine monomer is IPDA in all cases.

| | d1/d5 | | tan δ | | |
|---|---|---|---|---|---|
| Network Epoxy | temp | mechanical | FWHH | rubbery plateau | bulk density |
| Component | (° C.) | Tg(° C.) | (° C.) | modulus (MPa) | (g-cm⁻³) |
| DGEBA | 340/356 | 173.7 ± 1.6 | 12.6 ± 1.1 | 27.7 ± 2.2 | 1.139 ± 0.001 |
| pHBA-TY(18) | 332/348 | 153.3 ± 2.9 | 11.4 ± 0.7 | 19.8 ± 1.0 | 1.201 ± 0.001 |
| pHBA-ED(21) | 325/337 | 150.5 ± 3.3 | 10.7 ± 0.7 | 19.5 ± 0.7 | 1.234 ± 0.000 |
| pHPAA-TY(19) | 330/352 | 114.4 ± 1.9 | 10.0 ± 1.2 | 14.0 ± 0.4 | 1.192 ± 0.002 |
| pHPAA-ED(23) | 313/341 | 96.0 ± 2.8 | 10.0 ± 1.0 | 12.2 ± 0.1 | 1.229 ± 0.000 |
| pHPAA-PD(24) | 327/347 | 90.2 ± 2.9 | 10.2 ± 1.5 | 12.9 ± 0.2 | 1.216 ± 0.001 |
| pHPPA-TY(20) | 337/357 | 108.2 ± 1.1 | 10.7 ± 1.3 | 13.5 ± 1.0 | 1.184 ± 0.002 |
| pHPPA-ED(25) | 328/350 | 88.2 ± 2.8 | 10.4 ± 1.6 | 11.9 ± 0.2 | 1.207 ± 0.000 |
| pHPPA-PD(26) | 336/355 | 79.7 ± 1.9 | 11.7 ± 1.9 | 11.4 ± 0.1 | 1.199 ± 0.001 |

The tan δ (E″/E′) and storage moduli (E′) curves obtained by dynamic mechanical analysis for the ester-containing networks are provided in FIG. 11A-11C and the data from the analysis is also summarized in Table 2. The mechanical glass transition temperatures (T_{g}) of the ester-containing networks were taken as the peaks of the tan δ curves. In general, networks derived from mono-ester-bridged diepoxides (18-20) exhibited higher Tg values (153.3 to 108.2° C.) compared to those derived from diester-bridged derivatives (21-26 at 150.5 to 79.7° C.). Among networks from monoester derivatives, the highest T_{g} was observed for 18 at 153.3° C., while among the diester derivatives 21 exhibited the highest T_{g} at 150.5° C. This result is consistent with the fact that both 18 and 21 feature rigid aromatic ester linkages that reduce chain mobility relative to aliphatic ester linkages. Other diester systems showed significantly lower values (96.0-79.7° C.). Additionally, increased alkyl spacer length in either the phenolic acid (e.g., 23 to 25) or the diol (e.g., 25 to 26) constituents of the epoxy derivatives resulted in a decrease in Tg consistent with decreased crosslink density and higher chain flexibility and mobility in the network. The wide range of observed T_{g} values demonstrates the potential to systematically tune network properties by modifying the structure of the ester-bridged epoxy derivatives, offering a design pathway to tailor thermomechanical properties for specific applications.

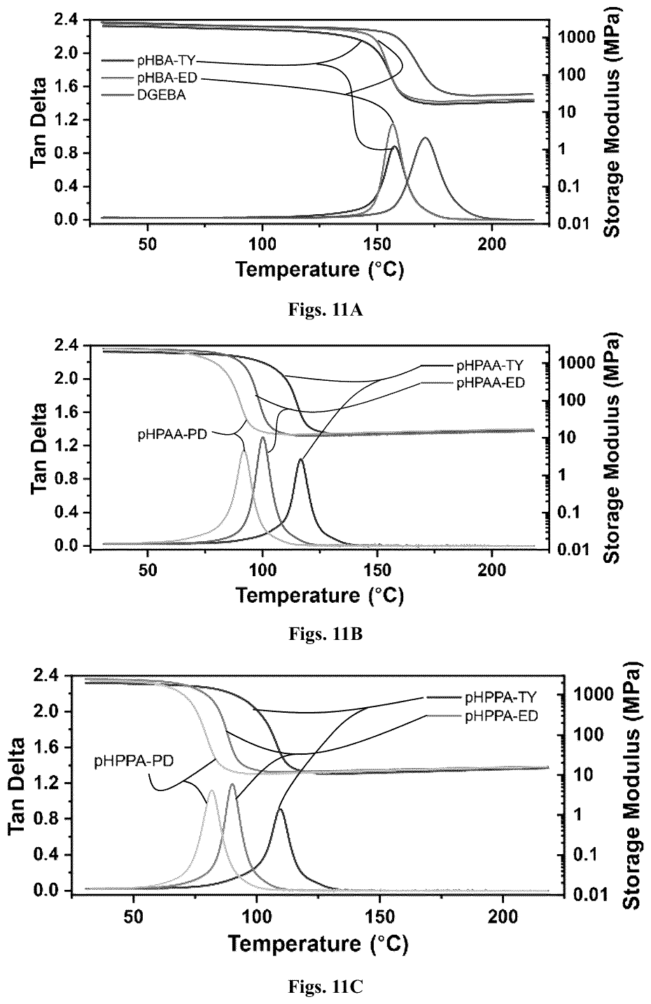

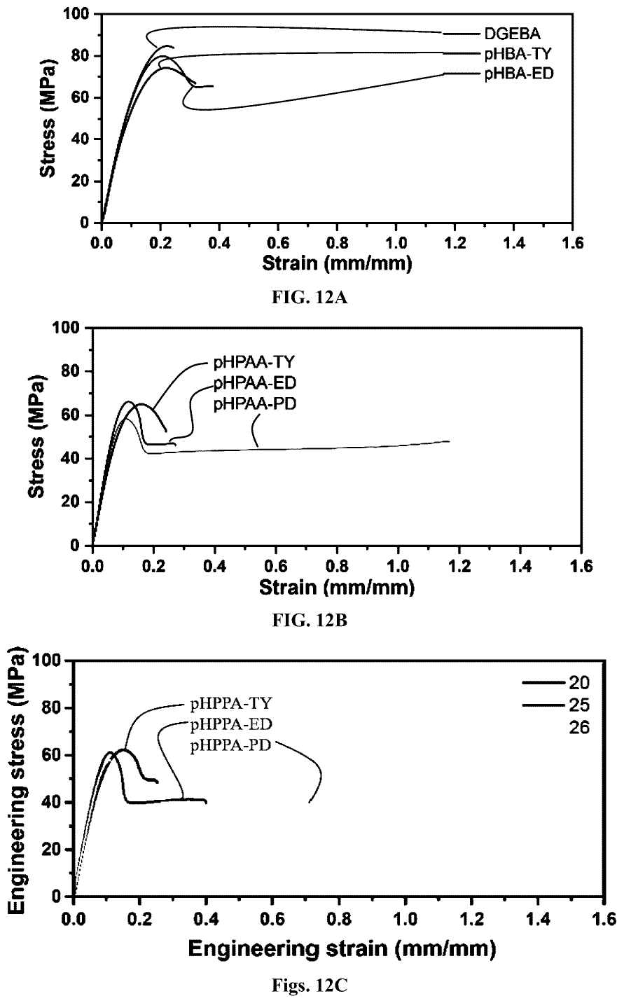

Mechanical glass transition temperatures were also highly correlated with tensile strengths (r=0.953). Representative stress-strain curves for the ester-bridged epoxy-amine thermosets are shown in FIGS. 12A-12C & 13A-13C, with the corresponding mechanical data summarized in Table 3. Tensile strengths for the ester-containing networks ranged from 54 to 81 MPa compared to 87 MPa for the DGEBA reference network. All ester-containing networks displayed some level of ductile behavior. The aromatic ester networks exhibited strains at yield comparable to the DGEBA network (approximately 0.20 mm/mm). In contrast, the aliphatic monoester networks showed lower strains at yield (around 0.15 mm/mm and the aliphatic diester networks showed the lowest strains at yield (approximately 0.10 mm/mm). In general, yield strains decreased with increasing bridge length, while ultimate strains increased. Networks including building blocks with the longest bridges (e.g., 24-26) exhibited pronounced necking behavior, with ultimate strains exceeding 0.7 mm/mm on average.

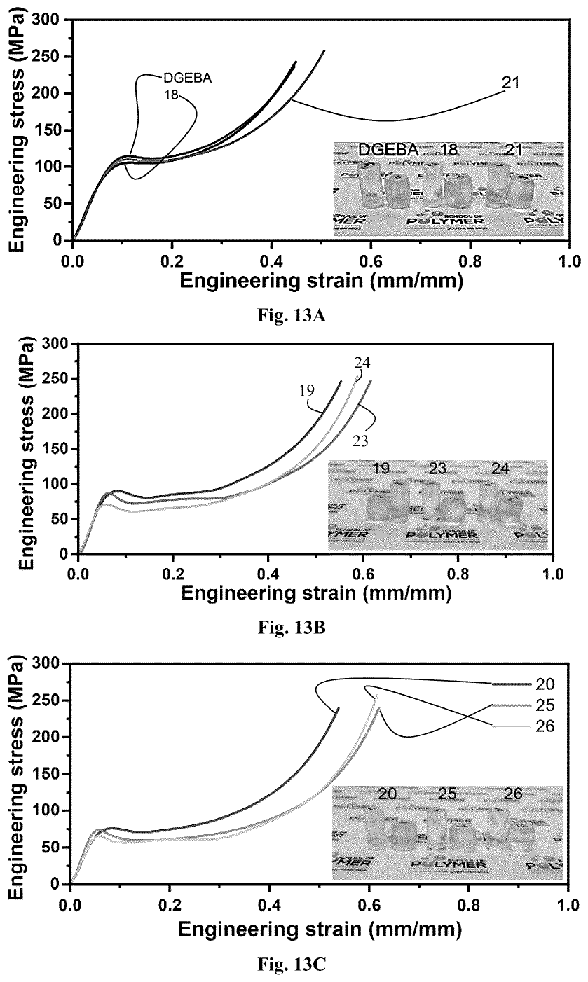

Structure-compressive property relationships generally paralleled structure-tensile property relationships, as shown in FIGS. 13A-13C. Across all networks, compressive yield stresses for each network were 1.21 to 1.39× that of tensile yield stresses. Aromatic ester networks exhibited compressive yield stresses slightly lower than the DGEBA reference (105 MPa for monomer 18 and 109 MPa for monomer 21, compared to 116 MPa for DGEBA) and comparable strains at yield (0.112 mm/mm for monomer 18 and 0.113 mm/mm for monomer 21, compared to 0.108 mm/mm for DGEBA). Networks derived from aliphatic ester monomers exhibited lower yield stresses and lower strains at yield—and yield values decreased as either the phenolic acid to ester spacer or the ester-to-ester spacer increased. Networks derived from aliphatic diester monomers fractured less than aromatic ester/monoester bridge monomers; only 2 fractures (out of 24 possible) occurred under 10 kN for any of the aliphatic, dual ester bridge networks.

TABLE 3
Table 3. Network tensile properties data.

| network epoxy | average tensile | average strain at | average strain at |
|---|---|---|---|
| component | strength (MPa) | yield (mm/mm) | break (mm/mm) |
| DGEBA | 86.6 ± 1.8 | 0.209 ± 0.007 | 0.231 ± 0.012 |
| pHBA-TY | 75.7 ± 0.4 | 0.221 ± 0.001 | 0.301 ± 0.018 |
| pHBA-ED | 81.2 ± 1.2 | 0.206 ± 0.002 | 0.391 ± 0.014 |
| pHPAA-TY | 68.5 ± 0.3 | 0.155 ± 0.001 | 0.282 ± 0.013 |
| pHPAA-ED | 68.0 ± 0.5 | 0.118 ± 0.001 | 0.491 ± 0.141 |
| pHPAA-PD | 56.6 ± 1.6 | 0.107 ± 0.003 | 0.822 ± 0.101 |
| pHPPA-TY | 63.7 ± 0.2 | 0.147 ± 0.001 | 0.344 ± 0.040 |
| pHPPA-ED | 61.0 ± 0.6 | 0.109 ± 0.001 | 0.752 ± 0.127 |
| pHPPA-PD | 54.3 ± 1.2 | 0.102 ± 0.004 | 1.098 ± 0.100 |

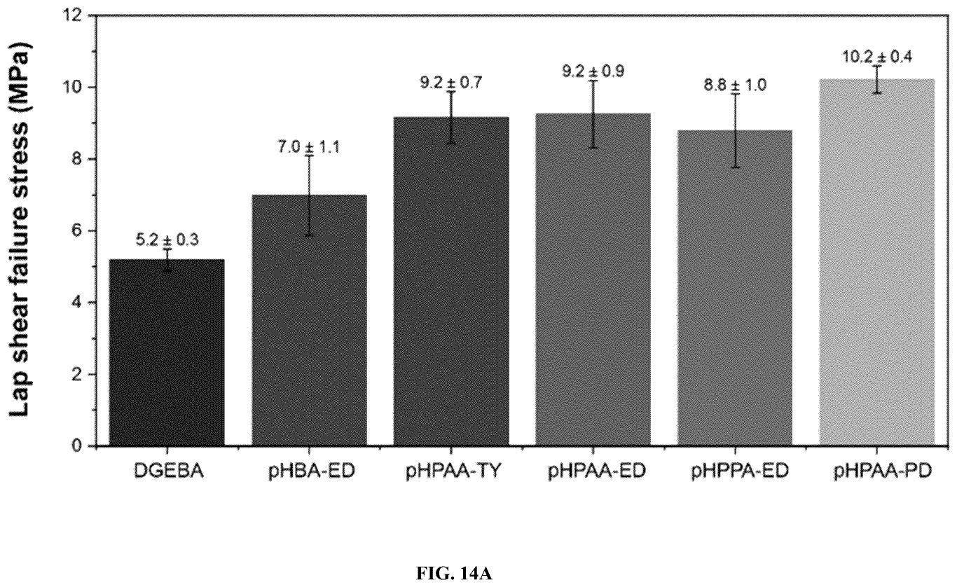

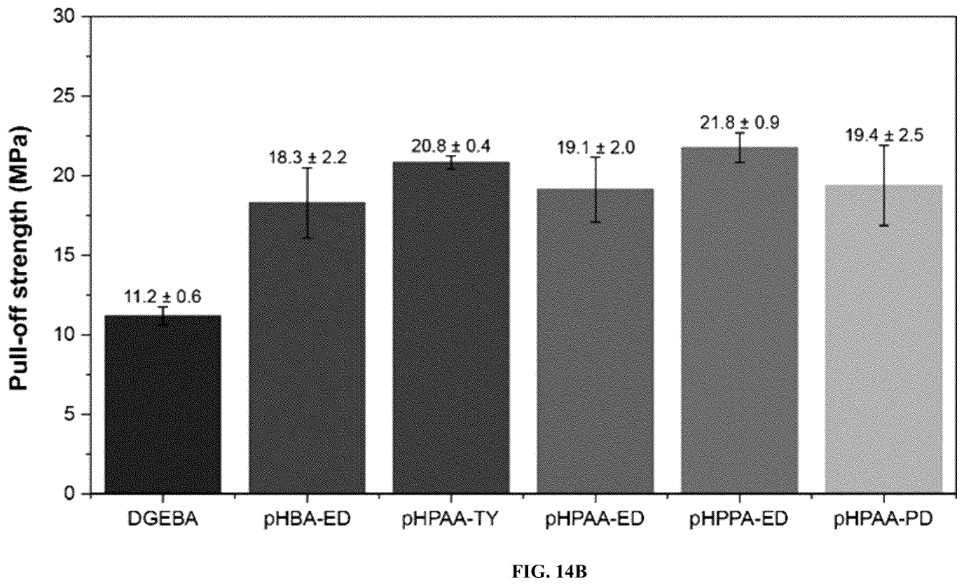

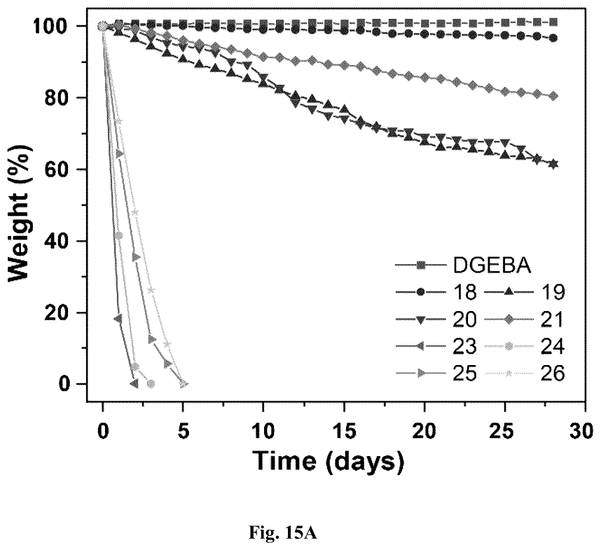

Epoxy systems are widely employed in adhesive applications, where performance of the adhesive material is derived from the contributions of interfacial and cohesive forces. The adhesive properties of epoxy-containing materials are impacted by the ability of hydroxyl groups to form during ring-opening of epoxide motifs to form hydrogen bonds with substrates—in particular those with high surface energy—and by the cohesive strength of the crosslinked network, which is influenced by factors such as molecular weight between cross-links, structural rigidity, etc. Hydroxyl concentration is higher for the DGEBA-IPDA network than any of the ester-containing networks (as epoxy equivalent weight (EEW) for DGEBA is lower than any of the ester-containing monomers). Less is understood about the influence of polar ester functionality on adhesive properties. An unformulated DGEBA-IPDA system (i.e., without fillers or modifiers) was compared against five of the ester-bridged epoxy-amine systems of the present invention using single-lap shear and pull-off adhesion tests. The results from lap shear tests are shown in FIG. 14A. Although higher lap shear strengths were observed for all ester-containing networks compared to the DGEBA network, lap shear strength did not appear to scale with the ester concentration of the network. The ester concentration was highest for the pHBA-ethylene glycol network, yet that network failed at lower stress than any of the ester-containing networks evaluated. The failure stress of the monoester bridged pHPAA-tyrosol network was comparable to the non-aromatic diester networks.

Failure stress in single lap shear appeared to correlate to network flexibility more than hydroxyl or functional group concentrations. The addition of spacer units and the resultant increase in plastic deformability has been connected to augmentation of adhesive properties in epoxy systems, and a higher level of deformability was observed in tensile and compressive tests for the ester-containing networks that scaled with the bridge length.

Although higher theoretical crosslink density and glass transition temperatures are in general associated with higher cohesion and shear strength, the DGEBA network and aromatic ester network derived from monomer 21 (pHBA-ED) networks (the most rigid networks and highest theoretical crosslink density networks evaluated for lap shear) failed at the lowest stresses. Although combination adhesive/cohesive failure was observed for all of the networks, nearly complete adhesive failure on one side of the lap joint was most common for the DGEBA network. The Brookfield viscosity of the pHBA-ED monomer at adhesive application temperature was the highest for any network evaluated (Brookfield viscosity appeared correlated to ester concentration and in particular aromatic ester concentration), and it is possible that the high relative viscosity contributed to poorer wetting out of lap shear panels, though inspection of post-tested panels did not indicate any lack of wetting.

To further investigate adhesive properties, adhesion pull-off was performed according to ASTM D4541 on the same networks as for lap shear. The pull-off strength data is shown in FIG. 14B. In this test, the tensile force direction is normal to that of the substrate/bond line. The overall trend in pull-off strength was comparable to that observed in lap shear. The DGEBA network failed at the lowest stress, the aromatic ester network derived from monomer 21 failed at a lower stress than the less rigid networks derived from aliphatic monoester-bridged monomer 19 and networks derived from diester bridged monomers 23-25. Among relatively flexible aliphatic ester networks, there was no clear trend in pull-off strength.

TABLE 4
Table 4 shows network compressive properties data..

| diepoxide | yield stress | strain at yield | # fractured specimens |
|---|---|---|---|
| component | (MPa) | (mm/mm) | under 10 kN load |
| DGEBA | 116 ± 2 | 0.108 ± 0.001 | 2 of 3 |
| pHBA-TY | 105 ± 1 | 0.112 ± 0.002 | 3 of 3 |
| pHBA-ED | 109 ± 2 | 0.113 ± 0.001 | 1 of 3 |
| pHPAA-TY | 88.3 ± 1.6 | 0.079 ± 0.002 | 1 of 3 |
| pHPAA-ED | 88.4 ± 0.8 | 0.064 ± 0.001 | 0 of 3 |
| pHPAA-PD | 70.3 ± 0.7 | 0.061 ± 0.001 | 0 of 3 |
| pHPPA-TY | 78.5 ± 1.2 | 0.085 ± 0.001 | 0 of 3 |
| pHPPA-ED | 73.6 ± 0.1 | 0.059 ± 0.001 | 1 of 3 |
| pHPPA-PD | 66.1 ± 0.4 | 0.056 ± 0.001 | 0 of 3 |

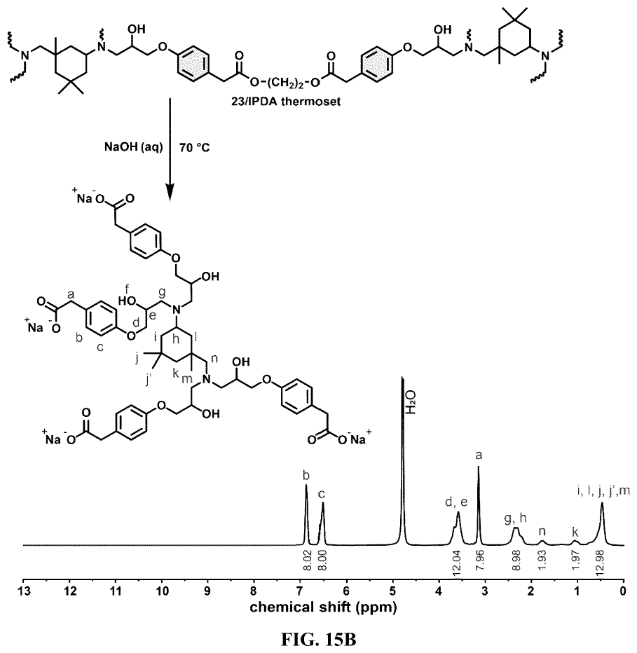

The integration of ester linkages into epoxy-amine thermosets enables hydrolysis—as illustrated in FIG. 15B—as a potential end-of-use processing strategy. The influence of structural variation in the ester-bridged building blocks on the hydrolytic degradability of the thermosets was evaluated via mass-loss experiments conducted under basic conditions. Thermoset discs of each ester-bridged network were immersed in 20% sodium hydroxide in water at about 70° C. and the change in mass was monitored over time. All thermoset samples exhibited surface-controlled erosion behavior. The results of these mass-loss experiments for a 28-day time frame are shown in FIG. 15A. No mass loss was observed for the non-ester containing DGEBA/IPDA reference network over the 28-day test period. Although weight loss was observed for all of the ester-containing networks, those derived from the monoester series and aromatic ester series of epoxy monomers were relatively slow to degrade.

For example, thermosets constructed from the aromatic monoester monomer 18 exhibited less than 4% mass loss within 28 days, whereas those derived from the aromatic diester monomer 21 exhibited less than 20% mass loss. These observations reflect the inherent stability of the aromatic ester linkages found in monomers 18 and 21 and highlight the influence of ester concentration (one vs two esters in the bridge). Thermosets derived from epoxy monomers bridged by a single aliphatic ester (such as monomers 19 and monomers 20) approached 40% mass loss within 28 days, reflecting the greater hydrolytic susceptibility of the aliphatic ester linkages compared to aromatic monoester linkages A marked increase in the degradation rates was observed for thermosets derived from aliphatic diester monomers 23 through 26. As indicated in FIG. 15A, these thermosets fully degraded within 5 days, with the thermoset constructed from monomer 23—the aliphatic diester system with highest per unit concentration of aliphatic ester functionality—reaching 100% mass loss (complete dissolution of disc in hydrolysis solution) in 48 h. To garner additional insight into the hydrolytic degradation of these thermosets, the degradation byproducts from the 23/IPDA network were hydrolyzed for an extended time period. Upon neutralization of the degradation solution with HCl, a white precipitant was collected via filtration and analyzed by NMR in 10% NaOD in D₂O. The ¹H NMR spectrum in FIG. 15B suggests that the recovered precipitant was a tetra-functional carboxylic acid comprising an IPDA core. Peak assignments and integrations in the spectrum correspond to the expected structure, consistent with high conversion of the epoxy-amine reaction forming the thermoset and near-quantitative hydrolysis of the ester linkages.

Polyester Thermosets from Ester-Containing Diepoxide and Ester-Containing Diamine Components

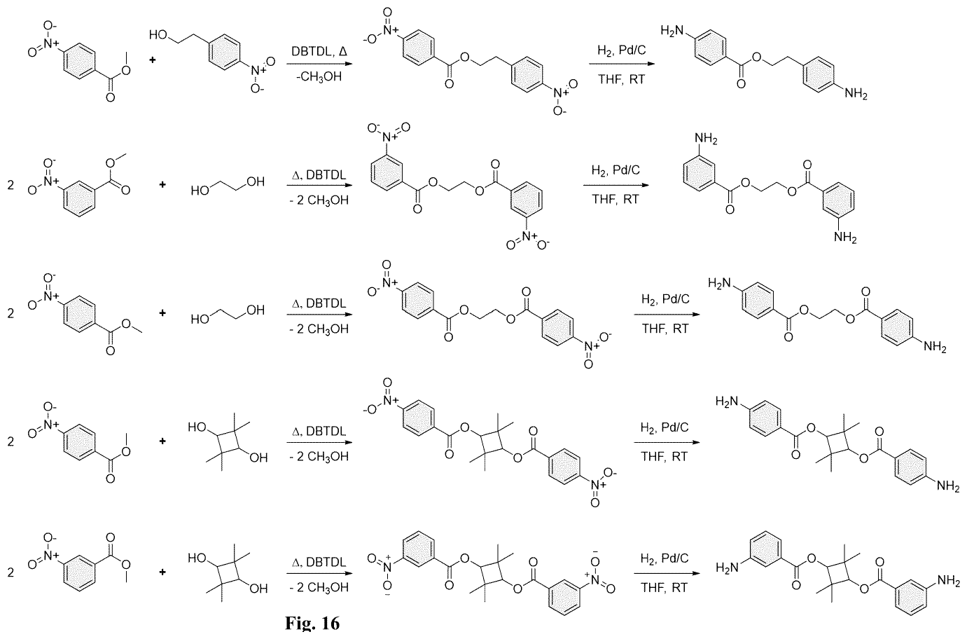

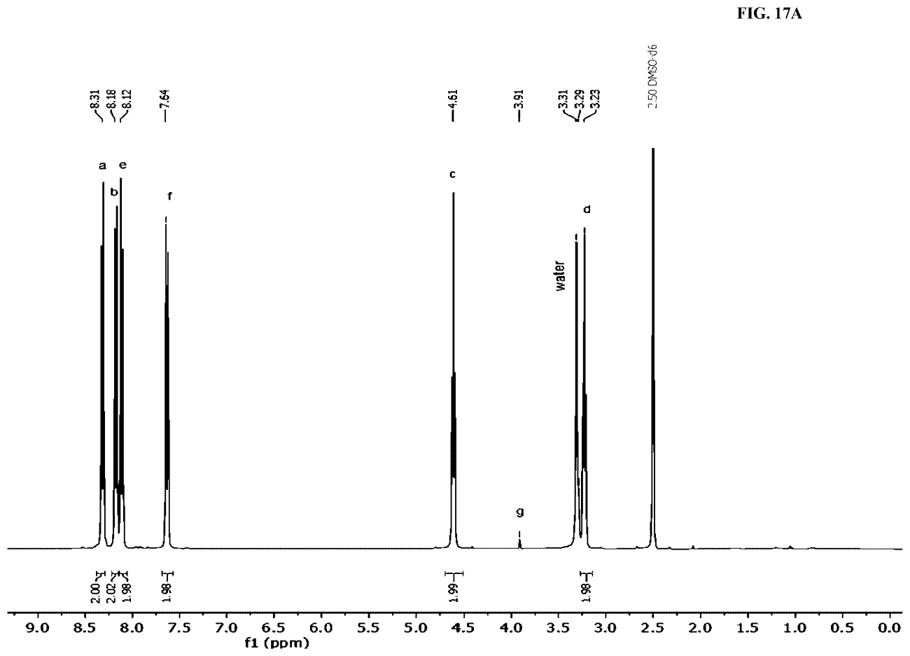

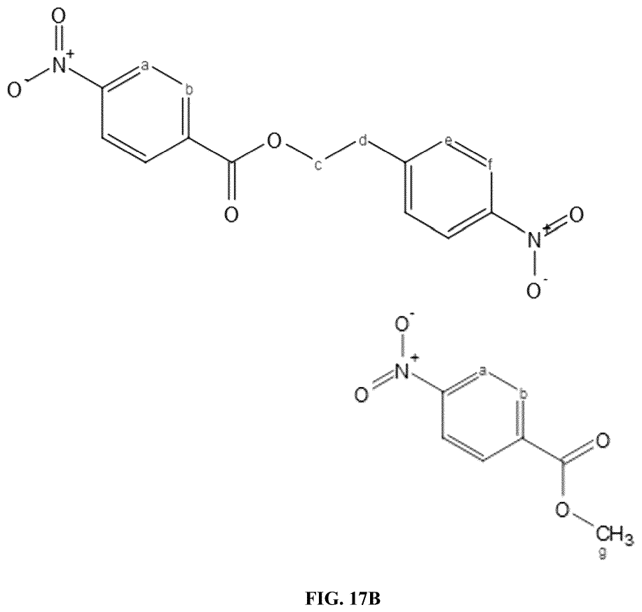

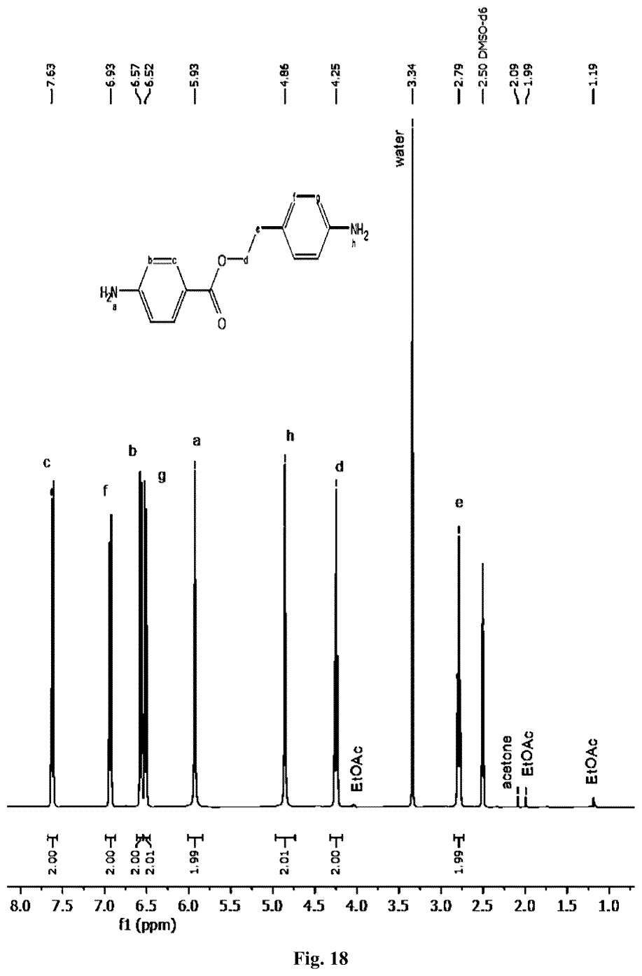

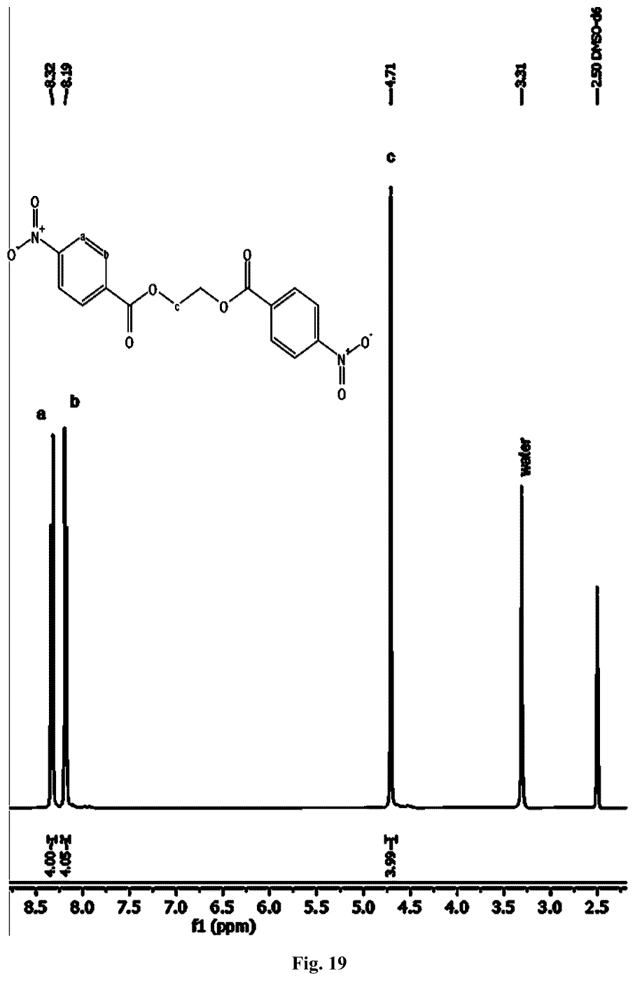

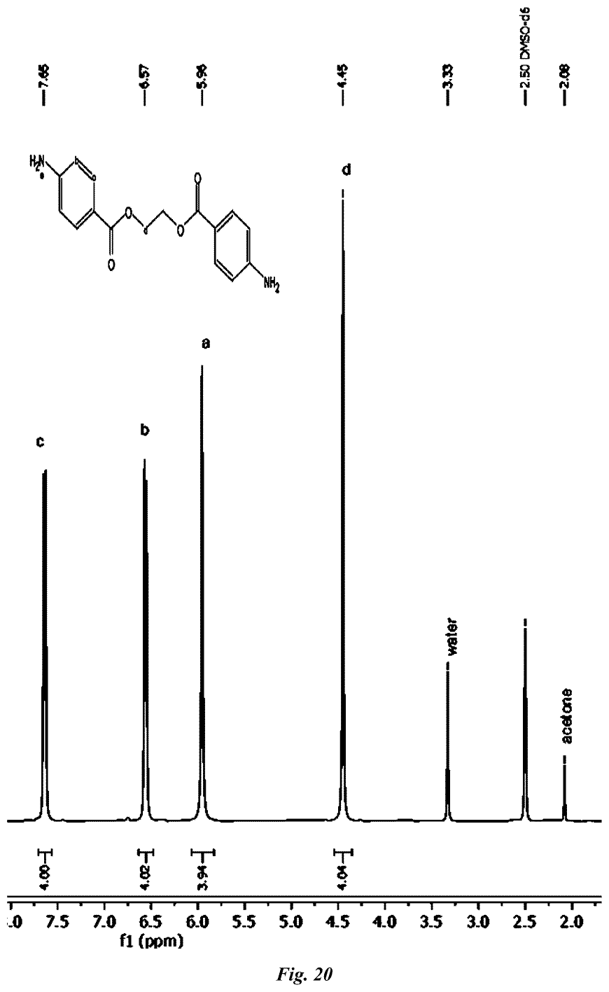

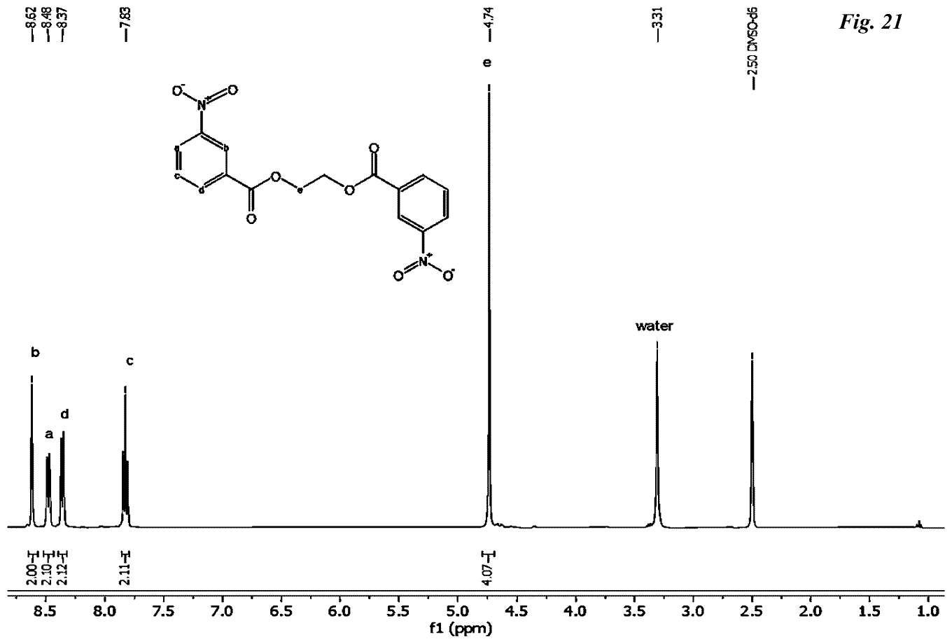

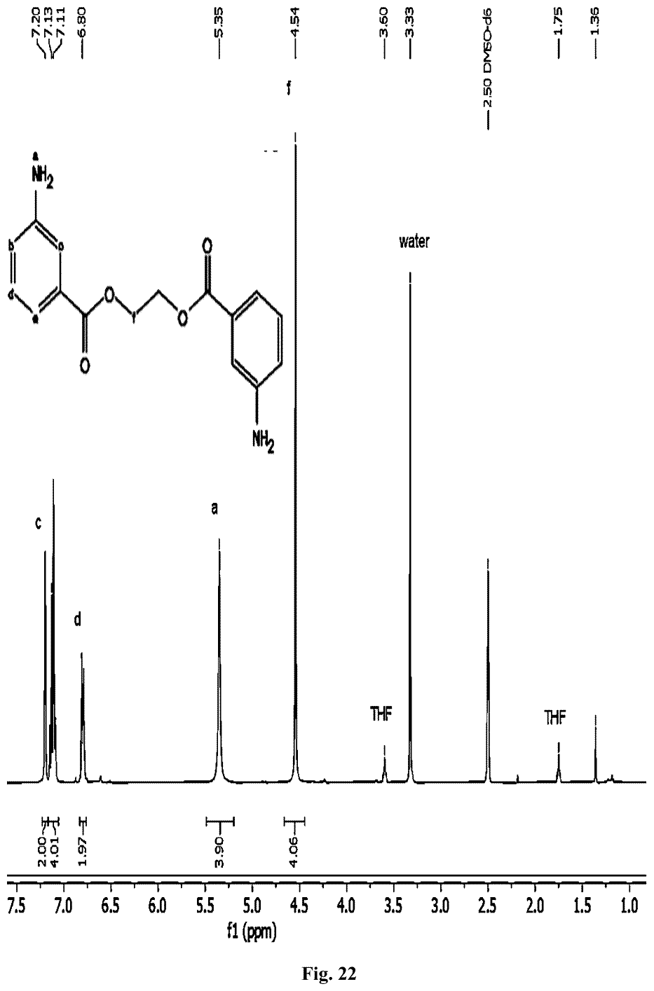

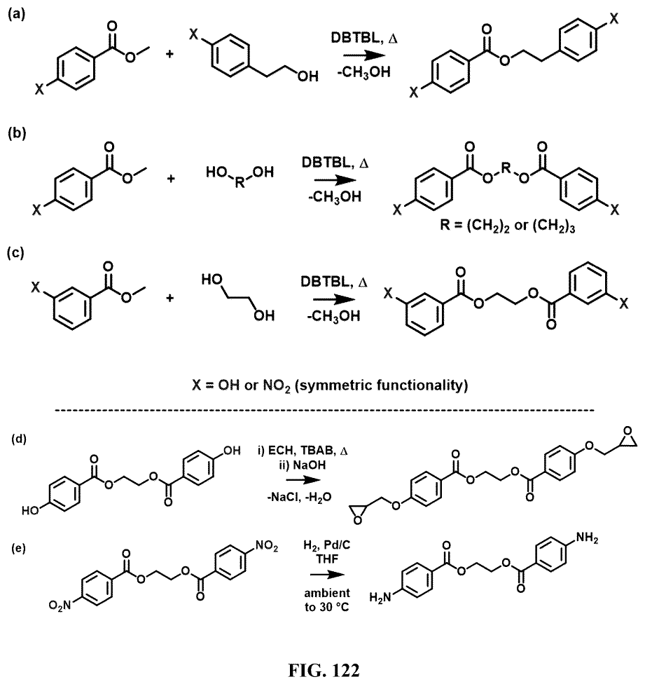

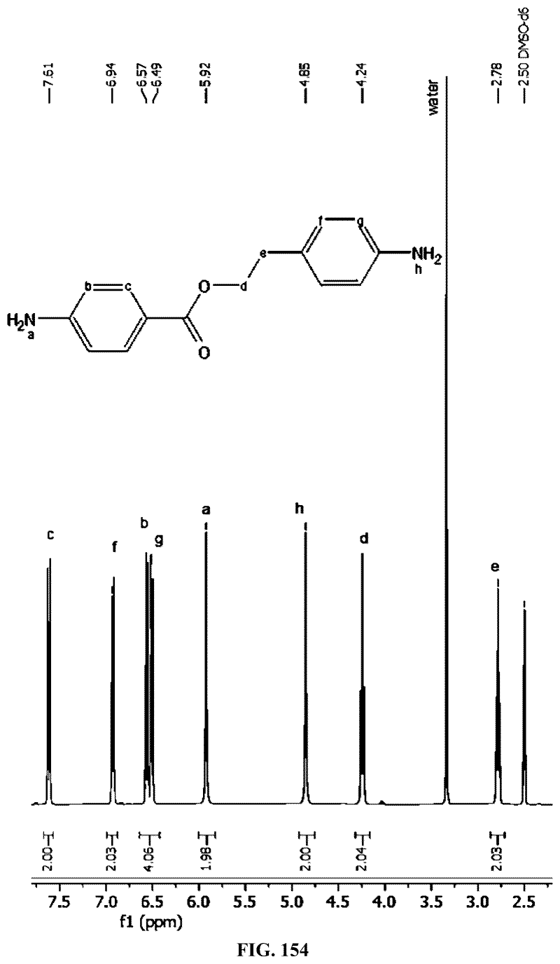

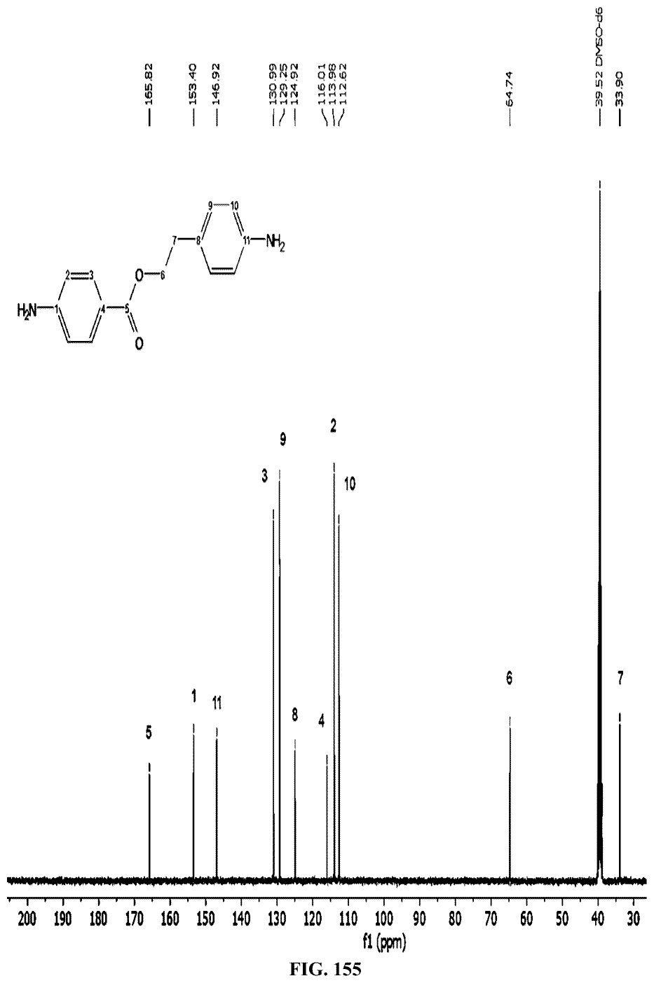

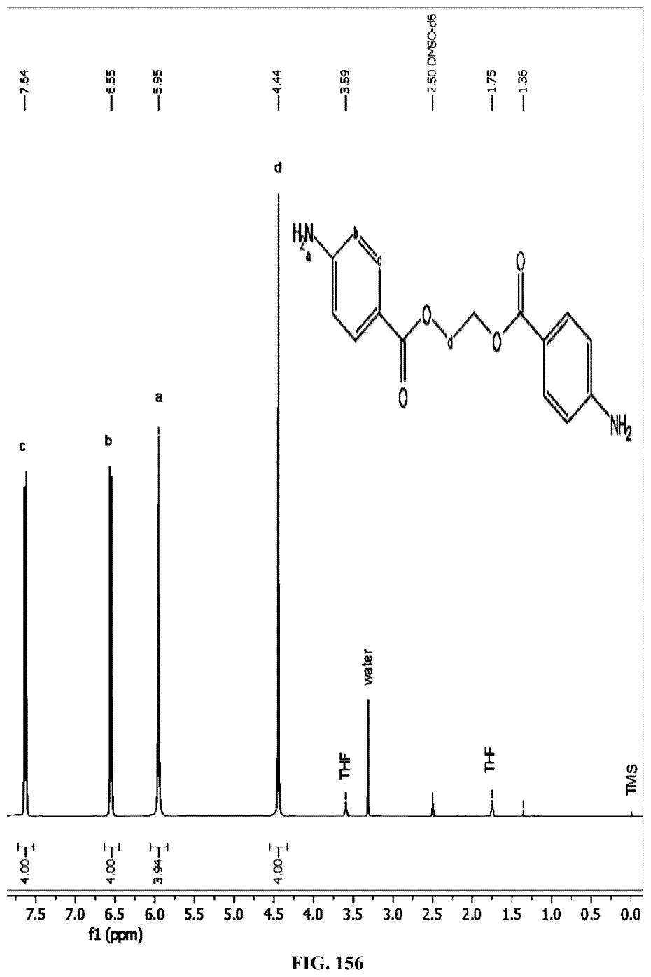

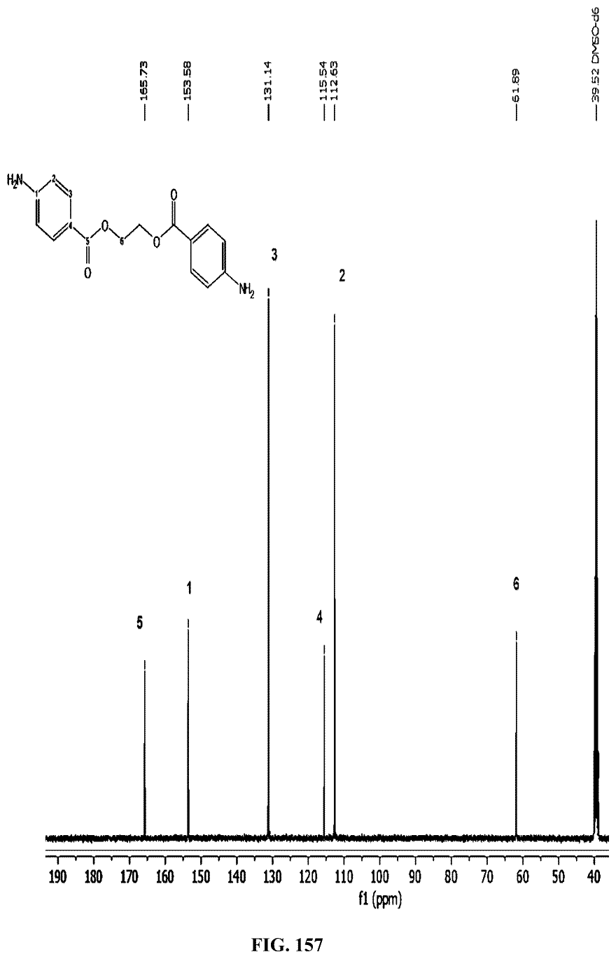

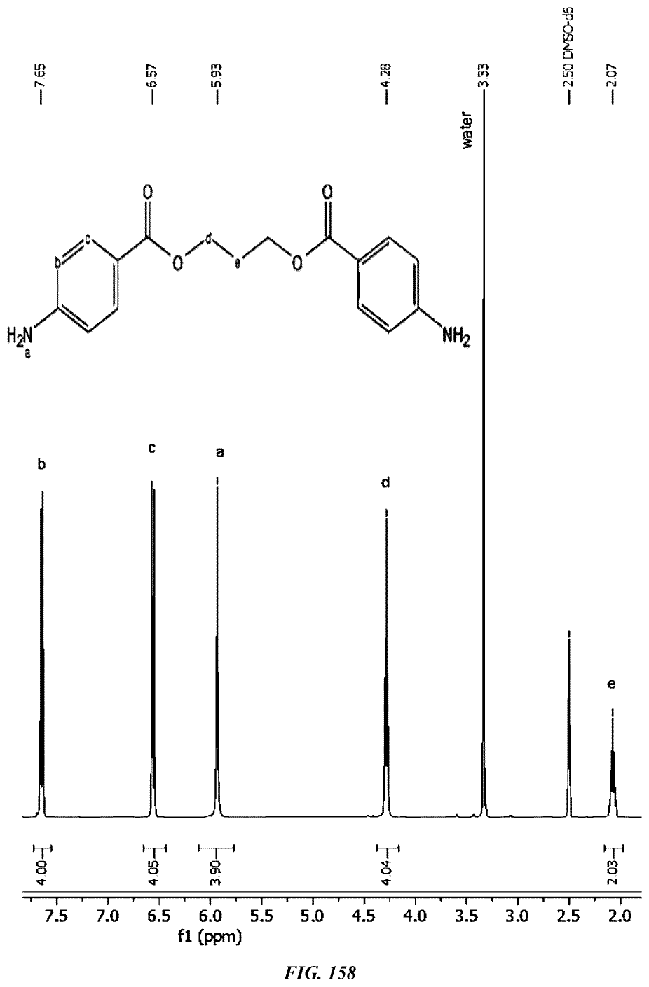

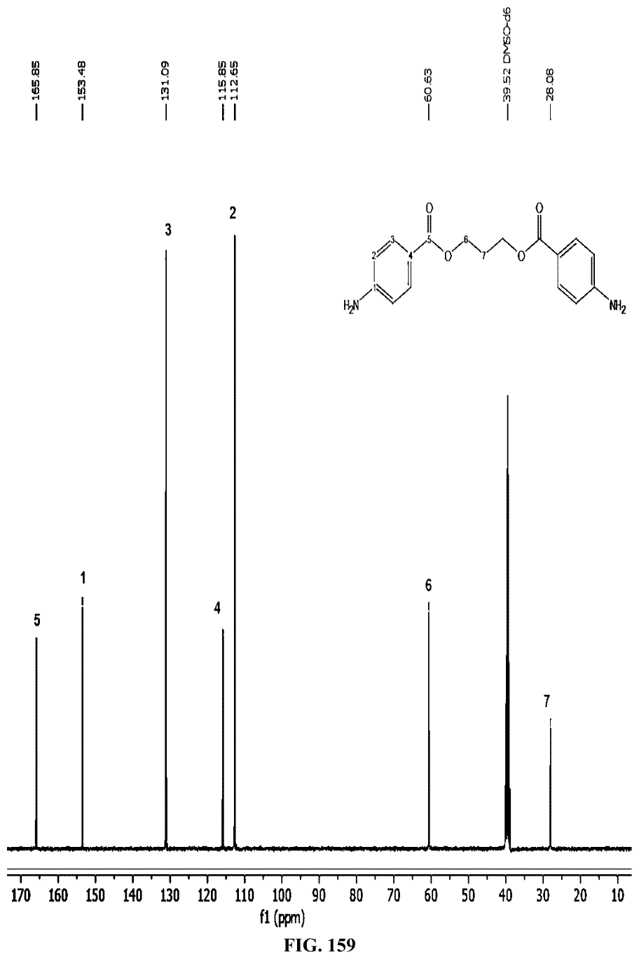

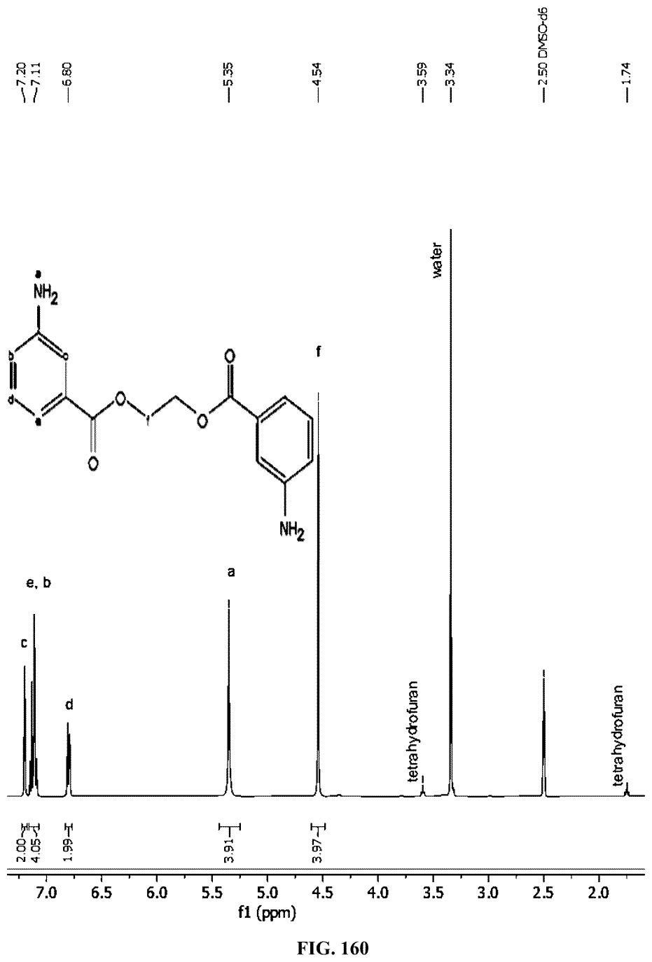

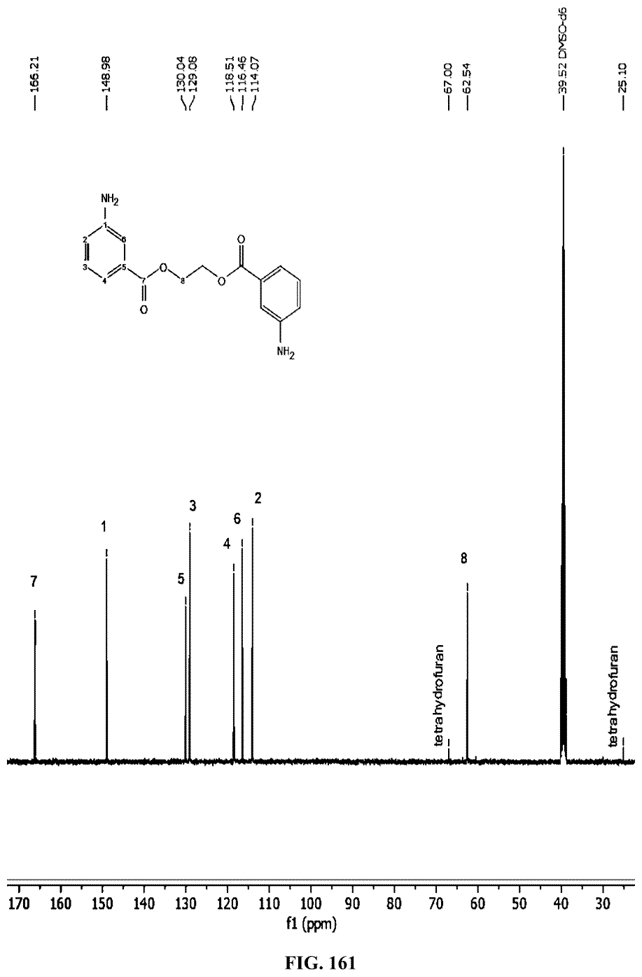

To enable the synthesis of several structurally-related aromatic ester diepoxide and diamine monomers, asymmetric monoester and symmetric diester bisphenol and diarylnitro precursors were prepared via transesterification. Asymmetric diaryl precursors bridged by a single ester were synthesized from either 4-(2-hydroxyethyl)phenol (tyrosol) or 4-nitrophenethyl alcohol using a near-stoichiometric ratio of para-substituted methyl benzoate in a single-stage reaction. In contrast, syntheses of symmetric diaryl precursors bridged by two esters generally followed a two-stage transesterification approach. In an initial stage, a 4:1 molar excess of alcohol to benzoate functionality was used to preferentially generate a monocondensation adduct. In the second stage, free diol was removed under reduced pressure, and additional diol was reactively distilled during conversion of the monocondensation adduct to the dicondensation adduct. In all cases, compounds were isolated via solvent rinses to remove the dibutyltin dilaurate (DBTDL) transesterification catalyst and used without additional purification. Isolated yields ranged 78-87% for bisphenol compounds and 80-87% for aryl dinitro compounds. Synthetic schemes for diarylnitro precursors are shown in FIGS. 16 and 122, image e. FIGS. 17-18 show the ¹H NMR spectra for 4-nitrophenethyl-4-nitrobenzoate and corresponding 4-aminophenethyl-4-aminobenzoate. FIGS. 19-20 show the ¹H NMR spectra for ethyl-1,2-bis-4-nitrobenzoate and corresponding ethyl-12-bis-4-aminobenzoate (E-1,2-B-4-AB). FIGS. 21-22 show the ¹H NMR spectra for ethyl-1,2-bis-3-nitrobenzoate and corresponding ethyl-12-bis-3-aminobenzoate. ¹H and ¹³C NMR spectra for all diamines are shown in FIG. 154-161.

All bisphenol precursors were converted to diepoxide monomers using a two-stage epichlorohydrin (ECH)/base procedure. In this process, ECH functioned as a reactant and a solvent. A 10:1 molar ratio of ECH to phenol was used to limit oligomerization, and tetra-butylammonium bromide (TBAB) was used as a coupling catalyst in the initial stage and a phase transfer catalyst in the biphasic second stage of the epoxidation reaction (base-assisted ring closure). NaOH was gradually added as an aqueous solution at near ambient temperature. Despite the potential for ester hydrolysis in the alkaline second stage of the epoxidation process, crude ¹H NMR spectra of aromatic ester bisphenols from our work indicated minimal hydrolysis (0-4%), based on aromatic-to-ester methylene integral ratios. Crude diepoxide monomers were washed with water to remove residual NaOH and dried. TBAB was removed via silica plug. Epoxide equivalent weights were 2-4% higher than theoretical values, attributable to minor levels of oligomerization. All diepoxide monomers were used for network formation without further purification. Yields ranged from 75-82%.

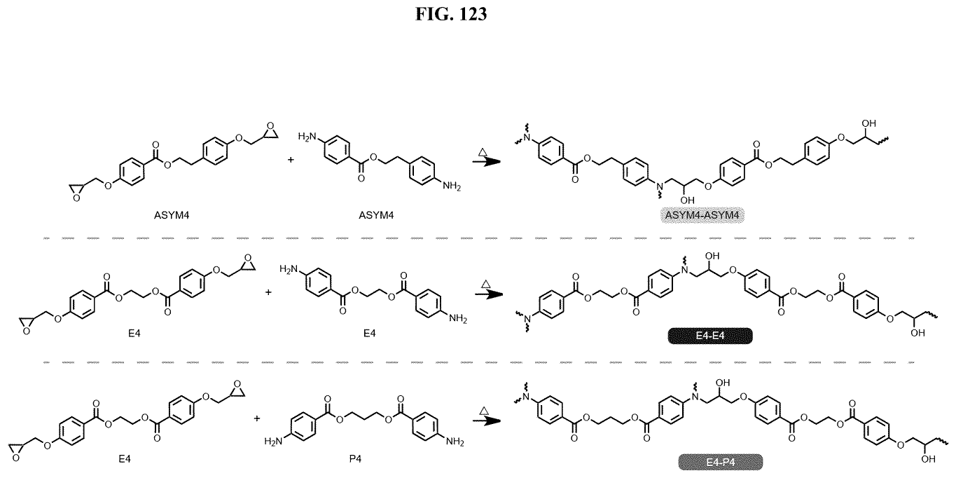

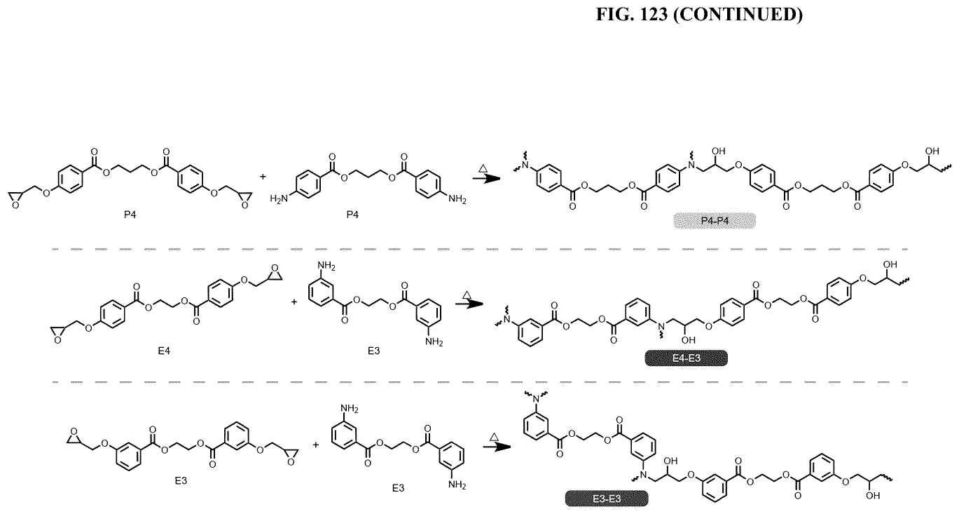

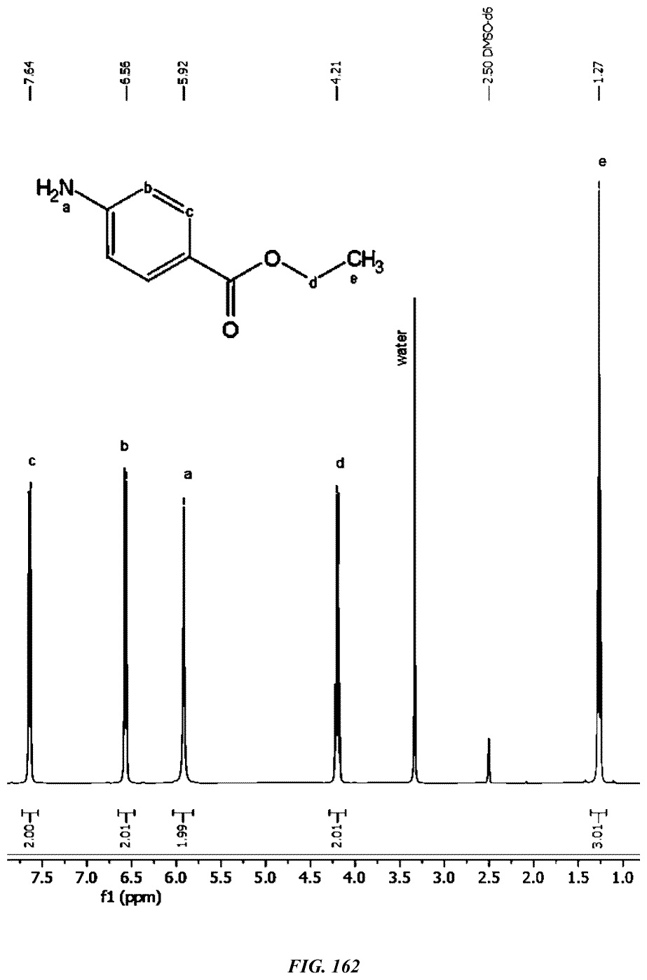

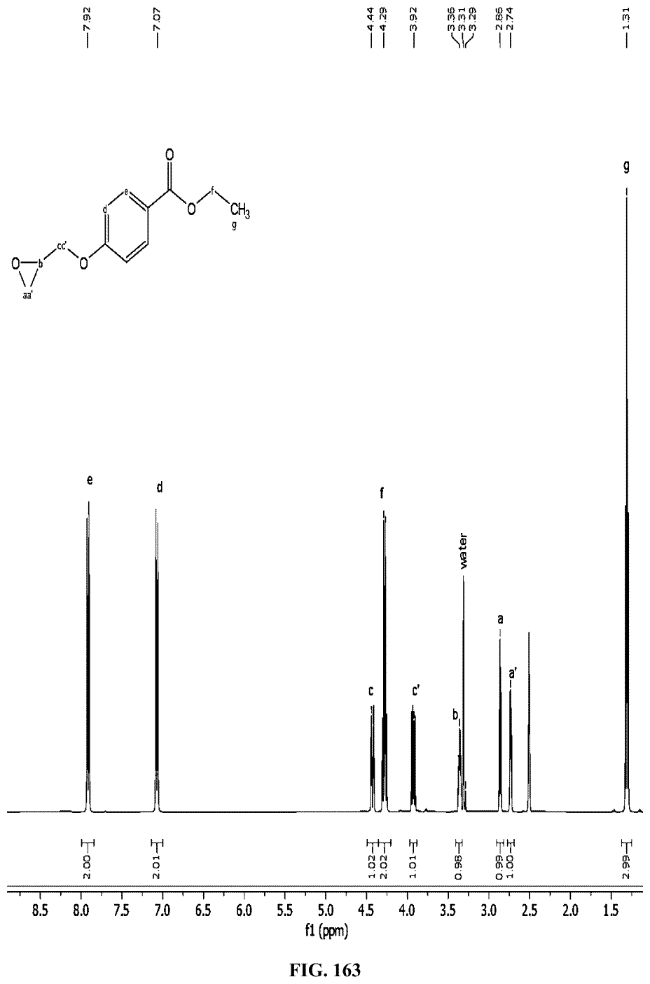

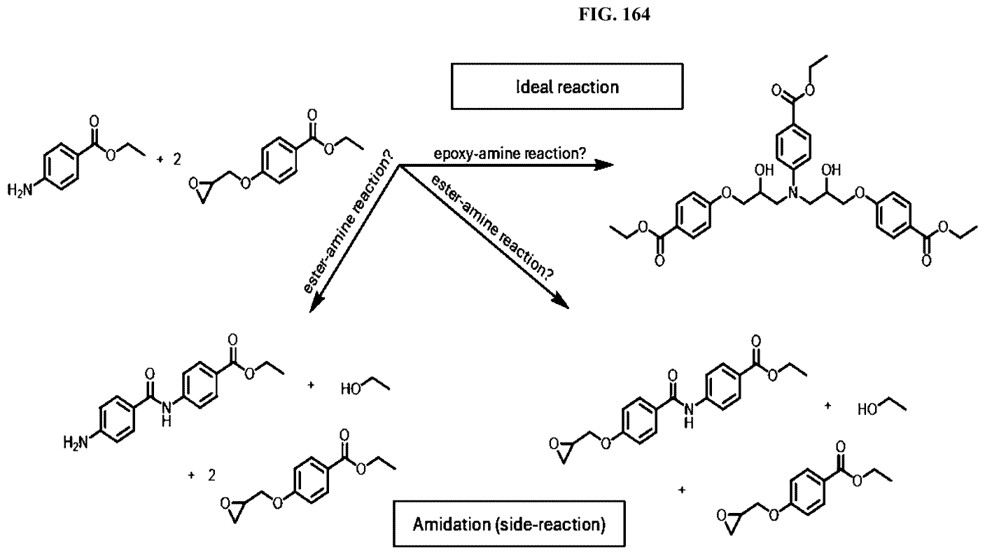

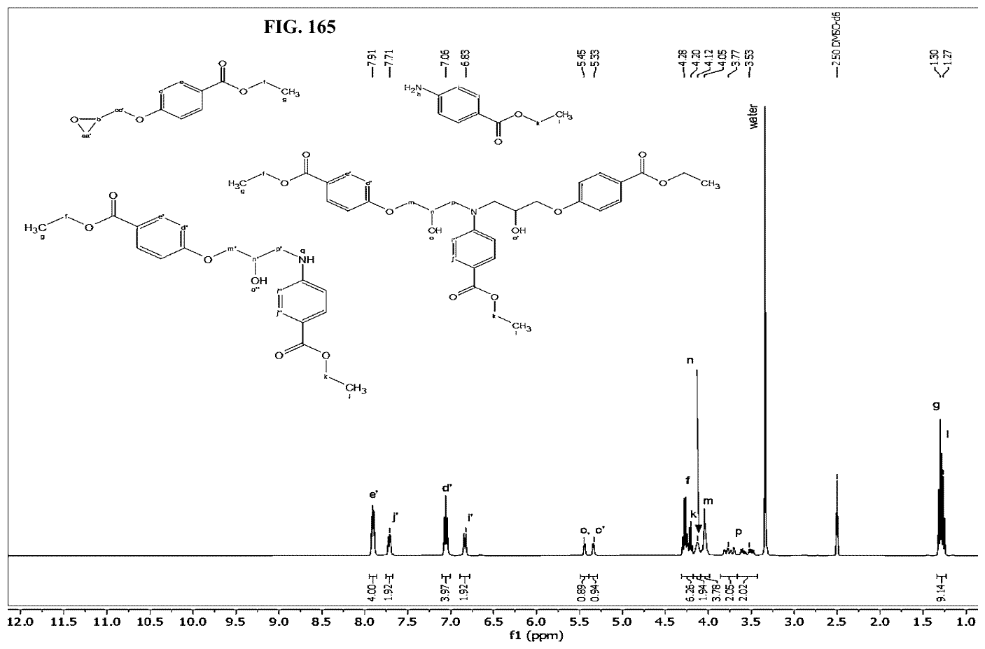

In addition to potential side reactions in ester-containing monomer synthesis, there is the potential for an amine-ester (amidation) reaction in the network formation process. To evaluate the occurrence of amidation using ¹H NMR, a model reaction was conducted using non-network forming monoepoxide (ethyl-4-glycidyloxybenzoate) and monoamine (ethyl-4-aminobenzoate/benzocaine) reactants, chosen for their structural relation to the diepoxide and diamine monomers. ¹H NMR spectra of the reactants are shown in FIGS. 162-163, and a scheme for the potential side reaction is shown in FIG. 164. The reaction was performed under the same thermal conditions as used for formation of 4 of 6 of the polyester networks (network structures in FIG. 123): 120° C. for 3 h followed by a ramp to 200° C. over 2 h and an isothermal hold at 200° C. for an additional 2 h. The ¹H NMR spectrum of the product (FIG. 165) was consistent with the epoxy-amine adduct. Specifically, the terminal methyl protons of the triethyl ester structure appeared at 1.27 ppm and 1.30 ppm. The integral ratio of these peaks to the aromatic protons (7.91 ppm, 7.71 ppm, 7.06 ppm, and 6.83 ppm) was 9.1:11.8, closely matching the theoretical value of 9:12. If amidation had occurred, this ratio would have decreased due to cleavage of ester groups. Further, ethanol—the expected byproduct of amidation—would not contribute to the observed methyl signals, as the reported chemical shift for the methyl protons of ethanol was 1.06 ppm in the same solvent. This confirms that under the applied cure conditions, ester groups in the monomers do not undergo appreciable amidation.

To evaluate structure-property relationships in polymer networks formed from ester-containing monomers, six polyester thermosets (FIG. 123) were synthesized from the diepoxide and diamine components using a nominal 1:1 stoichiometry of epoxide to amine hydrogen. Abbreviations for polyester networks reflect the structure of the diepoxide and diamine monomers: 3 and 4 indicate meta- and para-substitution of the epoxide and amine functional groups relative to the ester, ‘E’ and ‘P’ indicate ethyl or propyl spacers between the aromatic esters, and ‘ASYM’ refers to asymmetry—as in the asymmetric diepoxide and diamine monomers bridged by a single ester. Thermosets derived from DGEBA monomer/oligomer and 4,4′-diaminodiphenylmethane (DDM), 4,4′-diaminodiphenyl sulfone (4,4′-DDS), or 3,3′-diaminodiphenyl sulfone (3,3′-DDS) were included as industrially-relevant aromatic epoxy-amine reference systems.

Single ramp DSC experiments were used to determine the cure temperature profiles. Polymerization exotherm onsets, peak maxima and activation energies (Eₐ) determined by the Kissinger method are summarized in Table 5. In general, these values varied with chemical environment and by extension the nucleophilicity of the amine component. Eₐ values for the polyester networks spanned 54.6-63.6 kJ mol-1, falling between those of the DGEBA-4,4′-DDM (53.5 kJ mol-1) and DGEBA-4,4′-DDS (65.8 kJ mol-1) systems, underscoring their intermediate reactivity profiles.

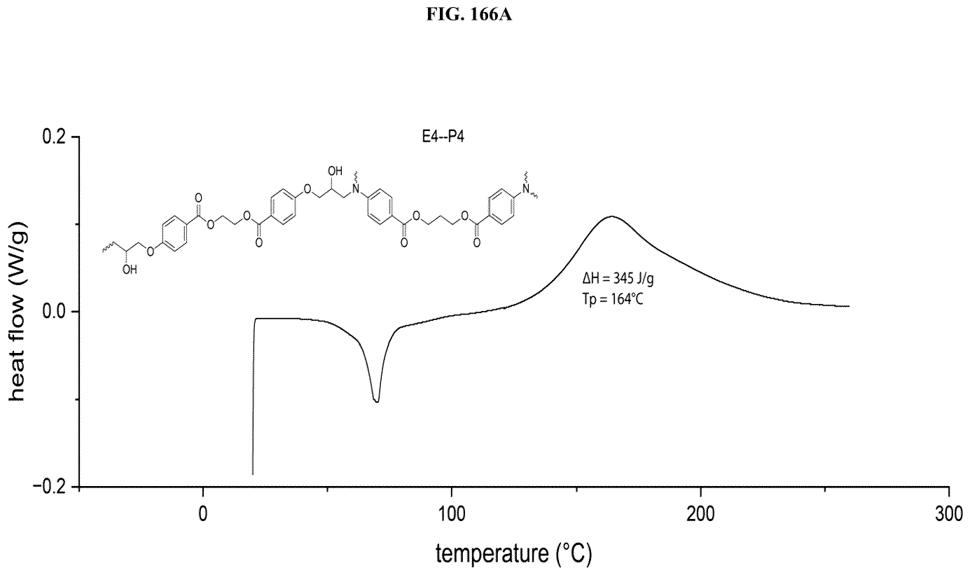

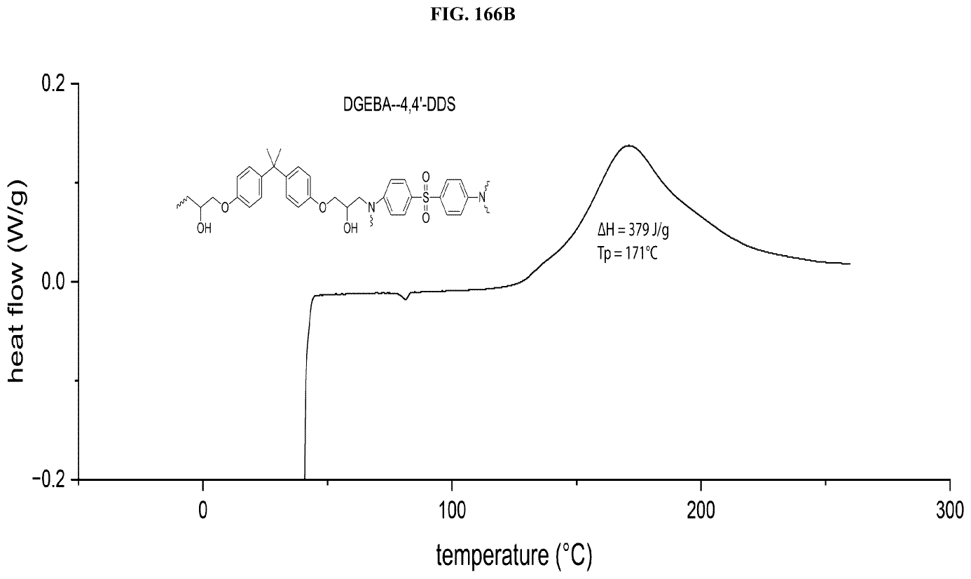

Among symmetric polyester systems, those that used diamines with ester substitution para to the amine (E4-E4, E4-P4, P4-P4) exhibited the highest peak exotherm temperatures and activation energies. This is consistent with a decreased amine nucleophilicity due to electron withdrawal by the para-positioned ester. In the reference system using DGEBA and 4,4′-DDS, where the amine is para to a sulfone group—a stronger electron withdrawing group than an ester—a marginally higher peak exotherm and Eₐ were observed, consistent with diminished nucleophilicity relative to the para-ester substituted amines. Comparative DSC traces for E4-P4 and DGEBA-4,4′-DDS network formation that include peak temperatures and enthalpies are shown in FIG. 166.

The meta-substitution in 3,3′-DDS prevented resonance delocalization of the nitrogen lone pair; this increased the nucleophilicity of the amine relative to the 4,4′-analog. Accordingly, DGEBA-3,3′-DDS exhibited a lower peak temperature and Ea. Similarly, polyester systems with meta-substituted ester groups in the diamine component (E4-E3, E3-E3) showed lower exotherm temperatures and activation energies compared to their para-substituted counterparts. 4,4′-DDM lacks electron withdrawing substituents; this prompted the lowest peak exotherm and Eₐ for DGEBA-4,4′-DDM among all systems, consistent with a relatively nucleophilic amine. Among the ester-containing systems, ASYM4-ASYM4 had the lowest peak temperature and Eₐ. This diamine is structurally asymmetric as it features one amine group para to an ester and the other para to a non-electron-withdrawing aliphatic span; asymmetric reactivity in this system is prompted from differential amine nucleophilicity.

TABLE 5
Table 5 shows polymerization thermodynamic data summmary.

| | Peak exotherm | Exotherm onset | Ea (kJ/mol) via |
|---|---|---|---|
| | temperature | temperature | Kissinger |
| Network | (° C.) * | (° C.) * | method |
| DGEBA-4,4′-DDM | 114 | 96 | 53.5 |
| DGEBA-4,4′-DDS | 171 | 141 | 65.8 |
| DGEBA-3,3′-DDS | 156 | 130 | 61.9 |
| ASYM4-ASYM4 | 129 | 103 | 54.6 |
| E4-E4 | 169 | 144 | 63.6 |
| E4-P4 | 164 | 133 | 61.9 |
| P4-P4 | 166 | 137 | 62.8 |
| E4-E3 | 147 | 118 | 59.5 |
| E3-E3 | 147 | 115 | 57.8 |

* as determined at 1° C. per minute ramp rate

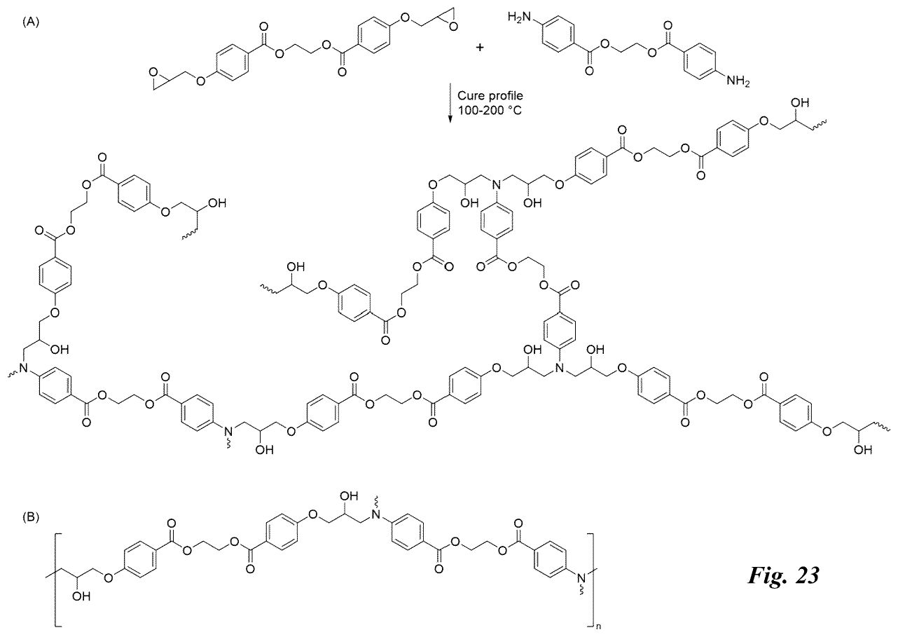

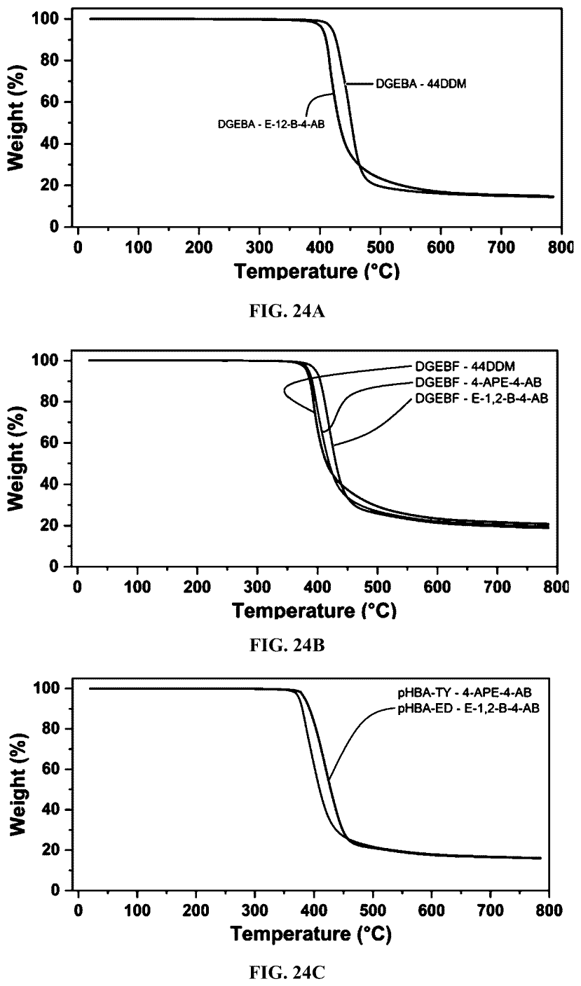

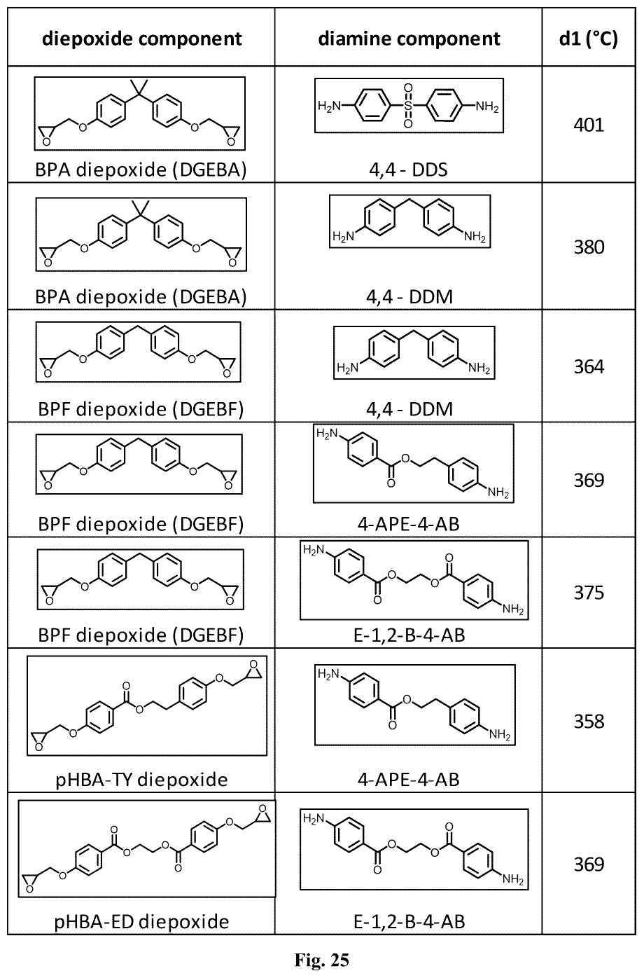

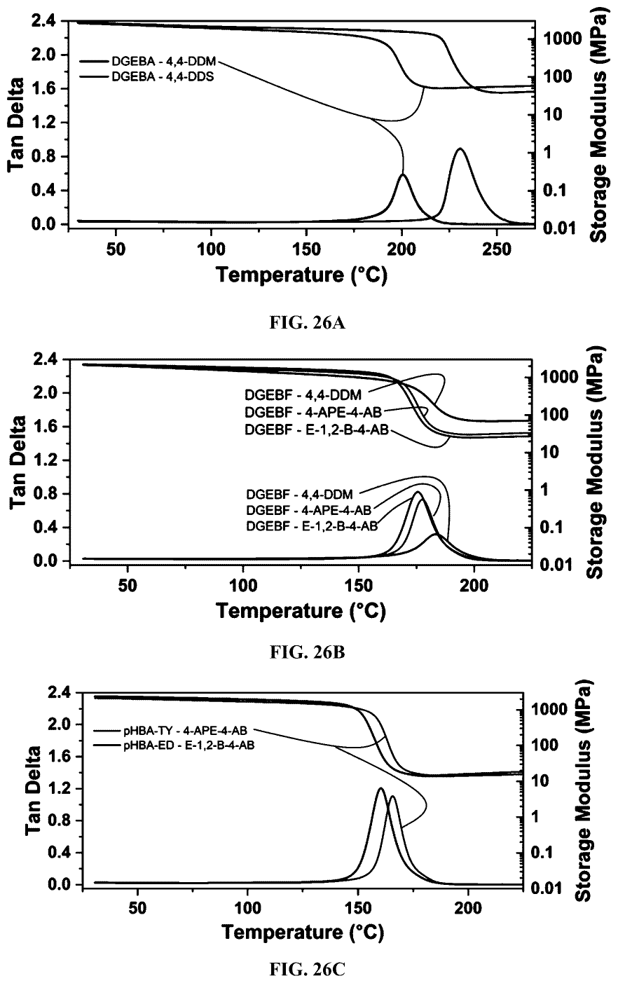

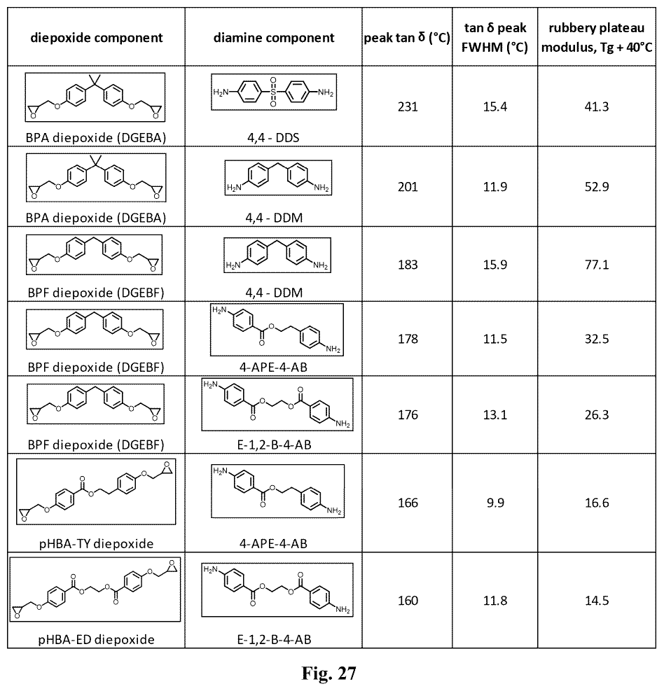

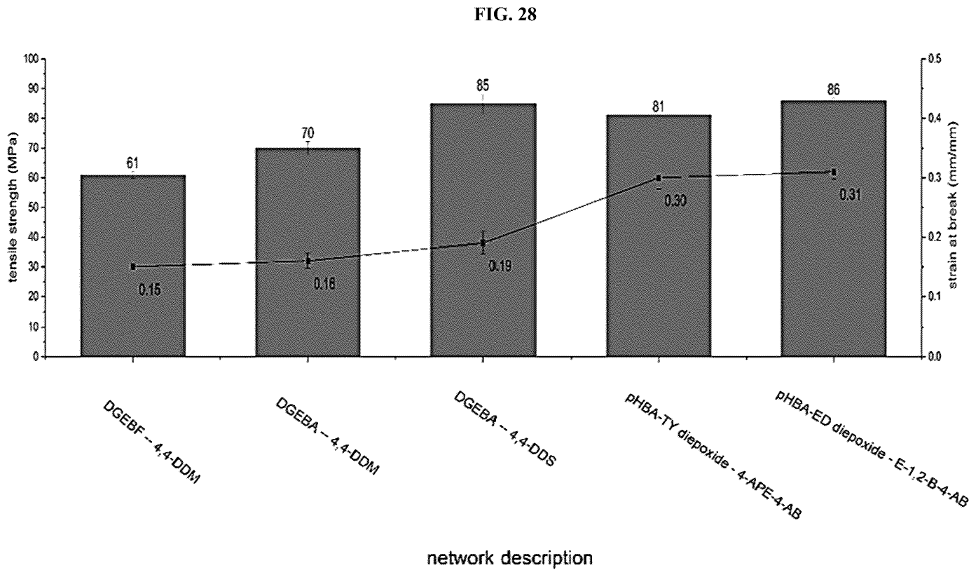

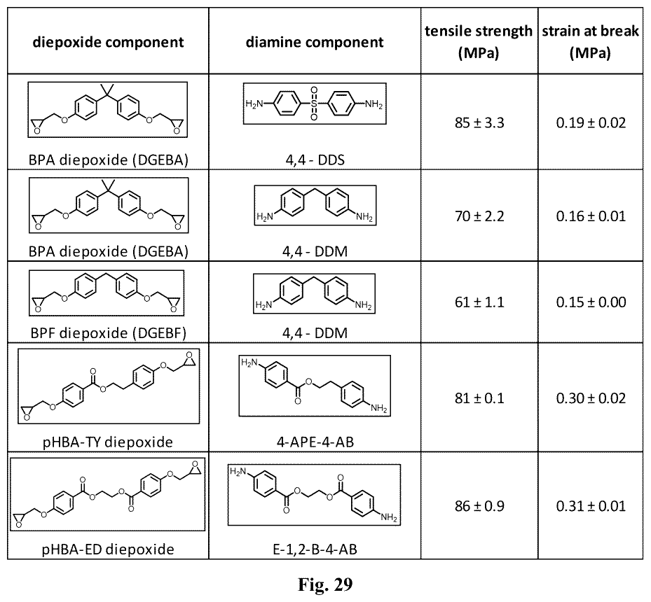

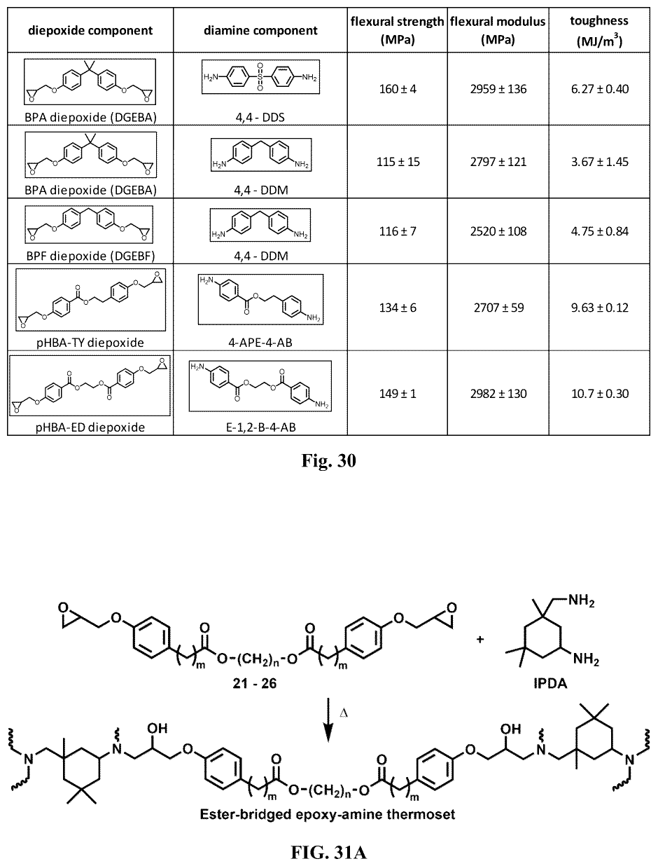

Thermoset polyester networks were prepared by curing a series of ester-containing diepoxide compounds with a series of ester-containing aromatic diamine compounds. Such network design endows each polymer network strand with at least one ester functional group, as illustrated in FIG. 23. Preliminary properties of the polyester networks, in comparison to several conventional epoxy-amine compositions (e.g. DGEBA-4,4-DDS, DGEBA-4,4-DDM) are shown in FIGS. 24-30.

Polymerizations were conducted in bulk without external catalyst. Solubility was achieved in all cases, as was qualitatively assessed by optical clarity. The temperature where a monomer solution formed correlated with the melting point (mp) of the diamine component. Experiments that used ASYM4, P4, or E3 diamines (mp=127-133° C.) formed solutions at ≤120° C. In contrast, systems that contained the E4 diamine (mp=214° C.) achieved full dissolution at 160° C. The elevated temperature could impede controlled network formation, as there is the potential for higher Ea secondary amine reaction to cause branches/crosslinks prior to substantial linear chain development due to primary amine reaction—and this could prompt a higher level of network defects/heterogeneity. To minimize time at elevated temperature, the E4 diamine was pulverized to reduce particle size; this enabled complete dissolution at 160° C. in only about 10 minutes. From this point it was possible to lower the temperature to 130° C. for the E4-E4 polymerization to proceed under relative control. Due to the higher initial temperature, the cure protocol for the E4-E4 network differed from the 120-200° C. profile used for the other symmetric polyester systems prepared herein.

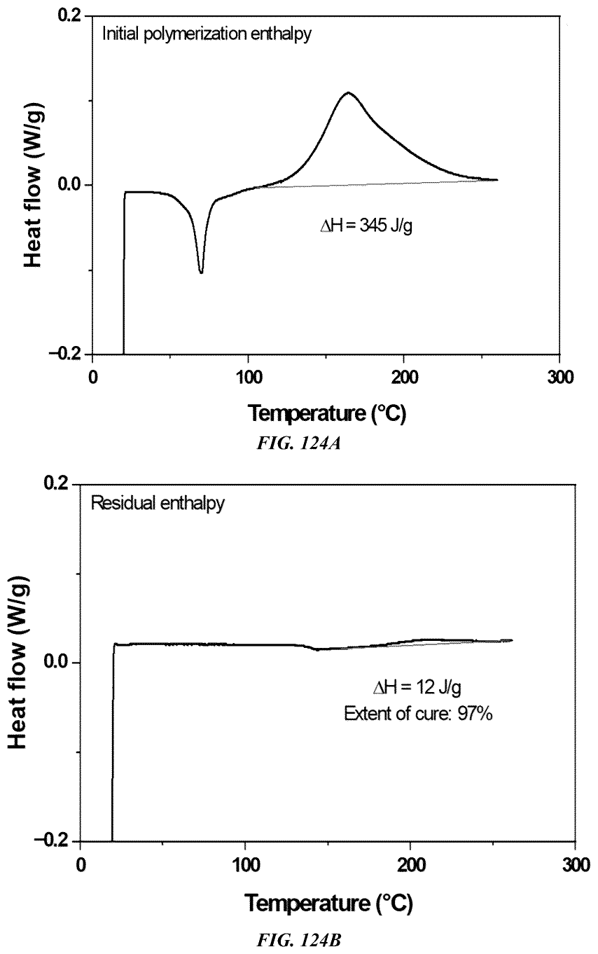

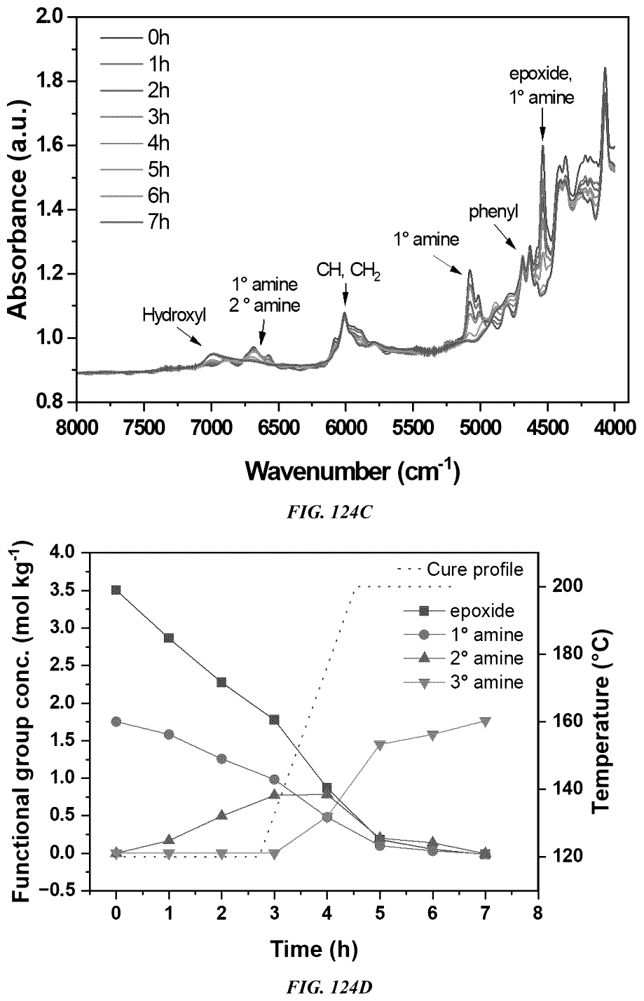

The extents of cure for the polyester networks were assessed via DSC from the ratio of initial to residual polymerization enthalpy following completion of the prescribed cure protocols (Table 8). For the symmetric polyester systems, enthalpy data indicated 94.7-96.6% extent of cure. The asymmetric system reached a lower 93.8% extent of cure—possibly due to lower polymerization control related to the asymmetric reactivity of the ASYM4 diamine. By the same approach the 4,4′ and 3,3′-DDS reference systems ranged from 95.4-96.5% extent of cure, and the 4,4′-DDM reference system reached 98.1%. DSC traces for a representative polyester system (E4-P4) are shown in FIG. 124A-124B. Near-infrared (NIR) spectroscopy was used to monitor functional group absorbances over the course of the polymerization, and the Beer-Lambert law was applied to determine concentrations (FIG. 124C-124D). Quantification of the NIR spectra confirmed that epoxide, primary amine, and secondary amine groups were depleted to baseline levels by the end of the cure, in agreement with the DSC results.

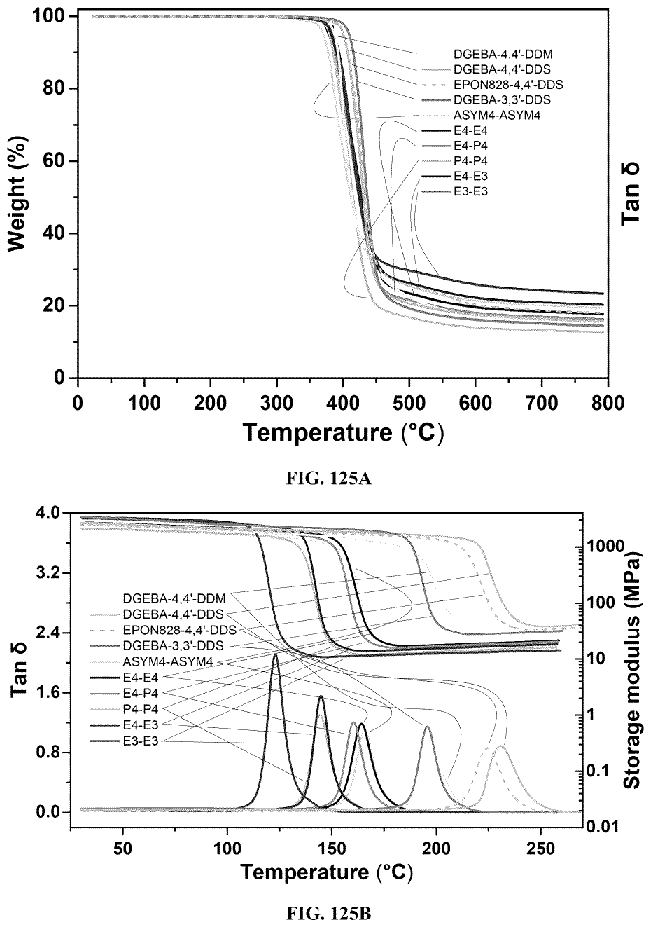

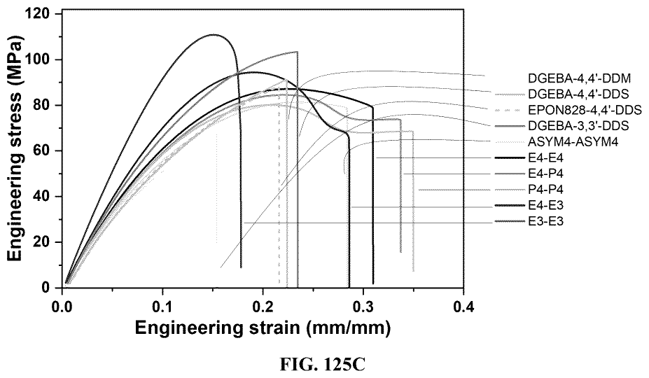

The thermal stabilities of the polyester networks were evaluated via thermogravimetric analysis (TGA) using a 10° C./min ramp rate under N₂. Weight % vs temperature traces are supplied in FIG. 125A, with quantification summarized in Table 6. As indicated, thermal degradation occurred through a single major decomposition step. The 5% weight loss temperature (T_{d,5}) for the ASYM4-ASYM4 network was 370° C., and those for the symmetric networks ranged from 378-382° C. Despite the high concentration of ester functionality, the thermal stabilities of polyester networks were only marginally lower than that of the DGEBA-type networks (387-407° C.). Epoxy networks that contained a higher percentage of oxygen linkages increased susceptibility to chain scission and crosslinking events that promote char formation,³⁶ so the presence of ester functionality in general could partially explain the higher average residue at 800° C. observed for the polyester networks relative to the DGEBA type networks. Among polyester networks, increased residue was observed with increase in meta substitution (i.e. residue increase from E4-E4 to E4-E3 to E3-E3) and with decrease in aliphatic spacer length among all para-substituted networks (i.e. residue increase from E4-E4 to E4-P4 to P4-P4)—attributable at least partially to increased aromatic to aliphatic ratio.

Thermomechanical properties of the networks were probed by dynamic mechanical analysis (DMA), with representative tan δ and storage modulus plots supplied in FIG. 125B. Quantitative data are summarized in Table 6. The polyester networks exhibited a range of glass transition temperatures (T_{g})—all lower than the DGEBA reference networks (122-164° C. for polyester networks vs. 196-231° C. for the reference networks). The difference in T_{g} was attributable in part to the flexibility introduced by the ester linkages and aliphatic spacers in the phenylene bridges of the polyester networks. Additionally, as shown in Table 6, the theoretical crosslink densities of networks derived from DGEBA monomers (8005-8173 mol/m³) were higher than those of the polyester networks (6644-6998 mol/m³ for symmetric networks, 7652 mol/m³ for the asymmetric network)—an additional contributor to the observed differences in T_{g}. To partially normalize to theoretical crosslink density, a network derived from Hexion Epon 828 (monomeric/oligomeric DGEBA—a standard liquid epoxy resin) and 4,4′-DDS was evaluated. Although theoretical crosslink density is lower for the Epon 828 network (7448 mol/m³) than the ASYM4-ASYM4 network—glass transition temperature of the ASYM4 network was substantially lower—and is highly comparable to that of the lower-theoretical crosslink density E4-E4 network. This is probably due to the additional aromatic ester linkage present in every network strand of the E4-E4 network in place of the aliphatic span in the ASYM4-ASYM4 network.

Among the para-substituted symmetric polyester networks, a systematic decrease in T_{g} was observed as the aliphatic spacer length increased from ethyl-ethyl (E4-E4) to ethyl-propyl (E4-P4) to propyl-propyl (P4-P4). This was attributable to increased network strand flexibility, reduction in the theoretical crosslink density, and dilution of phenylene and functional groups with linear aliphatic content. A similar systematic decrease in T_{g} was observed as meta substitution increased in the polyester networks (E4-E4 to E4-E3 to E3-E3). Meta-substitution in the DGEBA reference networks (3,3′-DDS vs 4,4′-DDS) also depressed T_{g}, consistent with prior reports and attributable to the increased conformational freedom conferred to the networks by the meta-substituted linkages despite higher chain packing efficiency. The influence of the isomeric substitution was also evident in the storage modulus plots (FIG. 125B). For example, the glassy modulus consistently increased with meta substitution (E3-E3>E4-E3>E3-E3) and the rubbery plateau modulus consistently decreases. Modulus has been related to the level of unoccupied volume, and in the glassy state meta-substituted epoxy/amine networks have demonstrated tighter packing.

TABLE 6
Network thermal stability, thermomechanical properties, and architecture summary

| | | | | | Rubbery | | |
|---|---|---|---|---|---|---|---|
| | | | | Tan δ | plateau | | |
| | | Residue at | Peak tan | FWHH | modulus | M_{c} | ν_{theoretical maximum} |
| Network | T_{d5} (° C.) | 800° C. (%) | δ (° C.) | (° C.) | (MPa) | (g/mol)* | (mol/m³)** |
| DGEBA - | 387 ± 0.7 | 16.1 ± 1.1 | 200 ± 0.5 | 12.3 ± 0.3 | 50.3 ± 2.6 | 294 | 8173 |
| 4,4′-DDM | | | | | | | |
| DGEBA - | 400 ± 0.0 | 15.7 ± 0.1 | 231 ± 0.6 | 15.5 ± 0.2 | 37.9 ± 0.9 | 310 | 8005 |
| 4,4′-DDS | | | | | | | |
| Epon 828 - | 401 ± 0.0 | 17.6 ± 0.6 | 225 ± 0.2 | 14.4 ± 0.1 | 35.5 ± 0.2 | 333 | 7465 |
| 4,4′-DDS | | | | | | | |
| DGEBA - | 407 ± 2.0 | 14.7 ± 0.4 | 196 ± 0.2 | 9.8 ± 0.1 | 29.2 ± 0.2 | 310 | 8015 |
| 3,3′-DDS | | | | | | | |
| ASYM4- | 370 ± 0.2 | 19.4 ± 0.1 | 163 ± 2.6 | 10.9 ± 1.0 | 17.1 ± 0.4 | 333 | 7652 |
| ASYM4 | | | | | | | |
| E4-E4 | 378 ± 0.7 | 17.8 ± 0.2 | 164 ± 0.6 | 11.0 ± 0.2 | 17.5 ± 0.5 | 377 | 6972 |
| E4-P4 | 381 ± 0.6 | 15.6 ± 1.0 | 160 ± 0.3 | 9.8 ± 0.0 | 16.9 ± 0.0 | 382 | 6843 |
| P4-P4 | 381 ± 1.2 | 12.6 ± 0.2 | 143 ± 1.1 | 10.2 ± 0.1 | 12.4 ± 0.2 | 391 | 6644 |
| E4-E3 | 382 ± 0.6 | 20.2 ± 0.0 | 144 ± 0.5 | 8.8 ± 0.0 | 14.9 ± 0.3 | 377 | 6981 |
| E3-E3 | 380 ± 3.9 | 21.0 ± 2.5 | 122 ± 1.0 | 9.4 ± 0.4 | 11.2 ± 0.1 | 377 | 6998 |

*as determined from weighted average network strand molar mass,
**and from bulk density values

A summary of tensile and flexural properties data for all polymer networks is supplied in Table 7. Data related to calculation of theoretical crosslink density is supplied in Table 9. Polyester networks generally exhibited ductile failure in tension, with strains at yield that ranged from 0.15 to 0.24 mm/mm, whereas non-ester containing reference networks exhibited brittle failure in all cases. Among completely para-substituted networks, strain at yield values decreased proportionally with theoretical crosslink density (i.e., ASYM4-ASYM4>E4-E4>E4-P4>P4-P4). Strain at yield values were inversely proportional to meta-substituted content (i.e. E4-E4>E4-E3>E3-E3). Higher strain at yield values for para-substituted (vs. partially meta-substituted) epoxy systems in the glassy state have been previously attributed to increased molecular mobility via phenylene rotation.

The tighter packing and restricted rotational freedom of meta-substituted linkages contribute to the accumulation of stress prior to yield. Tensile and flexural strengths increased with meta substitution across both polyester (E4-E4, E4-E3, E3-E3) and reference (DGEBA-4,4′-DDS, 3,3′-DDS) networks. The tensile strength at yield of the fully-para substituted E4-E4 network closely matched the strength at break of the DGEBA-4,4′-DDS benchmark, while the partially-meta substituted E4-E3 network approached the strength of DGEBA-3,3′-DDS. Although the all meta-substituted E3-E3 network lacked an equivalent reference network, it exhibited the highest tensile and flexural strength of all networks evaluated. Despite a noticeable reduction in flexural strain at break for the E3-E3 network relative to E4-E3 and E4-E4, the material still yielded prior to failure, consistent with the ductile character of the ester-bridged epoxy-amine materials. Among para-substituted polyester networks, an increase in the spacer length (E4-E4 to E4-P4 to P4-P4) led to progressive decreases in both tensile and flexural strength.

TABLE 7
Table 7 shows a summary of ambient temperature mechanical properties.

| | | Strain at | Strain at | | | |
|---|---|---|---|---|---|---|
| | Tensile | yield | break | Flexural | Flexural | Flexural |
| | strength | (tension) | (tension) | strength | modulus | toughness |
| Network | (MPa) | (mm/mm) | (mm/mm) | (MPa) | (MPa) | (MJ/m³) |
| DGEBA - | 70.2 ± 2.2 | N/A | 0.164 ± 0.013 | 117 ± 7 | 2786 ± 58 | 3.54 ± 0.67 |
| 4,4-DDM | | | | | | |
| DGEBA - | 85.0 ± 3.3 | N/A | 0.187 ± 0.019 | 146 ± 8 | 3006 ± 66 | 4.81 ± 0.72 |
| 4,4-DDS | | | | | | |
| Epon 828 - | 87.8 ± 3.3 | N/A | 0.209 ± 0.023 | 141 ± 1 | 3292 ± 83 | 3.68 ± 0.28 |
| 4,4-DDS | | | | | | |
| DGEBA - | 107 ± 1.7 | N/A | 0.222 ± 0.007 | 167 ± 11 | 3614 ± 94 | 5.01 ± 0.82 |
| 3,3-DDS | | | | | | |
| ASYM4- | 81.2 ± 0.1 | 0.240 ± 0.001 | 0.298 ± 0.019 | 134 ± 3 | 2702 ± 40 | 9.42 ± 0.15 |
| ASYM4 | | | | | | |
| E4-E4 | 85.6 ± 0.9 | 0.233 ± 0.001 | 0.306 ± 0.012 | 149 ± 3 | 3004 ± 33 | 10.47 ± 0.21 |
| E4-P4 | 83.3 ± 1.0 | 0.220 ± 0.004 | 0.327 ± 0.040 | 144 ± 6 | 2719 ± 43 | 10.06 ± 0.48 |
| P4-P4 | 79.8 ± 0.5 | 0.209 ± 0.001 | 0.309 ± 0.021 | 133 ± 3 | 2567 ± 69 | 9.22 ± 0.20 |
| E4-E3 | 94.1 ± 0.2 | 0.189 ± 0.002 | 0.283 ± 0.015 | 172 ± 2 | 3416 ± 70 | 12.01 ± 0.15 |
| E3-E3 | 112 ± 0.5 | 0.148 ± 0.003 | 0.169 ± 0.008 | 188 ± 9 | 4154 ± 130 | 10.05 ± 2.06 |

Flexural moduli for polyester networks ranged from 2.6-4.2 GPa (vs. 2.8-3.6 GPa for reference networks). A consistent modulus increase with meta substitution was observed (E4-E4 to E4-E3 to E3-E3, and DGEBA-4,4′-DDS to DGEBA-3,3′-DDS), which aligns with epoxy-amine systems. Flexural toughness, calculated from the area under the stress/strain curve, was significantly higher (9.2-12.0 MJ-m³) for the polyester networks compared to the DGEBA reference networks (3.5-5.0 MJ-m³). The pronounced ductility of the polyester networks delayed or prevented failure within the 0.10 mm/mm strain window of the evaluation, and this was the primary contributor to the increase in area under the curve.

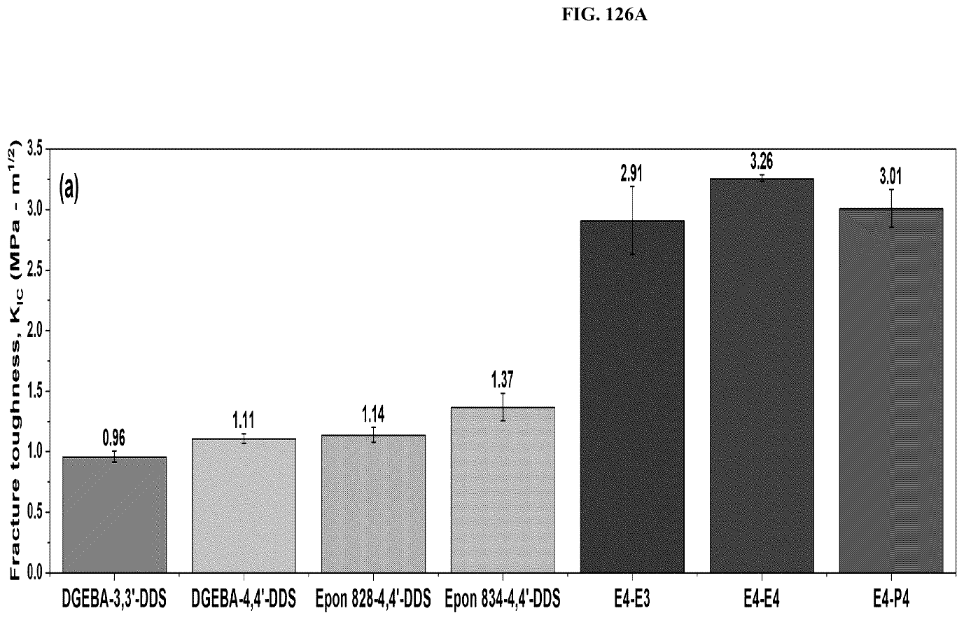

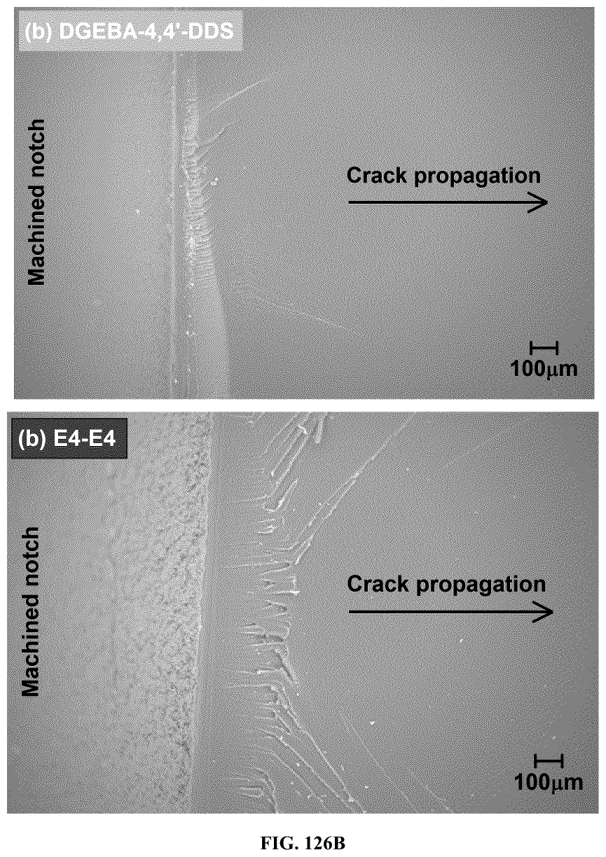

Resistance to fracture was evaluated under plane-strain conditions in mode I loading (opening mode), as materials typically exhibit lower failure thresholds in this mode compared to mode II (shearing) or III (tearing). Critical stress intensity factors (K_{IC}) for crack propagation were determined using single-edge notched bend (SENB) specimens, with data for representative polyester and DGEBA-based networks supplied in FIG. 126A. To examine the influence of crosslink density, a DGEBA-type network of lower theoretical crosslink density (5871 mol crosslinks/m³) than any of the polyester networks system derived from Epon 834 and 4,4′-DDS was evaluated. A clear increase in K_{IC} with decrease in crosslink density was observed for the DGEBA-type networks. K_{IC} values for the E4-E3, E4-E4, and E4-P4 polyester networks were about 3× higher than those for the DGEBA monomer networks and at least 2× as high as the oligomeric DGEBA networks For a broader context, the reactive incorporation of the ductile thermoplastic PES into a DGEBA-4,4′-DDS network has been reported to increase fracture toughness over the neat system by about 3× also (30 kDa PES at 30% by weight—reported as the most effective conditions) (Yoon, T. H.; Priddy Jr, D. B.; Lyle, G. D.; McGrath, J. E. Mechanical and morphological investigations of reactive polysulfone toughened epoxy networks. Macromolecular Symposia 1995, 98 (1), 673-686)

SEM images of the fracture surfaces of SENB specimens indicated clear differences between the representative DGEBA-type and polyester networks. A DGEBA-type specimen (FIG. 126B) exhibited a relatively featureless fracture surface, whereas the polyester network displayed a markedly rougher hackled topography (FIG. 126C). Increased surface roughness is often indicative of greater energy dissipation prior to crack propagation and is consistent with the higher fracture toughness observed in the polyester systems.

As crosslink density alone cannot explain the discrepancy in fracture toughness, a probable contributor is the enhanced distortional capacity of the polyester networks that arises from rotational freedom about the ester linkages and less compact phenylene packing due to incorporation of short spacers. A potential additional contributor is the difference in secondary network structure from hydrogen bonding interactions in the DGEBA-type vs polyester systems. Both polyester and DGEBA-type networks contain hydroxyl groups (from epoxide ring opening) capable of forming relatively strong hydroxyl-hydroxyl hydrogen bonds. Although the theoretical hydroxyl content is lower in the polyester networks (15% lower on average for symmetric polyester networks vs. DGEBA-type networks), ester groups can function as hydrogen bond acceptors and thereby add weaker carbonyl-hydroxyl hydrogen bonds to the secondary network structure. The presence of ester groups increases the overall number of possible interactions despite the reduction in hydroxyl functionality. To qualitatively investigate the participation of ester groups in hydrogen bonding, mid-infrared temperature sweep experiments were performed on representative polyester network E4-P4 and Epon 828-4,4′-DDS (as a reference). A peak associated with hydroxyl stretch vibration shifts from about 3400 cm⁻¹ at ambient temperature to 3560 or 3570 cm⁻¹ (Epon 828-4,4′-DDS and E4-P4, respectively) at 180° C. as hydrogen bonds are disrupted by the thermal energy input. a peak associated with C═O stretch vibration shifts from about 1700 cm⁻¹ to 1705 cm⁻¹ across the same temperature span—potentially from removal of hydrogen bonding, as this would shift absorption to higher wavenumber due to an increase in double bond character of the ester carbonyl. Data related to network functional group content is supplied in Table 10.

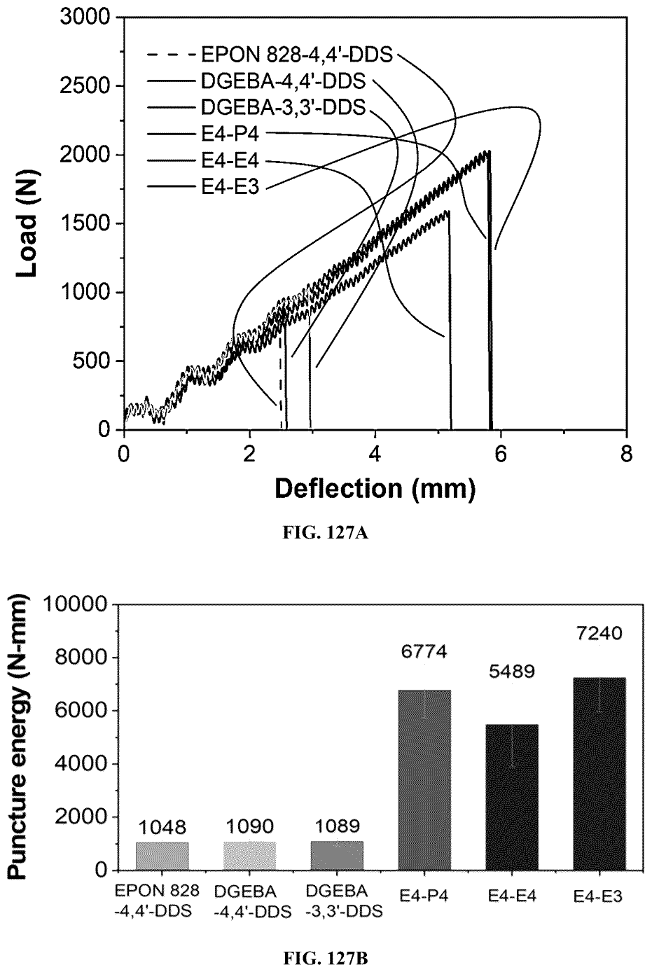

Although resistance to fracture under gradual loading is a useful indicator of the ability of a material to dissipate energy prior to failure, resistance under abrupt loading (impact) is also an important property when a material is potentially subject to collisions or drops. As seen in FIG. 127, the impact resistance of representative aromatic polyester thermosets E4-P4, E4-E4, and E4-E3 was compared to that of conventional aromatic epoxy/amine thermosets Epon 828-4,4′-DDS, DGEBA-4,4′-DDS, and DGEBA-3,3′-DDS. Panels of 100×100×3.4 mm were subjected to an impact energy of 20.0 J using a 10 mm diameter radiused impactor. Load vs. deflection curves were integrated to determine puncture energies. In all cases, the impactor fully penetrated the panels; however, the absorbed energy by the polyester panels ranged from 5.1 to 6.7× higher (5489 to 7240 N-mm) than the average for the DGEBA-type reference networks (1076 N-mm). Among reference networks, no substantial difference was observed. The structural characteristics previously identified as contributors to higher K_{IC} values for E4-P4 (i.e., low rotational barrier for ester linkage, less compact phenylene packing due to spacer incorporation, and modified secondary interactions) are probably also contributors to the higher impact resistance of E4-P4.

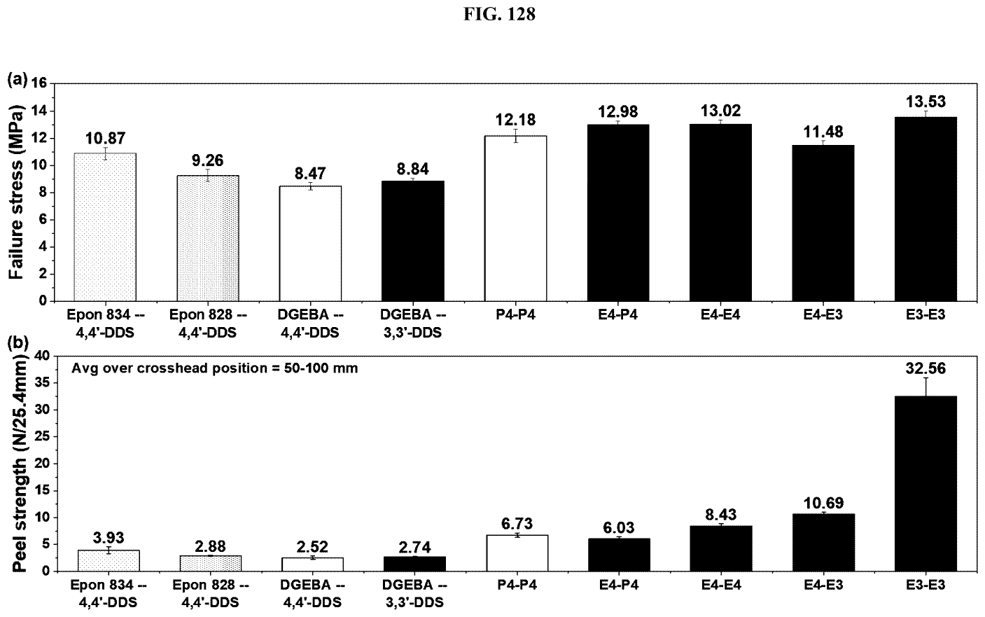

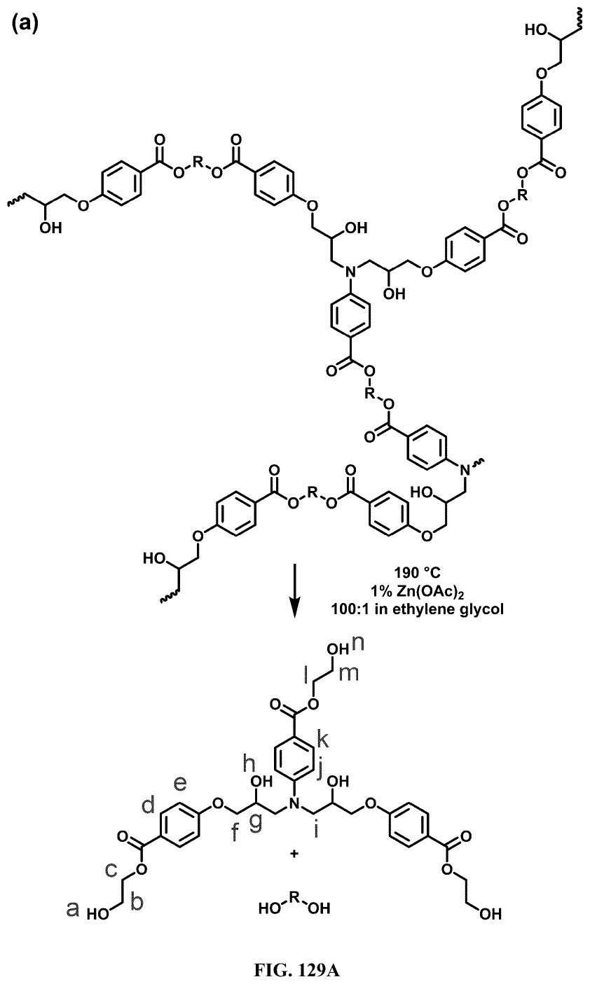

As substrate and/or filler interfaces are present in epoxy applications—and as the bonds at those interfaces can depend on structural features of the epoxy—adhesive properties of the polyester systems were evaluated via single lap shear (FIG. 128A) and peel resistance (FIG. 128B). Adhesion in epoxy systems is often attributed to hydrogen bonding between hydroxyl groups in the network structure to the functionalities on certain substrates. Theoretical hydroxyl concentration in epoxy networks (Table 10) decreases with as monomer bridge length increases and is therefore lower in the polyester networks than in the DGEBA systems. Yet, all polyester networks exhibited higher failure stresses in single lap shear than the DGEBA reference networks; this indicates that factors other than hydroxyl content contribute to adhesive performance. Some level of plastic deformability has been connected to augmentation of lap shear strength in epoxy systems; the increased deformability due to structural features probably the main contributor to the higher lap shear values observed. Among DGEBA type systems, there was a clear increase in lap shear strength with decrease in theoretical crosslink density (8005, 7448, and 5871 mol crosslinks per m³ for DGEBA (monomer), Epon 828, and Epon 834 networks, respectively). Difference in theoretical crosslink density among symmetric polyester networks was less pronounced (6998 to 6644 mol crosslinks per m³, respectively), and no clear overall correlation with crosslink density and lap shear strength was observed.

Increased ductility in epoxy systems has been shown to prompt higher peel resistance through shear yield and plastic flow, and increase in peel resistance prompted by decreased internal stress from introduction of flexible spacer units in epoxy has also been reported. Among the para-substituted polyester networks, average peel resistance did not correlate to aliphatic spacer length (peel strengths of P4-P4, E4-P4, and E4-E4 were 6.73, 6.03, and 8.43 N/25.4 mm, respectively). Increased meta substitution led to a marked increase in peel strength—E4-E3 reached 10.7 N/25.4 mm, while E3-E3 reached 32.6 N/25.4 mm. This jump is consistent with the meta substituted content: E4-E3 contains one-third meta-substituted strands whereas E3-E3 is fully meta-substituted. From previous discussion, the E3-E3 and E4-E3 also ranked highest in tensile and flexural strength among the polyester networks. Despite similar mechanical strength, the DGEBA-3,3′-DDS network exhibited a peel strength of 2.74 N/25.4 mm—only marginally higher than its fully-para counterpart DGEBA-4,4′-DDS (2.52 N/25.4 mm). One feature that distinguishes the polyester networks from DGEBA-3,3′-DDS and DGEBA-4,4′-DDS is the ability to yield prior to failure, a probable contributor to their increased peel performance.

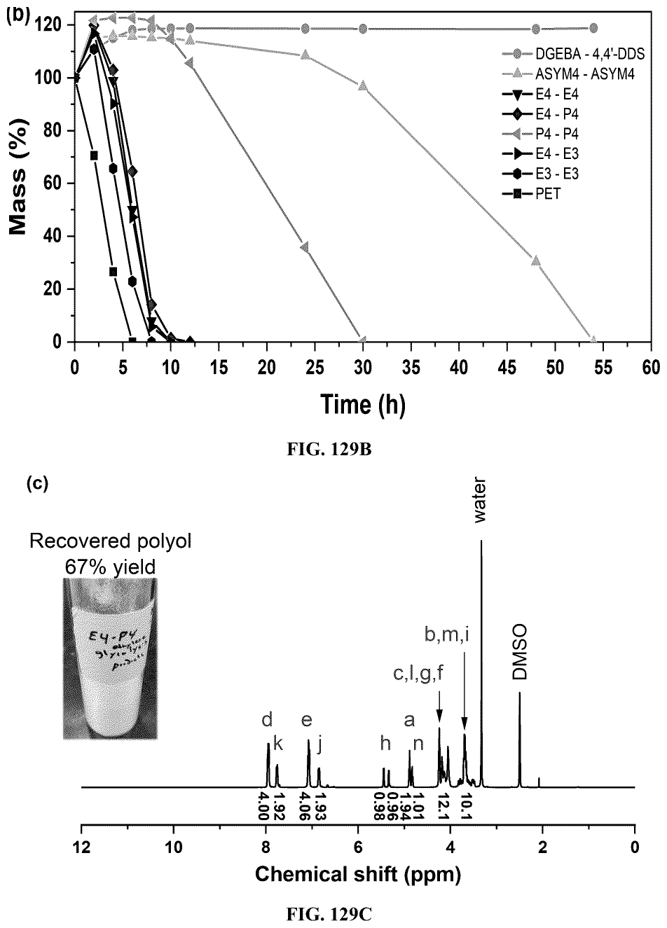

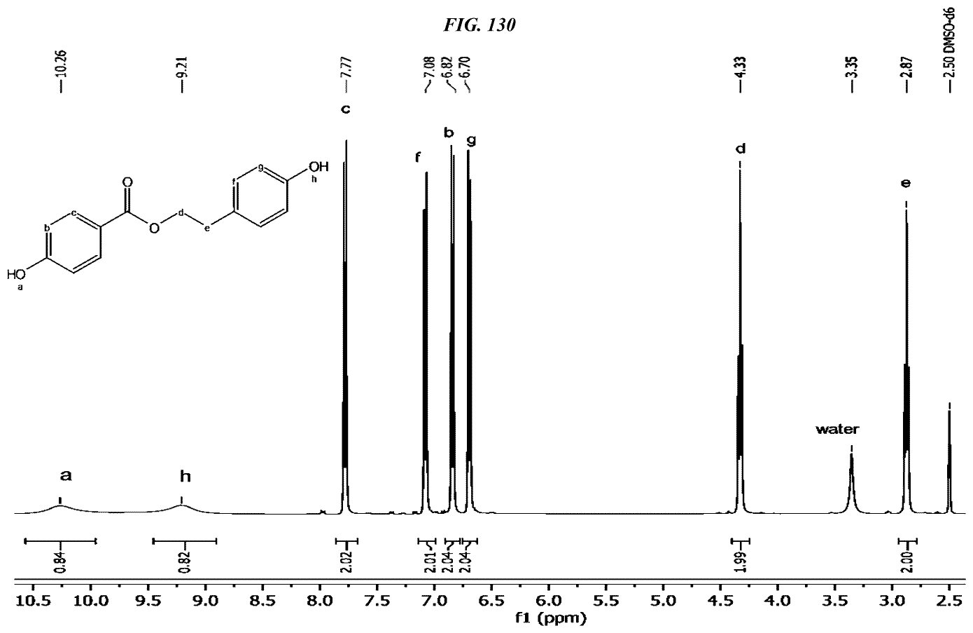

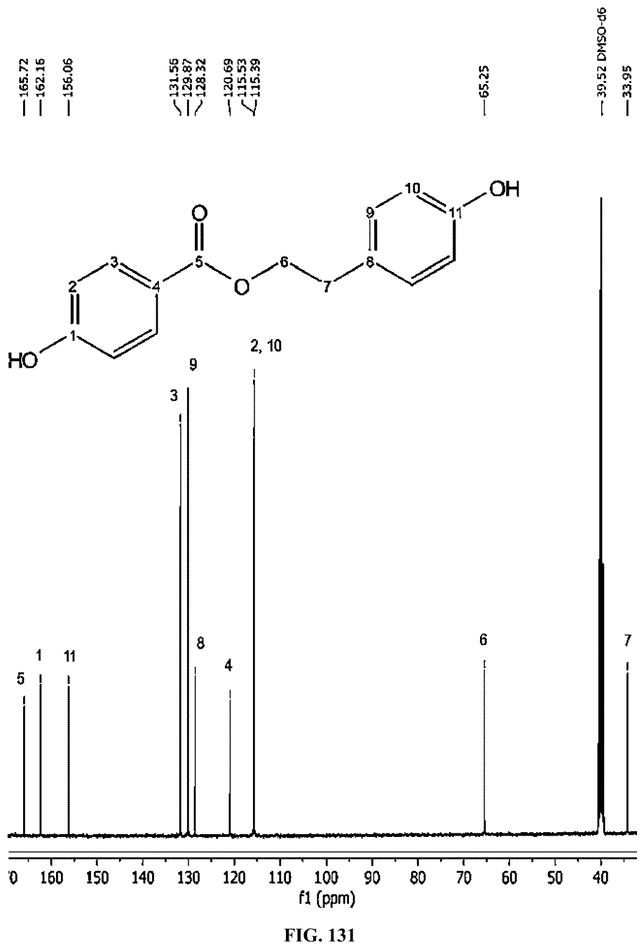

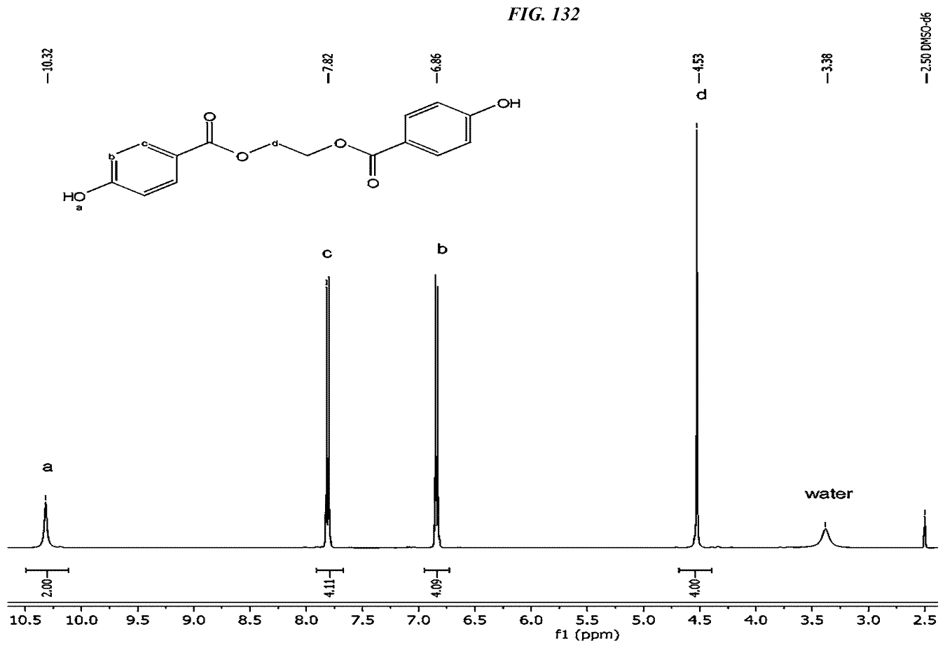

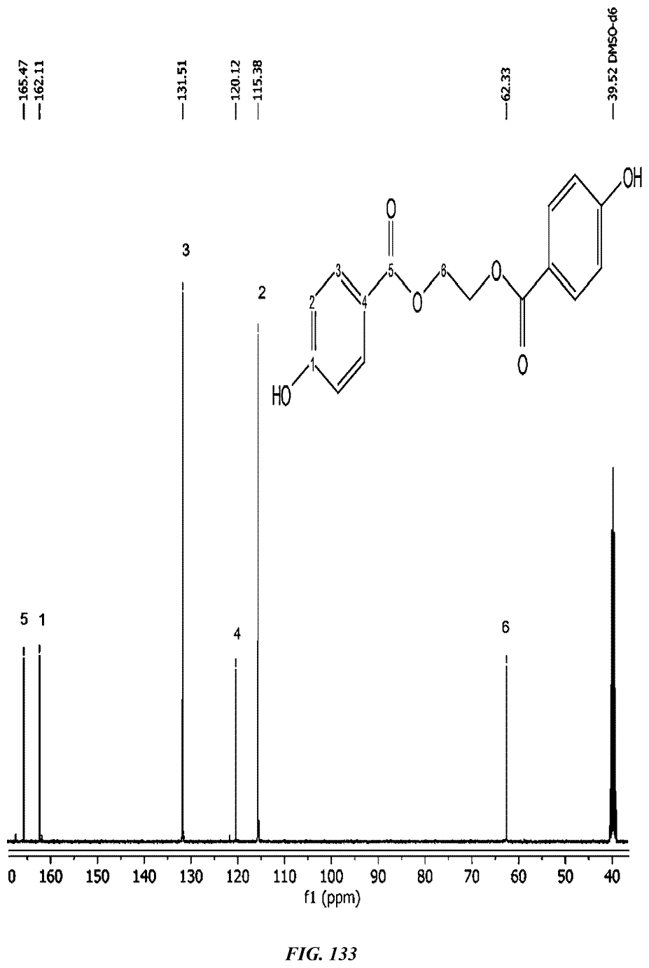

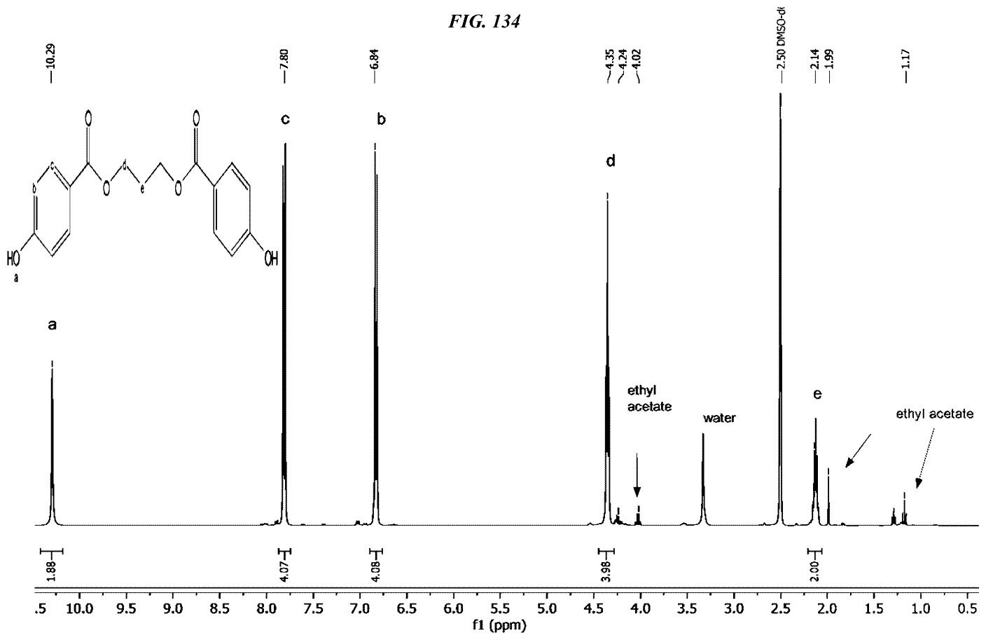

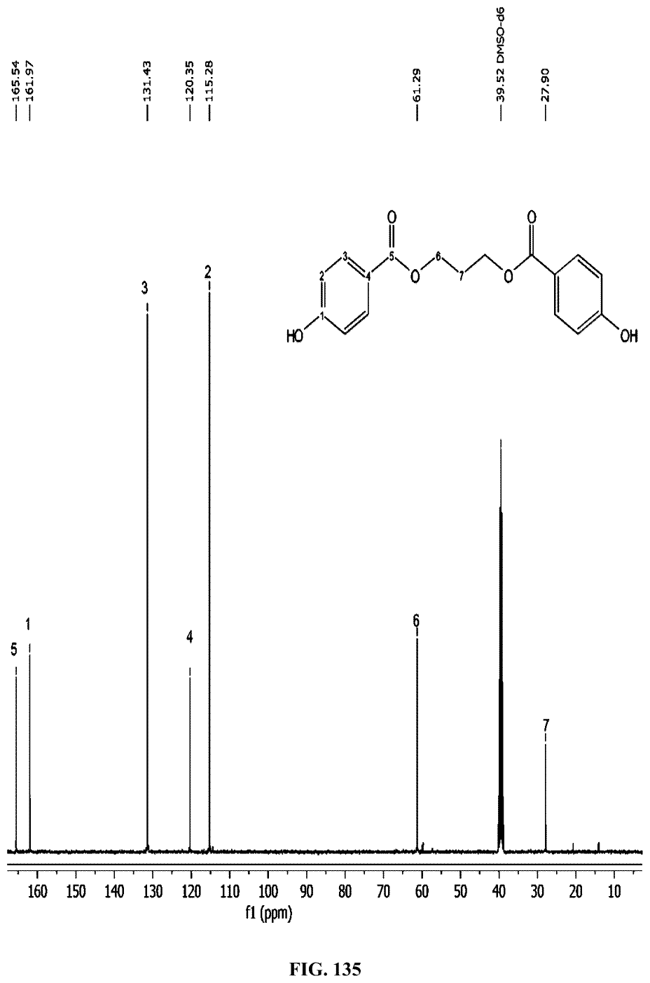

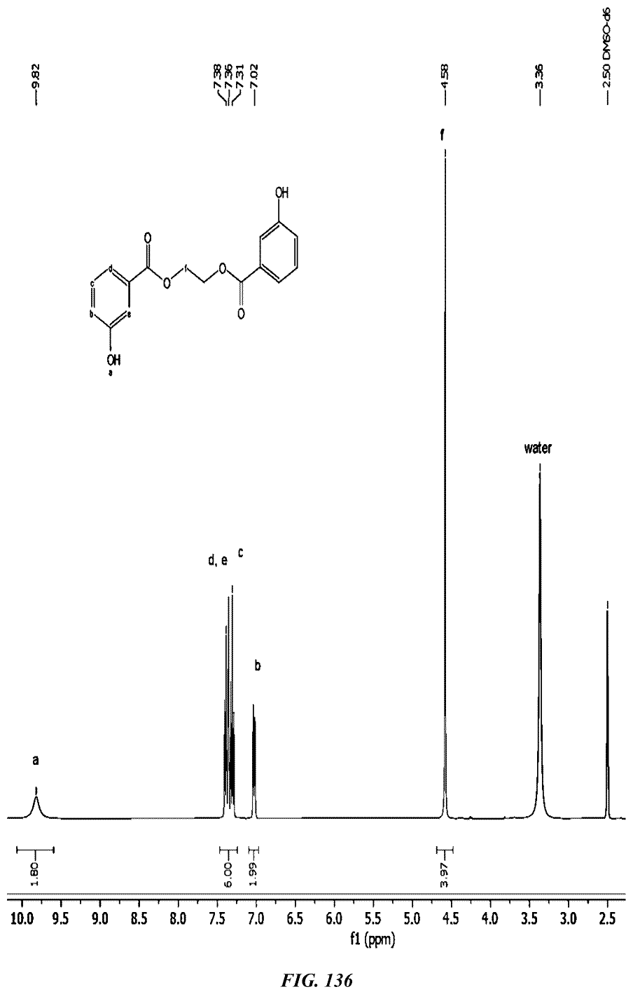

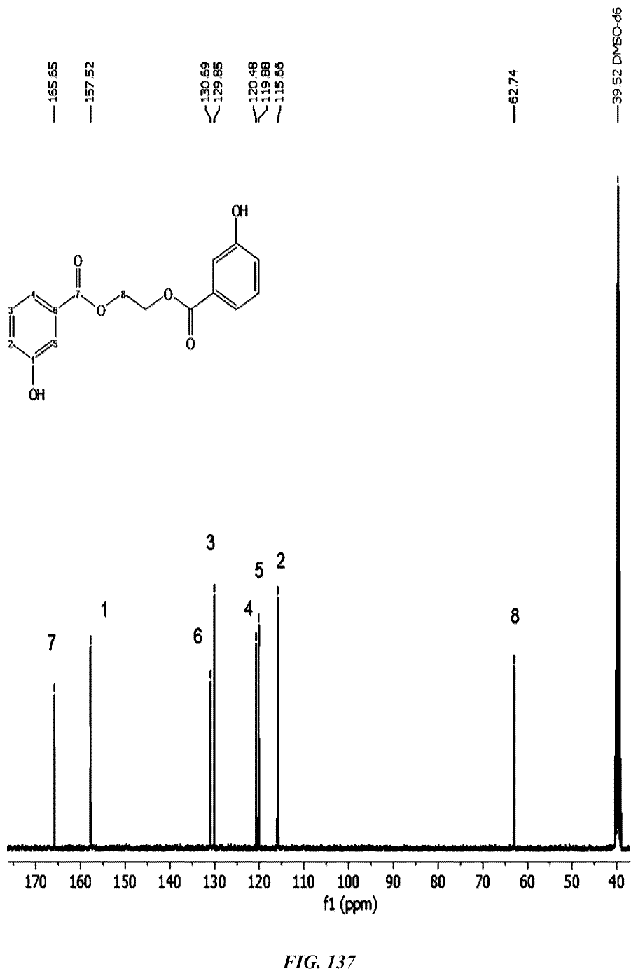

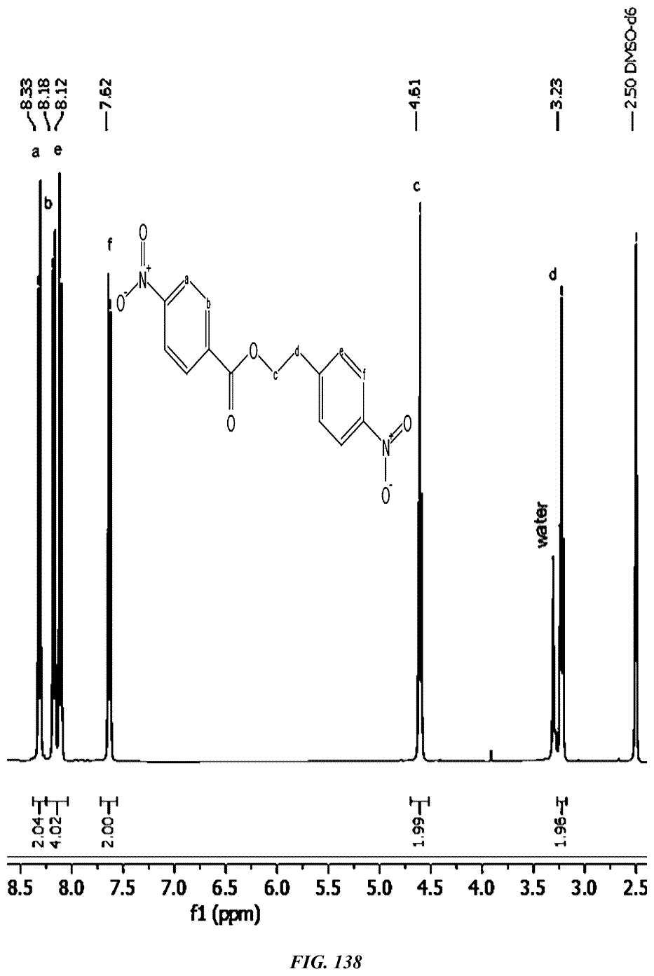

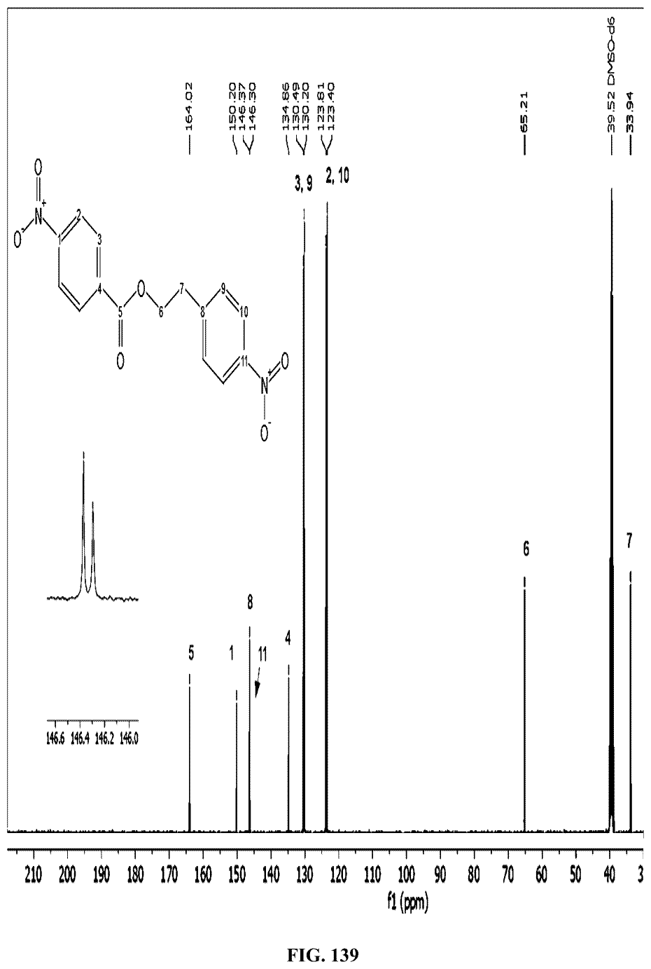

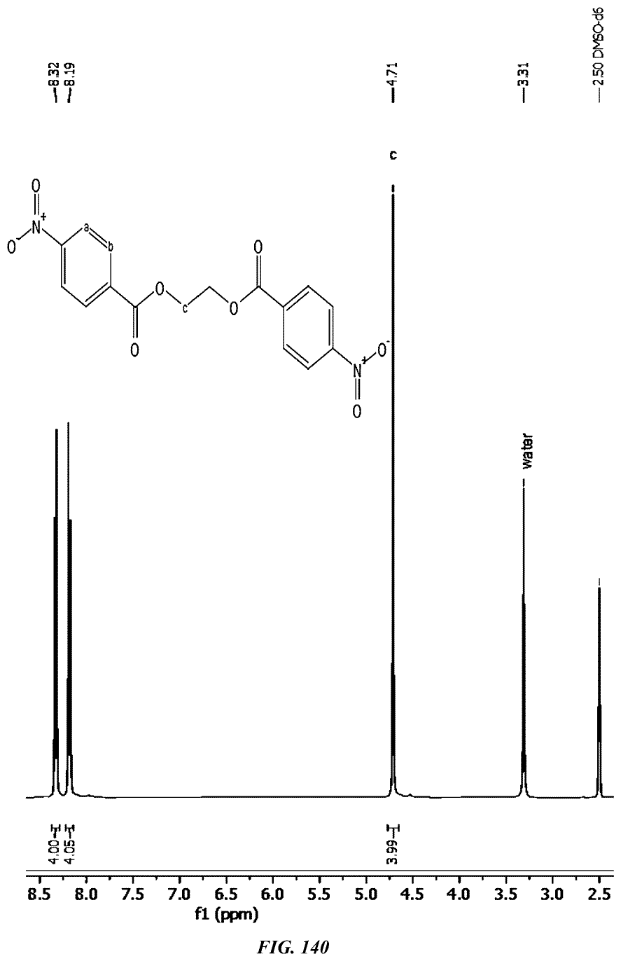

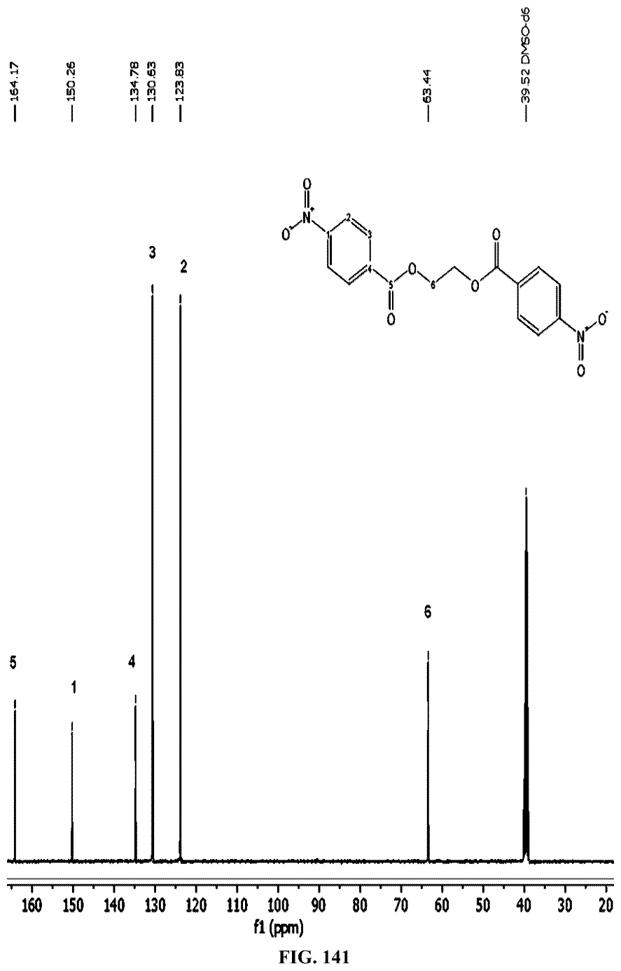

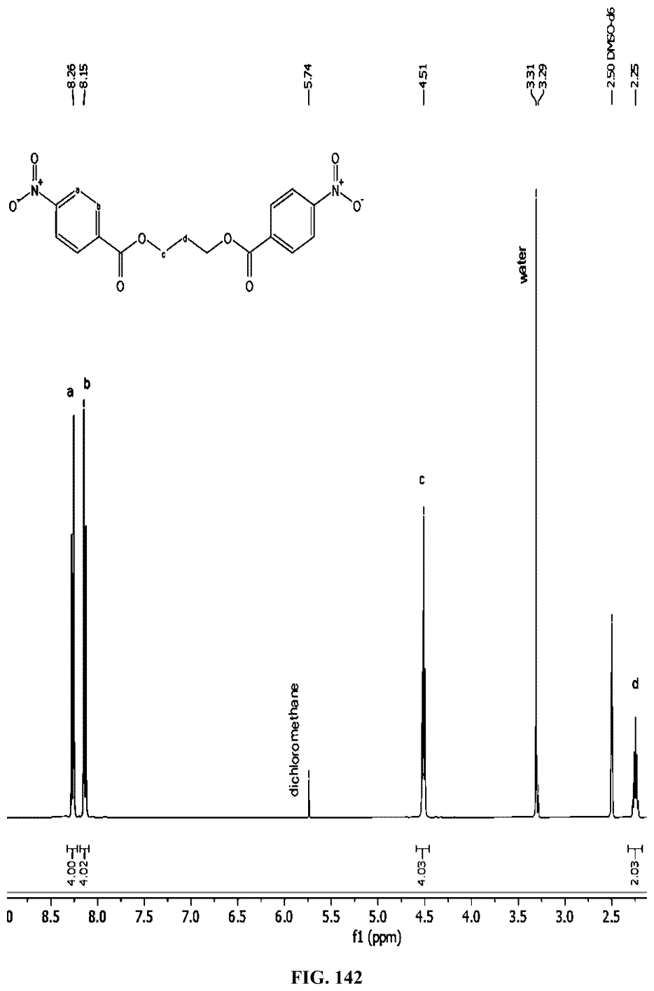

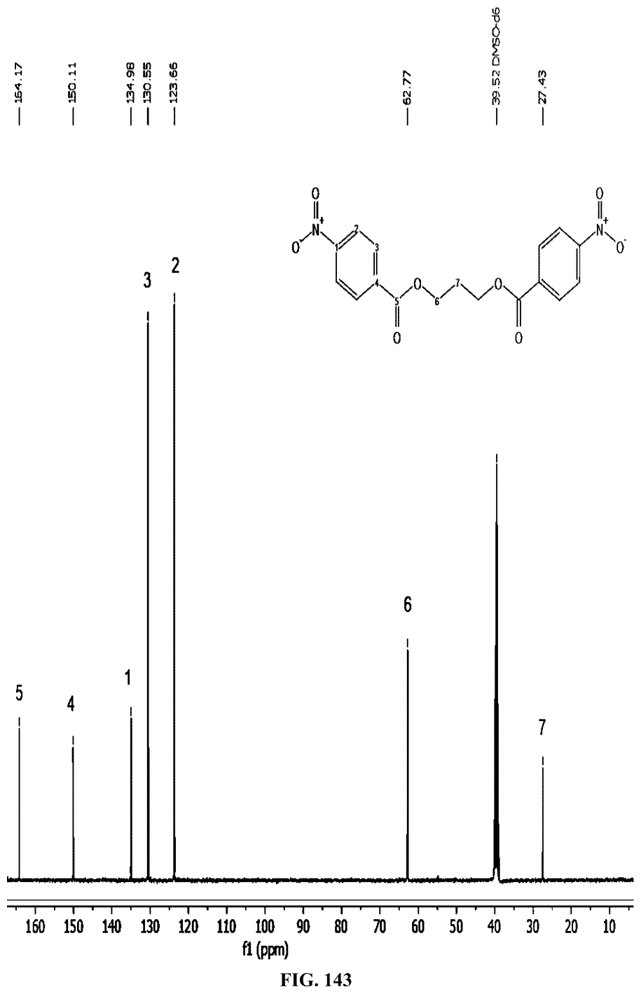

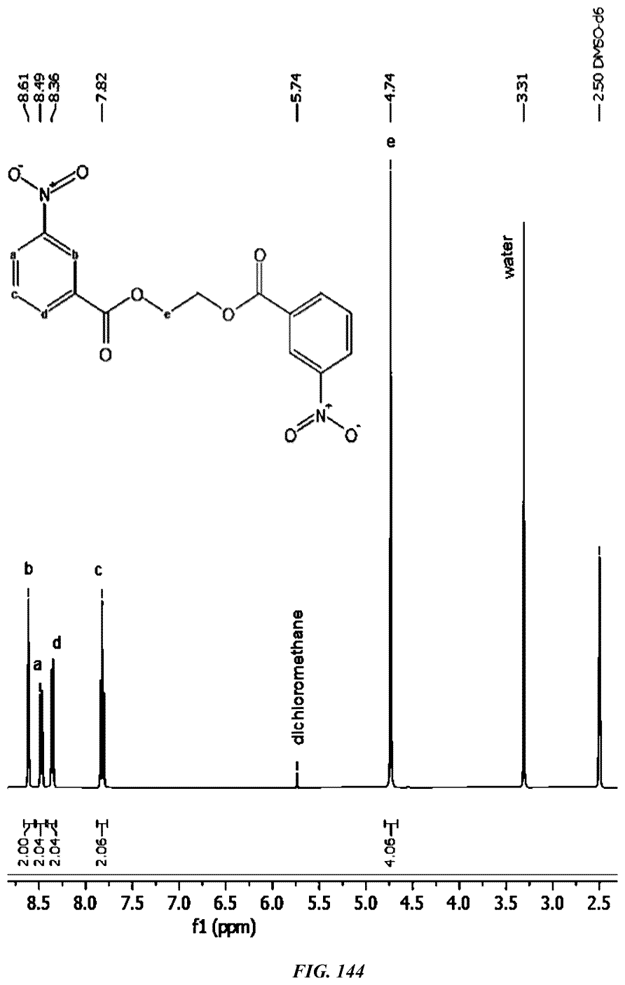

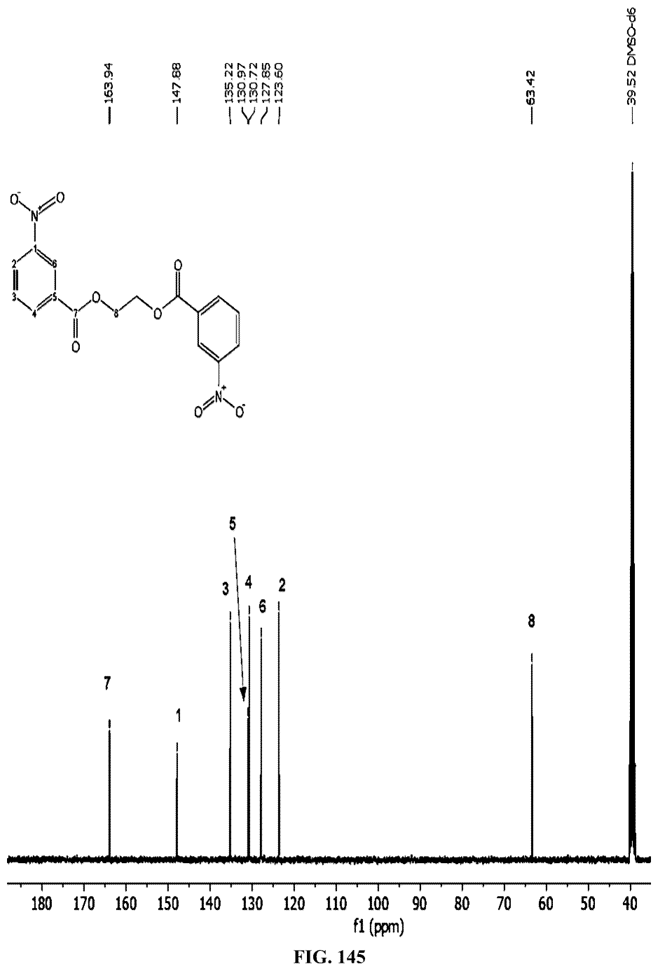

The presence of ester functionality enabled depolymerization of the polyester networks as illustrated in FIG. 129A. Ambient pressure glycolysis was leveraged to compare the degradability of the different polyester networks to one another, to one of the DGEBA reference networks, and to poly(ethylene terephthalate)—a benchmark thermoplastic polyester whose ability to undergo hydrolysis, methanolysis, and glycolysis and has been extensively studied and practiced. FIG. 129B shows the results of the mass-loss experiments for 1 mm×14 mm discs under the following evaluation conditions: 190° C., 100:1 by mass ethylene glycol on polymer and 1% Zn(OAc)₂ catalyst by mass. As indicated, the commercially-sourced PET completely degraded within 6 h—faster than any of the thermoset polyesters examined. In contrast, the DGEBA-4,4′-DDS exhibited no evidence of degradation over the 54 h experiment. For the polyester networks, the observed rates of degradation were governed by ethylene glycol diffusion into the network, relative susceptibility of the ester linkages to glycolysis, and the overall ester content. The ASYM4-ASYM4 network exhibited the slowest degradation (54 h), consistent with substantially lower ester content relative to the other polyester networks. The rate of ester glycolysis is affected by the susceptibility of the ester to nucleophilic attack, which is influenced by substitution pattern. In meta-substituted esters (ex. in E3-E3), electron density at the ester carbonyl is lower than equivalent para-substituted esters (ex. in E4-E4) due to resonance effects; the lower electron density increases electrophilicity of the carbonyl carbon and increases degradation rate. As shown in FIG. 129B, the E3-E3 network exhibited the fastest degradation (8 h), followed by E4-E3 and E4-E4 (10 h). The length of the aliphatic spacer also influenced degradation rate. Networks that contained propyl linkers degraded slower than their ethyl-linked counterparts, likely attributed to a decrease in ester density (Table 10) due to dilution by aliphatic content and diminished ethylene glycol permeability. For instance, the E4-P4 network reached complete dissolution in 12 h, whereas the fully propyl-spaced P4-P4 network dissolved in 30 h under identical conditions.

Although the degradation products at the zero-mass point for each network were completely soluble in ethylene glycol at 190° C., these products were insoluble at room temperature—an indication of incomplete alcoholysis. To evaluate the product obtained from complete alcoholysis, E4-P4 specimens were maintained at 190° C. for two days. In this case, solubility in ethylene glycol was retained upon cooling to ambient temperature, and precipitation was possible by addition of water (3:1 water to ethylene glycol). FIG. 129C shows the ¹H NMR spectrum of the isolated degradation product—a white solid recovered in 67% yield after filtration, rinsing with water, and drying. The integral ratios and peak assignments closely align with the expected structure of the product depicted in FIG. 129A. The recovered product differs structurally from the epoxy and amine monomers used to prepare the network, so the process employed here does not constitute a fully circular pathway for direct recycling to the initial monomers. While all polyester networks exhibited degradability, a comprehensive life cycle assessment is necessary to determine the economic viability and environmental practicality of implementing this depolymerization and product recovery strategy.

Compared to conventional DGEBA-based systems, these networks exhibited significantly improved fracture toughness, impact resistance, and adhesive performance, while maintaining comparable strength and modulus. The introduction of meta substitution and variations in spacer length systematically influenced thermal and mechanical properties, highlighting the tunability of these networks. Importantly, the presence of ester linkages enabled depolymerization under glycolysis conditions, demonstrating potential for sustainable end-of-life processing. These findings provide a foundation for the design of high-performance, recyclable thermosets with tailored mechanical properties.

Silica is a widely used particulate filler in epoxy thermosets. Several properties may be improved by addition of silica to epoxy to include decreased coefficient of thermal expansion (CTE). Decreased CTE translates to higher dimensional stability and can help prevent debonding to metals and augment resistance to thermal shock. Silica also has low electrical conductivity—important for electronic applications. A possible end-use of epoxy/silica composites is epoxy-based molding compounds for such applications. However, strength and elongation are understood to generally decrease with addition of particulate fillers.

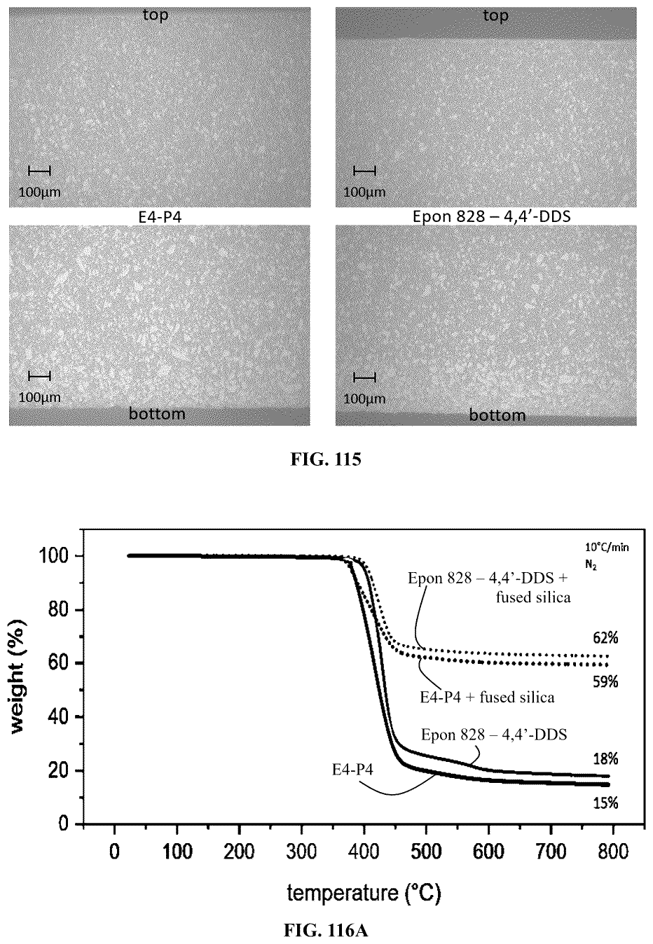

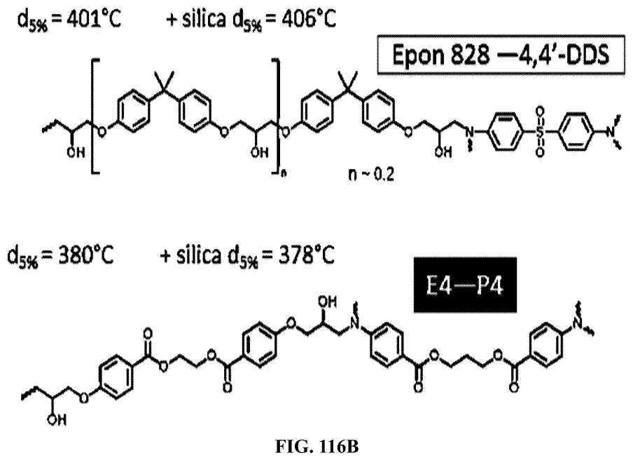

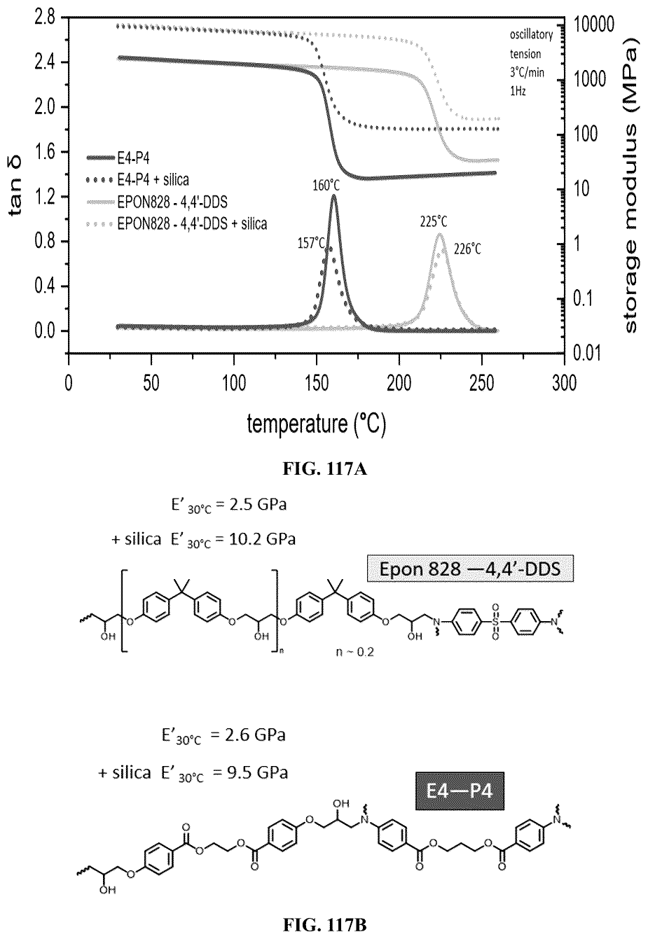

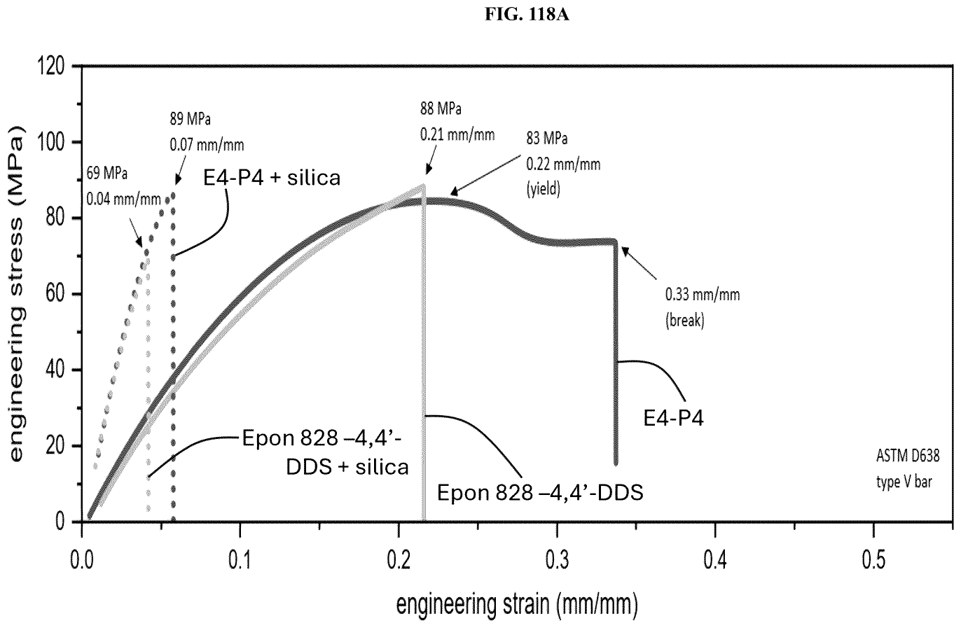

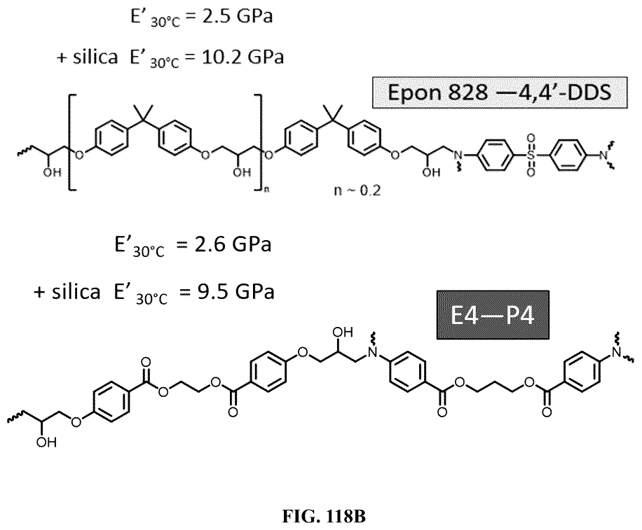

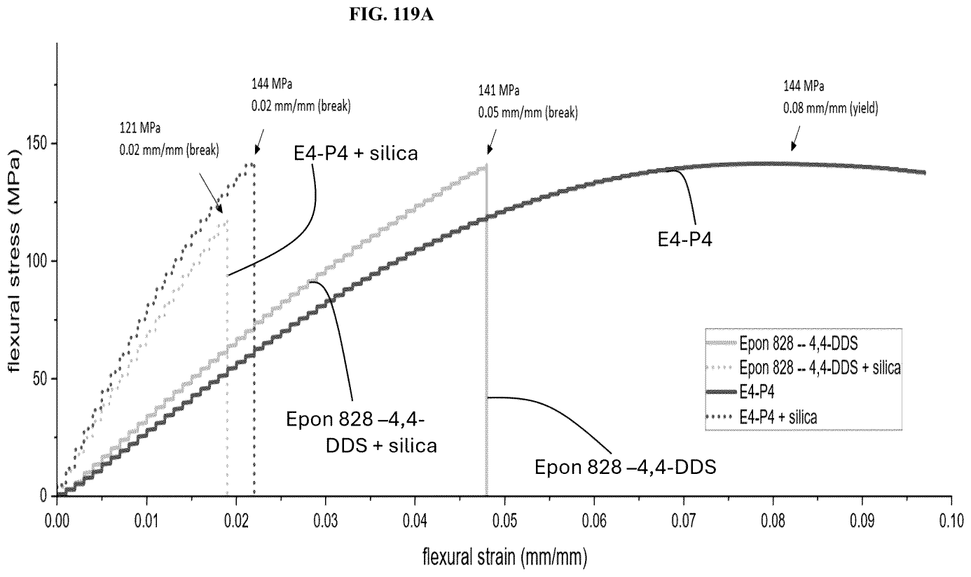

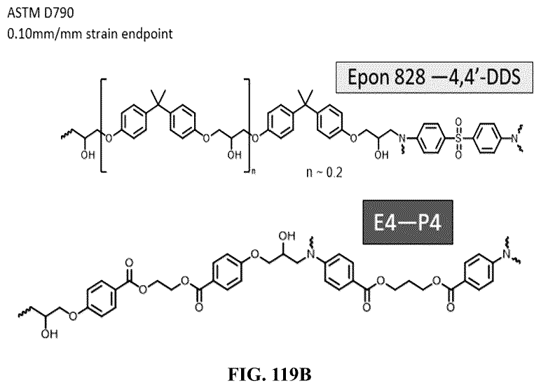

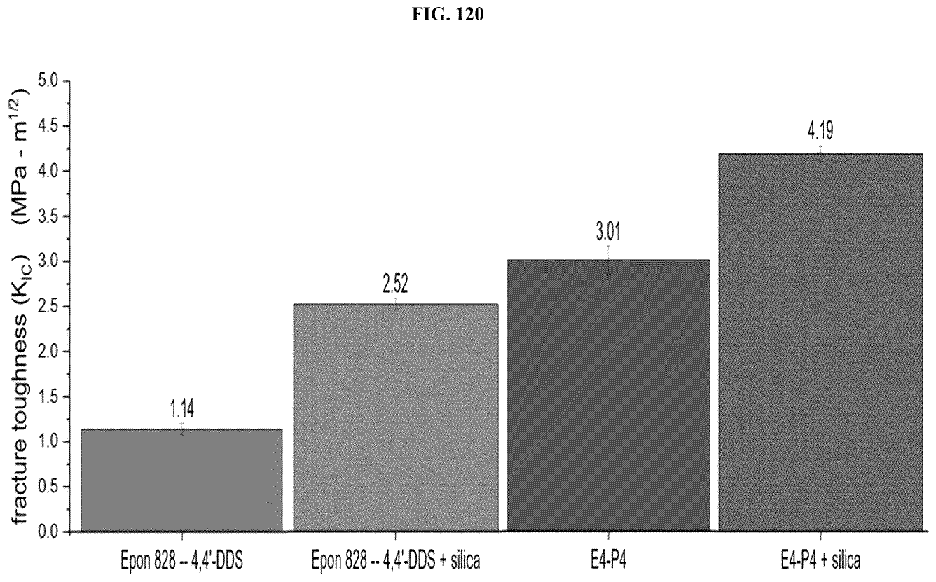

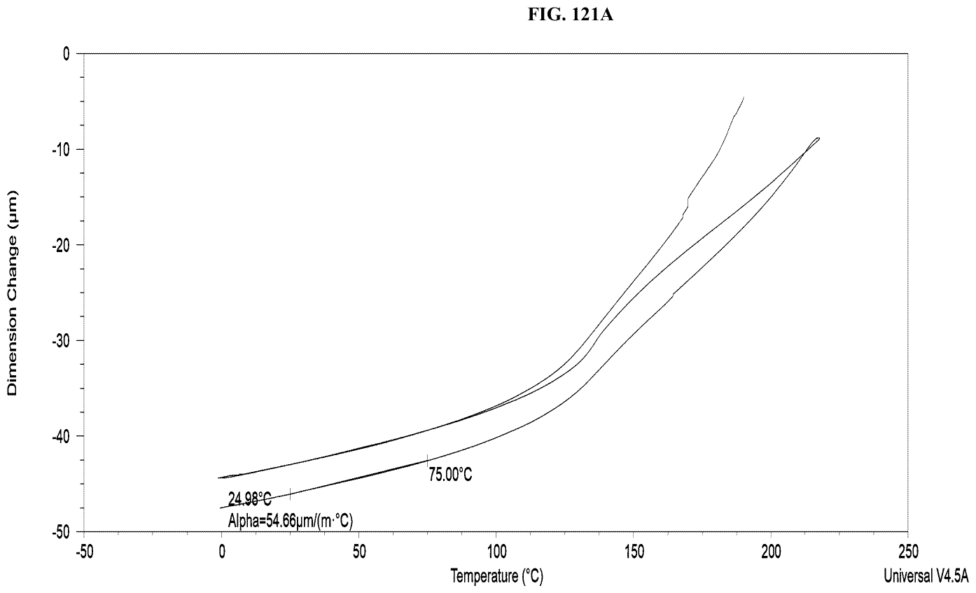

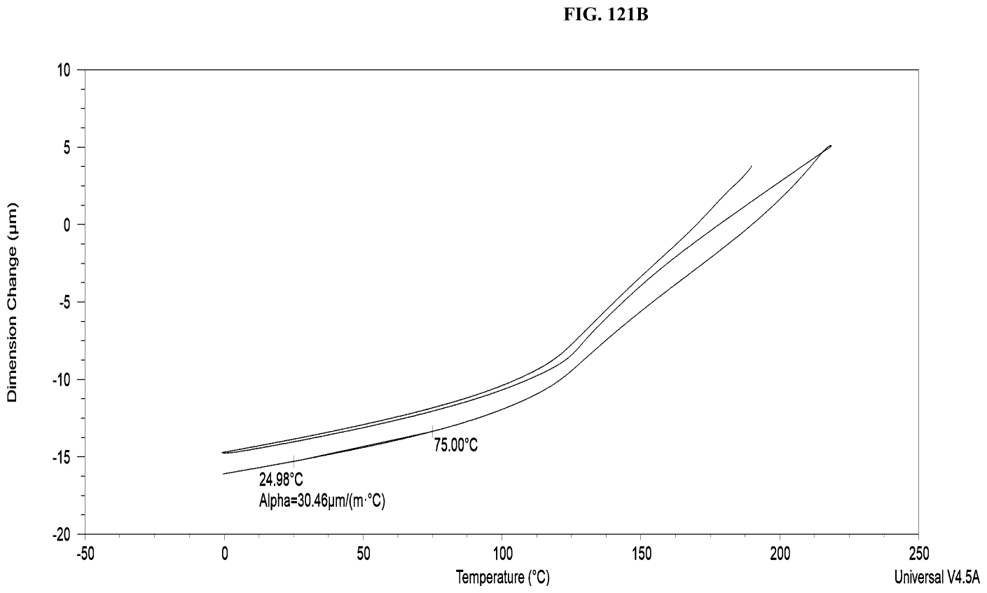

An epoxy/amine-derived polyester composite material was formed from 50 weight % fused silica (325 mesh, unsized), 36.25 weight % (ester-containing epoxy resin, ethyl-1,2-bis-4-glycidyloxybenzoate), and 13.75 weight % (ester-containing diamine hardener, propyl-1,3-bis-4-aminobenzoate). The same protocol for curing was employed. Thermal stability as measured by d_{5%} temperature via thermogravimetric analysis was unaffected by the presence of silica (+/−1%). Glassy storage modulus at 30° C. was about 3.8× higher for the composite vs equivalent unfilled system (˜9.97 GPa vs. ˜2.59 GPa), and rubbery plateau modulus was about 5.7× higher for the composite (˜97.1 GPa vs. ˜16.9 GPa). The modulus increase corresponded to a decrease in tensile elongation at break (33% to 7%) when comparing the unfilled system and the composite using the polymer claimed in the present invention. Tensile strength was maintained in the composite (89 MPa for composite vs. 83 MPa for equivalent unfilled material). This is atypical of aromatic epoxy/silica systems; in general—addition of particulate fillers prompts decreases in tensile strength. Flexural strength was also maintained (0% change) in the composite, and flexural modulus increased from 2.7 GPa to 7.4 GPa. Plane-strain fracture toughness (K_{IC}) increased from 3.01 MPa-m^{1/2} to 4.19 MPa-m^{1/2}. Coefficient of thermal expansion (CTE) decreased 44% in comparison to the unfilled material. See FIGS. 115-121.

TABLE 8
Extent of cure information obtained by comparison of initial and residual
polymerization enthalpies for polyester and reference systems.
Extent of cure information obtained by comparison of initial and residual
polymerization enthalpies for polyester and reference systems.

| | cure | cure | residual | residual | residual | calculated |
|---|---|---|---|---|---|---|
| network | enthalpy, | enthalpy, | enthalpy, | enthalpy, | enthalpy, | extent of cure |
| identification | round 1 (J/g) | round 2 (J/g) | round 3 (J/g) | round 1 (J/g) | round 2 (J/g) | (%) |
| DGEBA- | 505.84 | 435.35 | 506.02 | 7.1104 | 10.744 | 98.149 |
| 4,4′-DDM | | | | | | |
| DGEBA- | 379.09 | 423.13 | 387.90 | 19.245 | 16.966 | 95.436 |
| 4,4′-DDS | | | | | | |
| Epon828- | 444.82 | 444.82 | 432.94 | 16.635 | 13.798 | 96.548 |
| 4,4′-DDS | | | | | | |
| DGEBA- | 429.18 | 376.71 | 464.72 | 18.137 | 15.874 | 95.985 |
| 3,3′-DDS | | | | | | |
| ASYM4- | 318.12 | 305.66 | 363.30 | 23.448 | 17.314 | 93.806 |
| ASYM4 | | | | | | |
| E4--E4 | 333.12 | 336.47 | 339.82 | 12.749 | 15.662 | 95.778 |
| E4--P4 | 345.76 | 366.48 | 417.95 | 14.113 | 11.845 | 96.555 |
| P4--P4 | 381.69 | 401.97 | 356.68 | 21.187 | 15.907 | 95.121 |
| E4--E3 | 480.04 | 397.78 | 355.30 | 20.587 | 15.098 | 95.659 |
| E3--E3 | 418.22 | 336.09 | 382.52 | 19.596 | 18.638 | 94.955 |

TABLE 9
Overview of polyester and reference network densities (obtained by Archimedes principle),
component molar masses and theoretical molecular weight between crosslinks and crosslink density
Overview of polyester and reference network densities (obtained by Archimedes principle),
component molar masses and theoretical molecular weight between crosslinks and crosslink density

| | | | | | | weighted | | |
|---|---|---|---|---|---|---|---|---|
| | ρ (mass | molar | molar | diepoxide | diamine | average | mol | mol |
| | (g) of | mass of | mass of | strand | strand | molar mass | crosslinks | crosslinks |
| | network/ | diepoxide | diamine | molar | molar | between | per cm³ | per m³ |
| network | cm³) | (g/mol) | (g/mol) | mass | mass | crosslinks | network | network |
| DGEBA -- | 1.2002 | 340.42 | 198.27 | 342.42 | 196.27 | 294 | 0.0081729 | 8173 |
| 4,4′-DDM | | | | | | | | |
| DGEBA -- | 1.2423 | 340.42 | 248.3 | 342.42 | 246.3 | 310 | 0.0080050 | 8005 |
| 4,4′-DDS | | | | | | | | |
| EPON828 -- | 1.2421 | 374* | 248.3 | 376 | 246.3 | 333 | 0.0074653 | 7465 |
| 4,4′-DDS | | | | | | | | |
| DGEBA -- | 1.2438 | 340.42 | 248.3 | 342.42 | 246.3 | 310 | 0.0080147 | 8015 |
| 3,3′-DDS | | | | | | | | |
| ASYM4- | 1.2742 | 370.4 | 256.31 | 372.4 | 254.31 | 333 | 0.0076520 | 7652 |
| ASYM4 | | | | | | | | |
| E4-E4 | 1.3144 | 414.41 | 300.31 | 416.41 | 298.31 | 377 | 0.0069721 | 6972 |
| E4-P4 | 1.3061 | 414.41 | 314.34 | 416.41 | 312.34 | 382 | 0.0068432 | 6843 |
| P4-P4 | 1.2991 | 428.44 | 314.34 | 430.44 | 312.34 | 391 | 0.0066438 | 6644 |
| E4-E3 | 1.3161 | 414.41 | 300.31 | 416.41 | 298.31 | 377 | 0.0069812 | 6981 |
| E3-E3 | 1.3193 | 414.41 | 300.31 | 416.41 | 298.31 | 377 | 0.0069981 | 6998 |

TABLE 10
Table 10 shows an overview of polyester and reference network
functional group equivalent weights/concentrations.
Overview of polyester and reference network functional group
equivalent weights/concentrations.

| | | | calculated | | calculated | | |
|---|---|---|---|---|---|---|---|
| | molecular | hydroxyl | hydroxyl | ester | ester | | |
| | weight of | groups | equivalent | groups | equivalent | calculated | calculated |
| | repeat | per | weight | per | weight | hydroxyl | ester |
| | unit | repeat | (g/mol | repeat | (g/mol | concentration | concentration |
| network | (g/mol) | unit* | hydroxyl) | unit | ester) | (mol/cm³) | (mol/cm³) |
| DGEBA- | 879.11 | 2 | 440 | 0 | N/A | 0.00273 | N/A |
| 4,4′-DDM | | | | | | | |
| DGEBA- | 929.14 | 2 | 465 | 0 | N/A | 0.00267 | N/A |
| 4,4′-DDS | | | | | | | |
| EPON828-- | 997.94 | — | 449 | 0 | N/A | 0.00276 | N/A |
| 4,4′- | | | | | | | |
| DDS ** | | | | | | | |
| DGEBA- | 929.14 | 2 | 465 | 0 | N/A | 0.00268 | N/A |
| 3,3′-DDS | | | | | | | |
| ASYM4-- | 997.11 | 2 | 499 | 2 | 249 | 0.00256 | 0.00511 |
| ASYM4 | | | | | | | |
| E4--E4 | 1129.13 | 2 | 565 | 4 | 141 | 0.00233 | 0.00931 |
| E4--P4 | 1142.16 | 2 | 571 | 4 | 143 | 0.00229 | 0.00915 |
| P4--P4 | 1171.22 | 2 | 586 | 4 | 146 | 0.00222 | 0.00887 |
| E4--E3 | 1129.13 | 2 | 565 | 4 | 141 | 0.00233 | 0.00932 |
| E3--E3 | 1129.13 | 2 | 565 | 4 | 141 | 0.00234 | 0.00935 |

*repeat unit derived from 2 equivalents of diepoxide and 1 equivalent of diamine (1:1 epoxide ring to amine hydrogen)

### EXAMPLES

### Example Syntheses of Bisphenol Precursor Compounds to Ester-Containing Diepoxide Monomers.

4-hydroxyphenethyl 2-(4-hydroxyphenyl)acetate (pHPAA-tyrosol bisphenol). 0.231 mol of tyrosol and 0.229 mol of (4-hydroxyphenyl)acetic acid (pHPAA) were added to a 1 L round bottom flask. 700 mL of toluene was added, and magnetic agitation was initiated. 0.016 mol of phosphoric acid was added, and a Dean Stark trap and a condenser were connected to the flask. The reaction was allowed to proceed for about 7 hours (the point of collection of the theoretical byproduct water volume in the trap), then cooled to near ambient temperature. When the agitation was stopped, a beige-pink product layer underneath the toluene was apparent. The toluene was decanted, and the product layer was dissolved in 300 mL of ethyl acetate. Four rinses with 100 mL of 5 w/w % NaHCO₃ in water and two rinses with 100 mL DI water were performed. Anhydrous MgSO₄ was added, and the product (a white solid) was concentrated by rotary evaporation and used without further purification. Yield=74% (84% at 3× the scale described). 1H NMR (400 MHz, DMSO) δ 9.22 (s, 1H), 6.98 (dd, J=10.7, 8.2 Hz, 4H), 6.67 (t, J=8.7 Hz, 4H), 4.13 (t, J=6.9 Hz, 2H), 3.47 (s, 2H), 2.72 (t, J=6.9 Hz, 2H). ¹³C NMR (101 MHz, DMSO) δ 171.44 (C), 156.21 (C), 155.85 (C), 130.23 (CH), 129.76 (CH), 127.90 (C), 124.42 (C), 115.14 (CH), 115.12 (CH), 65.04 (CH₂), 39.63 (CH₂), 33.56 (CH₂).

4-hydroxyphenethyl 3-(4-hydroxyphenyl)propanoate (pHPPA-tyrosol bisphenol). The same process as for the pHPAA-tyrosol bisphenol was used except that 3-(4-hydroxyphenyl)propanoic acid (pHPPA) was used as the phenolic carboxylic acid component, and that the crude product was washed in solid form (the product was a white solid) and used without further purification. Yield=78% (86% at 3× the scale described). ¹H NMR (400 MHz, DMSO) δ 9.19 (s, 2H), 7.01-6.90 (m, 4H), 6.70-6.59 (m, 4H), 4.10 (t, J=7.0 Hz, 2H), 2.69 (dt, J=10.7, 7.3 Hz, 4H), 2.49 (t, J=7.0 Hz, 2H). ¹³C NMR (101 MHz, DMSO) δ 172.20 (C), 155.87 (C), 155.61 (C), 130.50 (C), 129.71 (CH), 129.04 (CH), 127.89 (C), 115.16 (CH), 115.09, 64.72 (CH₂), 35.62 (CH₂), 33.57 (CH₂), 29.51 (CH₂).

2-1[(4-hydroxyphenyl)acetyloxy]ethyl 4-hydroxyphenylacetate (pHPA4-ethylene glycol bisphenol). The process used followed the general process described for the pHPAA-tyrosol bisphenol. 0.231 mol of ethylene glycol (dehydrated with 3A molecular sieves), 0.508 mol of pHPAA, and 0.0231 mol of H₃PO₄ were used. The reaction proceeded for about 8 hours, and upon cooldown the beige-pink liquid product transformed into a white solid. The product exhibited limited solubility in ethyl acetate; 800 mL ethyl acetate was used to solubilize the crude product. Yield=86%. The dissolved product was washed in the same manner as the pHPAA-tyrosol bisphenol and used without further purification. ¹H NMR (400 MHz, DMSO) δ 9.29 (s, 2H), 7.08-7.00 (m, 4H), 6.76-6.67 (m, 4H), 4.22 (s, 2H), 3.50 (s, 2H). ¹³C NMR (101 MHz, DMSO) δ 171.42 (C), 156.27 (C), 130.24 (CH), 124.26 (C), 115.14 (CH), 62.05 (CH₂), 39.31 (CH₂).

2-[3-(4-hydroxyphenyl)propanoyloxy]ethyl 3-(4-hydroxyphenyl)propanoate (pHPPA-ethylene glycol bisphenol). The process used followed the general process described for the pHPAA-tyrosol bisphenol. 0.231 mol of ethylene glycol (dehydrated with 3A molecular sieves), 0.508 mol of pHPPA, and 0.0231 mol of H₃PO₄ were used. The reaction proceeded for about 8 hours; the product remained a brownish liquid upon cooldown and formed a white solid upon concentration following NaHCO₃ and water washes. Yield=80%. ¹H NMR (400 MHz, DMSO) δ 9.14 (s, 2H), 7.04-6.95 (m, 4H), 6.70-6.62 (m, 4H), 4.18 (s, 4H), 3.34 (s, 2H), 2.73 (t, J=7.5 Hz, 4H), 2.55 (t, J=7.5 Hz, 4H). ¹³C (101 MHz, DMSO) δ 172.16 (C), 155.61 (C), 130.45 (C), 129.06 (CH), 115.08 (CH), 61.85 (CH₂), 35.39 (CH₂), 29.42 (CH₂).

2-[(4-hydroxyphenyl)acetyloxy]propyl 4-hydroxyphenylacetate (pHPAA-1,3-propanediol bisphenol). The process used followed the general process described for the pHPAA-tyrosol bisphenol. 0.231 mol of 1,3-propanediol (dehydrated with 3A molecular sieves), 0.508 mol of pHPAA, and 0.0231 mol of H₃PO₄ were used. The reaction proceeded for about 8 hours, and the product remained a beige-pink liquid on cooldown. 88% yield (white solid). ¹H NMR (400 MHz, DMSO) δ 9.28 (s, 2H), 7.08-7.00 (m, 4H), 6.74-6.66 (m, 4H), 4.06 (t, J=6.4 Hz, 4H), 3.52 (s, 4H), 1.87 (p, J=6.4 Hz, 2H). ¹³C (101 MHz, DMSO) δ 171.49 (C), 156.21 (C), 130.19 (CH), 124.42 (C), 115.13 (CH), 60.91 (CH₂), 39.46 (CH₂), 27.52 (CH₂).

2-[3-(4-hydroxyphenyl)propanoyloxy]propyl 3-(4-hydroxyphenyl)propanoate (pHPPA-1,3-propanediol bisphenol). The process used followed the general process described for the pHPAA-tyrosol bisphenol. 0.231 mol of 1,3-propanediol (dehydrated with 3A molecular sieves), 0.508 mol of pHPPA, and 0.0231 mol of H₃PO₄ were used. The reaction proceeded for about 8 hours, and the product remained a brownish liquid on cooldown. The washed and concentrated product remained a reddish-brown liquid at ambient temperature for a period and gradually crystallized. 88% yield (repeating with dehydrated 1,3-propanediol, more careful workup). ¹H NMR (400 MHz, DMSO) δ 9.14 (s, 2H), 7.03-6.95 (m, 4H), 6.70-6.62 (m, 4H), 4.02 (t, J=6.3 Hz, 4H), 2.73 (t, J=7.6 Hz, 4H), 2.54 (t, J=7.6 Hz, 4H), 1.82 (p, J=6.4 Hz, 2H). ¹³C (101 MHz, DMSO) δ 172.23 (C), 155.61 (C), 130.48 (C), 129.04 (CH), 115.08 (CH), 60.66 (CH₂), 35.48 (CH₂), 29.50 (CH₂), 27.58 (CH₂).

4-hydroxyphenethyl-4-hydroxybenzoate (pHBA-tyrosol bisphenol). 0.420 mol of ethyl 4-hydroxybenzoate and 0.400 mol of 4-(2-hydroxyethyl)phenol (tyrosol) were added to a 250 mL round bottom flask. The temperature was increased to the point that the methyl 4-hydroxybenzoate was molten, and 0.0044 mol of dibutyltin dilaurate was added under magnetic agitation. A Dean Stark trap for collection of byproduct ethanol was connected to the flask in line with a condenser. The flask contents were further heated to about 200° C. and allowed to react for 22 hours. The trap and condenser were removed in the final hours of the reaction. A nitrogen line was added the temperature was incrementally increased to 240° C. The crude product—a solid at 240° C.—was cooled to ambient temperature, pulverized, washed two times with ethyl acetate to remove the dibutyltin dilaurate and residual ethyl paraben, and used without further purification. Yield=78% (a white solid). ¹H NMR (400 MHz, DMSO) δ 10.26 (s, 2H), 9.21 (s, 2H), 7.81-7.74 (m, 4H), 7.11-7.05 (m, 4H), 6.88-6.80 (m, 4H), 6.73-6.65 (m, 4H), 4.33 (t, J=6.8 Hz, 4H), 2.87 (t, J=6.9 Hz, 4H). ¹³C NMR (101 MHz, DMSO) δ 165.72 (C), 162.16 (C), 156.06 (C), 131.56 (CH), 129.87 (CH), 128.32 (C), 120.69 (C), 115.53 (CH), 115.39 (CH), 65.25 (CH₂), 33.95 (CH₂).

Ethyl-1,2-bis-4-hydroxybenzoate (pHBA-ED bisphenol). 0.260 mol of methyl p-hydroxybenzoate and 0.520 mol ethylene glycol were added to a 250 mL 1-neck round bottom flask. The temperature was increased to the point that the methyl 4-hydroxybenzoate was molten, and 0.0029 mol of dibutyltin dilaurate was added under magnetic agitation. The flask was fitted with a Dean-Stark trap and a condenser to collect byproduct methanol. The flask was insulated, and the temperature was increased to 170-180° C. When the transesterification reaction proceeded for 10 hours, the temperature was lowered to 100° C. and the trap and condenser were replaced with a short path vacuum distillation apparatus and receiving flask. Vacuum was applied via a 0.9 CFM rotary vane pump and the temperature was gradually increased to 180° C. to control the distillation of free ethylene glycol. The ester interchange reaction proceeded at 180° C. for 8 hours. At ambient temperature, the solid crude product was thoroughly pulverized with a mortar and pestle, and washed 2× in a beaker under agitation with diethyl ether to remove the transesterification catalyst. Yield=84% (a white solid). 1H NMR (400 MHz, DMSO) δ 10.32 (s, 2H), 7.85-7.76 (m, 4H), 6.88-6.79 (m, 4H), 4.53 (s, 4H). 13C NMR (101 MHz, DMSO) 165.47 (C), 162.11 (C), 131.51 (CH), 120.12 (C), 115.38 (CH), 62.33 (CH₂).

Ethyl-1,2-bis-3-hydroxybenzoate (mHBA-ED bisphenol). 0.260 mol of methyl m-hydroxybenzoate and 0.520 mol ethylene glycol were added to a 250 mL 1-neck round bottom flask. The temperature was increased to the point that the methyl p-hydroxybenzoate was molten, and 0.0029 mol of dibutyltin dilaurate was added under magnetic agitation. The flask was fitted with a Dean-Stark trap and a condenser to collect byproduct methanol. The flask was insulated, and the temperature was increased to 170-180° C. When the transesterification reaction proceeded for 11 hours, the temperature was lowered to 100° C. and the trap and condenser were replaced with a short path vacuum distillation apparatus and receiving flask. Vacuum was applied via a 0.9 CFM rotary vane pump and the temperature was gradually increased to 180° C. to control the distillation of free ethylene glycol. The ester interchange reaction proceeded at 180° C. for 8 hours. At ambient temperature, the solid crude product was thoroughly pulverized with a mortar and pestle, and washed 2× in a beaker under agitation with diethyl ether to remove the transesterification catalyst. Yield=87% (a white solid). ¹H NMR (400 MHz, DMSO) δ 9.83 (s, 1H), 7.45-7.34 (m, 2H), 7.31 (t, J=7.8 Hz, 1H), 7.03 (ddd, J=8.1, 2.6, 1.1 Hz, 1H), 4.59 (s, 2H). 13C NMR (101 MHz, DMSO) 165.65 (C), 157.52 (C), 130.69 (C), 129.85 (CH), 120.48 (CH), 119.88 (CH), 115.66 (CH), 62.74 (CH₂).

Propyl-1,3-bis-4-hydroxybenzoate (pHBA-PD bisphenol). 0.260 mol of methyl p-hydroxybenzoate and 0.130 mol 1,3-propanediol were added to a 250 mL 1-neck round bottom flask. The temperature was increased to the point that the methyl p-hydroxybenzoate was molten, and 0.058 mol of dibutyltin dilaurate were added under magnetic agitation. The flask was fitted with a Dean-Stark trap and a condenser to collect byproduct methanol, and the flask was insulated, and the temperature was increased to 170-180° C. When the transesterification reaction proceeded for 10 hours, the trap and condenser were removed and nitrogen flow was introduced to the headspace to promote the ester interchange reaction. At ambient temperature, the solid crude product was thoroughly pulverized with a mortar and pestle, and washed 2× in a beaker under agitation with diethyl ether to remove the transesterification catalyst. Yield=78% (a white solid). ¹H NMR (400 MHz, DMSO) δ 10.29 (s, 2H), 7.86-7.77 (m, 4H), 6.88-6.79 (m, 4H), 4.35 (t, J=6.2 Hz, 4H), 2.13 (h, J=6.6 Hz, 2H). ¹³C NMR (101 MHz, DMSO) δ 165.54 (C), 161.97 (C), 131.43 (CH), 120.35 (C), 115.28 (CH), 61.29 (CH₂), 27.90 (CH₂).

Generic ester-containing diepoxide synthesis description. 0.100 mol of bisphenol component, 0.010 mol of tetra-butylammonium bromide (TBAB), and 2.000 mol of epichlorohydrin were added to a 500 mL 1-neck round bottom flask. For certain diepoxides, a lower reaction scale was used (see below). The flask contents were agitated magnetically and heated to about 100° C. The epichlorohydrin completely solvated the bisphenols in all cases at this temperature. The bisphenol-epichlorohydrin coupling reaction was allowed to proceed for about 1 hour, then the flask temperature was lowered to about 27° C. via water bath application to the underside of the flask. 0.400 mol of sodium hydroxide in a 5M solution in water with 0.010 mol additional TBAB were added via an addition funnel to the flask, and the temperature was maintained in the range 25-30° C. for about 30 minutes. The flask contents were transferred to a 1 L separatory funnel; 350 mL of ethyl acetate (or dichloromethane where noted below) and 150 mL of DI water were used to rinse the flask contents into the separatory funnel. The organic phase was subjected to three additional DI water washes. The organic phase was dried using MgSO₄ and concentrated via rotary evaporation and then via Schlenk line briefly. Each monomer was then redissolved in dichloromethane, passed through a silica plug to remove TBAB, reconcentrated, and used without further purification.

### Example Syntheses of Ester-Containing Diepoxide Compounds

4-glycidyloxyphenethyl 2-(4-glycidyloxyphenyl)acetate (pHPAA-tyrosol diepoxide). 83% yield. mp. 83° C. EEW=194. ¹H NMR (400 MHz, CDCl₃) δ 7.18-7.11 (m, 2H), 7.08-7.02 (m, 2H), 6.90-6.78 (m, 4H), 4.31-4.14 (m, 4H), 3.95 (ddd, J=11.1, 5.6, 3.9 Hz, 2H), 3.53 (s, 2H), 3.41-3.26 (m, 2H), 2.95-2.79 (m, 4H), 2.75 (dd, J=4.9, 2.6 Hz, 2H). ¹³C NMR (101 MHz, CDCl₃) δ 171.75 (C), 157.70 (C), 157.32 (C), 130.49 (C), 130.44 (CH), 130.00 (CH), 126.82 (C), 114.82 (CH), 114.76 (CH), 68.93 (CH₂), 65.47 (CH₂), 50.24 (CH), 50.21 (CH), 44.74 (CH₂), 40.59 (CH₂), 34.24 (CH₂). m/z=407.14697 observed (407.146510 calculated).

4-glycidyloxyphenethyl 3-(4-glycidyloxyphenyl)propanoate (pHPPA-tyrosol diepoxide). 85% yield. mp. 70° C. EEW=198. ¹H NMR (400 MHz, CDCl₃) δ 7.15-7.04 (m, 4H), 6.89-6.79 (m, 4H), 4.28-4.14 (m, 4H), 3.94 (ddd, J=11.1, 5.6, 2.6 Hz, 2H), 3.33 (dp, J=8.0, 2.6 Hz, 2H), 2.92-2.80 (m, 6H), 2.78-2.71 (m, 2H), 2.57 (dd, J=8.3, 7.2 Hz, 2H). ¹³C NMR (101 MHz, CDCl₃) δ 172.88 (C), 157.34 (C), 157.10 (C), 133.29 (C), 130.58 (C), 129.98 (CH), 129.37 (CH), 114.79 (CH), 68.93 (CH₂), 65.12 (CH₂), 50.24 (CH), 44.76 (CH₂), 36.17 (CH₂), 34.29 (CH₂), 30.14 (CH₂). m/z=421.16251 observed (421.162160 calculated).

2-[(4-glycidyloxy phenyl)acetyloxy]ethyl 4-glycidyloxyphenylacetate (pH PAA-ethylene glycol diepoxide). 74% yield (86% yield if 1.1× excess NaOH used vs typical 2.0× excess). mp. 39° C. EEW=226. ¹H NMR (400 MHz, CDCl₃) δ 7.24-7.16 (m, 4H), 6.94-6.85 (m, 4H), 4.30 (s, 4H), 4.22 (dd, J=11.1, 3.2 Hz, 2H), 3.96 (dd, J=11.1, 5.6 Hz, 2H), 3.56 (s, 4H), 3.35 (ddt, J=5.7, 4.0, 2.9 Hz, 2H), 2.91 (dd, J=4.9, 4.1 Hz, 2H), 2.76 (dd, J=5.0, 2.6 Hz, 2H). ¹³C NMR (101 MHz, CDCl₃) δ 171.57 (C), 157.79 (C), 130.44 (CH), 126.52 (C), 114.87 (CH), 68.93 (CH₂), 62.42 (CH₂), 50.19 (CH), 44.73 (CH₂), 40.26 (CH₂). m/z=465.15289 observed (465.151989 calculated).

2-[3-(4-glycidyloxyphenyl)propanoyloxy]ethyl 3-(4-glycidyloxyphenyl)propanoate (pHPPA-ethylene glycol diepoxide). 77% yield. mp. 31° C. EEW=237. ¹H NMR (400 MHz, CDCl₃) δ 7.07-6.99 (m, 4H), 6.81-6.70 (m, 4H), 4.16 (s, 4H), 4.10 (dd, J=11.0, 3.2 Hz, 2H), 3.85 (dd, J=11.0, 5.6 Hz, 2H), 3.25 (ddt, J=5.7, 4.1, 2.9 Hz, 2H), 2.85-2.77 (m, 6H), 2.66 (dd, J=5.0, 2.7 Hz, 2H), 2.53 (dd, J=8.2, 7.2 Hz, 4H). ¹³C NMR (101 MHz, CDCl₃) δ 172.68 (C), 157.14 (C), 133.13 (C), 129.37 (CH), 114.80 (CH), 68.92 (CH₂), 62.20 (CH₂), 50.24 (CH), 44.75 (CH₂), 35.95 (CH₂), 30.06 (CH₂). m/z=493.18405 observed (493.183289 calculated).

2-[(4-glycidyloxyphenyl)acetyloxy]propyl 4-glycidyloxyphenylacetale (pHPAA-13-propanediol diepoxide). 82% yield. mp. 48° C. EEW=235. ¹H NMR (400 MHz, CDCl₃) δ 7.21-7.13 (m, 4H), 6.91-6.83 (m, 4H), 4.19 (dd, J=11.1, 3.2 Hz, 2H), 4.12 (t, J=6.3 Hz, 4H), 3.94 (dd, J=11.1, 5.6 Hz, 4H), 3.53 (s, 4H), 3.33 (ddt, J=5.7, 4.0, 2.9 Hz, 2H), 2.89 (dd, J=4.9, 4.1 Hz, 2H), 2.74 (dd, J=5.0, 2.6 Hz, 2H), 1.93 (p, J=6.3 Hz, 2H). ¹³C NMR (101 MHz, CDCl₃) δ 171.73 (C), 157.75 (C), 130.38 (CH), 126.70 (C), 114.87 (CH), 68.91 (CH₂), 61.32 (CH₂), 50.19 (CH), 44.74 (CH₂), 40.45 (CH₂), 27.93 (CH₂). m/z=479.16837 observed (479.167639 calculated).

2-[3-(4-glycidyloxyphenyl)propanoyloxy]propyl 3-(4-glycidyloxyphenyl)propanoate (pHPPA-1,3-propanediol diepoxide). 87% yield. mp. 34° C. EEW=243. ¹H NMR (400 MHz, CDCl₃) δ 7.14-7.06 (m, 4H), 6.88-6.80 (m, 4H), 4.18 (dd, J=11.1, 3.2 Hz, 2H), 4.09 (t, J=6.3 Hz, 4H), 3.93 (dd, J=11.1, 5.6 Hz, 2H), 3.33 (ddt, J=5.7, 4.0, 3.0 Hz, 2H), 2.92-2.84 (m, 6H), 2.73 (dd, J=5.0, 2.7 Hz, 2H), 2.59 (t, J=7.7 Hz, 4H), 1.89 (p, J=6.3 Hz, 2H). ¹³C NMR (101 MHz, CDCl₃) δ 172.85 (C), 157.14 (C), 133.18 (C), 129.35 (CH), 114.81 (CH), 68.93 (CH₂), 61.05 (CH₂), 50.24 (CH), 44.76 (CH₂), 36.07 (CH₂), 30.15 (CH₂), 28.05 (CH₂). m/z=507.19992 observed (507.198939 calculated).

4-glycidyloxyoxyphenethyl-4-glycidyloxybenzoate (pHBA-tyrosol diepoxide). White solid (76% yield). mp. 102° C. m/z (Na⁺)=393.13113 (vs. 393.130860 expected). EEW=184 g/eq (flash chromatography), 192 g/eq (silica plug only). ¹H NMR (400 MHz, CDCl₃) δ 8.00-7.92 (m, 2H), 7.23-7.14 (m, 2H), 6.97-6.89 (m, 2H), 6.93-6.83 (m, 2H), 4.46 (t, J=7.0 Hz, 2H), 4.29 (dd, J=11.1, 3.0 Hz, 1H), 4.19 (dd, J=11.0, 3.2 Hz, 1H), 3.97 (ddd, J=16.5, 11.1, 5.7 Hz, 2H), 3.40-3.30 (m, 2H), 3.00 (t, J=7.0 Hz, 2H), 2.90 (dt, J=10.1, 4.5 Hz, 2H), 2.75 (ddd, J=7.6, 4.9, 2.6 Hz, 2H). ¹³C NMR (101 MHz, CDCl₃) 166.19 (C), 162.25 (C), 157.35 (C), 131.68 (CH), 130.76 (C), 130.05 (CH), 123.38 (C), 114.84 (CH), 114.31 (CH), 68.93 (CH₂), 65.46 (CH₂), 50.24 (CH), 49.97 (CH), 44.77 (CH₂), 44.65 (CH₂), 34.49 (CH₂).

Ethyl-1,2-bis-4-glycidyloxybenzoate (pHBA-ED diepoxide). White solid (80% yield). mp. 82° C. m/z (Na⁺)=437.12115 (vs. 437.120689 expected). EEW=205 g/eq (flash chromatography), 213 g/eq (silica plug only). ¹H NMR (400 MHz, CDCl₃) δ 8.04-7.95 (m, 4H), 6.97-6.88 (m, 4H), 4.61 (s, 4H), 4.28 (dd, J=11.1, 3.0 Hz, 2H), 3.98 (dd, J=11.1, 5.7 Hz, 2H), 3.36 (ddd, J=5.8, 4.0, 2.8 Hz, 2H), 2.91 (t, J=4.5 Hz, 2H), 2.75 (dd, J=4.9, 2.6 Hz, 2H). ¹³C NMR (101 MHz, CDCl₃) δ 166.05 (C), 162.43 (C), 131.87 (CH), 122.90 (C), 114.37 (CH), 68.94 (CH₂), 62.66 (CH₂), 49.96 (CH), 44.64 (CH₂).

Propyl-1,3-bis-4-glycidyloxybenzoate (pHBA-PD diepoxide). White solid (75% yield—0.075 mol scale). Dichloromethane was used for extraction as opposed to ethyl acetate. mp. 110° C. m/z (Na⁺)=451.13696 (vs. 451.136339 expected). EEW=217 g/eq (flash chromatography), 218 g/eq (silica plug only). ¹H NMR (400 MHz, CDCl₃) δ 8.01-7.93 (m, 4H), 6.95-6.87 (m, 4H), 4.46 (t, J=6.2 Hz, 4H), 4.28 (dd, J=11.0, 3.0 Hz, 2H), 3.98 (dd, J=11.1, 5.8 Hz, 2H), 3.36 (ddd, J=5.7, 4.0, 2.8 Hz, 2H), 2.91 (t, J=4.5 Hz, 2H), 2.76 (dd, J=4.9, 2.6 Hz, 2H), 2.22 (p, J=6.2 Hz, 2H). ¹³C NMR (101 MHz, CDCl₃) δ 166.19 (C), 162.30 (C), 131.73 (CH), 123.15 (C), 114.30 (CH), 68.94 (CH₂), 61.68 (CH₂), 49.95 (CH), 44.63 (CH₂), 28.42 (CH₂).

Ethyl-1,2-bis-3-glycidyloxybenzoate (mHBA-ED diepoxide). White solid (82% yield). mp. 85° C. m/z (Na⁺)=437.12015 (vs. 437.120689 expected). EEW=209 g/eq (flash chromatography), 214 g/eq (silica plug only). ¹H NMR (400 MHz, CDCl₃) δ 7.67 (s, 2H), 7.57 (s, 2H), 7.34 (s, 2H), 7.13 (s, 2H), 4.65 (s, 4H), 4.25 (s, 2H), 3.95 (s, 2H), 3.34 (s, 2H), 2.89 (s, 2H), 2.74 (s, 2H). ¹³C NMR (101 MHz, CDCl₃) δ 166.13 (C), 158.56 (C), 131.25 (C), 129.65 (CH), 122.71 (CH), 120.38 (CH), 114.98 (CH), 69.09 (CH₂), 62.86 (CH₂), 50.04 (CH), 44.61 (CH₂).

### Polyester Thermoset Synthesis Using Ester-Containing Diepoxide Compounds and Commercially-Available Isophorone Diamine (IPDA)

Purified epoxy monomer (0.6 to 3.0 g, dependent on the type of part formed) was weighed into a tared 20 mL scintillation vial with a PTFE-coated ½×⅛″ stirbar and the tare weight was recorded. The vial was transferred to a vacuum oven and the monomer was degassed at 80° C. (or higher in cases where the monomer m.p. exceeded 80° C.) for a period of about 1 hour. In a separate vacuum oven, a vial filled roughly halfway with isophorone diamine (IPDA) was degassed at ambient temperature. The epoxy monomer was reweighed, and the tare weight subtracted. The vial was placed into an aluminum vial block on a magnetic stir plate at 80° C. and agitation was initiated.

The vial of degassed IPDA was removed and the weight of IPDA was added in order to achieve a 1:1 epoxide functional group to amine hydrogen ratio and was determined from the weight of the degassed epoxy monomer. This weight was withdrawn via pipette from the halfway-filled IPDA vial tared on a scale and added to the epoxy monomer under slow agitation. The agitation rate was gradually increased to the point where the vial contents were uniform (in all cases IPDA was solvated completely in the epoxy monomer, and the disappearance of solvation lines was used to determine sufficiency of agitation). The IPDA transfer pipette was rinsed with the vial contents for stoichiometric accuracy, and agitation was continued. The viscosity remained low, and after about three minutes of cumulative agitation, the vial contents were transferred via pipette to a preheated HT silicone mold. The filled mold was transferred to a convection oven programmed to run the following profile: 3 hours at 80° C., ramp 80° C. to 150° C. over 3 hours, 150° C. for 1 hour.

### Example Syntheses of Diarylnitro Precursor Compounds to Ester-Containing Diamine Monomers.

4-nitrophenethyl-4-nitrobenzoate. 0.210 mol of methyl 4-nitrobenzoate and 0.200 mol of 4-nitrophenethyl alcohol were added to a 250 mL 1-neck round bottom flask. The temperature was increased to the point that the methyl 4-hydroxybenzoate was molten, and 0.0022 mol of dibutyltin dilaurate was added under magnetic agitation. A Dean Stark trap for collection of byproduct methanol was connected to the flask in line with a condenser and the flask contents were further heated to about 200° C. and allowed to react for 10 hours. The trap and condenser were removed in the final hours of the reaction and replaced with a nitrogen line through the open port. The crude product was cooled to ambient temperature, pulverized, washed two times with diethyl ether to remove the dibutyltin dilaurate and residual methyl 4-nitrobenzoate, and used without further purification. Yield=85% (a beige solid). ¹H NMR (400 MHz, DMSO) δ 8.31 (s, 2H), 8.18 (s, 2H), 8.12 (s, 2H), 7.64 (s, 2H), 4.61 (s, 2H), 3.23 (s, 2H). ¹³C NMR (101 MHz, DMSO) δ 164.02 (C), 150.20 (C), 146.37 (C), 146.30 (C), 134.86 (C), 130.49 (CH), 130.20 (CH), 123.81 (CH), 123.40 (CH), 65.21 (CH₂), 33.94 (CH₂).

Ethyl-1,2-bis-4-nitrobenzoate. 0.700 mol of methyl 4-nitrobenzoate and 1.400 mol of ethylene glycol were added to a 1 L 1-neck round bottom flask. The temperature was increased to the point that the methyl 4-hydroxybenzoate was molten, and 0.0077 mol of dibutyltin dilaurate was added under magnetic agitation. A Dean Stark trap for collection of byproduct methanol was connected to the flask in line with a condenser and the flask contents were further heated to about 180° C. and allowed to react for 3 hours. The trap and condenser were then removed and replaced with a nitrogen line through the open port. The reaction continued at 180° C. for 5 hours. At this point, the temperature was lowered to 100° C. and a short path vacuum distillation apparatus and receiving flask were added. Vacuum was applied via a 0.9 CFM rotary vane pump and the temperature was gradually increased to 200° C. to control the distillation of free ethylene glycol. The ester interchange reaction proceeded at 200° C. for 11 hours. The crude product was cooled to ambient temperature, pulverized, washed two times with diethyl ether to remove the dibutyltin dilaurate and residual methyl 4-nitrobenzoate, and used without further purification. Yield=84% (a beige solid). ¹H NMR (400 MHz, DMSO) δ 8.32 (s, 4H), 8.19 (s, 4H), 4.71 (s, 4H). ¹³C NMR (101 MHz, DMSO) δ 164.17 (C), 150.26 (C), 134.78 (C), 130.63 (CH), 123.83 (CH), 63.44 (CH₂).

Propyl-1,3-bis-4-nitrobenzoate. 0.120 mol of methyl 4-nitrobenzoate and 0.240 mol of 1,3-propanediol were added to a 100 mL 1-neck round bottom flask. The temperature was increased to the point that the methyl 4-hydroxybenzoate was molten, and 0.0011 mol of dibutyltin dilaurate was added under magnetic agitation. A Dean Stark trap for collection of byproduct methanol was connected to the flask in line with a condenser and the flask contents were further heated to about 180° C. and allowed to react for 2 hours. The trap and condenser were then removed and replaced with a nitrogen line through the open port. The reaction continued at 180° C. for 4 hours. At this point, the temperature was lowered to 100° C. and a short path vacuum distillation apparatus and receiving flask were added. Vacuum was applied via a 0.9 CFM rotary vane pump and the temperature was gradually increased to 200° C. The ester interchange reaction proceeded at 200° C. for 2 hours and 210° C., 220° C., 230° C. and 240° C. for about 1 hour at each temperature. The crude product was cooled to ambient temperature, pulverized, washed two times with diethyl ether to remove the dibutyltin dilaurate and residual methyl 4-nitrobenzoate. Yield=80% (a beige-orange solid). ¹H NMR (400 MHz, DMSO) δ 8.26 (s, 4H), 8.15 (s, 4H), 4.51 (s, 4H), 2.25 (s, 2H). ¹³C NMR (101 MHz, DMSO) δ 165.85 (C), 153.48 (C), 131.09 (CH), 115.85 (C), 112.65 (CH), 60.63 (CH₂), 28.08 (CH₂).

Ethyl-1,2-bis-3-nitrobenzoate. 1.200 mol of methyl 4-nitrobenzoate and 2.400 mol of ethylene glycol were added to a 1 L 1-neck round bottom flask. The temperature was increased to the point that the methyl 4-hydroxybenzoate was molten, and 0.0132 mol of dibutyltin dilaurate was added under magnetic agitation. A Dean Stark trap for collection of byproduct methanol was connected to the flask in line with a condenser and the flask contents were further heated to about 180° C. and allowed to react for 3 hours. The trap and condenser were then removed and replaced with a nitrogen line through the open port. The reaction continued at 180° C. for 5 hours. At this point, the temperature was lowered to 100° C. and a short path vacuum distillation apparatus and receiving flask were added. Vacuum was applied via a 0.9 CFM rotary vane pump and the temperature was gradually increased to 200° C. to control the distillation of free ethylene glycol. The ester interchange reaction proceeded at 200° C. for 11 hours, 210° C. for 1 hour, and 220° C. for 1 hour. The crude product was cooled to ambient temperature, cryofractured, pulverized, and washed two times with diethyl ether to remove the dibutyltin dilaurate and residual methyl 4-nitrobenzoate. The product (a solid at this point) was dissolved in dichloromethane and passed through a silica plug to remove residual monocondensation adduct. Yield=81% (a beige solid). ¹H NMR (400 MHz, DMSO) δ 8.62 (s, 2H), 8.48 (s, 2H), 8.35 (s, 2H), 7.83 (s, 2H), 4.74 (s, 4H). ¹³C NMR (101 MHz, DMSO) δ 163.94 (C), 147.88 (C), 135.22 (CH), 130.97 (C), 130.72 (CH), 127.85 (CH), 123.60 (CH), 63.42 (CH₂).

Generic ester-containing diamine synthesis description. A sealed 2-neck 1 L round bottom flask with a magnetic stirbar was purged via a vacuum pump and backfilled with dry nitrogen via Schlenk line techniques. 0.00120 mol Pd (as 10% in activated carbon) was added to the flask. The flask was opened briefly and 0.050 mol of dinitro precursor pre-dissolved in THF was added (a typical concentration of dinitro compound in THF was 0.1 mol/L). Under agitation, the resealed flask was again purged and filled with nitrogen (4× cycles). A balloon within a balloon was filled with nitrogen, nearly emptied, then filled with hydrogen. The balloon was connected to a valve equipped with a Luer-Lok on the opposite end. A needle was connected to the Luer-Lok end and was inserted into one of the rubber septa on the flask under static vacuum. The reaction proceeded initially at ambient temperature, and the temperature was gradually ramped to ca. 30° C. over a ca. 30 hour reaction period. Additional hydrogen was supplied (balloon replaced) upon depletion.

### Example Syntheses of Ester-Containing Diamine Compounds

4-aminophenethyl-4-aminobenzoate. beige solid (95% yield at 0.0500 mol scale). mp. 133° C. m/z (Na⁺)=279.11017 (vs. 279.110399 expected). ¹H NMR (400 MHz, DMSO) δ 7.65-7.58 (m, 2H), 6.96-6.90 (m, 2H), 6.60-6.53 (m, 2H), 6.53-6.47 (m, 2H), 5.92 (s, 2H), 4.85 (s, 2H), 4.24 (t, J=7.0 Hz, 2H), 2.78 (t, J=7.0 Hz, 2H). ¹³C NMR (101 MHz, DMSO) δ 165.82 (C), 153.40 (C), 146.92 (C), 130.99 (CH), 129.25 (CH), 124.92 (C), 116.01 (C), 113.98 (CH), 112.62 (CH), 64.74 (CH₂), 33.90 (CH₂).

Ethyl-1,2-bis-4-aminobenzoate. beige solid (97% yield at 0.0500 mol scale). mp. 214° C. m/z (Na⁺)=323.10001 (vs. 323.100228 expected). ¹H NMR (400 MHz, DMSO) δ 7.64 (s, 4H), 6.55 (s, 4H), 5.95 (s, 4H), 4.44 (s, 4H). ¹³C NMR (101 MHz, DMSO) δ 165.73 (C), 153.58 (C), 131.14 (CH), 115.54 (C), 112.63 (CH), 61.89 (CH₂).

Propyl-1,3-bis-4-aminobenzoate. Synthesized as a reference only (Air Products Polacure 470M was used for network synthesis). beige solid (92% yield at 0.0160 mol scale). mp.=124° C. m/z (Na⁺)=337.11575 (vs. 337.115878 expected). ¹H NMR (400 MHz, DMSO) δ 7.65 (s, 4H), 6.57 (s, 4H), 5.93 (s, 4H), 4.28 (s, 4H), 2.07 (s, 2H). ¹³C NMR (101 MHz, DMSO) δ 165.73 (C), 153.58 (C), 131.14 (CH), 115.54 (C), 112.63 (CH), 61.89 (CH₂), 30.62 (CH₂).

Ethyl-1,2-bis-3-aminobenzoate. beige solid (95% yield at 0.0400 mol scale). mp. 137° C. m/z (Na⁺)=323.10004 (vs. 323.100228 expected). ¹H NMR (400 MHz, DMSO) δ 8.62 (s, 2H), 8.48 (s, 2H), 8.35 (s, 2H), 7.83 (s, 2H), 4.74 (s, 4H). ¹³C NMR (101 MHz, DMSO) δ 163.94 (C), 147.88 (C), 135.22 (CH), 130.97 (C), 130.72 (CH), 127.85 (CH), 123.60 (CH), 63.42 (CH₂).

### Polyester Thermoset Synthesis Using Ester-Containing Diepoxide Compounds and Ester-Containing Diamine Compounds.

Diepoxide (mass dependent on the type of part formed) was weighed into a tared 20 mL scintillation vial with a PTFE-coated ½×⅛″ stir bar and the tare weight was recorded. The vial was transferred to a vacuum oven and the monomer was degassed at −120° C. for a period of about 1 hour. In a separate vacuum oven, a vial filled roughly halfway with diamine was degassed at ˜100° C. The vial of degassed epoxy monomer was reweighed and the tare weight subtracted. The vial was placed into an aluminum vial block on a magnetic stir plate at 100-120° C. (system-dependent) and agitation was initiated.

The vial of degassed diamine was removed and the weight of diamine added to achieve a 1:1 epoxide functional group to amine hydrogen molar ratio which was determined from the weight of the degassed diepoxide. This weight of diamine was added to an empty 20 mL vial. The filled vial tared and added to the epoxy monomer under agitation; the vial was reweighed to confirm the added weight. Agitation of the vial contents at 100° C. (DGEBA-4,4′-DDM, ASYM4-ASYM4) or 120° C. (DGEBA-4,4′-DDS, DGEBA-3,3′-DDS, E4-P4, P4-P4, E4-E3, E3-E3) or 160° C. (E4-E4) continued until an optically-clear solution formed (˜10 minutes). The vial contents were then degassed at the agitation temperature (or at 130° C. for E4-E4) for about 10 minutes and transferred via pipette to a preheated HT silicone mold. The filled mold was transferred to a convection oven programmed to run the following profile: 3 hours at 100° C., ramp 100° C. to 200° C. over 2 hours, 200° C. for 2 hours (DGEBA-4,4′-DDM) or 3 hours at 110° C., ramp 110° C. to 200° C. over 2 hours, 200° C. for 2 hours (ASYM4-ASYM4) or 3 hours at 120° C., ramp 120° C. to 200° C. over 2 hours, 200° C. for 2 hours (DGEBA-4,4′-DDS, DGEBA-3,3′-DDS, E4-P4, P4-P4, E4-E3, and E3-E3) or 3 hours at 130° C., ramp 130° C. to 200° C. over 2 hours, 200° C. for 2 hours (E4-E4).

What is claimed is:

1. A polyester thermoset produced from an ester-bridged diepoxide monomer and a diamine comprising a crosslinked network, wherein the ester-bridged diepoxide monomer is selected from the group consisting of monomers of Formulae (I)-(VI): 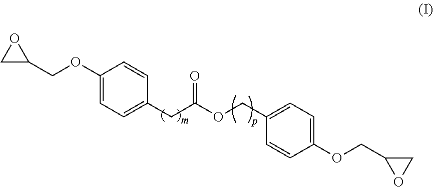
wherein m is an integer between 1 and 10; and p is an integer between 1 and 10; 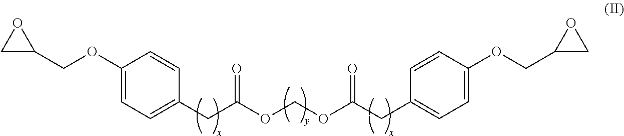
wherein each x is independently selected from an integer between 1 and 10; and y is an integer between 1 and 10; 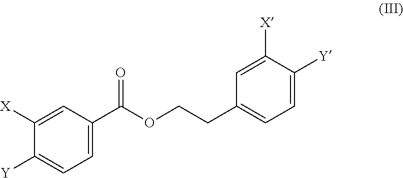
wherein X, Y, X′, and Y′ are each independently selected from 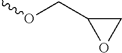
and H, and the pairs X and Y and X′ and Y′ are not the same, and 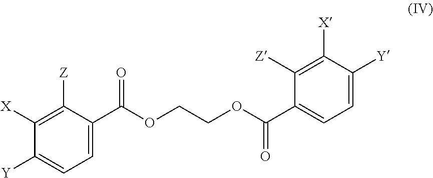
wherein X, X′ are both 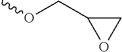
and the pairs Y, Y′ and Z, Z′ are H; Y, Y′ are both 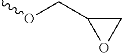
and the pairs X, X′ and Z, Z′ are each H; or Z, Z′ are both 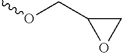
and the pairs X, X′ and Y, Y′ are each H; and 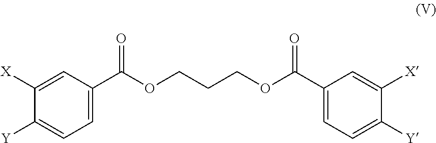
wherein X, Y, X′, and Y′ are each independently selected from 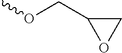
and H, and the pairs X and Y and X′ and Y′ are not the same, and 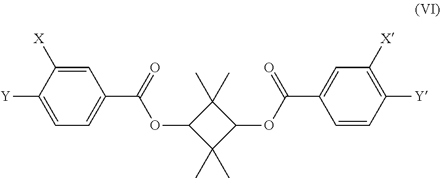
wherein X, Y, X′, and Y′ are each independently selected from 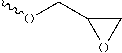
and H, and the pairs X and Y, and X′ and Y′ are not the same.

2. The polyester thermoset of claim 1, wherein the diamine monomer is selected from the group consisting of isophorone diamine, diaminocyclohexane, 4,4′methylenebis(cyclohexan-1-amine), 1,3-bis(aminomethyl)cyclohexane, diethyl-toluene-diamine, 4,4′-diaminodiphenylmethane, 4,4′-diaminodiphenylsulfone, 3,3′-diaminodiphenylsulfone, and a diamine according to Formulae (VII)-(VIII): 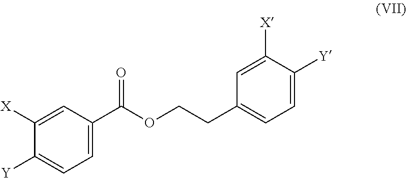
wherein X, Y, X′, and Y′ are each independently selected from NH₂ and H, and the pairs X and Y, and X′ and Y′ are not the same, and 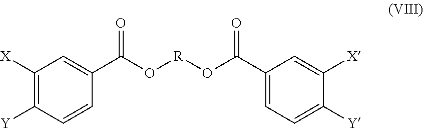
wherein R is selected from a hydrocarbylene group comprising 2 or 3 carbon atoms, and a cycloalkane ring having 4 carbon atoms and is optionally substituted with two or more methyl groups.

3. The polyester thermoset of claim 1, wherein the crosslinked network is formed by curing at a temperature in a range of from about 60° C. to about 200° C.

4. The polyester thermoset according to claim 1, wherein the compound of the Formula (I) is selected from the group consisting of:
a) 4-glycidyloxyphenethyl 2-(4-glycidyloxyphenyl)acetate 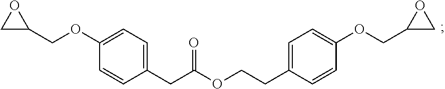 [SMILES: O=C(Cc1ccc(OCC2CO2)cc1)OCCc1ccc(OCC2CO2)cc1]
and
b) 4-glycidyloxyphenethyl 3-(4-glycidyloxyphenyl)propanoate

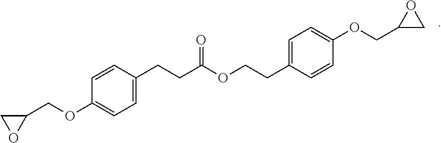 [SMILES: O=C(CCc1ccc(OCC2CO2)cc1)OCCc1ccc(OCC2CO2)cc1]

5. The polyester thermoset according to claim 1, wherein the compound of the Formula (II) is selected from the group consisting of:
a) 2-[(4-glycidyloxyphenyl)acetyloxy]ethyl 4-glycidyloxyphenylacetate 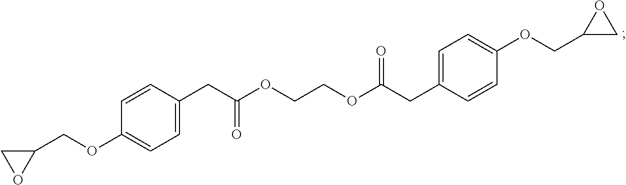 [SMILES: O=C(Cc1ccc(OCC2CO2)cc1)OCCOC(=O)Cc1ccc(OCC2CO2)cc1]
b) 2-[3-(4-glycidyloxyphenyl)propanoyloxy]ethyl 3-(4-glycidyloxyphenyl)propanoate 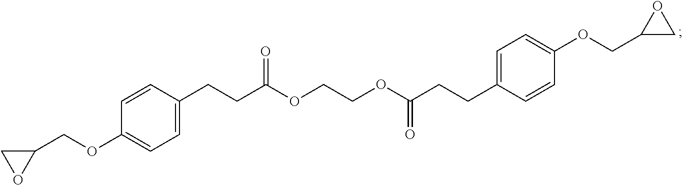 [SMILES: O=C(CCc1ccc(OCC2CO2)cc1)OCCOC(=O)CCc1ccc(OCC2CO2)cc1]
c) 3-[(4-glycidyloxyphenyl)acetyloxy]propyl 4-glycidyloxyphenylacetate 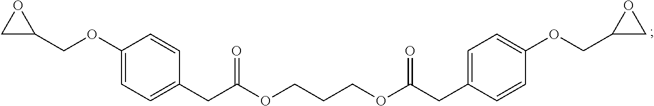 [SMILES: O=C(Cc1ccc(OCC2CO2)cc1)OCCCOC(=O)Cc1ccc(OCC2CO2)cc1]
and
d) 3-[3-(4-glycidyloxyphenyl)propanoyloxy]propyl 3-(4-glycidyloxyphenyl)propanoate

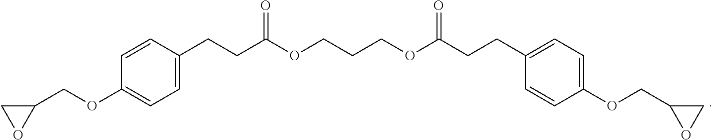 [SMILES: O=C(CCc1ccc(OCC2CO2)cc1)OCCCOC(=O)CCc1ccc(OCC2CO2)cc1]

6. The polyester thermoset according to claim 1, wherein the compound of the Formula (III) is selected from the group consisting of:
a) 2-(4-glycidyloxyphenethyl) 4-glycidyloxybenzoate 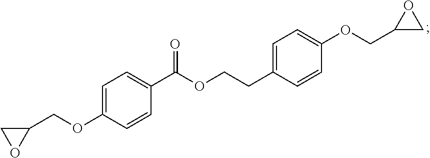 [SMILES: O=C(OCCc1ccc(OCC2CO2)cc1)c1ccc(OCC2CO2)cc1]
and
b) 2-(3-glycidyloxybenzoyl)oxyethyl 3-glycidyloxybenzoate

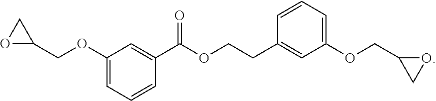 [SMILES: O=C(OCCc1cccc(OCC2CO2)c1)c1cccc(OCC2CO2)c1]

7. The polyester thermoset according to claim 1, wherein the compound of the Formula (IV) is selected from the group consisting of:
a) ethyl-1,2-bis-4-glycidyloxybenzoate 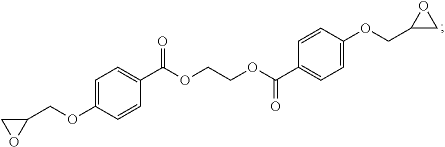 [SMILES: O=C(OCCOC(=O)c1ccc(OCC2CO2)cc1)c1ccc(OCC2CO2)cc1]
b) ethyl-1,2-bis-3-glycidyloxybenzoate 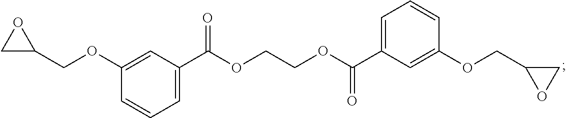 [SMILES: O=C(OCCOC(=O)c1cccc(OCC2CO2)c1)c1cccc(OCC2CO2)c1]
and
c) ethyl-1,2-bis-2-glycidyloxybenzoate

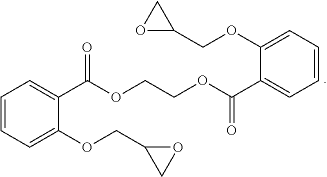 [SMILES: O=C(OCCOC(=O)c1ccccc1OCC1CO1)c1ccccc1OCC1CO1]

8. The polyester thermoset according to claim 1, wherein the compound of the Formula (V) is selected from the group consisting of:
a) propyl-1,3-bis-4-glycidyloxybenzoate 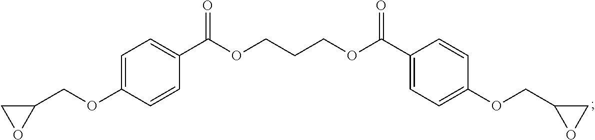 [SMILES: O=C(OCCCOC(=O)c1ccc(OCC2CO2)cc1)c1ccc(OCC2CO2)cc1]
and
b) propyl-1,3-bis-3-glycidyloxybenzoate

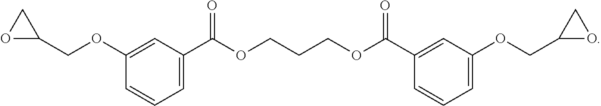 [SMILES: O=C(OCCCOC(=O)c1cccc(OCC2CO2)c1)c1cccc(OCC2CO2)c1]

9. The polyester thermoset according to claim 1, wherein the compound of the Formula (VI) is selected from the group consisting of:
a) 2,2,4,4-tetramethylcyclobutane-1,3-diyl-bis-4-glycidyloxybenzoate 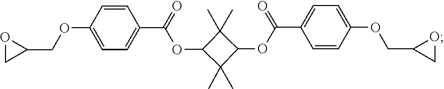 [SMILES: CC1(C)C(OC(=O)c2ccc(OCC3CO3)cc2)C(C)(C)C1OC(=O)c1ccc(OCC2CO2)cc1]
and
b) 2,2,4,4-tetramethylcyclobutane-1,3-diyl-bis-3-glycidyloxybenzoate

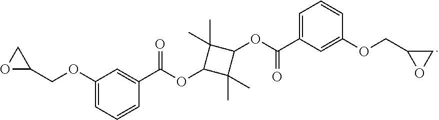 [SMILES: CC1(C)C(OC(=O)c2cccc(OCC3CO3)c2)C(C)(C)C1OC(=O)c1cccc(OCC2CO2)c1]

10. The polyester thermoset according to claim 2, wherein the diamine of the Formula (VII) is selected from the group consisting of:
a) 4-aminophenethyl 4-aminobenzoate 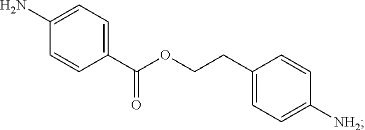 [SMILES: Nc1ccc(CCOC(=O)c2ccc(N)cc2)cc1]
and
b) 3-aminophenethyl 3-aminobenzoate

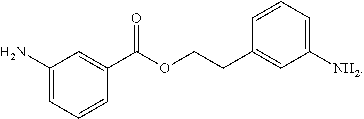 [SMILES: Nc1cccc(CCOC(=O)c2cccc(N)c2)c1]

11. The polyester thermoset according to claim 2, wherein the diamine of the Formula (VIII) is selected from the group consisting of:
a) ethyl-1,2-bis-4-aminobenzoate 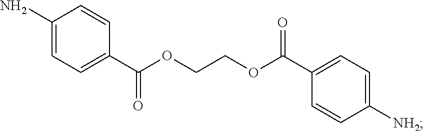 [SMILES: Nc1ccc(C(=O)OCCOC(=O)c2ccc(N)cc2)cc1]
b) ethyl-1,2-bis-3-aminobenzoate 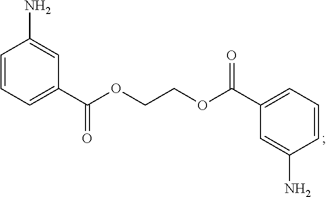 [SMILES: Nc1cccc(C(=O)OCCOC(=O)c2cccc(N)c2)c1]
c) propyl-1,3-bis-4-aminobenzoate 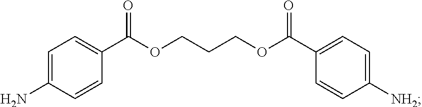 [SMILES: Nc1ccc(C(=O)OCCCOC(=O)c2ccc(N)cc2)cc1]
d) propyl-1,3-bis-3-aminobenzoate 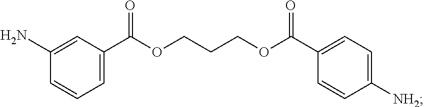 [SMILES: Nc1ccc(C(=O)OCCCOC(=O)c2cccc(N)c2)cc1]
e) 2,2,4,4-tetramethylcyclobutane-1,3-diyl bis(4-aminobenzoate) 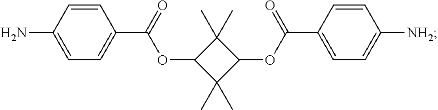 [SMILES: CC1(C)C(OC(=O)c2ccc(N)cc2)C(C)(C)C1OC(=O)c1ccc(N)cc1]
and
f) 2,2,4,4-tetramethylcyclobutane-1,3-diyl bis(3-aminobenzoate)

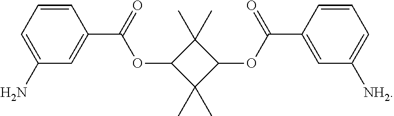 [SMILES: CC1(C)C(OC(=O)c2cccc(N)c2)C(C)(C)C1OC(=O)c1cccc(N)c1]

12. The polyester thermoset of claim 1, wherein a moiety of the polyester thermoset is prepared by reacting the diepoxide monomer and the diamine such that a molar ratio of epoxide groups of the diepoxide to amine hydrogens of the diamine is from about 1:0.5 to 1:2.

13. A method for producing a polyester thermoset comprising a crosslinked network, the method comprising steps of:
reacting one or more diepoxide monomers with one or more diamine monomers to form a solution, wherein the one or more diepoxide monomers is according to Formulae (I)-(VI): 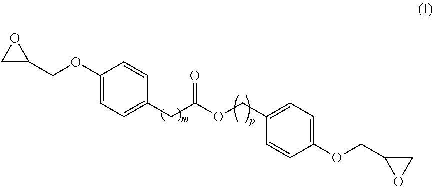
wherein m is an integer between 1 and 10; and p is an integer between 1 and 10; 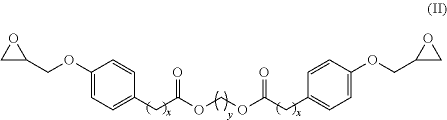
wherein x is an integer between 1 and 10; y is an integer between 1 and 10; 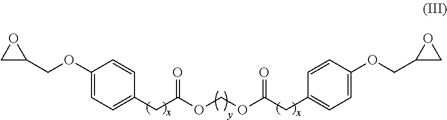
wherein X, Y, X′, and Y′ are each independently selected from 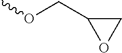
and H, and the pairs X and Y and X′ and Y′ are not the same; and 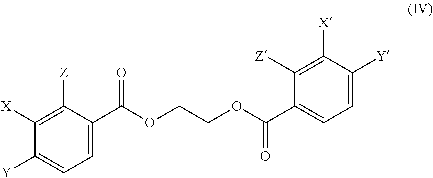
wherein X, X′ are both 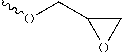
and the pairs Y, Y′, or Z, Z′ are each H;
Y, Y′ are both 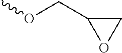
and the pairs X, X′ and Z, Z′ are each H, or
Z, Z′ are both 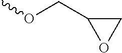
and the pairs X, X′ and are each H; and 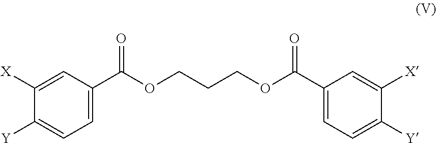
wherein X, Y, X′, and Y′ are each independently selected from 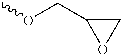
and H, and the pairs X and Y and X′ and Y′ are not the same; and 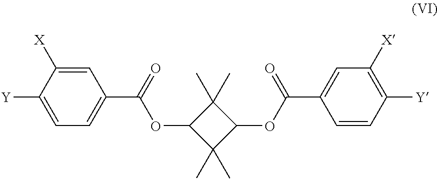
wherein X, Y, X′, and Y′ are each independently selected from 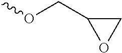
and H, and the pairs X and Y, and X′ and Y′ are not the same; and
the one or more diamine monomers is according to Formulae (VII)-(VIII): 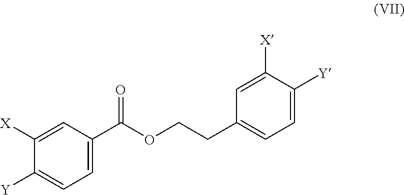
wherein X, Y, X′, and Y′ are each independently selected from NH₂ and H, wherein the pairs X and Y, and X′ and Y′ are not the same, and 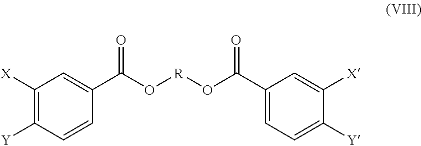
wherein X, Y, X′, and Y′ are each independently selected from NH₂ and H, wherein the pairs X and Y, and X′ and Y′ are not the same; and
heating the solution at a temperature of from about 120° C. to about 200° C. to form the polyester thermoset comprising a crosslinked network.

14. A diepoxide monomer according to Formulae (I)-(VI): 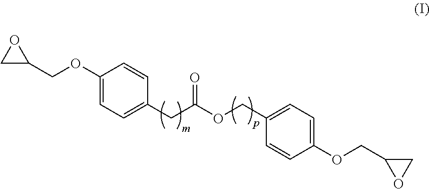
wherein m is an integer between 1 and 10; and p is an integer between 1 and 10; 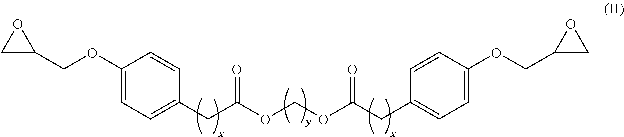
wherein each x is independently selected from an integer between 1 and 10; y is an integer between 1 and 10; 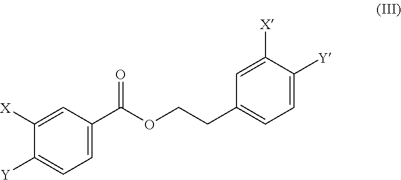
wherein X, Y, X′, and Y′ are each independently selected from 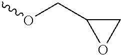
and H, and the pairs X and Y and X′ and Y′ are not the same; 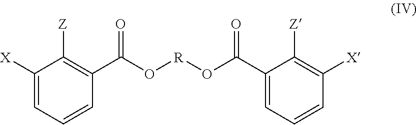
wherein R is a hydrocarbylene group comprising 2 carbon atoms and X, Z, X′, and Z′ are each independently selected from 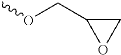
and H, and the pairs X and Z, and X′ and Z′ are not the same, or R is a hydrocarbylene group comprising 3 carbon atoms, X and X′ are 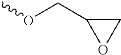
and Z and Z′ are H; 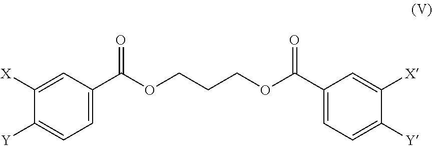
wherein X, Y, X′, and Y′ are each independently selected from 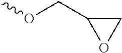
and H, and the pairs X and Y and X′ and Y′ are not the same; and 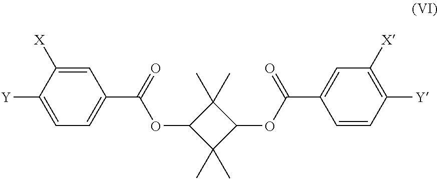
wherein X, Y, X′, and Y′ are each independently selected from 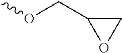
and H, and the pairs X and Y, and X′ and Y′ are not the same.

15. The monomer according to claim 14, wherein the compound of the Formulae (I) is selected from the group consisting of:
a) 2-[(4-glycidyloxyphenyl)acetyloxy]ethyl 4-glycidyloxyphenylacetate 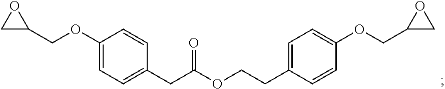 [SMILES: O=C(Cc1ccc(OCC2CO2)cc1)OCCc1ccc(OCC2CO2)cc1]
and
b) 4-glycidyloxyphenethyl 3-(4-glycidyloxyphenyl)propanoate

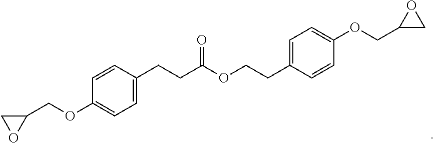 [SMILES: O=C(CCc1ccc(OCC2CO2)cc1)OCCc1ccc(OCC2CO2)cc1]

16. The monomer according to claim 14, wherein the compound of the Formulae (II) is selected from the group consisting of:
a) 2-[(4-glycidyloxyphenyl)acetyloxy]ethyl 4-glycidyloxyphenylacetate 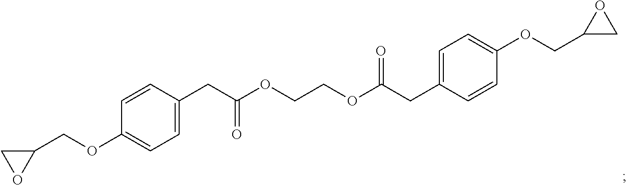 [SMILES: O=C(Cc1ccc(OCC2CO2)cc1)OCCOC(=O)Cc1ccc(OCC2CO2)cc1]
b) 2-[3-(4-glycidyloxyphenyl)propanoyloxy]ethyl 3-(4-glycidyloxyphens)propanoate 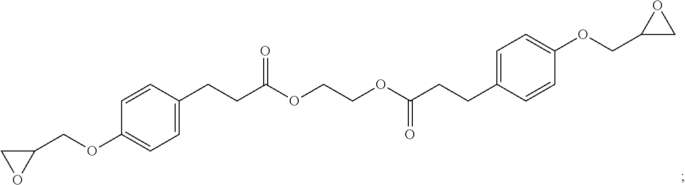 [SMILES: O=C(CCc1ccc(OCC2CO2)cc1)OCCOC(=O)CCc1ccc(OCC2CO2)cc1]
c) 3-[(4-glycidyloxyphenyl)acetyloxy]propyl 4-glycidyloxyphenylacetate 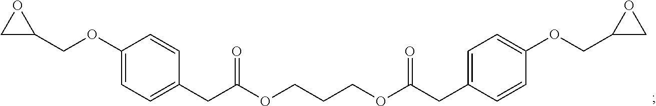 [SMILES: O=C(Cc1ccc(OCC2CO2)cc1)OCCCOC(=O)Cc1ccc(OCC2CO2)cc1]
and
d) 3-[3-(4-glycidyloxyphenyl)propanoyloxy]propyl 3-(4-glycidyloxyphenyl)propanoate

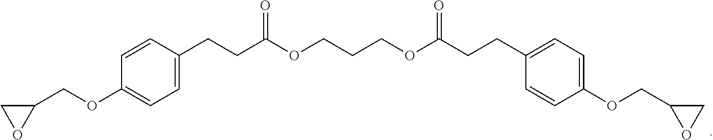 [SMILES: O=C(CCc1ccc(OCC2CO2)cc1)OCCCOC(=O)CCc1ccc(OCC2CO2)cc1]

17. The monomer according to claim 14, wherein the compound of the Formula (III) is selected from the group consisting of:
a) 2-(4-glycidyloxyphenethyl) 4-glycidyloxybenzoate 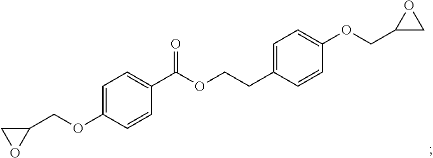 [SMILES: O=C(OCCc1ccc(OCC2CO2)cc1)c1ccc(OCC2CO2)cc1]
and
b) 2-(3-glycidyloxybenzoyl)oxyethyl 3-glycidyloxybenzoate

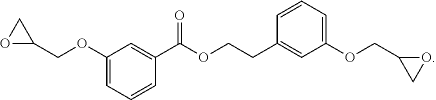 [SMILES: O=C(OCCc1cccc(OCC2CO2)c1)c1cccc(OCC2CO2)c1]

18. The monomer according to claim 14, wherein the compound of the Formula (IV) is selected from the group consisting of:
a) ethyl-1,2-bis-3-glycidyloxybenzoate 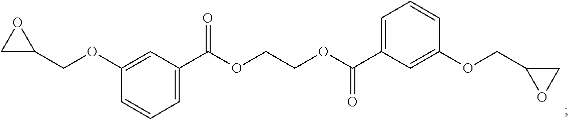 [SMILES: O=C(OCCOC(=O)c1cccc(OCC2CO2)c1)c1cccc(OCC2CO2)c1]
b) ethyl-1,2-bis-2-glycidyloxybenzoate 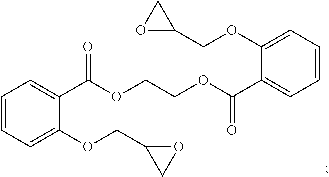 [SMILES: O=C(OCCOC(=O)c1ccccc1OCC1CO1)c1ccccc1OCC1CO1]
and
c) propyl-1,3-bis-3-glycidyloxybenzoate

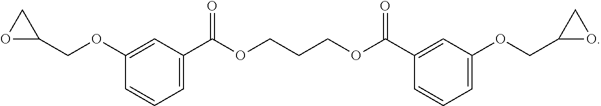 [SMILES: O=C(OCCCOC(=O)c1cccc(OCC2CO2)c1)c1cccc(OCC2CO2)c1]

19. The monomer according to claim 14, wherein the compound of the Formula (VI) is selected from the group consisting of:
a) 2,2,4,4-tetramethylcyclobutane-1,3-diyl-bis-4-glycidyloxybenzoate 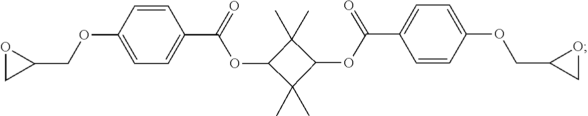 [SMILES: CC1(C)C(OC(=O)c2ccc(OCC3CO3)cc2)C(C)(C)C1OC(=O)c1ccc(OCC2CO2)cc1]
and
b) 2,2,4,4-tetramethylcyclobutane-1,3-diyl-bis-3-glycidyloxybenzoate

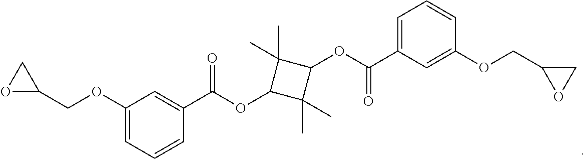 [SMILES: CC1(C)C(OC(=O)c2cccc(OCC3CO3)c2)C(C)(C)C1OC(=O)c1cccc(OCC2CO2)c1]

20. A polymer comprising one or more moieties prepared by reacting the one or more diepoxide monomers according to claim 14 with one or more diamines.

21. The polymer of claim 20, wherein the one or more moieties have a structure according to Formula (IX): 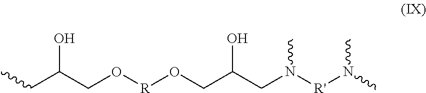
wherein R is derived from the diepoxides of Formulae (I)-(VI) and R′ is derived from a diamine.
